(19) United States
(12) Patent Application Publication
(10) Pub. No.: US 2026/0260192 A1
(43) Pub. Date: Sep. 3, 2026

(54) METHODS AND SYSTEMS OF FACILITATING MULTI-CLOUD FINANCIAL AND EXECUTION GOVERNANCE OF AN AUTOMATED WORKLOAD

(71) Applicant: Venkatesh Kumar Krishnaiah, Chantilly, VA (US)

(72) Inventor: Venkatesh Kumar Krishnaiah, Chantilly, VA (US)

(21) Appl. No.: 19/653,991

(22) Filed: Apr. 21, 2026

Related U.S. Application Data
(63) Continuation-in-part of application No. 19/373,174, filed on Oct. 29, 2025.
Application No. 19/373,174 is a continuation-in-part of application No. 18/929,223, filed on Oct. 28, 2024, now Pat. No. 12,481,945.
Application No. 18/929,223 is a continuation of application No. 18/657,347, filed on May 7, 2024, now Pat. No. 12,229,698.
Application No. 18/929,223 is a continuation-in-part of application No. 18/298,177, filed on Apr. 10, 2023, now Pat. No. 12,028,274.
Application No. 18/298,177 is a continuation-in-part of application No. PCT/US21/48091, filed on Aug. 27, 2021.
(60) Provisional application No. 63/230,416, filed on Aug. 6, 2021.
(60) Provisional application No. 63/553,995, filed on Feb. 15, 2024.

(51) Int. Cl. G06Q 10/0631; G06Q 10/0637

(52) U.S. Cl. CPC G06Q 10/06315; G06Q 10/06375

(57) ABSTRACT

The present disclosure provides a method of facilitating multi-cloud financial and execution governance of an automated workload. Further, the method may include analyzing the billing record to identify an eligible service category for a pricing adjustment. Further, the method may include computing reconstructed effective cost data for the billing record based on vendor contract data and the eligible service category. Further, the method may include detecting an anomalous execution behavior of the automated workload in a runtime execution environment based on execution telemetry data. Further, the method may include determining enforcement confidence data representing a control-authority level for applying a provider-native control action based at least in part on the reconstructed effective cost data and the anomalous execution behavior. Further, the method may include generating governance action data specifying a reversible operational state transition for the automated workload in response to the anomalous execution behavior and the enforcement confidence data.

### REFERENCE TO RELATED APPLICATIONS

This application is a continuation in part of U.S. patent application Ser. No. 19/373,174, filed on Oct. 29, 2025, which is a Continuation-in-Part of U.S. patent application Ser. No. 18/929,223 (U.S. Pat. No. 12,481,945), filed on Oct. 28, 2024, which is a Continuation-in-Part of U.S. patent application Ser. No. 18/657,347 (U.S. Pat. No. 12,229,698), filed on May 7, 2024, which is a Continuation-in-Part of U.S. patent application Ser. No. 18/298,177 (U.S. Pat. No. 12,028,274 B1), filed on Apr. 10, 2023, and claims the benefit of U.S. Provisional Application No. 63/230,416, filed on Aug. 6, 2021. The entire contents of each of the foregoing applications are incorporated by reference herein in their entirety.

### FIELD OF DISCLOSURE

The present disclosure generally relates to data processing. More specifically, the present disclosure relates to methods and systems of facilitating multi-cloud financial and execution governance of an automated workload.

### BACKGROUND

Cloud computing platforms are increasingly relied upon by enterprises to deliver scalable application hosting, data processing, artificial intelligence workloads, and managed execution services across geographically distributed environments. This field is important because cloud infrastructure is used to support mission-critical business operations, and because cloud consumption directly affects operational continuity, financial planning, and enterprise risk management. As organizations adopt multiple cloud providers and engage with distributors, resellers, integrators, and managed service providers, cloud execution environments and procurement structures have become more complex and difficult to manage using unified approaches.

A desirable objective in this field is to provide effective governance of cloud resource consumption across multiple cloud environments, including both financial oversight of procurement arrangements and operational oversight of automated workload execution, in order to maintain predictable spending, reduce waste, prevent uncontrolled consumption, and improve administrative visibility across heterogeneous cloud architectures.

However, existing approaches to cloud financial governance and execution governance may suffer from several technical and operational limitations. For example, cloud billing data may be represented using provider-specific formats, inconsistent service categorizations, and varying discount structures that may prevent accurate comparison or consolidation across multiple procurement pathways. In many cases, cloud services may be procured through multi-tier vendor relationships that apply layered pricing adjustments, discounts, markups, contractual exclusions, and service-related charges, thereby making it difficult to determine a reliable, effective cost for cloud usage. These procurement structures may also incorporate labor-related service components, contract-specific rate schedules, or tier-dependent fee models that may not be reflected in provider-native billing reports.

In addition, automated cloud workloads such as triggered services, scheduled jobs, managed execution services, auto-scaling resources, and machine learning pipelines may consume significant cloud resources without direct human invocation. Such workloads may experience runaway execution behavior caused by misconfiguration, recursive triggers, scaling anomalies, unexpected data volume, cascading dependencies, or scheduling faults. In such circumstances, consumption may accelerate rapidly and may generate excessive cost exposure before an operator can identify and intervene. Existing monitoring and alerting approaches may provide visibility into execution activity, but may be insufficient to prevent or mitigate excessive consumption in real time.

Further, enforcing operational control over automated workloads across multiple cloud platforms may be challenging due to differences in provider control mechanisms, inconsistent configuration interfaces, varying access permissions, and uncertainty regarding the reliability of enforcement actions. In some environments, configuration drift or incomplete authority may prevent safe modification of execution behavior. As a result, governance mechanisms may either fail to respond in a timely manner or may introduce operational disruption through incorrect or unsafe intervention.

Moreover, multi-cloud deployments may involve logically related workloads distributed across heterogeneous environments, accounts, and execution substrates, which may hinder unified governance under shared financial or operational policies. As used herein, the term “account” or “cloud account” refers to a logical billing, tenancy, subscription, project, or equivalent resource or workload boundary construct within a cloud service provider environment. The term may further encompass logical groupings of resources, workloads, services, deployments, application stacks, portfolios, or other execution constructs that may span one or more such boundary constructs, whether defined for billing, operational, governance, or organizational purposes. Fragmented governance may prevent consistent application of budget constraints, escalation policies, or risk controls across an organization's overall cloud footprint. These limitations may increase administrative burden, reduce predictability of cloud spending, and increase exposure to uncontrolled execution and resource consumption.

Therefore, there is a need for improved methods and systems for facilitating multi-cloud financial and execution governance of automated workload that may overcome one or more of the preceding problems.

### SUMMARY OF DISCLOSURE

This summary is provided to introduce a selection of concepts in a simplified form that are further described below in the Detailed Description. This summary is not intended to identify key features or essential features of the claimed subject matter. Nor is this summary intended to be used to limit the claimed subject matter's scope.

The present disclosure provides a method of facilitating multi-cloud financial and execution governance of an automated workload. Further, the method may include receiving, using a communication device, a billing record from a cloud provider system. Further, the method may include receiving, using the communication device, a vendor contract data from a procurement system. Further, the method may include receiving, using the communication device, an execution telemetry data from the cloud provider system. Further, the method may include analyzing, using a processing device, the billing record to identify an eligible service category for a pricing adjustment. Further, the method may include computing, using the processing device, a reconstructed effective cost data for the billing record based on the vendor contract data and the eligible service category. Further, the method may include detecting, using the processing device, an anomalous execution behavior of the automated workload based on the execution telemetry data. Further, the method may include determining, using the processing device, an enforcement confidence data representing a control-authority level for applying a provider-native control action to the automated workload. Further, the method may include generating, using the processing device, a governance action data specifying a reversible operational state transition for the automated workload based on the anomalous execution behavior and the enforcement confidence data. Further, the method may include storing, using a storage device, the reconstructed effective cost data. Further, the method may include storing, using the storage device, the governance action data. Further, the method may include transmitting, using the communication device, the governance action data to a client device.

The present disclosure provides a system for facilitating multi-cloud financial and execution governance of an automated workload. Further, the system may include a communication device. Further, the communication device may be configured for receiving a billing record from a cloud provider system. Further, the communication device may be configured for receiving a vendor contract data from a procurement system. Further, the communication device may be configured for receiving an execution telemetry data from the cloud provider system. Further, the communication device may be configured for transmitting a governance action data to a client device. Further, the system may include a processing device. Further, the processing device may be configured for analyzing the billing record to identify an eligible service category for a pricing adjustment. Further, the processing device may be configured for computing a reconstructed effective cost data for the billing record based on the vendor contract data and the eligible service category. Further, the processing device may be configured for detecting an anomalous execution behavior of the automated workload based on the execution telemetry data. Further, the processing device may be configured for determining an enforcement confidence data representing a control-authority level for applying a provider-native control action to the automated workload. Further, the processing device may be configured for generating the governance action data specifying a reversible operational state transition for the automated workload based on the anomalous execution behavior and the enforcement confidence data. Further, the system may include a storage device which may be configured for storing the reconstructed effective cost data and the governance action data.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a block diagram of a computing device for implementing the methods disclosed herein, in accordance with some embodiments.

FIG. 3 is a flow chart of a method 300 for facilitating controlling and managing cloud usage costs incurred by cloud accounts for using cloud resources of a cloud server, in accordance with some embodiments.

FIG. 4 is a flow chart of a method 400 for facilitating controlling and managing cloud usage costs incurred by cloud accounts for using cloud resources of a cloud server in which the method 400 may include determining a level of the cloud usage cost in relation to one or more threshold levels, in accordance with some embodiments.

FIG. 5 is a flow chart of the method 500 for facilitating controlling and managing cloud usage costs incurred by cloud accounts for using cloud resources of a cloud server in which the method 500 may include transmitting the one or more alerts to one or more devices associated with the one or more cloud accounts, in accordance with some embodiments.

FIG. 6 is a flow chart of a method 600 for facilitating controlling and managing cloud usage costs incurred by cloud accounts for using cloud resources of a cloud server in which the method 600 may include determining the level of the cloud usage cost, in accordance with some embodiments.

FIG. 7 is a flow chart of a method 700 for facilitating controlling and managing cloud usage costs incurred by cloud accounts for using cloud resources of a cloud server in which the method 700 may include creating the budget for the one or more cloud accounts, in accordance with some embodiments.

FIG. 8 is a flow chart of a method 800 for facilitating controlling and managing cloud usage costs incurred by cloud accounts for using cloud resources of a cloud server in which the method 800 may include determining the one or more threshold levels of the one or more cloud accounts, in accordance with some embodiments.

FIG. 9 is a flow chart of a method 900 for facilitating controlling and managing cloud usage costs incurred by cloud accounts for using cloud resources of a cloud server in which the method 900 may include analyzing the estimated cloud usage cost, in accordance with some embodiments.

FIG. 10 is a block diagram of a system 1000 for facilitating controlling and managing cloud usage costs incurred by cloud accounts for using cloud resources of a cloud server, in accordance with some embodiments.

FIG. 11 is a flowchart of a method 1100 for facilitating, controlling, and managing cloud usage costs incurred by cloud accounts of a cloud server, in accordance with some embodiments.

FIG. 12 is a flowchart of a method 1200 for facilitating overriding the attainment of the threshold cost by the at least one cloud usage cost, in accordance with some embodiments.

FIG. 13 is a flowchart of a method 1300 for estimating budgets for the cloud accounts of the cloud server, in accordance with some embodiments.

FIG. 14 is a block diagram of a system 1400 for creating, managing, and planning a budget for any given period or fiscal year across all the accounts in the cloud server, in accordance with some embodiments.

FIG. 15 is a flowchart of methods for creating, managing, and controlling the budget, budget schedules, and budget planning for the cloud accounts across multiple cloud service providers, in accordance with some embodiments.

FIG. 16 is a flowchart of a method 1600 for dynamically terminating cloud resources when the cloud resources are not in use, in accordance with some embodiments.

FIG. 17 is a flowchart of a method 1700 for facilitating managing budgets for cloud accounts, in accordance with some embodiments.

FIG. 18 is a flowchart of a method 1800 for facilitating managing budgets for cloud accounts, in accordance with some embodiments.

FIG. 19 is a flowchart of a method 1900 for facilitating managing budgets for cloud accounts, in accordance with some embodiments.

FIG. 20 is a flowchart of a method 2000 for facilitating managing budgets for cloud accounts, in accordance with some embodiments.

FIG. 21 is a flowchart of a method 2100 for facilitating managing budgets for cloud accounts, in accordance with some embodiments.

FIG. 22 is a flowchart of a method 2200 for facilitating managing budgets for cloud accounts, in accordance with some embodiments.

FIG. 23 is a flowchart of a method 2300 for facilitating managing budgets for cloud accounts, in accordance with some embodiments.

FIG. 24 is a flowchart of a method 2400 for facilitating managing budgets for cloud accounts, in accordance with some embodiments.

FIG. 25 is a flowchart of a method 2500 for facilitating managing budgets for cloud accounts, in accordance with some embodiments.

FIG. 26 is a block diagram of a system 2600 for facilitating managing budgets for cloud accounts, in accordance with some embodiments.

FIG. 27 is a block diagram of the system 2600, in accordance with some embodiments.

FIG. 28 is a block diagram of the system 2600, in accordance with some embodiments.

FIG. 29 is a block diagram of a system 2900 for facilitating managing budgets for cloud accounts, in accordance with some embodiments.

FIG. 30 is a graphical representation 3000 of a computation of a budget for a cloud account, in accordance with some embodiments.

FIG. 31 is a graphical representation 3100 of a triggering of the budget for the cloud account and an overriding of the triggering of the budget, in accordance with some embodiments.

FIG. 32 is a graphical representation 3200 of a modification of the budget for the cloud account and an overriding of an amount of the budget, in accordance with some embodiments.

FIG. 33 is a screenshot of a Monthly Budget & Threshold Status interface 3300 of a software application for managing budgets for cloud accounts, in accordance with some embodiments.

FIG. 34 is a flow diagram of a method 3400 for managing budgets for cloud accounts, in accordance with some embodiments.

FIG. 35 is a flow diagram of a method 3500 for facilitating scheduling of resources, in accordance with some embodiments.

FIG. 36 is a flowchart of a method 3600 for facilitating scheduling of cloud resources, in accordance with some embodiments.

FIG. 37 is a screenshot of an Update Schedule interface 3700 of a software application for facilitating managing budgets for cloud accounts, in accordance with some embodiments.

FIG. 38 is a screenshot of a Select Type of Schedule interface 3800 of the software application, in accordance with some embodiments.

FIG. 39 is a screenshot of a Create Holiday List interface 3900 of the software application, in accordance with some embodiments.

FIG. 40 is a screenshot of an Edit Standard Schedule interface 4000 of the software application, in accordance with some embodiments.

FIG. 41 is a screenshot of an Override Schedule interface 4100 of the software application, in accordance with some embodiments.

FIG. 42 is a flow diagram of a method 4200 for facilitating optimizing cloud resource utilization using a Proactive Resource Management System (Proms), in accordance with some embodiments.

FIG. 43 is a flow diagram of a method 4300 for setting a budget using the system 2600 for facilitating managing budgets for cloud accounts, in accordance with some embodiments.

FIG. 44 is a block diagram of a system 4400 for facilitating cloud budget management based on artificial intelligence, in accordance with some embodiments.

FIG. 45 is a flow chart of a method 4500 for facilitating cloud budget management based on artificial intelligence, in accordance with some embodiments.

FIG. 46 illustrates a flowchart of a method 4600 of facilitating intelligent budget governance for a cloud resource, in accordance with some embodiments.

FIG. 47 illustrates a flowchart of a method 4700 of facilitating intelligent budget governance for a cloud resource including determining, using the processing device 1004, an effective start date and an effective end date for a membership of the cloud resource within the hierarchical entity, in accordance with some embodiments.

FIG. 48 illustrates a flowchart of a method 4800 of facilitating intelligent budget governance for a cloud resource including evaluating, using the processing device 1004, the threshold variance at a plurality of hierarchical levels comprising a resource level, an account level, and a group level, in accordance with some embodiments.

FIG. 49 illustrates a flowchart of a method 4900 of facilitating intelligent budget governance for a cloud resource including predicting, using the processing device 1004, a future threshold breach, in accordance with some embodiments.

FIG. 50 illustrates a flowchart of a method 5000 of facilitating intelligent budget governance for a cloud resource including determining, using the processing device 1004, an approval status corresponding to the override request, in accordance with some embodiments.

FIG. 51 illustrates a flowchart of a method 5100 of facilitating intelligent budget governance for a cloud resource including associating, using the processing device 1004, an identifier with the audit entry to enable reproducibility of an evaluation result, in accordance with some embodiments.

FIG. 52 illustrates a flowchart of a method 5200 of facilitating intelligent budget governance for a cloud resource including generating, using the processing device 1004, a forecast visualization data representing the group budget status, the threshold variance, and the control intent data, in accordance with some embodiments.

FIG. 53 illustrates a block diagram of a smart budget grouping and schedule enforcement architecture 5300, in accordance with some embodiments.

FIG. 54 illustrates a block diagram of a hierarchical grouping engine and portfolio rollup architecture 5400, in accordance with some embodiments.

FIG. 55 illustrates a flowchart of a schedule creation and holiday definition workflow 5500, in accordance with some embodiments.

FIG. 56 illustrates a planning-period rollup graph 5600, in accordance with some embodiments.

FIG. 57 illustrates a flowchart of a policy-handling engine 5700, in accordance with some embodiments.

FIG. 58 illustrates a flowchart of an override and approval routing 5800, in accordance with some embodiments.

FIG. 59 illustrates an audit and reporting table 5900, in accordance with some embodiments.

FIG. 60 illustrates a block diagram of a resource scheduling engine 6000, in accordance with some embodiments.

FIG. 61 illustrates a flowchart of an operational workflow 6100, in accordance with some embodiments.

FIG. 62 illustrates a flowchart of a decision framework 6200, in accordance with some embodiments.

FIG. 63 illustrates a centralized control plane architecture 6300, in accordance with some embodiments.

FIG. 64A illustrates a flowchart of a method 6400 of facilitating multi-cloud financial and execution governance of an automated workload, in accordance with some embodiments.

FIG. 64B illustrates a continuation of the flowchart of the method 6400 of facilitating multi-cloud financial and execution governance of an automated workload, in accordance with some embodiments.

FIG. 65 illustrates a flowchart of a method 6500 of facilitating multi-cloud financial and execution governance of an automated workload including generating, using the processing device 7404, an eligibility flag for application of a pricing adjustment to the billing record, in accordance with some embodiments.

FIG. 66 illustrates a flowchart of a method 6600 of facilitating multi-cloud financial and execution governance of an automated workload including filtering, using the processing device 7404, the charge attribute from the pricing adjustment, in accordance with some embodiments.

FIG. 67 illustrates a flowchart of a method 6700 of facilitating multi-cloud financial and execution governance of an automated workload including aggregating, using the processing device 7404, the adjusted cost data to generate the reconstructed effective cost data, in accordance with some embodiments.

FIG. 68 illustrates a flowchart of a method 6800 of facilitating multi-cloud financial and execution governance of an automated workload including combining, using the processing device 7404, the labor cost data with an infrastructure cost component to generate the reconstructed effective cost data, in accordance with some embodiments.

FIG. 69 illustrates a flowchart of a method 6900 of facilitating multi-cloud financial and execution governance of an automated workload including inhibiting, using the processing device 7404, the generating of the governance action data when the configuration deviation metric exceeds a predefined threshold, in accordance with some embodiments.

FIG. 70 illustrates a flowchart of a method 7000 of facilitating multi-cloud financial and execution governance of an automated workload including assigning, using the processing device 7404, a severity level to the anomalous execution behavior, in accordance with some embodiments.

FIG. 71 illustrates a flowchart of a method 7100 of facilitating multi-cloud financial and execution governance of an automated workload including generating, using the processing device 7404, an advisory notification data representing a predicted cost exposure derived from the reconstructed effective cost data, in accordance with some embodiments.

FIG. 72 illustrates a flowchart of a method 7200 of facilitating multi-cloud financial and execution governance of an automated workload including recording, using the storage device 7406, the provider-native control instruction in a governance log, in accordance with some embodiments.

FIG. 73 illustrates a flowchart of a method 7300 of facilitating multi-cloud financial and execution governance of an automated workload including restoring, using the processing device 7404, the runtime configuration snapshot to reestablish an original execution state without modifying application code, in accordance with some embodiments.

FIG. 74 illustrates a block diagram of a system 7400 of facilitating multi-cloud financial and execution governance of an automated workload, in accordance with some embodiments.

FIG. 75 illustrates an example integrated architecture 7500 of a multi-cloud financial and execution governance system in which procurement-layer vendor modeling, execution-layer governance, financial modeling, analytics, and user interaction components operate in a coordinated framework, in accordance with some embodiments.

FIG. 76 illustrates an example vendor-chain representation and associated cost reconstruction workflow 7600 in which a cloud service provider and one or more optional intermediary vendor tiers contribute pricing adjustments, commercial terms, and optional labor or service overlays that collectively influence effective cost and procurement governance, in accordance with some embodiments.

FIG. 77 illustrates an example service-level classification and discount eligibility workflow 7700 for reconstructing effective cost records from provider billing and usage data, in accordance with some embodiments.

FIG. 78 illustrates an example reconstructed effective cost workflow 7800 in which provider-reported billing and usage records are processed through vendor discount and markup adjustment logic, combined with optional labor and service cost overlays, filtered using excluded or pass-through cost components, and transformed into reconstructed effective cost records that support downstream financial modeling and vendor comparison, in accordance with some embodiments.

FIG. 79 illustrates an example workload telemetry flow 7900 in which execution-related signals generated by cloud workloads and managed services are collected, normalized, analyzed, and transformed into execution telemetry output signals used by an execution-layer governance system, in accordance with some embodiments.

FIG. 80 illustrates an example Runaway Guard detection and response architecture 8000 for monitoring execution-layer risk of an automated workload and generating graduated governance responses based on behavioral telemetry analysis, configuration drift detection, policy evaluation, and response selection, in accordance with some embodiments.

FIG. 81 illustrates an example workflow 8100 for performing runtime operational state transitions for cost governance in which an automated workload may be transitioned between an active workload state, a minimal-cost operational state, and a cost-eliminated operational state, while preserving original configuration state for later restoration, in accordance with some embodiments.

FIG. 82 illustrates an example configuration 8200 for cross-environment workload grouping for unified governance, in which workloads executing across heterogeneous environments are logically grouped under a shared policy group that applies coordinated financial and operational governance policies independent of deployment platform or execution location, in accordance with some embodiments.

FIG. 83 illustrates an example combined financial and execution-layer governance workflow presented through a user interface, in which a governance system provides execution telemetry analytics, generates runaway risk guidance, enables selection of an execution governance mode, and applies a selected execution control configuration to manage cost and runaway behavior of an automated workload, in accordance with some embodiments.

FIG. 84 illustrates an example combined financial and execution-layer governance workflow 8400 in which vendor-chain economics, reconstructed effective cost data, contract conditions, and execution-layer signals are collectively evaluated to generate workload governance decisions including advisory notifications, scheduling adjustments, configuration guidance, validation alerts, and optional execution-layer enforcement actions, in accordance with some embodiments.

### DETAILED DESCRIPTION OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and is made merely for the purposes of providing a full and enabling disclosure. The detailed disclosure herein of one or more embodiments is not intended, nor is to be construed, to limit the scope of patent protection afforded in any claim of a patent issuing herefrom, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denote “at least one,” but do not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issued herefrom. The present disclosure contains headers. It should be understood that these headers are used as references and are not to be construed as limiting upon the subject matter disclosed under the header.

The present disclosure includes many aspects and features. Moreover, while many aspects and features relate to, and are described in the context of methods, systems, apparatuses, and devices for facilitating managing budgets for cloud accounts, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smart phone, an Internet of Things (IOT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding, and decoding. Further, the server computer may include a communication device configured for communicating with one or more external devices. The one or more external devices may include, for example, but are not limited to, a client device, a third-party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data fingerprinting, role-based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g., transmitting and/or receiving) with one or more sensor devices and/or one or more actuators in order to perform authentication. For example, the one or more steps may include receiving, using the communication device, the secret human-readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state (e.g. motion, direction of motion, orientation, speed, velocity, acceleration, trajectory, etc.) of the device corresponding to the performance of the one or more steps, and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor, etc.), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the one or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more devices operated by the one or more users. Further, the one or more predefined conditions may be stored in the storage device. Alternatively, and/or additionally, in some embodiments, the one or more predefined conditions may be automatically determined, using the processing device, based on historical data corresponding to the performance of the one or more steps. For example, the historical data may be collected using a storage device from a plurality of instances of performance of the method. Such historical data may include performance actions (e.g., initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and the performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity, such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview:

The present disclosure describes systems, methods, apparatuses, and devices for facilitating managing budgets for cloud accounts. Further, the managing of the budgets may include controlling the budgets for the cloud accounts.

Further, the present disclosure describes a system and a method for facilitating controlling and managing cloud usage costs incurred by cloud accounts due to their utilization of various cloud resources, such as computing power, databases, storage, and other services. The disclosed system may include a centralized cloud usage-cost management system for setting up one or more cloud account budgets, multi-level thresholds, alerting, and/or controlling and monitoring the usage cost, limiting resource usage by a given threshold, and facilitating Information Technology (IT) cloud budget planning. The disclosed system may be configured to control multiple cloud account budgets across multiple cloud providers interactively over the defined period from a centralized interface. The disclosed system may be configured to set up the allocated budget for the cloud account for a given period or financial year set by the enterprise budget team. The System monitors the budget and controls the cloud usage cost to help the organization manage cloud usage costs on the allocated budget for the given period or execute fixed price cloud usage-cost projects. The System monitors monthly usage costs and sends alerts to the administrator and/or product/application owner if the usage costs exceed threshold levels on the cloud usage cost. Further, the disclosed system may be configured to control the cloud usage cost and not to initiate further cloud resources unless the account usage cost is brought back to below threshold levels or overriding set thresholds by adding funds or exceptions. Further, the disclosed system may be configured to provide Artificial Intelligence (AI)/Machine Learning (ML) based budget estimation for any given period or fiscal year based on similar workloads and/or enterprise historical usage-cost data. This estimation is used for IT cloud budget planning, forecasting cloud usage costs, and cloud cost and budget management across cloud accounts. Further, the disclosed system may be configured to generate various reports on the show back and/or chargeback, IT cloud budget planning, budget planner, AI-based multi-cloud cost savings recommendation, etc.

Further, the disclosed system may be associated with a centralized cloud budget planner. The disclosed system may be associated with a unified management console to plan, manage, and control cloud usage cost spending of products or cloud applications from development to Operation and Maintenance (O&M). The disclosed system is configurable to set up multi-level budget thresholds and alerts across all the cloud accounts to notify if the set budget cost has reached the threshold on any given period. Suppose the set budget reached a critical threshold. In that case, the system may restrict the spinning of more cloud resources in that cloud account or subscription unless terminating the existing resources, which are already influencing usage cost to bring it below the set critical threshold level for that period, or overriding set thresholds by adding funds or exceptions. Cloud usage costs may surge beyond the allocated budget threshold for various reasons. Developers or application teams run multiple environments without shutting down unwanted environments or run numerous test resources or spin oversized resources, or may be forgotten resources, etc. These unwanted resources may ramp up the usage cost, preventing recovery of the metered cost, which impacts project execution, deliverables, and creates funding chaos.

Further, the disclosed system may be configured to allow overriding the budget amount during any given period due to changes in application design or requirements, or funding, or any negations to override the critical threshold point, allowing the reset to new threshold levels. If a project or product requires restructuring the whole budget based on the application design changes, the system may reconfigure the budget at any time.

Further, the disclosed system may be configured to plan, manage, and control the allocated budget for the project or product cloud accounts and maintain the applications over the multi-cloud infrastructure ecosystem. Further, the disclosed system may be configured to collect all the organization's cloud accounts from the different cloud providers' master/payer accounts, classify the organizational accounts based on the Cloud Service Providers (CSP), associate the product or project information with the accounts, and map the associated charge code. Through a unified console, the disclosed system may be configured to create a budget plan for an account, manage a budget plan, and create a new budget plan for the entire portfolio of cloud accounts for a given period or fiscal year. Budget and cost control systems can be implemented on any virtual machine or server, or provided as software as a service from a remote server as a managed service. The system has a unified interface to log in and manage the entire enterprise's multi-cloud accounts, cost control, and budget planning system. The unified interface console can be accessed through an Internet web browser from a computer device, mobile phone, tablet, or any device with a compatible Internet web browser.

Before accessing the system, a user may log in to the system through a unified interface. As discussed before, administrative (admin) users, finance users, cloud infrastructure users, project/product/application users, or any stakeholder users can access the system. By default, one admin user exists for the initial system setup and configuration. The system allows a different type of user access to be created based on the duties, as per information technology data security industry standard requirements. The system allows categorizing the users by admin, technical, and viewer, based on the access type that the individual access policies are attached to the different users. Admin users can access and set all the system-level configurations, page defaults, field default values, drop-down lists, data feed, cloud cross-account access, configure budget data, create users, and reset user passwords. Admin users also have all other users' permissions by default. Technical users can add, edit, update cloud accounts, set up a budget for an account, data feed, budget planner for the given period or fiscal year, report, and dashboard. The viewer user can view the shared dashboard, generate the reports, search, and view cloud-account information and budget information.

To set up a budget and/or budget planning or cost control for a cloud account, at least one cloud account, related business product/project information, and cloud vendor, provider, or reseller information should exist. First, cloud service provider, vendor, or reseller information is collected before importing respective cloud accounts and enterprise product information. The system allows capturing cloud service provider, vendor, or reseller information. The required vendor information is captured and can include, but is not limited to, vendor-name, contract period, contract number, service provider, task, scope, markup, admin fees, discount, credits, and status. This vendor information is automatically mapped to the vendor's name associated with the cloud accounts. If captured vendor details from the cloud account do not have the correct information, the system enables a manual mapping of the vendor information. This manual mapping takes precedence over automapping.

Cloud account information may be captured by manually entering each account's information through the cloud account information entry page or by using the bulk import interface. Required cloud-account information is captured and can include, but is not limited to, account number, account-name, account-status, cloud service provider, vendor/reseller name, creation date, organization group, join method, etc. For bulk account information, imports can be uploaded through Comma-Separated Values (CSV) format files. This bulk account information is retrieved and exported from resellers' billing, master, payer, subscription, project, or equivalent provider management hierarchies, or can be created manually in a CSV format. If an account is already present during bulk account import, those accounts are not imported, and the system creates a rejected duplicate list for further review.

Most organizations have a broader Business Product Components classification to view the budget and IT spending by business area, components, portfolio, product, product line, cyber identification (ID), etc. The system also allows to input organization-specific bulk product information import via CSV format. The system captures enterprise-specific business product information through the product information entry page. The required product/project information is captured and can include, but is not limited to, project ID, Project, business area, business unit, portfolio, product line, product owner, master system technical lead, cost center, etc. These system field names are dynamically configurable to align with enterprise or agency-specific business field names or naming standards through admin login. Once the accounts and business product information are captured in the system, the system automatically maps the product name associated with the cloud account using the account name. For example, when the cloud account name is not aligned with the business product name or any changes in the business-naming conventions, the system allows manual mapping of the product name to the account ID. Manual mapping overrides auto mapping to avoid ambiguity.

Further, the system allows input of any vendor's markups, administration fees, discounts, and credits associated and/or negotiated from the vendor, reseller, or cloud service provider. These fees, discounts, and credits are part of budget formulation on top of cloud service provider usage costs. To accurately forecast budget planning and monitor the budget burndown rate, the system allows vendor fees and discounts to be included in part of the budget planning and cost control on cloud accounts. By enabling markup, discounts, and credits as part of the budget formulation, the system accurately tracks the organization's cloud IT spending.

Further, the system has the feature to normalize the billing and utilize the data to remove duplicate tags, misspelled tags, assign missing tags to categorize, resources grouping, resource automation, security management, resource triggers, alerts, group products, and map the resources to the product or project the resources belong to. This feature aligns with organization resource tag classification, so that there are no misaligned or untagged tag resources to track accurate budget and cost tracking. Further, the disclosed system may be configured to allow adding additional tags to track by environment, vendor, external/internal, etc., to help track budget spending by the environment, vendor, external/internal, etc. Further, the disclosed system may be configured to allow for manual entry of tag-mapping or bulk upload through to a tag and mapping interface.

Advanced charge code mapping allows tracking the budget and burn rate of the product or project by the project, environment, phases, and releases on a weekly, monthly, yearly, and even by Agile Sprints levels. These financial reports are also to be used for the showback or chargeback. Further, the disclosed system may be configured to allow entering the organization-specific charge code through the chargeback interface. The required charge code information is captured and can include, but is not limited to, project name, program name, account, start date, end date, etc., and budget schedule to the respective cloud account. On the cloud account side, once the cloud account receives new or changes in the budget schedule, the serverless budget governance agent may execute the budget schedule and set all required budget parameters to that cloud after capturing cloud accounts, vendor information, and product information, the system is ready to create a budget for the cloud accounts and/or generate a budget plan for any given period. The system allows the creation of a budget for an account for a given period and/or creates a budget plan for a given period or fiscal year. To create a budget for an account, an account from the existing account list is chosen, and budget details are entered, including, but not limited to, start date, end date, allocated or computed budget amount for the period, warning threshold, and critical threshold. Once all required budget information is entered, the system may generate a monthly budget plan for the account before pushing the budget information relevant to the cloud service provider account. The budget is validated and submitted to enforce the budget governance on that cloud account. Once the budget is submitted, the system may generate a schedule via the budget scheduler module to push the account. After successful budget governance is set to the account, the agent validates and sends the budget status back to the budget and cost control system to make sure the budget values set at the cloud account align with the budget values set on the system. After receiving the status, the budget scheduler validates the feedback received from the cloud account versus the budget schedule in the system. If there is any misalignment from the budget set at the cloud account, the budget scheduler engine pushes the schedule again. The schedule engine tries several times before raising the deviation or error notice at the panel or in the schedule status report. If the budget schedule engine does not receive feedback from the cloud account, the schedule engine tries multiple times before raising an alert or notice at the interface panel and marks that budget as failed to set.

Once the budget is set, the schedule engine periodically pulls the budget information from all the cloud accounts to make sure the budget information aligns with the budget set in the system. If any deviation is found, the budget scheduler pushes the schedule to that account to align with a set value. If there is any budget information access issue from the cloud account, the system sends alerts and generates an error report for validation and auditing purposes. This validation process helps to identify any changes in the cloud component, network-related issues, any deviation or manipulated budget at an account level, compromised accounts, or policy changes that caused budget and cost control to break. Any component or service may break due to the dynamic nature of the cloud service provider's managed resources, services, and/or any changes that occur at the infrastructure level. Deviation from the budget set at the system compared to the account-level budget due to manipulation or a compromised cloud account may also be identified.

Further, the budget and cost control system allows configuring multiple levels of thresholds based on control preference. For example, the multi-level warning threshold can be set to send warning alerts on the budget amount spent. The critical threshold can be set to send a critical alert on the budget amount spent. An add-on feature on the critical threshold setting restricts the spin of more resources to control the cost until the usage cost consumption goes below the set critical threshold value. This feature is more beneficial for the development environment to keep cost control on the projected budget burn rate on the allocated funds. For example, if a warning threshold is set at 70% on the allocated account budget, the system sends the warning alert to the respective team when the usage hits 70%. If a critical threshold is set at 90% on the allocated account budget, a critical alert is sent when the usage hits 90%. Suppose the critical threshold, along with the resource restriction feature, is enabled. In that case, the system sends a critical alert and stops spinning more resources on that account to control the cost until the usage cost consumption goes below the set critical threshold value.

Further, the system allows changing the budget that has already been created or is in place for any changes in the project funding, budget schedules, and architectural changes that affect the usage cost and override the critical threshold for the given period. If there are any changes in the project funding or budget, the system allows updating the new amount on the existing budget. If there is a change in the schedule and the amount, the system enables making those changes, and those updated budget schedules are pushed to the appropriate account. One of the system's main features is to enter the override amount on the critical threshold that has been triggered. For example, a critical alert is triggered when the budget burn rate reaches 90% of the monthly set budget, and the cloud account is restricted from spinning more resources. In this scenario, the system allows overriding of the budget amount by adding the budget amount for that month. This feature avoids a deadlock scenario on the cloud account to override the resource spin restriction. There are several common scenarios in the development environment to spin up more resources than required, which are not anticipated during the project planning and design phase. Here are a few scenarios that burn up the allocated monthly budget: (1) underestimating resources or capacity needed during the design phase, (2) forgetting resources that are not noticed, which are being charged, and consume the allocated budget, (3) spinning oversized resources than required for testing purposes, and (4) creating too many test resources and/or resource stacks that are not shut down and are not required.

Further, the disclosed system may be configured to allow the creation of a budget planner for the fiscal year or any given period. This budget planner monitors budget burndown cost, sends threshold alerts, controls cloud usage cost, and also restricts the cloud account to not allow more resources to be brought up to avoid usage costs beyond the allocated budget. In the system, budget planning can be created in three methods, namely, (1) creating a budget plan for an individual account through a budget planning interface, (2) creating a new budget plan from the previously existing budget year/period plan, or (3) creating a new budget plan through a bulk upload through CSV format for the entire or part of all the cloud accounts. The second method may include creating a new budget plan from a previously existing budget year or period plan through the budget planner interface page. Upon entering new start and end dates for the applicable accounts, the system allows selective modification of parameters, including threshold values and allocated budget amounts for individual accounts. In an embodiment, the system may automatically compute a projected budget amount for the new fiscal period based on one or more growth-rate parameters, including but not limited to a fixed percentage increase, compound annual growth rate, historical trend-based increase, capacity-based scaling factor, or configurable growth rule defined per cloud account, application group, organizational unit, or enterprise-wide level. The system applies the selected growth-rate parameter to the prior period's allocated budget amount to generate a projected budget for the upcoming period, which may be automatically populated in a draft state within the budget planner interface to allow user review, modification, approval, or override prior to publishing. Upon publishing, the system enables save or save-and-publish functionality, and the new budget becomes active according to the specified start and end dates. Further, the third method may include creating a new AI-based forecasted budget estimation plan based on historical or last year's cost consumption through the budget planner interface page. By entering the new start and end dates for all accounts, the system allows to selectively change dates and other values like threshold, the budget amount, and so on for individual accounts. Once the new AI-based forecasted budget plan is updated, the system enables it to save and/or save and publish. The new budgeting is active based on the start and end dates mentioned in the plan.

Further, in an embodiment, the disclosed system may be configured to upload the bulk budget plan through CSV format for all cloud accounts or some cloud accounts. The existing budget for all cloud accounts is exported in CSV format. Then, the exported file is opened, and the new start and end dates are edited, as well as the threshold percentage, the budget amount, and other values for the cloud accounts. The updated budget file is then imported into the system to publish the new budget. Further, in an embodiment, the disclosed system may be configured to create a budget plan in the CSV file for the cloud accounts that need to control budget and usage costs. To create a bulk budget plan for the cloud accounts, the cloud-account numbers and budget details are entered, including, but not limited to, start date, end date, allocated budget amount for the period, warning-threshold in percentage, and critical-threshold in percentage. The newly created CSV file is then uploaded to the system and saved before publishing the Budget. Furthermore, the system generates various finance, show back/chargeback, and IT budget plan reports, which play a crucial role in IT planning, cloud IT cost distribution, cloud infrastructure cost of ownership, and auditing. The system uses an ML algorithm to generate AI-based budget estimates for the next budget based on the previous year's or period usage cost consumption.

Regarding cloud IT budget planning, analysts and managers have to reach out to various teams to pull the historical cloud usage-cost data for Total Cost of Ownership (TCO) analysis for the cloud IT planning. Capacity and forecast estimation need to be calculated for the application or project to compute an accurate IT budget formulation. These calculations are often manual, which can be time and resource-consuming. To avoid this, the disclosed system may be configured to eliminate all these manual processes by providing AI-based budget estimate recommendations. The system also provides the provision to include markups, discounts, and credits from vendors and/or cloud resellers. This allows the system to provide the exact budget estimate recommendations required for the given period. In addition to AI-based budget estimate recommendations, the system can automatically generate cloud account budget estimation, forecasting, and planning for the next budget period or fiscal year. The engine for the AI-based budget estimate recommendations can be built using commercially available services offered by cloud service providers or third-party vendors, or through proprietary systems developed in-house. Further, AI estimation services can utilize one or more models generated using different methods including, but not limited to, machine learning, deep learning, predictive analytics, natural language processing, and intelligent data discovery. The different models for cost forecasting can be tuned from historical usage-cost data captured by the system on the cloud accounts. The system computes the data generated by the AI estimation service to provide budget estimation forecast recommendations for the given period or the next budget cycle. Further, the disclosed system may be configured to generate several reports using the report and analytical engine. Using an analytical engine, the user can create and interact with visuals and tell data-driven stories. Some data points represent a significant event, and others represent a random occurrence. The analysis uncovers which data is worth investigating, based on what driving factors (key drivers) contributed to the event.

Further, the system has several cloud cost management features to manage the cloud usage cost within the allocated fixed budget that the users can set through a unified cost management interface. This feature enables the organization to manage the cost of fixed budget projects, applications, or services within the allocated funds. This cost management feature also enables management and enforcement of cloud usage costs within the allocated or available budget and may automatically throttle, restrict, and/or shut down cloud resources or associated workloads when not necessary to prevent budget overruns. This unified interface eliminates the tedious job of logging into individual accounts and manually shutting down resources across multiple clouds to stop cloud resources and save on usage costs. Using this unified interface, users can define or configure budget parameters, budgeting periods, and scheduling policies for the project/application, wherein the system is configured to automatically apply and dynamically adjust execution schedules and selectively throttle, restrict, or shut down cloud resources or associated workloads based on enterprise working hours, custom-defined schedules, dynamic or policy-driven scheduling conditions, service level requirements (SLAs), or operational policies.

Further, the main feature of the system is to remotely control usage costs by throttling endpoints on how much the enterprise wants to spend the funds or budget over a given period to provide services. This feature enables the organization to control how much customers can utilize the enterprise contents and/or services without hogging the application bandwidth or interrupting other customers who want to use the same services, and not bring down the entire application. This handy feature for the organization enables control over funds and throttles the data miners on publicly disseminated information like historical labor statistics data, census data, research and national archives data, patent and trademark data, media content delivery, bulk download contents, etc.

The system also has an integrated visualization dashboard. The visualization dashboard is a graphical representation of data. A dashboard is a read-only snapshot of an analysis to share with other users for reporting purposes. A dashboard preserves the analysis configuration at the time of publishing, including filtering, parameters, controls, and sort order. The data used for the analysis is dynamic, and the visualization dashboard reflects the current data in the data sets used by the analysis. The system visualization dashboard consists of several visualization pages with associated reports. Some of the reports include, but are not limited to, billing summary, tagged/untagged services usage cost, budget monitoring, AI-based anomaly detection, budget burn rate, AI-based forecast, and AI-based multi-cloud, multi-account savings plan recommendation.

The billing summary includes a summary of consolidated cloud usage costs at an organization level, which shows usage costs by account, associated project, and product, as well as any chargeback over the selected period. Tagged/untagged services usage cost shows the usage of the different environments by accounts, by services with tags, or by untagged cloud resources (system, environment, business area, etc.). Budget monitoring includes a high-level view of monitoring account usage by comparing it with the monthly budget allocated per account. The visuals show the comparison between the actual usage cost of an account versus the budget amount allocated to the account monthly. AI-based anomaly detection shows the outliers, spikes, or deviations in the usage cost or budget that fall outside a distribution pattern. Anomaly detection identifies the causations and correlations to enable users to make data-driven decisions. AI-based forecast shows key business metrics, which are the costs for a forward period, which can be configured as per the requirement. Analytics insight is a quick data interpretation that gives a high-level takeaway from the visuals the system creates. These insights enable the user to perform any computation, using customized wordings to provide context to the fields. AI-based multi-cloud, multi-account savings plan recommendation includes the most frequently computed, database, storage, and other metered resource utilization categories across all the cloud accounts breakdown by product/portfolio. These statistics help the organization generate purchase saving plans/committed-use discounts and reserved capacity recommendations for targeted compute, database, storage, networking, and other billable cloud services across various cloud platforms. This approach facilitates substantial savings on on-demand multi-cloud resource consumption costs compared to the costs of long-term committed or prepaid resource purchases. Using these explorative analytics, the user can perform deep-dive analysis by drilling down to specific cloud resources, pricing, and other specifications. This offers the ability to monitor budget control, cost savings, and optimization. This also provides the flexibility in cost comparison between multi-clouds for long-term investments and savings plans. Further, the disclosed system may be integrated with an enterprise active directory to set up email notifications. The disclosed system may be configured to send email notifications and alerts to various users and teams, such as sending the budget summary alerts, multi-level soft and hard cap threshold alerts, burn-rate alerts, monthly finance reports, executive reports, etc.

Further, the present disclosure describes AI-based methods and systems for cloud budget management for optimizing financial oversight across cloud platforms. Tailored for federal sectors and corporations, the disclosed system features real-time tracking, forecasting, and optimization, integrated into a simplified workflow. This system ensures strategic resource allocation and adherence to budget constraints, enabling efficient and effective cloud spending management.

Further, the present disclosure describes a cloud budget management system and methodology which serves as a foundational framework for managing cloud spending across multiple platforms and accounts. The disclosed system and methodology are deeply intertwined with optimizing cloud resource utilization and minimizing unnecessary expenditures, thereby addressing the dual challenges of operational efficiency and fiscal discipline.

Further, the disclosed system may be associated with the disclosed system's two fundamental design elements: Advanced ProActive Budget Monitoring and Management—for cloud resources and Cloud Storage (Object Storage, Block Storage, File Storage, Data Archives, Snapshots, Images, Volumes, data files) and ProActive Resource Management System.

Further enhancing its value, the disclosed system may be instrumental in dealing with the intricacies of fixed price contracts across both government and commercial sectors while simultaneously ensuring efficient management of cloud resources. By aligning with the evolving and varied cloud usage demands of these sectors, the disclosed system may be configured for maintaining predictable cloud-related expenses. This commitment to innovation in financial management allows the disclosed system to not only fulfill but exceed the rigorous expectations arising from stringent budget constraints and the flexible needs of government and commercial bodies. Through its comprehensive approach, the disclosed system stands as a testament to the adaptability and efficiency required in today's fast-paced cloud computing environment.

Further, automated and AI-powered Budget Management in the disclosed system empowers organizations with enhanced cost efficiency, enabling precise control over cloud spending. Further, the disclosed system may be configured to provide improved financial oversight and adaptability, ensuring optimal resource allocation and strategic agility in cloud resource utilization.

Further, the disclosed system may be configured for facilitating budget management by integrating artificial intelligence (AI) into a cloud budgeting tool associated with the disclosed system. This integration focuses on using synthetic data alongside real budget historical data for early detection of budget anomalies.

In this example, an annual budget is set at $120,000, corresponding to a standard monthly allocation of $10,000. A monthly cap may be limited to 80% of the standard monthly allocation, equating to $8,000. A daily spending limit may be calculated by dividing the $8,000 monthly cap by the number of days in the applicable billing period. For example, assuming a standardized 30-day month, the daily spending limit would be approximately $267 per day. The daily limit may be dynamically adjusted based on the actual number of days in a given month or billing cycle.

### Implementing Synthetic Data Generation for AI Training:

Generating Synthetic Data: The disclosed system generates a dataset that reflects various spending patterns, including typical daily expenses, sudden spikes, and gradual increases. This dataset is designed to simulate the range of scenarios that might occur in real project management.

Training AI with Synthetic Data: Further, the AI model associated with the disclosed system is trained using this synthetic dataset, enabling it to recognize standard spending patterns (around $267/day) and identify anomalies or unexpected spikes.

Incorporating Real Project Data: By blending real project data with the synthetic dataset, the disclosed system's AI model refines its predictive capabilities, adapting to the unique characteristics of each project's spending patterns.

Further, the disclosed system may use AI for early detection. Further, the early detection encompasses:

Monitoring Daily Spending: The AI system continuously compares actual daily spending against both synthetic data patterns and the $267/day benchmark.

Identifying Anomalies: The AI is programmed to flag significant deviations from expected spending patterns, such as sudden spikes or consistently higher daily expenditures.

Early multi-level Warning System: These alerts serve as an early warning system, notifying project managers of potential budget issues before they become critical. Advantages of AI Integration in the disclosed system:

Customized to Project Specifics: The AI, trained on a diverse set of synthetic data, is adept at adapting to various project spending patterns, regardless of the project's budgeting and SDLC stages.

Proactive Budget Management: This approach empowers proactive budget control, allowing for timely adjustments before reaching the monthly cap, set in this example at 80% or incurring overspending.

Data Enrichment: In cases where historical data is limited, synthetic data enriches the AI's training, enhancing its effectiveness as a budget analysis tool from the start.

By leveraging synthetic data generation to train the disclosed AI model, the disclosed system offers a robust and effective strategy for early detection in budget management. This innovative approach allows the AI to learn from a broad spectrum of spending scenarios, applying this knowledge to monitor and analyze real project spending. Consequently, the disclosed system enhances budget management by providing early alerts to potential issues, facilitating more informed and timely decision-making.

Further, the present disclosure describes a system, CloudPause, configured for intelligent predictive cloud capacity management.

Further, the disclosed system may be configured for revolutionizing cloud cost management with advanced scheduling features. In the ever-evolving landscape of cloud computing, effective cost management remains a paramount concern for businesses worldwide. Further, the disclosed system emerges as a trailblazing solution, offering a comprehensive suite of features designed to optimize cloud resource usage and significantly reduce costs.

Tackling the Billion-Dollar Cloud Waste Challenge: The disclosed system addresses a critical issue plaguing many organizations—the wastage of resources and funds due to idle cloud assets. A significant portion of the cloud budget drain can be attributed to development, testing, and internal-facing applications that are operational 24/7, despite not being required outside the development team's working hours.

The disclosed system's initiative to combat the billion-dollar cloud waste challenge is not just a fiscal endeavor but also an environmentally conscious effort. Further, the disclosed system reduces the significant energy consumption and greenhouse gas emissions associated with these facilities. The solution lies not only in shifting towards renewable energy sources but also in innovating cooling methods, server usage, and data center design to enhance efficiency. Additionally, responsible e-waste management, prolonging hardware lifespan, and tackling the environmental costs of construction and chip scarcity are key aspects of this approach.

Further, the disclosed system's initiative extends beyond fiscal responsibility, contributing to an environmentally conscious effort. By optimizing cloud resource usage, the disclosed system may lower energy consumption and greenhouse gas emissions, aligning with sustainable practices in Federal projects and beyond. Further, the present disclosure describes innovative cooling methods, efficient server usage, and responsible e-waste management, addressing the broader environmental impact of cloud computing. This commitment positions the disclosed system as a leader in sustainable cloud management, balancing cost-effectiveness with environmental stewardship in Federal and large-scale projects.

Further, the disclosed system is a paradigm shift in the domain of data processing, specifically tailored to the intricacies of cloud computing. The disclosed system is an AI-powered platform designed to furnish a unified console for the orchestration and optimization of cloud budgets across diverse cloud platforms and multiple accounts. This innovation addresses the complex demands for stringent budget adherence, enhanced operational efficiency, and strategic financial planning within a singular, integrated framework, catering to the nuanced requirements of both federal sectors and corporations.

Further, the innovations and systems associated with the disclosed system are as follows:

ProActive Budget Alert System (ProBAS): A system configured within the disclosed system for revolutionizing cloud financial management through the utilization of artificial intelligence to analyze spending patterns. This includes the acquisition and processing of both synthetic and real historical data to preemptively detect budget anomalies. The system is further configured for automated budget proration, rollover, and modifications, thereby ensuring precise and adaptable financial planning.

ProActive Resource Management System (ProRMS): A system integrated into the disclosed system, leveraging AI-driven scheduling to optimize cloud resource utilization. The system is configured to identify peak and non-peak hours, adjusting resource availability accordingly. This minimizes unnecessary cloud costs and ensures efficient resource allocation based on actual operational needs.

CloudPause-Intelligent Predictive Cloud Capacity Management: An integral feature of the disclosed system, this advanced scheduling functionality is designed to address the billion-dollar cloud waste challenge. By automating the enablement and disabling of cloud resources based on operational needs, CloudPause significantly reduces costs and contributes to environmental sustainability by lowering energy consumption and greenhouse gas emissions.

Advanced Budget Workflow System: At the core of the disclosed system, this system is designed to streamline the management of cloud expenditures with advanced tools for real-time budget tracking, forecasting, and adjustments. Enhanced by artificial intelligence, it facilitates seamless coordination across budget planning, execution, and monitoring phases.

Holistic View and Control: The disclosed system provides comprehensive control over cloud financial resources, simplifying the complexity inherent in cloud budget management. This system strengthens fiscal discipline and strategic resource allocation, ensuring cloud spending aligns strictly with organizational objectives and constraints.

AI-Powered Efficiency: The integration of AI within the disclosed system ensures the accuracy of financial tracking and forecasting while adapting to unique spending patterns across various projects and platforms. This configuration enables more informed decision-making and strategic financial planning.

Sustainability and Efficiency: Beyond operational and financial efficiencies, the disclosed system contributes to sustainable cloud management practices. It is configured to optimize resource usage, thereby reducing energy consumption and carbon footprint, and aligning financial management with environmental stewardship. It requires rigorous monitoring, predictive analytics for demand forecasting, and dynamic adjustment capabilities to address these challenges effectively. Additionally, this approach is particularly beneficial for projects with fixed budgets, as it aids in executing within predictable spending limits, ensuring that financial planning is realistic and adhered to. This ensures Cloud Cost or Cloud budget observability is at the forefront of the disclosed system's design, enabling a proactive stance toward cloud budget management and operational efficiency.

Further, these embodiments illustrate the disclosed system's commitment to providing an encompassing solution for cloud budget and resource management, with a focus on innovation, efficiency, and sustainability in the cloud computing domain.

Further, the present disclosure describes cost management comprising budget monitoring and management in cloud computing. In the dynamic world of cloud computing, effective management of cloud budgets is essential for any organization, and the disclosed system emerges as a key solution. The primary challenges include managing untracked cloud expenses, controlling unexpected cost overruns, and optimizing resource allocation. Without diligent monitoring, these issues can lead to significant imbalances in cloud spending. Unchecked cloud expenses can accumulate unnoticed, while unforeseen overruns, though sometimes necessary, can disrupt the budget if left unmonitored. Similarly, inefficient allocation of cloud resources can lead to wasteful spending. Further, the disclosed system addresses these challenges head-on. Its advanced monitoring capabilities allow organizations to keep a precise track of cloud expenditures, manage costs effectively, and ensure optimal resource utilization. This tool is instrumental in maintaining financial discipline and supporting strategic objectives in cloud investments. Regular insights provided by the disclosed system into spending patterns and financial trends enable businesses to proactively identify and address potential budgetary and resource allocation issues, ensuring the efficiency of cloud-based operations. In industries with strict financial management requirements, the disclosed system proves to be even more valuable. Overall, the disclosed system is indispensable for controlling cloud costs, enhancing operational efficiency, and ensuring the financial well-being of an organization in the ever-evolving cloud computing landscape. Further, the disclosed system is a cutting-edge, cloud-agnostic platform specifically crafted to monitor and control cloud account budgets. Its primary objective is to provide organizations with deep insights into their cloud spending, enabling effective financial management in the cloud environment.

Further, the cost management in cloud computing may be associated with an initial setup process, which includes API or any other mechanism integration. Further, the initial setup process may be associated with the following features:

Comprehensive connectivity: The disclosed system is expertly integrated with the APIs of various cloud service providers. This integration is crucial for accessing up-to-date data on cloud account spending and budgetary allocations, ensuring accurate and real-time financial monitoring.

Security and compliance: The platform maintains a secure connection with cloud providers' APIs or any other mechanism, prioritizing data security and compliance with privacy standards. This secure integration allows for the reliable and safe transfer of financial data for monitoring and analysis.

Multi-cloud compatibility-diverse cloud service support: Recognizing the varied cloud environments in organizations, the disclosed system is designed to be compatible with multiple cloud providers. It efficiently retrieves financial data from services such as AWS, Azure, Google Cloud Platform, etc., ensuring a comprehensive view of cloud spending across different platforms.

Unified financial management: This multi-cloud compatibility positions the disclosed system as a versatile and essential tool for businesses that utilize a range of cloud services, providing a unified and coherent view of overall cloud account budgets.

Data retrieval configuration-Financial data collection: The disclosed system is configured to routinely gather crucial data related to cloud spending and budget allocations. This persistent collection is vital for ongoing budget control and strategic financial planning.

In-depth financial analysis: The platform adeptly processes detailed financial information, offering in-depth insights into spending patterns and enabling organizations to manage their cloud budgets with greater precision and foresight.

Further, the cost management in cloud computing may be associated with data collection and aggregation. Further, the features of the data collection and aggregation are as follows:

Extensive financial data gathering: The disclosed system collects detailed financial data across various cloud platforms. This aggregation is crucial for a complete overview of cloud account spending, including different types of expenses and usage patterns.

Integrated financial overview: The platform provides an integrated view of an organization's cloud spending, essential for effective budget management and strategic financial planning.

Further, the cost management in cloud computing may be associated with AI-supported analysis. Further, the features of the AI-supported analysis are as follows:

Machine learning for enhanced insights: While the disclosed system utilizes machine learning algorithms, the focus remains on providing actionable insights into spending patterns and budget allocations, assisting in identifying significant financial trends and anomalies.

Predictive insights for future planning: The platform occasionally employs predictive analytics to anticipate future budget needs, aiding in proactive financial planning and efficient budget allocation.

Further, the cost management in cloud computing may be associated with establishing baseline metrics. Further, the features of the establishing baseline metrics are as follows:

Financial baseline establishment: The disclosed system sets baseline metrics for cloud accounts, reflecting typical expenditure and budgeting patterns. These baselines serve as benchmarks for ongoing financial monitoring.

Responsive baseline updates: The baselines are updated in response to new financial data, ensuring they accurately represent current spending behaviors and budgetary conditions.

Further, the present disclosure describes cloud storage budget monitoring and management. In the dynamic realm of cloud computing, efficient and effective storage management is a critical aspect of any organization's IT strategy. The significance of storage monitoring and budget control is amplified by several common issues, such as orphaned volumes, excessive snapshots, and duplicate data, which, if not properly monitored, can cause storage costs to spiral out of control. Orphaned volumes, which are storage spaces detached from any active instance or compute but still accruing charges, can silently inflate expenses. Similarly, the accumulation of multiple snapshots for backup and recovery purposes, while essential for data protection, can lead to redundant data storage and increased costs if not regularly reviewed and pruned. Duplicate data, often overlooked, can occupy valuable storage space unnecessarily, further straining the budget.

Effective storage monitoring and budget control are crucial for managing these issues. By implementing robust monitoring tools and practices, organizations can identify and eliminate orphaned volumes, manage snapshot lifecycles effectively, and detect duplicate data to optimize storage usage. This proactive approach is vital for maintaining data availability and ensuring business continuity. Regular tracking of storage usage and trends enables organizations to preemptively tackle potential issues such as capacity shortages and performance bottlenecks, ensuring the integrity and accessibility of critical business data. Additionally, in the context of regulatory compliance, where many industries have strict data storage, retention, and protection guidelines, effective storage management becomes even more crucial. In summary, diligent monitoring and management of storage resources are indispensable for controlling costs, enhancing performance, and securing data in the increasingly data-driven business landscape.

Further, the present disclosure describes a process flow for cloud storage budget monitoring and control. Further, the cloud storage budget monitoring is performed using the disclosed system. Further, the disclosed system is a sophisticated, cloud-agnostic platform designed to monitor storage size and manage budgets across various cloud platforms. It offers businesses a comprehensive view of their cloud storage utilization across different providers. This capability enables informed decision-making, optimizing costs, and ensuring operational efficiency and data integrity. The disclosed system's adaptability makes it ideal for businesses using diverse cloud services, including Amazon Web Services (AWS), Microsoft Azure, Google Cloud Platform (GCP), and other cloud service providers. Further, the disclosed system for cloud storage budget monitoring and control is meticulously integrated with the APIs or any other similar mechanism of multiple cloud services, essential for accessing real-time storage usage and billing data. Its setup process encompasses:

Cloud service providers' integration: The disclosed system securely connects with cloud service providers' APIs or any other similar mechanism. It authenticates seamlessly, aligning with the security and privacy standards of various cloud providers, and fetches real-time data essential for accurate monitoring and analysis.

Multi-cloud compatibility: It is compatible with multiple cloud providers, ensuring efficient data retrieval from services like AWS S3, Azure Blob Storage, and others.

Data retrieval configuration: The disclosed system is configured to regularly fetch key data about storage usage and costs. It adeptly handles the retrieval of detailed billing information for proactive budget management.

Read access setup: The disclosed system maintains read-only access to storage services, ensuring data integrity and security. It can access necessary billing data without affecting other cloud service operations.

Further, features associated with a storage service inventory associated with the disclosed system are as follows:

Service cataloging: The disclosed system automatically catalogs all storage services utilized in the connected cloud accounts, providing a comprehensive overview of storage assets.

Resource tagging: It effectively implements and utilizes resource tagging, categorizing storage resources by department, project, or other relevant factors for better management and reporting.

User Interface (UI) and dashboard: The disclosed system features an intuitive UI, presenting essential storage metrics and financial data in a user-friendly format. Interactive dashboards are integrated into the disclosed system, offering real-time visualization of storage usage and budget allocations.

Initial data analysis and baseline establishment: The disclosed system conducts an initial assessment of storage and billing data to establish a baseline for ongoing monitoring. It identifies immediate opportunities for optimization and cost savings from the initial data analysis.

Further, the process flow for cloud storage budget monitoring and control may include data collection and aggregation. Further, the disclosed system initially gathers comprehensive storage and billing data across all connected cloud platforms. It aggregates this data, ensuring a holistic view that encompasses various storage types, usage patterns, and cost structures. Further, the data collection and aggregation may encompass:

AI-driven analysis: The disclosed system employs advanced machine learning algorithms to analyze the aggregated data. These algorithms are designed to identify patterns, trends, and anomalies in storage usage and costs. The disclosed system uses predictive analytics to forecast future storage needs and potential cost implications. This helps in proactive capacity planning and budgeting.

Establishing baseline metrics: Based on the AI analysis, the disclosed system establishes baseline metrics for each storage service. These baselines represent typical usage patterns and cost structures for an organization. The baseline acts as a reference point for ongoing monitoring and is dynamically updated as the AI system learns from new data.

Optimization opportunities comprise cost-saving insights and performance improvement recommendations.

Cost-saving insights: By analyzing historical data, the disclosed system's AI identifies inefficiencies such as underutilized resources, overprovisioning, or expensive storage options that could be replaced with more cost-effective alternatives.

Performance improvement recommendations: The tool suggests optimization strategies, such as data tiering, compression, or archiving, to improve performance and reduce costs.

Automated reporting: The disclosed system generates automated reports highlighting key findings from the AI analysis, including potential cost savings and areas needing attention. These reports are tailored to different stakeholders, providing actionable insights for IT managers, financial controllers, and executive leadership.

Continuous learning and adjustment: The AI component in the disclosed system continuously learns from new data, refining its predictions and recommendations over time. The baseline metrics and optimization strategies are regularly updated to reflect the evolving storage landscape and organizational needs.

Integration with decision-making processes: The disclosed system's AI-driven insights are integrated into the organization's decision-making processes, enabling data-backed strategies for cloud storage management. This integration helps in aligning storage practices with business objectives and budget constraints.

Further, the process flow may include real-time monitoring. Further, the real-time monitoring may encompass:

Dynamic data tracking: The disclosed system is equipped with capabilities to monitor storage usage in real-time. It continuously tracks data across all connected cloud services, offering immediate visibility into storage dynamics.

Responsive dashboard: The real-time data is displayed on a user-friendly dashboard, providing an at-a-glance view of current storage states, facilitating quick decision-making and response.

Further, the process flow may include key metrics tracking. Further, the key metrics tracking may encompass:

Comprehensive metrics coverage: The disclosed system meticulously tracks a range of key metrics, including storage capacity usage, read/write operations, and data transfer rates.

Custom metric selection: Users have the flexibility to choose and prioritize specific metrics they wish to track, aligning the monitoring process with their unique operational needs.

Further, the process flow may be associated with advanced budget management strategies. Further, the advanced budget management strategies may encompass:

Base Budget: Foundation of Financial Planning: The disclosed system establishes a ‘Base Budget’ for each project on a cloud account, serving as the initial financial plan or allocation. This base budget is the benchmark against which all changes or modifications are measured.

Reference Point for Evaluation: It sets the framework for financial planning and decision-making, providing a key reference for evaluating performance and determining the need for adjustments or additional funding.

Budget Prorate: Accurate Tracking and Reporting: The disclosed system automatically prorates budgets at the beginning of budget creation and at the end of every month. This proration ensures accurate tracking and reporting of the budgetary performance of cloud account/project spending.

Automated Budget Prorate: This feature involves proportionally allocating a budget based on a specific time period, adjusting the total budget amount to match the duration of the given period. It allows for precise monitoring of budgetary performance within specific timeframes.

Budget Rollover: Utilization of Unused Budgets: The disclosed system implements an automated budget rollover system, where any unused or unspent portion of a budget from a cloud account is carried forward from one period to the next.

Preserving Financial Resources: Instead of resetting the budget to zero at the end of a specific time period, the remaining funds are conserved and made available for use in subsequent periods, ensuring that the unutilized cloud budget is not wasted but effectively allocated.

Further, the process flow may include alerts and notifications. Further, the alerts and notifications may encompass threshold-based alerts ranging from early warning signals to critical management alerts. Further, the threshold-based alerts may include multi-level soft trigger alerts and hard trigger alerts. The disclosed system's preliminary warning alert or soft trigger alert activates when storage usage reaches an initial percentage of the expected monthly growth rate, serving as an early warning system and prompting review and potential adjustment of resource management strategies. As thresholds approach critical levels, i.e. the hard trigger alert, set at critical thresholds such as 80% of the allocated growth rate for a project or cloud account, either enacts policy changes to restrict further storage additions, maintaining budget control, or a critical management alert notifies senior management and other key stakeholders, thus maintaining budget control and ensuring strict compliance with financial policies.

Further, the process flow may include budget overrides and additional funds. Further, the budget override and additional funds may encompass:

Budget override flag: Allows surpassing predefined hard caps on cloud accounts. Activation of this flag enables access to the full 100% allocation of monthly funds in the face of unexpected costs.

Budget Override Amount: Represents the additional funds granted to a project or cloud account for a particular month, over and above predefined budgetary limits.

Additional Funds and Budget Modification include allocation of extra financial resources and adapting to changing needs.

Allocation of Extra Financial Resources: Additional funds refer to extra financial resources allocated to augment the existing budget temporarily.

Adapting to Changing Needs: Budget modification in the disclosed system caters to changes in project requirements, unforeseen circumstances, or shifts in priorities.

Further, the process flow may include implementing monitoring, comprising real-time monitoring and key metrics tracking. Further, the real-time monitoring and key metrics tracking may include dynamic data analysis. The disclosed system provides real-time monitoring and key metrics tracking, focusing on storage capacity, read/write operations, and data transfer rates for dynamic data analysis.

Further, the process flow may include historical data analysis, comprising data storage and trend analysis. Further, the data storage and trend analysis may encompass long-term data management. Further, the long-term data management may include storing and analyzing historical data for trend analysis and forecasting, supporting strategic planning, and budgeting for cloud resources.

Further, the process flow may include optimization and reporting with AI integration, comprising optimization strategies. Further, the optimization and reporting with AI integration may encompass:

Resource Optimization: The disclosed system, with AI enabled, efficiently analyzes cloud storage or cloud resource utilization to identify underutilized resources. It provides practical recommendations for resizing or decommissioning these resources, aiding in optimal resource allocation without over-reliance on AI. The tool's AI component is calibrated to offer insights without overwhelming users, ensuring straightforward and actionable advice.

Cost Optimization: Utilizing AI to analyze usage patterns, the disclosed system intelligently suggests transitioning data to more cost-effective storage solutions. This might include recommending lower-cost storage tiers for less-accessed data or employing data optimization strategies. These AI-driven suggestions are designed to be intuitive and easily interpretable, enhancing the tool's usability while optimizing costs.

Further, the process flow may include budget management. Further, the budget management may encompass:

Budget Setting and Tracking: The disclosed system enables users to set storage budgets and employs AI to provide a real-time overview of spending. The AI system assists in identifying trends and anomalies in expenditure against the budget, offering a nuanced financial perspective. The AI component enriches the budget tracking feature by adding an extra layer of predictive analytics without overwhelming the core functionality.

Forecasting Tools: The forecasting tools in the disclosed system leverage AI to predict future costs based on historical trends and current data. This predictive capability is carefully balanced to provide accurate forecasts while ensuring ease of interpretation and decision-making.

Further, the process flow may include reporting. Further, the reporting may encompass:

Automated Reports: The disclosed system generates automated reports, enhanced by AI, to provide insights into storage usage, budget performance, and optimization opportunities. The AI component enriches these reports with predictive analytics and trend analysis. These reports, while AI-enhanced, are presented in a user-friendly format, ensuring accessibility and understandability.

Custom Report Generation: Users can create custom reports with AI assistance to analyze specific aspects such as time period, project, or department. The AI helps in sorting and analyzing large datasets to deliver tailored reports.

Further, the present disclosure describes CloudPause for smart cloud capacity management. Further, the CloudPause is included in the disclosed system for revolutionizing cloud cost management with advanced scheduling features. In the ever-evolving landscape of cloud computing, effective cost management remains a paramount concern for businesses worldwide. The disclosed system emerges as a trailblazing solution, offering a comprehensive suite of features designed to optimize cloud resource usage and significantly reduce costs. Here's an in-depth look at the innovative functionalities that make the disclosed system an indispensable tool for modern enterprises.

Further, the present disclosure describes methods and systems for facilitating cloud budget management based on artificial intelligence. Further, the disclosed methods and systems relate generally to the field of data processing. More specifically, the disclosed methods and systems anchor themselves in the arena of cloud computing, spotlighting an avant-garde, comprehensive methodology for cloud budget management, in the disclosed system. Further, the disclosed methods and systems introduce an artificial intelligence-powered unified console adept at orchestrating and optimizing cloud budgets across a variety of cloud platforms and numerous accounts. Specifically designed to meet the nuanced requirements of both federal sectors and corporations, the disclosed system stands out for its ability to facilitate stringent budget adherence, enhance operational efficiency, and enable strategic financial planning, all within a singular, cohesive framework. Importantly, it is suited for all sizes of businesses and startups, aiming to achieve control over cloud costs and ensuring that organizations, regardless of their scale, can benefit from optimized cloud financial management. Cloud Cost or Cloud budget observability is at the forefront of the disclosed system's design, enabling a proactive stance toward cloud budget management and operational efficiency.

Central to the disclosed system is an advanced budget workflow system, ingeniously integrated to streamline the management of cloud expenditures. This system empowers users with sophisticated tools for real-time budget tracking, forecasting, and adjustments, leveraging AI to ensure accuracy and efficiency. The workflow enables seamless coordination between budget planning, execution, and monitoring phases, ensuring that cloud spending aligns with organizational objectives and constraints. By providing a holistic view and control over cloud financial resources, the disclosed system not only simplifies the complexity of cloud budget management but also fortifies fiscal discipline and strategic resource allocation across federal and corporate cloud environments.

The disclosed system is engineered to meet the specific needs of cloud budget management as required by the federal sector and corporations. It provides a unified console for managing cloud budgets across multiple clouds and accounts, simplifying the complexities of cloud budget management. This system offers a holistic view and control over cloud financial resources and strengthens fiscal discipline and strategic resource allocation across federal and corporate cloud environments. The disclosed system represents a comprehensive solution designed to enable organizations to fully leverage cloud computing's potential by tackling hidden costs directly and enhancing operational efficiency. It ensures that expenditures are strategically aligned with organizational goals, navigating away from the pitfalls of unmanaged cloud spending and meeting the intricate requirements of managing cloud budgets on a unified platform across diverse cloud landscapes. This strategic alignment is crucial for the successful execution of fixed-price projects within predictable spending parameters, offering a clear pathway to achieving project objectives without the risk of budget overruns.

The present disclosure describes a System and Method for Budget Grouping and Time-Aware Scheduling for Cloud Resource Governance. The present disclosure relates generally to cloud infrastructure cost governance and control, and more specifically to systems and methods for budget grouping across cloud environments and time-aware scheduling that can be integrated with budget-period thresholds. In some embodiments, group evaluation triggers notification and escalation; in other embodiments, actions may be automated subject to policy and audit. The disclosure further encompasses planning-period budgeting (e.g., fiscal-year and custom accounting calendars) and short- and long-horizon forecasting, implemented using rule- or logic-based evaluators and, in some embodiments, AI-assisted components.

Managing cloud resources and budgets across hundreds of accounts is a complex and labor-intensive process that requires meticulous tracking and reconciliation. Existing tools often lack executive-level visibility and consolidated views across business units, product lines, or projects, and provide limited support for group-level budget evaluation with threshold-based escalation. Many systems also fail to coordinate schedules with budget targets, resulting in resources continuing to operate outside business hours or during holidays, which contributes to overruns. Additionally, manual controls are prone to errors and difficult to audit.

Financial planning and budget forecasting often occur in systems disconnected from runtime cloud controls, which limits the translation of planning-period targets (e.g., annual, quarterly, monthly, or custom calendars) into time-aware, enforceable policies. The disconnect reduces the ability to act preemptively on projected overruns. Accordingly, there is a need for a unified approach that couples budget grouping with time-aware scheduling integrated with budget-period thresholds, while also supporting planning-period budgeting and short- and long-horizon forecasting implemented using rule- or logic-based evaluators and, in some embodiments, AI-assisted components. In certain embodiments, group evaluation triggers notification and escalation; in other embodiments, actions may be automated subject to policy and audit.

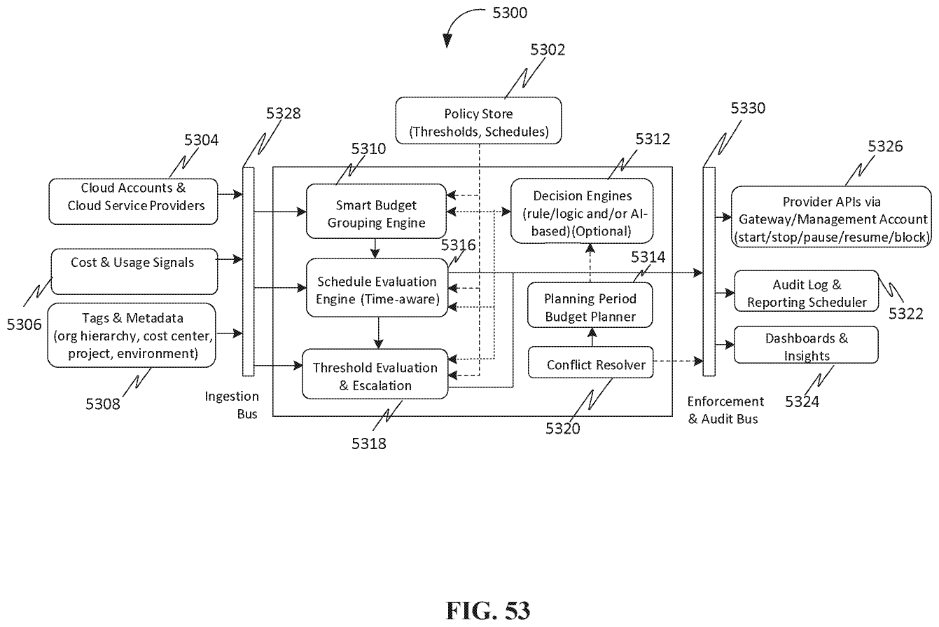

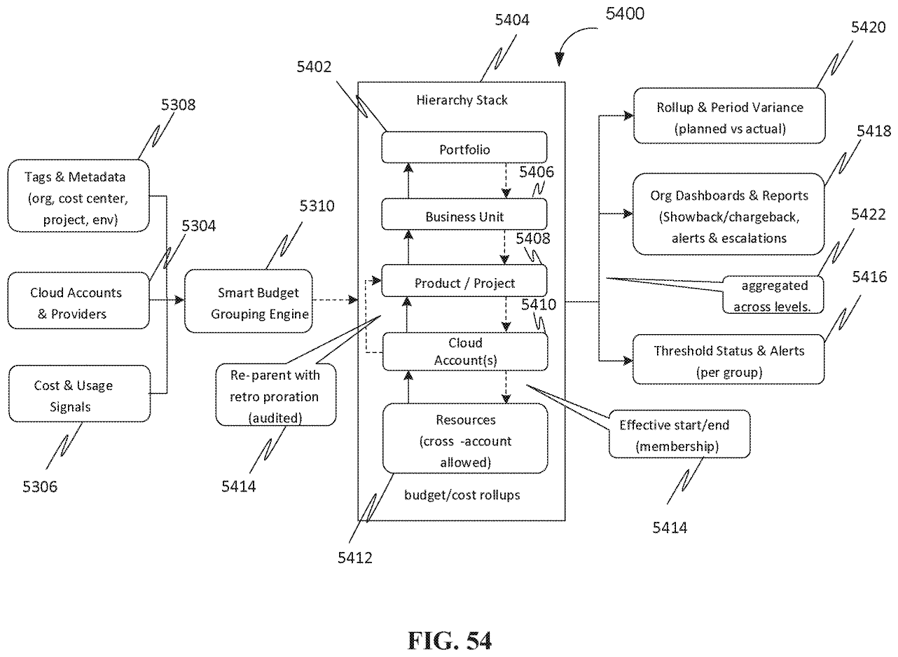

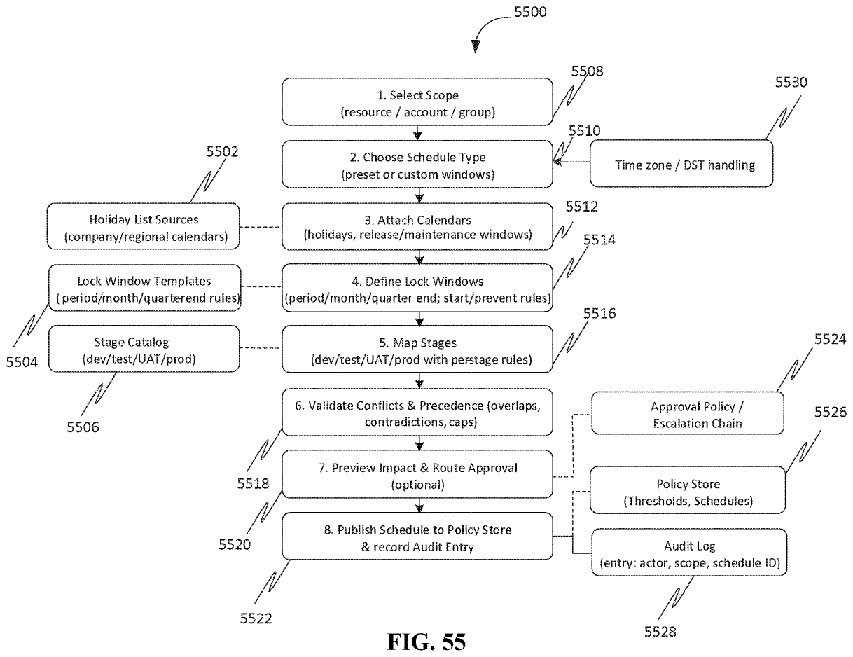

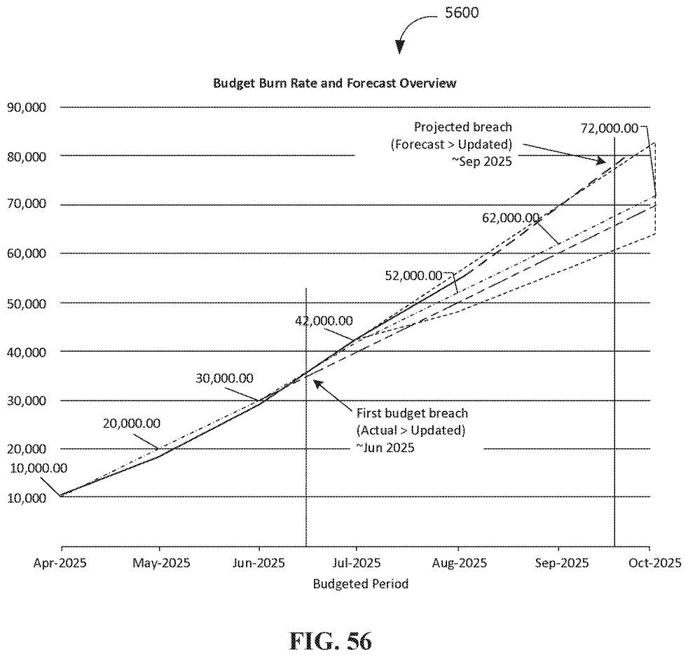

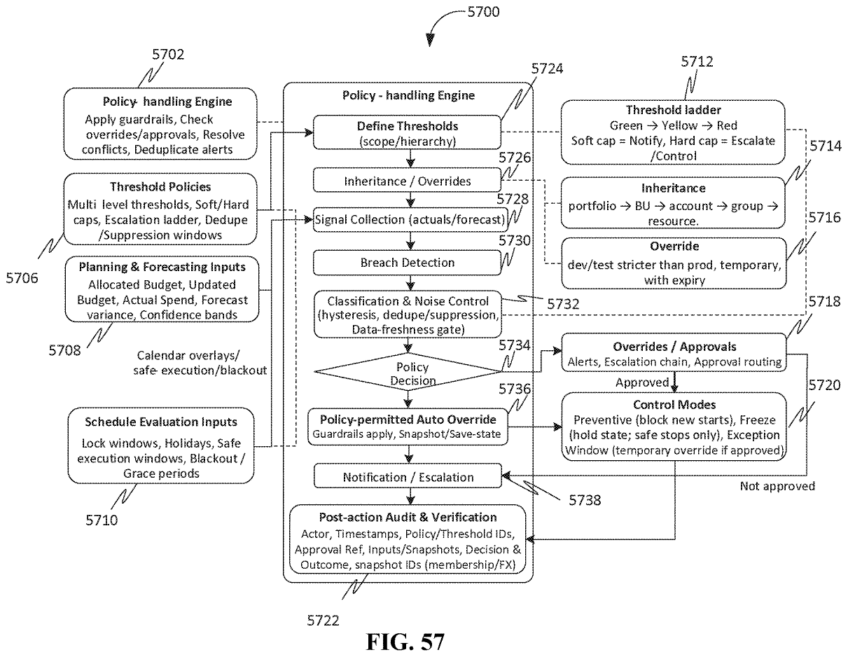

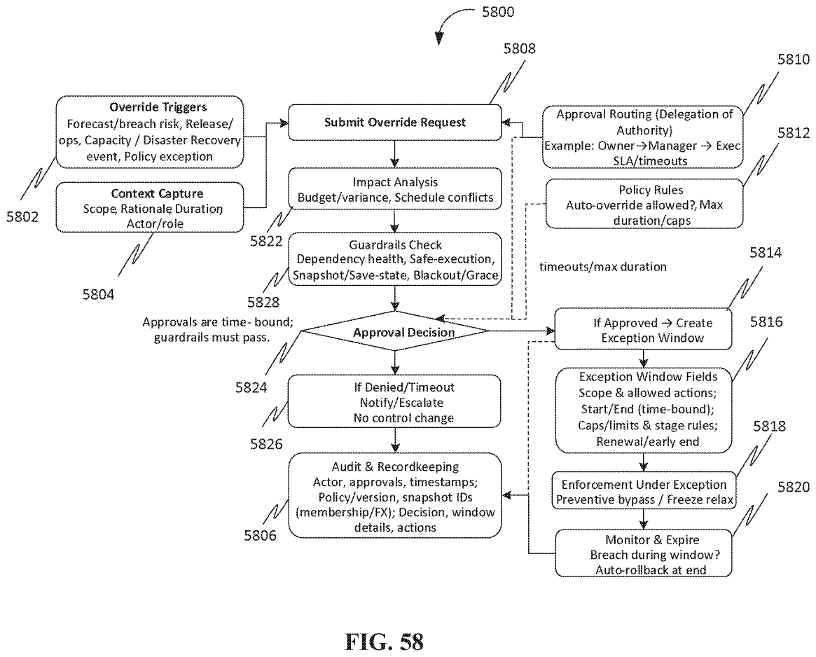

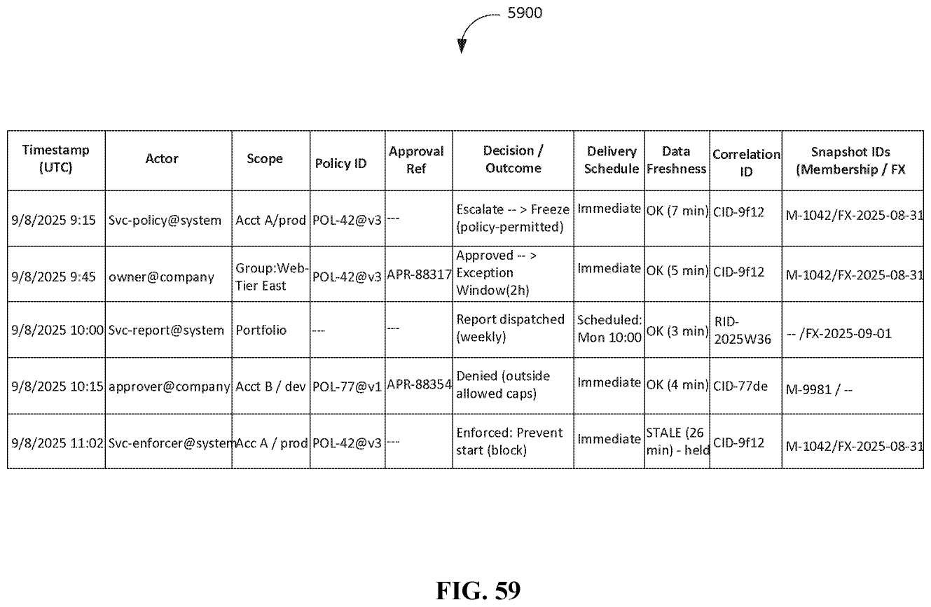

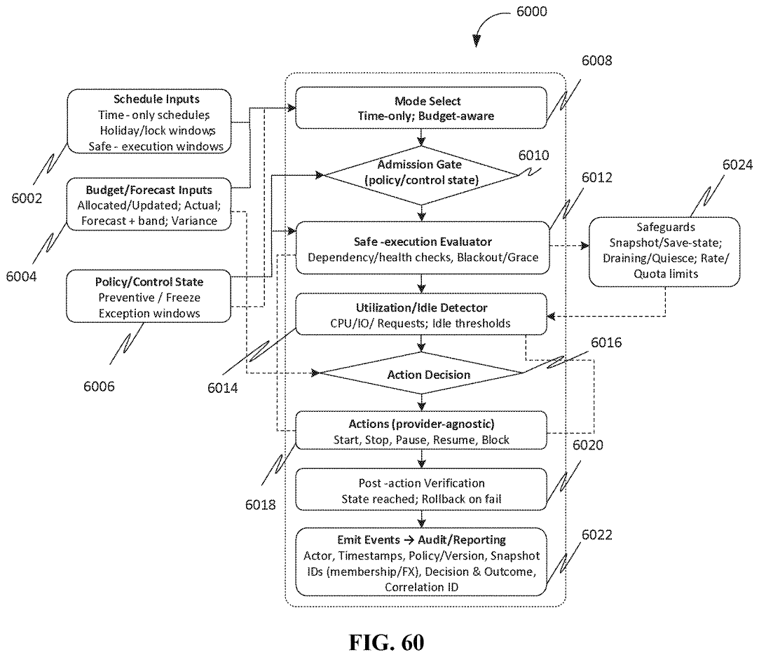

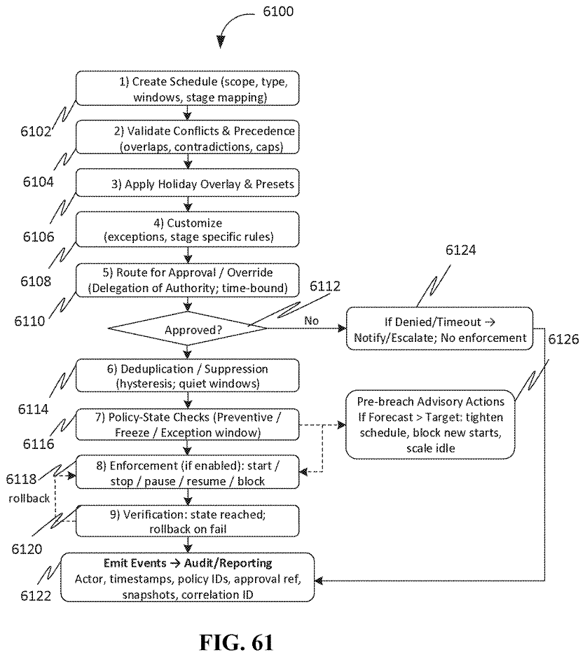

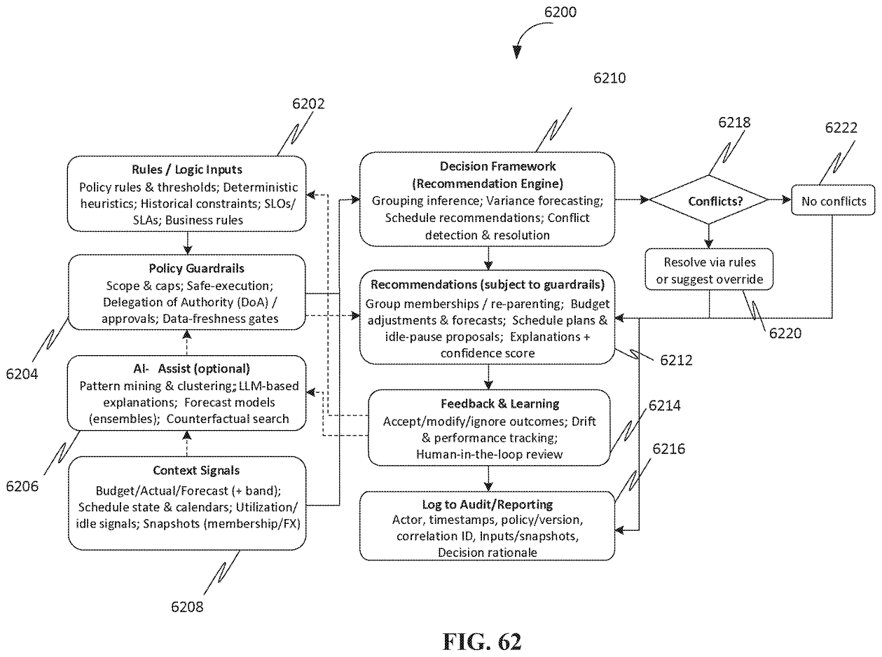

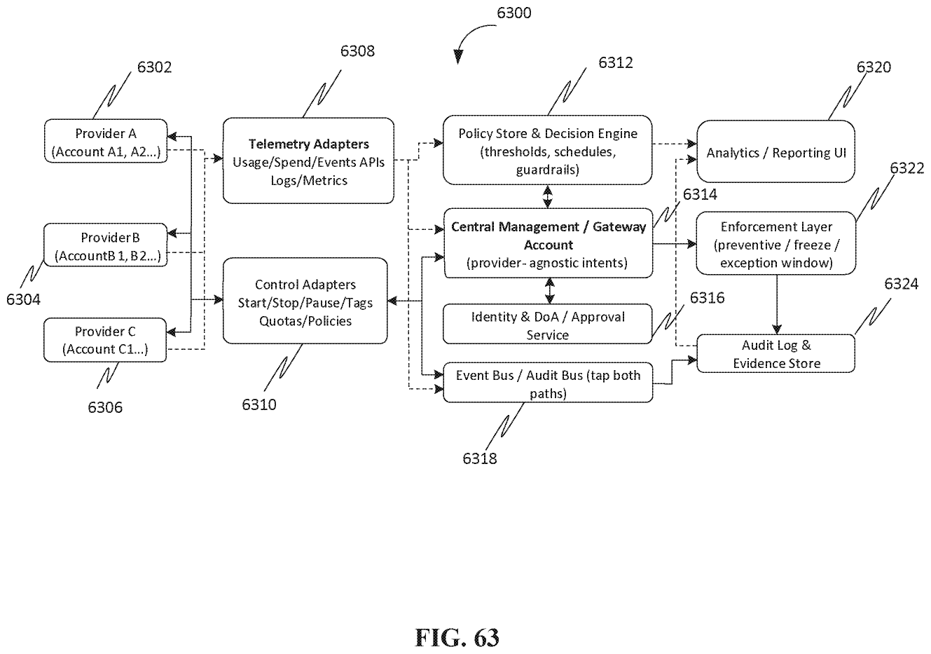

The disclosure addresses cloud budget governance across many accounts by providing:
Budget grouping across clouds. An engine that aggregates budgets and actuals across business units, product lines, projects, and accounts, including cross-account and multi-cloud resources.
Hierarchical membership with audit. Parent-child rollups; effective-dated membership (start/end); re-parenting with optional retroactive proration; inheritance of calendars, policies, and thresholds; full audit trails.
Tag/metadata-driven grouping with assistance. Group resolution using rule- or logic-based evaluators and, in some embodiments, AI-assisted methods (e.g., tags, organizational metadata, cost patterns, usage similarity).
Multi-level thresholds and escalation. A configurable ladder evaluated at resource, account, group, business-unit/product, and portfolio levels, with de-duplication and propagation of alerts up the hierarchy. In some embodiments, outcomes trigger notification and escalation only; in other embodiments, handling may be automated subject to policy and audit. Two evaluation modes are supported: (a) aggregate mode that compares group sums of actuals versus base/target; and (b) severity mode that elevates status based on constituent member severities. A proactive rule elevates one severity level when the forecast breach is within T days (e.g., T=7).
Time-aware scheduling (optional linkage). Operates in two modes: time-only (calendars/holidays) and budget-aware (uses planning-period targets, thresholds, and forecast proximity to breach). Safeguards include dependency checks, snapshot/save-state, grace periods, and blackout windows. The engine computes safe-execution windows for control intents (start, stop, pause, resume, block). Evaluations run in the target group's time zone; DST follows wall-clock semantics; all audit timestamps are in UTC. Definitions: Block: deny actions that increase running capacity (e.g., scale-out, restart) while allowing safe stops. Prevent start: deny creation or initial start of a runtime or job. Freeze: hold the current state (no new starts or scale-out), allowing only safe stop/scale—in.
Overrides and approvals. Workflows that route requests per delegation-of-authority, create temporary exception windows (e.g., weekend or off-hours access) with guardrails, and record rationale and outcomes in audit logs.
Multi-phase orchestration. Configuration, conflict validation, calendar/holiday overlays, customization, override/approval routing, enforcement (where enabled), and post-action verification with audit.
Planning-period budgeting. Supports annual, quarterly, monthly, weekly, daily, and custom calendars (e.g., 4-4-5, 13-period). Proration for partial periods and rollover or reserve pools is applied under policy, with lock windows and policy-driven reallocations. All budgets, calendar bindings, and changes are effectively dated and captured in the audit log, and evaluations bind to the relevant membership and, where applicable, FX snapshots at the evaluation timestamp for reproducible audit.
Period-aware evaluation and forecasting. Evaluation of spend, burn rate, and forecast variance against planning-period targets at each hierarchy level; forecasting using rule- or logic-based evaluators and, in some embodiments, AI-assisted components; support for scenario proposals and re-baselines with recorded approvals.
Reporting and cross-functional insights. Consolidated dashboards and scheduled delivery of burn rate, variance, threshold/escalation status, forecast vs. plan, and recent enforcement/override/audit entries-without requiring direct access to every account.
Centralized control plane (optional). A management/gateway context that applies policies and actions across many cloud accounts and providers while maintaining audit logging. 1. FIG. 53 is a block diagram of a Budget Grouping and Time-Aware Scheduling system architecture, including data ingestion, evaluation, policy-handling, and audit subsystems.
2. FIG. 54 is a diagram of a hierarchical grouping engine with portfolio, business-unit, account, and resource rollups, including effective-dated memberships, re-parenting with audit, and cross-account/cross-provider aggregation.
3. FIG. 55 is an illustrative user interface for schedule creation and holiday definition, including lock windows and stage mapping.
4. FIG. 56 is a visualization of planning-period rollups showing Allocated Budget, Updated Budget, Actual Spend, and a Forecast with confidence band with variance and threshold status across the planning calendar.
5. FIG. 57 is a workflow of the policy-handling engine illustrating inputs from planning/forecasting, schedule evaluation, threshold policies, and approval/audit routing, with a selectable outcome: notification/escalation and/or policy-driven control modes (preventive, freeze, exception window).
6. FIG. 58 is a diagram of override and approval routing that generates a temporary exception window with guardrails (dependency checks, snapshot/save-state, grace periods, blackout windows).
7. FIG. 59 is an audit and reporting interface showing actors, timestamps, policy identifiers, approvals, scheduled report delivery, data-freshness indicators, and correlation IDs.
8. FIG. 60 is a block diagram of the resource scheduling engine illustrating time-only and budget-aware modes, admission gated by current policy/control mode, safe-execution windows, and actions (start, stop, pause, resume, block) with safeguards and utilization/idle detection.
9. FIG. 61 is a step-by-step operational workflow from schedule creation through conflict validation, holiday overlay, customization, approval/override, deduplication/suppression windows, policy-state checks, enforcement (where enabled), and verification. 10. FIG. 62 is a decision framework (rule-/logic-based and/or AI-assisted) for grouping inference, variance forecasting, schedule recommendations, and conflict resolution subject to policy guardrails.
11. FIG. 63 is an architecture of a centralized control plane (management/gateway account) applying policies and actions across multiple cloud accounts and providers with audit logging, showing read-only data paths and control paths.

The embodiments described herein provide systems and methods for budget grouping and time-aware scheduling for cloud resource governance. The system operates across multiple cloud accounts and, in some embodiments, across multiple cloud providers. It ingests account, resource, cost, and usage telemetry; resolves effective-dated group membership from tags and metadata; evaluates planning-period context (calendars, proration, rollover) and multi-level thresholds; and produces outcomes under policy. In some embodiments, outcomes comprise notification and escalation; in other embodiments, a controller may issue policy-constrained control commands (e.g., start, stop, pause, resume, block) via provider-agnostic adapters, subject to guardrails and audit logging. Features such as planning-period budgeting (including fiscal and custom calendars), proration, rollover/reserve rules, and forecasting may be implemented using rule- or logic-based evaluators and, in some embodiments, AI-assisted components. Evaluations are rendered from membership snapshots to ensure reproducibility, and may observe data-freshness gates before emitting outcomes.

Definitions-“Block” means deny actions that increase running capacity (for example, scale-out or restart), while allowing safe stops/scale-in. “Prevent start” means deny the creation or initial start of a new runtime or job. “Freeze” means hold current state; no new starts or scale-out; allow safe stop/scale-in only.

Budgets from multiple cloud-provider accounts are grouped under higher-level entities such as business units, portfolios, products, or projects. Groups may include resources drawn from one or more accounts and, in some embodiments, from multiple cloud providers. Grouping can be manual, rule- or logic-based, or AI-assisted using tags and metadata (e.g., organizational hierarchy, cost center, project ID, environment) and cost/usage similarity.

Eligibility and membership. Memberships and policies are effective-dated. Each assignment records a start date and, optionally, an end date, and changes are logged with audit trails. Re-parenting is supported and may include retroactive proration from the effective date when an entity moves between parents during an active planning period. In some embodiments, a member account is eligible only when a valid account-level budget exists for the active planning period; otherwise, the group may enter a degraded state, and evaluation/alerts are suppressed until eligibility is restored. Entities may be restricted from appearing in multiple groups simultaneously or, in other embodiments, permitted with multi-group membership labeling.

Inheritance and evaluation. Each group may inherit planning-period allocations (annual, quarterly, monthly, weekly, daily, or custom calendars such as 4-4-5 or 13-period) and define multi-level thresholds with local overrides. Threshold evaluation can be policy-selectable, for example: (i) Aggregate comparison (sum of actuals versus sum of bases) and/or (ii) Severity comparison (maximum member severity level). Outcomes may include notification and escalation; in other embodiments, policy-driven control modes (e.g., preventive or freeze, with approved exception windows) are applied, subject to guardrails and an audit. Evaluation may propagate through the hierarchy so that variance to planning-period targets is computed at the resource, account, group, business-unit, product, and portfolio levels, including cross-provider rollups where configured. To reduce noise, de-duplication and suppression/cool-down windows may be applied between account-level and group-level alerts.

Burn-rate, forecasting, and visualization. The system computes current burn rate and projected spend against planning-period targets and renders time-series visualizations at any hierarchy level (resource, account, group, business unit, portfolio). Charts may display Allocated Budget, Updated/Approved Budget (re-baselines), Actual Spend, and a Forecast with a confidence band (e.g., P50/P90) derived from rule- or logic-based and, in some embodiments, AI-assisted evaluators. Visuals can annotate expected threshold-crossing dates, days-to-EOP/EOM, and policy events (e.g., approvals, overrides) and may highlight variance-to-plan and variance-to-forecast. Forecasts may use daily/weekly pacing, seasonality, and commitment schedules; evaluation can be advisory (notification/escalation) or, in other embodiments, inform policy-driven control modes subject to guardrails and audit. Visualizations are rendered from a membership snapshot (members, prorated bases, ladder configuration, model version and parameters, and, where applicable, an FX (foreign exchange) snapshot), enabling reproducibility and cross-provider normalization. Outputs can be exported or embedded in dashboards and scheduled reports.

Reporting and stakeholder delivery. A reporting scheduler can deliver daily, weekly, or monthly summaries to designated recipients and, in some embodiments, event-triggered delivery may occur upon threshold breach. Reports may include burn-rate visuals, variance-to-target, threshold/escalation status, forecast versus plan, and recent enforcement/override/audit entries. Distribution cadence, templates, recipient lists, and data-freshness gates are policy-controlled.

### Smart Budget Grouping Workflow:

1. Collect inputs:-ingest account/resource/cost/usage telemetry; manual assignments; tags/metadata; cost/usage similarity (rule-/logic-based or AI-assisted); calendars/holidays, and, where used, FX (foreign exchange) settings.
2. Compose membership & naming-create/update groups of accounts/resources (including cross-account and cross-provider); validate eligibility (member has an active account-level budget); set effective start/end dates; record rationale.
3. Resolve conflicts-apply precedence rules for overlapping selectors or re-parenting; optionally use AI recommendations; log decisions and resulting hierarchy.
4. Apply inheritance & policy-attach planning-period allocations and multi-level thresholds; store local overrides and effective dates; associate escalation routing; configure data-freshness gates and overlap policy.
5. Evaluate & propagate-compute base/actuals, burn rate, and (optionally) forecast; render a membership snapshot for reproducibility; apply child→parent rollups and parent→child guardrails; apply de-duplication and suppression/cool-down windows; select outcome per policy: notification/escalation and/or policy-driven control modes (e.g., preventive or freeze with approved exception windows). Trigger pre-breach advisory actions when projections exceed targets.
6. Audit & refresh-record outcomes (actors, timestamps, policy IDs, rationale); support re-parenting with retroactive proration; refresh on change or schedule; support multi-cloud and (optionally) multi-currency rollups.
7. Report & distribute-generate burn/forecast visuals and summaries; deliver daily/weekly/monthly or event-triggered reports to designated stakeholders per policy (templates, recipients, quiet hours).

Schedules can be custom (e.g., Mon-Fri 08:00-18:00), preset (e.g., Business Hours), or holiday-based (e.g., company or regional closures). A schedule may be bound to a resource (including cross-account or cross-provider resources), an account, a group, a business unit, a product, or a project. All schedule evaluation resolves in the target entity's time zone; Daylight Saving Time transitions use wall-clock semantics, with skipped or repeated hours automatically adjusted. All audit timestamps are recorded in UTC. Schedules and the bindings are effective-dated and audit-logged.

Scheduler modes—The scheduler operates in two modes: (i) time-only mode that enforces calendars and holiday rules, and (ii) budget-aware mode that evaluates schedule rules together with planning-period targets, thresholds, and forecast variance. The engine ingests real-time context such as current time, utilization/idle status (determined via rule-/logic-based thresholds and/or model-based methods), release or maintenance windows, and project stage.

Admission, guardrails, and execution—For each attempted or scheduled action, the engine evaluates policy state (e.g., preventive or freeze modes) and checks for conflicts. A safe-execution window opens only if (a) no declared dependency reported “Degraded” in the last T minutes, (b) a clean checkpoint/snapshot exists within K minutes, (c) no blackout or release calendar overlaps the window, and (d) no operator or policy override is active; otherwise the action is deferred and requeued with the reason recorded. When admitted, the engine issues provider-agnostic control intents (start, stop, pause, resume, block, prevent start) subject to safeguards including dependency checks, snapshot/save-state, grace periods, and blackout windows. If conditions are not met, the engine prevents or defers execution and records the rationale. If approval is required, the system escalates an override and, upon approval, creates a temporary exception window (e.g., weekend access for non-production) with guardrails.

Composability and Precedence-Schedules support region-specific calendars and holiday overlays and can be layered with other enforcement rules (including soft and hard caps defined by threshold policies). Precedence rules ensure that freeze or preventive modes gate schedule admission, while approved exception windows take temporary priority within the effective interval.

Scale and audit—In some embodiments, operation spans multiple cloud providers and many accounts from a centralized control plane with audit logging. All schedule evaluations and actions (admitted, deferred, denied) are recorded with timestamps, actors, policy identifiers, and outcomes to enable replay and post-event analysis.

### Multi-Phase Enforcement Workflow

Schedule definition-A user selects a preset or defines allowed/disallowed windows and binds the allowed/disallowed windows to a scope (resource, account, group, business unit, product, or project), including cross-account/cross-provider resources. Schedules may be linked to planning periods (annual, quarterly, monthly, weekly, daily, or custom, such as 4-4-5 or 13-period). Bindings are effective, dated, and audit-logged.
Validation & precedence—The engine checks overlaps and contradictions across teams/scopes, verifies soft/hard caps and current policy/control mode (e.g., preventive or freeze), and applies precedence rules (including cross-provider scopes). Data-freshness gates may block evaluation when inputs are stale.
Calendar overlay-National, regional, and company holidays, release/maintenance windows, and optional blackout periods adjust evaluation windows.
Context evaluation (proactive)-Real-time signals are evaluated, including time, utilization/idle status (rule- or logic-based and/or model-based), current spend versus planning-period targets, forecast variance, and project stage/risk indicators. Where projections exceed targets, the system can apply pre-breach actions per policy (e.g., schedule tightening).
Idle assessment & safeguards—The idle evaluator determines underutilization and, if conditions and safeguards are met (dependency checks, snapshot/save-state, grace periods, blackout windows), proposes pause/stop/scale-to-zero, with optional notification.
Decision, admission, and Precedence-Conflicts are resolved using rule-/logic-based and/or AI-assisted policies. The system evaluates admission against the active control mode, computes safe-execution windows, and assigns priority by scope, ownership, and severity; associated policy/threshold identifiers are recorded for audit.

### Overrides and Approvals (Temporary Exception Windows:

1. Mode A-Escalation required. The system routes an override through a delegation-of-authority chain with time-bound approvals and recorded justification. Upon approval, it creates a scoped temporary exception window (e.g., weekend access for non-production) with guardrails.
2. Mode B-Policy-permitted auto-override. When policy allows automated handling, the system (i) auto-authorizes and creates a temporary exception window with preconfigured guardrails, or (ii) denies/defers the action per policy. All decisions are audit-logged.

Policy enforcement-Final control intents are compiled to provider-agnostic adapters to start, stop, pause, resume, prevent start, or block capacity increases within computed safe-execution windows, consistent with policy and any approvals. In some embodiments, outcomes are limited to notification/escalation without issuing control commands.

Post-action verification & audit-Results are verified; audit entries capture actors, timestamps, resources, policy/threshold identifiers, decisions, approvals/timeouts, and safeguards considered. Inputs (including budget/forecast state) and the membership snapshot (and, where applicable, model/FX versions) are recorded to enable replay. Optional learning updates refine idle-detection thresholds/baselines and future forecasts, normalized across providers.

Decision engines and agents may perform evaluations and recommendations described herein using rule- or logic-based methods and, in some embodiments, AI-assisted components. In operation, the engines (i) derive or validate group membership from tags, metadata, and usage/cost similarity, (ii) forecast spend/burn versus planning-period targets and detect variance, (iii) generate schedule recommendations, identify idle/under-utilization windows, and resolve policy conflicts, and (iv) assist real-time decisions (e.g., approve, deny, defer, or propose a temporary exception window), with all inputs, rationale, and outcomes recorded in an audit log.

Policy guardrails and modes-Engines operate within policy: outcomes may be limited to notification/escalation or, where enabled, may request or initiate policy-driven control modes (preventive/freeze) subject to delegation-of-authority, blackout windows, dependency checks, and other guardrails. Actions are compiled to provider-agnostic intents and executed only when caps/approvals permit.

Signals and normalization-Inputs can include multi-cloud cost and usage telemetry normalized by category and, where configured, converted to a base currency for cross-provider rollups. Data-freshness gates may suppress evaluation when inputs are stale.

Explainability and audit-All agent outputs are explainable and replayable. Audit records may include policy and threshold identifiers, rule-evaluation traces, and/or model confidence scores, actor/agent identifiers, timestamps, safeguards considered, and the membership snapshot (and, where applicable, model and FX versions).

AI is optional-All functions can be implemented using rule/logic alone. Where AI is used, models may be updated over time based on observed outcomes with controls for drift detection, safety testing, and rollback. In some embodiments, agents are advisory-only (recommendations without execution); in others, the agents propose or initiate actions subject to the guardrails and approvals above.

The platform supports multi-level thresholds evaluated at the resource, account, group, business-unit/product, and portfolio levels, including cross-provider rollups. Thresholds may target spend, burn rate, utilization/idle status, planning-period targets, and/or forecast variance, with inheritance and local overrides, and with soft and hard caps. Upon breach, outcomes are policy-selectable: the system may (i) route an override through an escalation chain with time-bound approvals and guardrails, or (ii) apply policy-driven control modes without escalation (e.g., notify/escalate, defer/deny, schedule tightening, start prevention, pause/stop), with audit logging. Evaluation may use rule- or logic-based and, in some embodiments, AI-assisted methods, and may adjust the sequence, scope, or timing of actions subject to guardrails. Operation may span multiple cloud providers with category normalization and, where configured, multi-currency rollups to a base currency. To reduce noise, the system may apply hysteresis, de-duplication, suppression/cool-down windows, and data-freshness gates.

### Threshold Evaluation and Policy Handling Workflow:

1. Define threshold: Specify the metric (spend, burn rate, utilization/idle, planning-period target, forecast variance), scope (resource/account/group/BU/product/project/portfolio), soft vs. hard cap, evaluation window, and the policy identifier.
2. Inheritance and overrides: Apply parent defaults; record local overrides and effective dates; store policy versions for audit.
3. Signal collection: Ingest real-time and recent signals (cost, usage, dependency/health), normalized across providers and, where configured, converted to a base currency; enforce data-freshness gates before evaluation.
4. Breach detection: Compare current and projected values to thresholds; support debounce windows, rate-of-change checks, and hysteresis to limit flap.
5. Classification & noise control: Assign severity; apply suppression windows and de-duplication (e.g., coalesce account- and group-level events) to avoid alert storms; respect quiet-hour policy where applicable.
6. Decision engine (policy evaluation): Using rule/logic and, in some embodiments, AI-assisted analysis, select the outcome: notification/escalation and/or policy-driven control modes (e.g., pre-breach schedule tightening, start prevention, pause/stop, defer/deny), or generate reallocation/re-baseline proposals with rationale.
7. Overrides and approvals (temporary exception windows).
Mode A-Escalation required: route an override through the delegation-of-authority chain with time-bound approvals and recorded justification; on approval, create a scoped temporary exception window with guardrails.
Mode B-Policy-permitted auto-override: when allowed by policy, auto-authorize and create the temporary exception window with preconfigured guardrails, or deny/defer per policy. All decisions are fully audited.
8. Enforcement (where enabled): Compile control intents to provider-agnostic adapters and execute start/stop/pause/resume/block actions or apply schedule changes; record any reallocation/re-baseline proposals; respect soft/hard caps and the active policy/control mode.
9. Post-action verification & audit. Verify outcomes; log threshold/policy IDs, inputs considered (including planning-period values and forecasts), actions, actors/agents, timestamps, approvals/timeouts, and any rule-evaluation traces or model confidence scores. Store the relevant membership snapshot (and, where applicable, FX and model versions) for replayability.
10. Learning & tuning (policy-controlled): Update baselines, seasonality profiles, and rule parameters either (A) automatically within guardrails (e.g., capped drift per period, cooldown intervals, shadow evaluation before commit, automatic rollback on regression), or (B) by generating change proposals for human review and approval. A hybrid mode may allow automatic micro-adjustments with approval required for major changes. All updates are versioned and audited.

The system provides a planning-period budget planner operating across hierarchical entities (portfolio, business unit, account, and resource) consistent with Smart Budget Grouping. A planning calendar can be defined for annual, quarterly, monthly, weekly, or daily periods, and may also support custom calendars (e.g., 4-4-5 or 13-period) with regional or company holiday sets. In some embodiments, operation spans multiple cloud providers and, where configured, supports multi-currency planning with rollups to a base currency using effective-dated FX snapshots.

For each group, the planner stores: (i) baseline budgets and period allocations; (ii) proration rules for partial periods (e.g., when entities are added mid-period); (iii) rollover (carry-forward) and reserve-pool rules with caps/expiry and policy-based release; (iv) period thresholds and variance targets (e.g., advisory “yellow,” critical “red,” soft and hard caps), optionally tied to an escalation policy or, in other embodiments, automated handling subject to policy and audit; (v) reallocation policies to move budget between groups or periods with approval and audit logging; (vi) lock windows (e.g., month-end or quarter-end) that restrict changes absent elevated approval; and (vii) organizational change handling, including re-parenting (mergers, splits, account moves) with retroactive proration and full audit history. Multi-currency support allows period budgets and actuals to be authored in local currency and rolled up using configured exchange-rate sources with effective-date rules.

Integration with schedule-aware control—The planner integrates with the policy/enforcement engine so that period context influences actions. For example, blackout windows at period close can block nonessential resource starts, tighten after-hours policies, or require overrides for cost-intensive actions. Evaluations consider planning-period targets and forecast variance, allowing policies to be tightened or relaxed pre-breach.

Forecasting and governance-Using rule- or logic-based evaluators and, in some embodiments, AI-assisted components, the system forecasts spend/burn against planning-period targets, accounts for seasonality and known events (e.g., releases or maintenance), detects at-risk periods, and may propose intra-year re-baselines or reallocations with rationale. Proposals follow approval, where configured; all inputs and decisions (including rule-evaluation traces or model confidence scores) and outcomes are recorded in the audit log.

Periodization and enforcement—As new cost and usage signals arrive, the system attributes spend to the active planning period, updates burn-rate projections and forecast variance, and, on threshold breach or projected overrun, follows policy by (i) issuing notifications and escalations, (ii) generating reallocation and/or re-baseline proposals, and/or (iii) applying policy-driven control modes such as schedule tightening, start prevention, or pause/stop. Where configured, actions may be routed through an escalation policy with time-bound approvals; in other embodiments, handling occurs automatically, subject to guardrails, with full notification and audit. At period close, when rollover is enabled, residual funds are moved per rule (e.g., a percentage carried forward and a percentage allocated to a reserve pool with caps/expiry), with complete audit entries. Operation may span multiple cloud providers with category normalization and, where configured, multi-currency rollups to a base currency using the applicable FX snapshot.

### Use Cases:

Group and portfolio governance. Apply planning-period targets and thresholds across business units, products, projects, or accounts, with rollups, inheritance, and local overrides. Support aggregate and/or severity evaluation, with de-duplication between account- and group-level alerts.
After-hours efficiency. Enforce off-hours schedules for development, test, and sandbox resources or workloads, and optionally selected production workloads where operational policies permit scheduled scaling, standby operation, or workload throttling; use utilization/idle and under-utilization detection (rule/logic or AI-assisted) to pause/stop/scale-to-zero with safeguards and audit.
Temporary exception windows (overrides). When policy requires approval, route an override through the escalation chain and, upon approval, create a scoped, time-limited exception window (e.g., Sat 10:00-16:00) with guardrails. When policy permits auto-override, auto-authorize within preconfigured guardrails, or deny/defer per policy, with full audit.
Planning-period governance. Manage period allocations with proration, rollover/reserve-pool rules, reallocation with approval, and lock windows (e.g., month- or quarter-end) that restrict changes absent elevated approval.
Variance action (proactive). Detect variance to planning-period targets or projected overruns and, as per policy, take pre-breach actions such as schedule tightening, start prevention, or propose reallocation/re-baseline scenarios for approval.
Release/maintenance windows. Respect change-freeze and maintenance windows; require overrides for cost-intensive actions during protected periods (with escalation or policy-permitted auto-override), and record outcomes in the audit log.
Holiday policies. Apply regional/company holiday overlays to adjust evaluation windows and enforcement decisions across affected scopes.
Multi-cloud planning & reporting. Normalize categories across providers and, where configured, perform multi-currency rollups to a base currency using effective-dated FX snapshots for planning, variance analysis, and consolidated reporting.
Centralized governance & audit. From a management/gateway context, orchestrate policy across many accounts and providers, issue provider-agnostic control intents (start/stop/pause/resume/block) where enabled, or operate in notification/escalation-only mode; maintain unified, effective-dated audit trails.
Data freshness and replayability. Suppress evaluation when inputs are stale via data-freshness gates; reproduce any alert or decision from a saved membership snapshot (members, prorated bases, ladder config, and where applicable model/FX versions).

### Aspects:

1. A method for grouped budget evaluation and time-aware governance of cloud resources, comprising:
   receiving a plurality of budget definitions for a plurality of cloud scopes, including accounts, sub-accounts, subscriptions, projects, resource groups, and resources;
   associating each budget with one or more grouping criteria represented by entity identifiers corresponding to organizational, financial, operational, or metadata-derived attributes, including resource and/or account tags, and with a scope selected from account, sub-account, project, subscription, resource group, or resource;
   creating hierarchical groups of accounts and resources based on the grouping criteria;
   storing effective start and end dates for group memberships and policy assignments, and supporting re-parenting with retroactive proration from an effective date;
   defining a planning calendar comprising budget periods selected from annual, quarterly, monthly, weekly, daily, or custom periods, including 4-4-5 or 13-period;
   allocating a baseline budget across the budget periods to the groups and, where applicable, to the associated scopes, including resources distributed across multiple accounts and across multiple cloud providers;
   receiving a schedule configuration including custom, preset, or holiday types and associating the schedule with at least one of (i) a scope selected from account, sub-account, project, subscription, resource group, or resource, or (ii) a group;
   processing signals comprising at least one of a current time context, a periodized budget state, and a forecast or variance relative to planning-period targets in view of the schedule and one or more thresholds;
   producing, according to a policy that specifies a manual approval workflow and/or automated handling, an outcome comprising at least one of (i) a notification and escalation event and (ii) a provider-agnostic control intent for a resource action selected from start, stop, pause, resume, block, or prevent start; and when the outcome comprises a control intent,
   transmitting commands via an adapter to one or more cloud provider systems and recording the outcome in an audit log.
2. Further, wherein the grouping criteria are derived using machine-learning models and/or rule- or logic-based evaluators based on resource and account tags, metadata (including organizational hierarchy), and cost- or usage-similarity features at account and resource levels, and wherein inferred memberships are assigned effective start and end dates.
3. Further, wherein alerts are triggered when a budget threshold is exceeded at any hierarchical group level across a plurality of accounts and/or resources and status is propagated to parent levels; wherein account- or resource-level and group-level events are de-duplicated and subject to suppression/cool-down windows, and evaluation is suppressed when input data is stale beyond a configured data-freshness threshold; and further comprising generating burn-rate and forecast visualizations and scheduling periodic reports (daily, weekly, or monthly) including threshold and escalation status for delivery to designated stakeholders.
4. Further, the method comprises:
   defining one or more resource schedules specifying allowed and disallowed time periods for resources, including resources distributed across multiple accounts and/or multiple cloud providers;
   receiving real-time context, including current time and resource usage and/or health;
   gating admission by a current policy/control mode and performing safeguard checks, including at least one of dependency checks, snapshot/save-state, grace periods, and blackout windows;
   computing safe-execution windows during which resource actions are permitted under policy;
   automatically authorizing a resource action within a safe-execution window in embodiments without escalation; preventing or deferring execution when conditions are not met; and
   triggering an alert or routing an override request via an escalation policy, or, when policy permits automated handling, automatically authorizing or denying the requested action and, upon authorization,
   creating a scoped, effective-dated temporary exception window with preconfigured guardrails, with outcomes recorded in an audit log.
5. Further, the schedule-based resource actions comprise at least one of start, stop, pause, resume, block, or prevent start, and wherein admitted actions are effective-dated and audit-logged.
6. Further, the method comprises:
   identifying conflicts among multiple schedules and/or policies applicable to a resource or group;
   applying a conflict-resolution policy using rule- or logic-based and/or AI-assisted evaluators; and
   assigning precedence based on at least one of scope (portfolio/business-unit/group/account/resource), severity level, policy/control mode, time proximity, or user-defined preference, with the resulting admission decision and precedence rationale recorded in an audit log.
7. Further the method comprises detecting override conditions and invoking an override/approval workflow that: (a) routes an override request through a delegation-of-authority escalation chain with time-bound approvals and recorded justification; (b) upon approval, creates a scoped, effective-dated temporary exception window with configured guardrails including at least one of dependency checks, snapshot/save-state, grace periods, blackout windows, and post-window reversion; (c) when policy permits automated handling, automatically authorizes or denies the requested action based on rule- or logic-based and/or AI-assisted evaluation and, upon authorization, creates the temporary exception window with preconfigured guardrails; (d) upon denial or timeout, prevents or defers the requested action per policy; and (e) logs workflow state transitions, including request, approval/denial/timeout, window creation/expiration, actor, scope, duration, and applied guardrails in an audit log.
8. Further, budget-period allocations are prorated for partial sub-periods when a member entity is added, removed, or re-parented mid-period; further comprising applying retroactive proration from the effective date of the membership or policy change, recomputing group rollups and threshold baselines to reflect the adjustment, and recording the proration adjustments and effective dates in an audit log.
9. Further the method comprises performing rollover of unspent funds at period close according to a policy that specifies at least one of carry-forward percentage, reserve-pool allocation, caps, and expiry; releasing reserved amounts per policy (including lock windows and approval requirements); updating period baselines to reflect the rollover or reservation; and recording the calculations, policy version, and effective dates in an audit log.
10. Further, the method comprises:
   generating a reallocation request between groups, accounts, resources, or budget periods upon detection of an at-risk or breach condition;
   routing the request through an approval workflow with time-bound approvals and recorded justification;
   applying approved reallocations by updating affected period baselines and thresholds with effective dates; and
   recording the request, decision, applied changes, and rationale in an audit log.
11. Further, the method comprises:
   defining release-plan calendars comprising change-freeze and maintenance windows and defining lock windows, including at least month-end and quarter-end periods;
   associating the calendars with at least one group, account, or resource;
   modifying schedule-based actions and/or threshold policies during the windows;
   routing overrides for actions attempted within a freeze or lock window through an approval workflow with time-bound approvals or, when policy permits automated handling, automatically authorizing or denying a requested action based on rule- or logic-based and/or AI-assisted evaluation and, upon authorization, creating a scoped, effective-dated temporary exception window with preconfigured guardrails; and
   recording requests, decisions, window intervals, and applied guardrails in an audit log.
12. Further, wherein the real-time context includes a project stage, and further comprising
   mapping resources to stages, including at least development, testing, user-acceptance, and production;
   associating per-stage budget allocations, threshold policies, and schedule rules; enforcing stage-specific admission rules;
   applying proration with effective dates when a resource transitions stages mid-period; tightening or relaxing schedules and thresholds based on the active stage; and
   recording stage assignments and transitions in an audit log.
13. Further, the method comprises:
   invoking an agent implemented using AI and/or rule- or logic-based algorithms to forecast burn versus planning-period budget targets, estimate threshold-breach dates, and detect variance;
   ingesting contract or commitment signals, including at least one of reserved capacity or committed-use discounts;
   generating scenario recommendations that modify budget allocations, thresholds, or schedule policies and proposing intra-period re-baselines or reallocations with rationale; and,
   subject to policy guardrails, issuing advisory notifications or initiating automated handling where permitted; and
   recording agent inputs, model/version identifiers, confidence or rule-evaluation scores, decisions, and outcomes in an audit log.
14. Further, the method comprises:
   monitoring real-time resource utilization and efficiency metrics;
   determining an idle or under-utilized state using rule- or logic-based thresholds and/or model-based methods, including statistical, heuristic, or learning-based techniques; and, subject to policy and safeguards, modifying a resource schedule or issuing a provider-agnostic control intent selected from pause, stop, scale-to-zero, prevent start, or reduce concurrency, executed within a computed safe-execution window with dependency checks, snapshot/save-state, grace periods, and blackout windows, and
   recording the assessment, safeguards, and outcomes in an audit log.
15. Further, wherein threshold evaluation is policy-selectable between: (i) an aggregate mode that compares a sum of actuals to a sum of bases for a group across member accounts/resources, and (ii) a severity mode that determines a group severity based on a maximum member severity level, with the selected mode applied when computing group-level threshold status and alert propagation.
16. A non-transitory computer-readable medium storing instructions that, when executed by one or more processors, cause the processors to perform operations comprising:
   receiving a plurality of budget definitions from a plurality of cloud accounts;
   associating each budget with one or more grouping criteria represented by entity identifiers corresponding to organizational, financial, operational, or metadata-derived attributes, including resource and/or account tags, and with one or more resources;
   creating hierarchical groups of accounts and resources based on the grouping criteria;
   storing effective start and end dates for group memberships and policy assignments, and supporting re-parenting with retroactive proration from an effective date;
   defining a planning calendar comprising budget periods selected from annual, quarterly, monthly, weekly, daily, or custom periods, including 4-4-5 or 13-period;
   allocating a baseline budget across the budget periods to the groups and, where applicable, to the resources, including resources distributed across multiple accounts and across multiple cloud providers;
   receiving a schedule configuration including custom, preset, or holiday types and associating the schedule with at least one of a resource (including resources distributed across multiple accounts), an account, or a group;
   processing signals comprising at least one of a current time context, a periodized budget state, and a forecast or variance relative to planning-period targets in view of the schedule and one or more thresholds;
   producing, according to a policy that specifies a manual approval workflow and/or automated handling, an outcome comprising at least one of (i) a notification and escalation event and (ii) a provider-agnostic control intent for a resource action selected from start, stop, pause, resume, block, or prevent start; and when the outcome comprises a control intent,
   transmitting commands via an adapter to one or more cloud provider systems and recording the outcome in an audit log.
17. A system comprising one or more processors, a communication interface, and a non-transitory memory storing instructions which, when executed by the one or more processors, cause the system to perform operations comprising:
   receiving a plurality of budget definitions for a plurality of cloud scopes, including accounts, sub-accounts, subscriptions, projects, resource groups, and resources;
   associating each budget with one or more grouping criteria represented by entity identifiers corresponding to organizational, financial, operational, or metadata-derived attributes, including resource and/or account tags, and with a scope selected from account, sub-account, project, subscription, resource group, or resource;
   creating hierarchical groups of accounts and resources based on the grouping criteria; storing effective start and end dates for group memberships and policy assignments, and supporting re-parenting with retroactive proration from an effective date;
   defining a planning calendar comprising budget periods selected from annual, quarterly, monthly, weekly, daily, or custom periods, including 4-4-5 or 13-period;
   allocating a baseline budget across the budget periods to the groups and, where applicable, to the associated scopes, including resources distributed across multiple accounts and across multiple cloud providers;
   receiving a schedule configuration including custom, preset, or holiday types and associating the schedule with at least one of (i) a scope selected from account, sub-account, project, subscription, resource group, or resource, or (ii) a group;
   processing signals comprising at least one of a current time context, a periodized budget state, and a forecast or variance relative to planning-period targets in view of the schedule and one or more thresholds;
18. Further, producing, according to a policy that specifies a manual approval workflow and/or automated handling, an outcome comprising at least one of (i) a notification and escalation event and (ii) a provider-agnostic control intent for a resource action selected from start, stop, pause, resume, block, or prevent start; and when the outcome comprises a control intent, transmitting commands via an adapter to one or more cloud provider systems and recording the outcome in an audit log.
19. Further the method comprises rendering each evaluation from a membership snapshot that records (i) the evaluated member set with effective dates, (ii) prorated bases and period baselines, (iii) policy/threshold configurations and schedule bindings in effect, and (iv) data timestamps and source identifiers; including a snapshot identifier in alerts and reports to enable replay of the evaluation; and, where multi-currency rollups are configured, storing an effective-dated foreign-exchange snapshot identifier used to normalize amounts for the evaluation.
20. Further, wherein a management or gateway account applies policies and outcomes across a plurality of cloud accounts and across multiple cloud providers by issuing provider-agnostic control intents via adapters and collecting telemetry via read-only data paths, and wherein the system distinguishes control paths from read-only paths in configuration and records centralized audit entries identifying path type, policy/threshold identifiers, actors, timestamps, target scopes, and results for multi-level threshold governance.

Systems and methods are provided for grouped budget evaluation and time-aware scheduling for cloud resource governance. Budgets from multiple cloud scopes (e.g., portfolio, business unit, account, project, resource group, resource) are organized under hierarchical entities with effective-dated membership, re-parenting with retroactive proration, inheritance, and rollups. A planning calendar (annual/quarterly/monthly/weekly/daily or custom 4-4- 5/13-period) defines period targets with proration, rollover/reserve-pool rules, and lock windows. A scheduler operates in time-only and budget-aware modes, evaluates real-time context (including utilization/idle), computes safe-execution windows, and, subject to policy, produces outcomes comprising notifications/escalations and/or provider-agnostic control intents (start, stop, pause, resume, block) executed via adapters with safeguards. Multi-level thresholds and escalation policies govern alerts, overrides (via approval workflow) or policy-permitted auto-override, and creation of temporary exception windows with guardrails. Decision engines (rule/logic-based and, in some embodiments, AI-assisted) forecast burn versus targets, detect at-risk periods, and may initiate pre-breach actions (e.g., schedule tightening or start-prevention). Evaluations may be rendered from membership snapshots for replay and audit. In some embodiments, a centralized management/gateway account applies policy across multiple accounts and providers, distinguishing read-only data paths from control paths and maintaining audit logs of inputs, policies, actions, and outcomes.

In some embodiments, the system may provide inherent technical improvements that directly enhance cloud governance, scheduling, and financial planning technologies by tightly coupling hierarchical budget grouping with time-aware policy enforcement and auditable evaluation snapshots.

In some embodiments, a membership snapshot with effective-dated entries may be persisted together with prorated period baselines and policy identifiers to ensure replayable evaluations, solving the technical problem of non-reproducible governance outcomes under organizational change, such as re-parenting of an account during an active planning period.

In some embodiments, implementation may include computing retroactive proration from an effective date, binding each evaluation to a snapshot identifier, and, where configured, binding to an effective-dated foreign-exchange snapshot for multi-currency normalization; examples may include re-computing a month's baseline after an account moves from a first group to a second group and recording the proration delta with the snapshot so that any subsequent audit may deterministically reproduce the earlier alert or enforcement decision. The improved technology may be an audit and compliance infrastructure for cloud cost governance.

In some embodiments, the system may implement multi-level threshold evaluation in two selectable modes-aggregate mode and severity mode, together with deduplication and suppression windows; addressing the technical problem of alert storms and inconsistent group status in large hierarchies. In some embodiments, aggregate mode may compare a sum of actuals against a sum of group baselines, whereas severity mode may elevate a group based on a maximum member severity; deduplication may coalesce account-level and group-level events within a cool-down interval. In some embodiments, an implementation may persist the selected mode with the snapshot identifier to maintain replayability; examples may include elevating a portfolio status to “red” when any child group reaches a critical threshold, while suppressing duplicate notifications during a configured hysteresis period. The improved technology may be hierarchical policy evaluation and alerting engines.

In some embodiments, a time-aware scheduler may compute a safe-execution window for control intents such as start, stop, pause, resume, block, or prevent start by validating dependency health, snapshot/save-state recency, blackout windows, and grace periods; solving the technical problem of unsafe or conflicting control execution in distributed cloud environments. In some embodiments, evaluation may occur in a target entity's time zone with wall-clock semantics for Daylight Saving Time, while audit timestamps may be recorded in UTC; examples may include skipping a repeated hour during a fallback transition or deferring a stop action when a dependency has reported “Degraded” in the last T minutes. The improved technology may be cloud orchestration and scheduling systems.

In some embodiments, the system may apply a proactive rule that elevates severity when a forecast breach is within T days, thereby linking short-horizon forecasting to threshold governance, addressing the technical problem of purely reactive budget controls that fail to prevent overruns. In some embodiments, forecasting may use rule- or logic-based evaluators and, optionally, AI-assisted components to compute burn-rate and variance to planning-period targets; examples may include increasing severity by one level when a P50 forecast crosses a monthly cap within seven days and tightening off-hours schedules accordingly. The improved technology may be cost forecasting and policy-driven actuation.

In some embodiments, the provider-agnostic adapters may compile control intents from a centralized management or gateway context and distinguish read-only telemetry paths from control paths, solving the technical problem of heterogeneous provider APIs and ambiguous audit trails. In some embodiments, an implementation may tag each action with a policy identifier, actor, target scope, and path type, and may route only permitted intents under an active control mode, such as preventive or freeze; examples may include issuing a “prevent start” intent to block capacity increases while still allowing a safe stop. The improved technology may be multi-cloud control planes with strong audit semantics.

In some embodiments, data-freshness gates may suppress evaluation when input telemetry is stale beyond a configured threshold, addressing the technical problem of decisions made on delayed or incomplete data pipelines. In some embodiments, a freshness watermark may be stored with each input source, and the evaluator may defer or re-queue policy handling until watermarks meet minimum recency; examples may include blocking escalation when cost ingestion lags by more than K hours or re-validating forecasts after a late usage update arrives. The improved technology may be dependable stream processing for governance workloads.

In some embodiments, an idle-detection subsystem may determine under-utilization using rule- or logic-based thresholds and, optionally, model-based methods and may propose pause, stop, or scale-to-zero actions only within a computed safe-execution window; solving the technical problem of wasteful off-hours consumption without violating dependency or state-safety constraints. In some embodiments, implementation may include CPU/IO/request-rate features, drain/quiesce safeguards, and rollback on failure; examples may include scaling a test environment to zero after business hours when utilization remains below a learned baseline for a grace period. The improved technology may be utilization-aware resource controllers.

In some embodiments, planning-period budgeting may support annual, quarterly, monthly, weekly, daily, and custom calendars such as 4-4-5 or 13-period with rollover and reserve-pool rules and lock windows, addressing the technical problem of mapping financial planning cadence to runtime controls. In some embodiments, periodization may attribute new signals to the active planning period, apply proration for partial periods, and enforce lock windows that restrict changes absent elevated approval; examples may include carrying forward a configured percentage of unspent funds and allocating a portion to a reserve with expiry, with all changes versioned in an audit log. The improved technology may be calendar-aware financial governance tied to operational enforcement.

In some embodiments, tag- and metadata-driven grouping may be resolved via rule- or logic-based selectors and, optionally, AI-assisted inference using cost and usage similarity; solving the technical problem of brittle manual group definitions in large organizations. In some embodiments, the system may propose memberships with confidence scores, apply precedence rules for overlapping selectors, and record decisions and rationale; examples may include auto-assigning a resource to a project group based on tag consensus and seasonality-aligned spend patterns. The improved technology may be automated resource classification for governance.

In some embodiments, the system may also provide additional technical improvements that may be incorporated as optional enhancements without departing from the disclosed architecture. In some embodiments, a counterfactual recommendation engine may explore minimal-change schedules, threshold ladders, or re-baselines that would have averted a projected breach under current snapshots, solving the technical problem of opaque policy tuning by generating actionable alternatives with quantified impact. In some embodiments, implementation may include search over calendar windows, start-prevention intervals, or soft-cap values subject to guardrails, with outputs recorded with snapshot and policy identifiers; examples may include proposing a 90-minute off-hours extension that yields a P50 forecast returning below a monthly cap while preserving a release window. The improved technology may be a decision-support optimization for policy configuration.

In some embodiments, the system may employ ensemble forecasting with calibrated P50/P90 bands that may gate control modes, thereby improving short- and long-horizon accuracy under seasonality and commitment schedules; addressing the technical problem of single-model brittleness. In some embodiments, implementation may include combining rule-based pacing with learned residuals and applying band-aware policy rules, such as tightening schedules when a P90 band crosses a cap; examples may include switching from advisory to preventive mode when the upper band exceeds a threshold for a persistence window. The improved technology may be robust time-series modelling for governance actuation.

In some embodiments, a shadow-policy evaluation framework may run proposed policy updates in parallel without enforcement, track drift and regression against historical baselines, and automatically rollback on degradation, solving the technical problem of unsafe policy changes in production. In some embodiments, the framework may record correlation identifiers, versions, and confidence metrics in the audit log and may promote only when guardrail criteria are satisfied; examples may include testing a more aggressive idle threshold in shadow for two weeks before enabling enforcement. The improved technology may be a safe policy deployment for cloud control planes.

In some embodiments, an explain ability layer may generate LLM-based natural-language rationales for governance outcomes using recorded rule traces, model features, and snapshot identifiers, thereby addressing the technical problem of operator trust and post-incident analysis; implementation may include template evidence extraction with policy identifiers and confidence scores stored alongside the audit entry; examples may include an explanation that a start request was denied because a freeze mode was active and a dependency reported degraded within T minutes. The improved technology may be explainable AI for policy decisions.

In some embodiments, membership inference may be strengthened by pattern mining and clustering over normalized multi-provider telemetry with human-in-the-loop review, thereby addressing the technical problem of cross-provider inconsistency; implementation may include provider-agnostic feature normalization and confidence-weighted proposals that require approval under a delegation-of-authority chain; examples may include recommending re-parenting of a subscription to a different business unit due to persistent usage similarity with that unit's cost signature. The improved technology may be cross-provider resource classification with governance guardrails.

In some embodiments, the override and approval workflow may be extended with time-bound exception windows that auto-expire and trigger reversion checks, thereby addressing the technical problem of lingering exceptions; implementation may include storing scope, allowed action, start/end, and guardrails such as dependency checks and blackout windows, with automatic rollback at expiry; examples may include granting a six-hour weekend access window for a non-production environment with caps and early-end capability. The improved technology may be controlled exception handling in cloud governance.

In some embodiments, a computer-implemented method for facilitating intelligent budget governance for cloud resources across multiple cloud service providers may include obtaining, by a communication device, account information from a cloud account system of a cloud service provider. The communication device may also obtain budget information corresponding to a budget allocated to the cloud resource, and may further obtain usage information indicating how the resource is being utilized. A processing device may determine a grouped budget status for the resource by analyzing the account, budget, and usage data. The processing device may then calculate a threshold variance that reflects the deviation of the grouped budget status from a budget threshold defined for a specific planning period. The processing device may additionally evaluate a schedule definition that specifies allowed or disallowed time windows for the resource operation and, based on both the threshold variance and the schedule data, may generate a control intent that represents an operational action to be applied to the cloud resource. A storage device may persist the collected and computed information, while the communication device may transmit the control intent to the cloud account system for policy enforcement. The communication device may also receive override information representing an approval or additional allocation, enabling the processing device to modify the budget data to form a revised or modified budget upon which further control intent generation may be based.

In some embodiments, the method may include determining, by the processing device, an effective start date and an effective end date that define the membership period of a cloud resource within a particular hierarchical entity. The storage device may then record the effective dates to maintain a continuous and auditable historical record of group membership transitions. In some embodiments, the method may include evaluating, by the processing device, threshold variance data at multiple hierarchical levels, such as the resource level, the account level, and the group level. Each evaluated level may yield a distinct threshold status that the storage device may record to support hierarchical variance tracking and reporting across the organization. In some embodiments, the method may include forecasting, by the processing device, a projected utilization and expenditure for a cloud resource using temporal trends extracted from usage data. The processing device may identify a pre-breach condition when the forecasted expenditure is expected to exceed a defined budget threshold within a predetermined time horizon, thereby enabling proactive budget intervention before an actual breach occurs.

In some embodiments, the method may include computing, by the processing device, a safe-execution window during which a resource control action may be implemented without violating operational dependencies. The safe-execution window may be calculated from schedule data and dependency-health information related to the resource. In some embodiments, the method may include initiating, by the processing device, automated enforcement of a generated control intent whenever a policy condition associated with a budget threshold is satisfied. The automated enforcement may include applying a preventive or freeze mode to temporarily limit or restrict resource activity in order to prevent unauthorized operation or excessive consumption. In some embodiments, the method may include receiving, by the communication device, an override request linked to a previously generated control intent from an authorized user system. The processing device may evaluate and determine an approval status for the request, and the storage device may record the approval status together with a corresponding timestamp for later audit verification. In some embodiments, the method may include recording, by the storage device, a detailed audit entry containing the account data, budget data, usage data, threshold variance, and control intent information generated during evaluation. The processing device may associate a unique identifier with each audit entry to ensure that any past evaluation can be reproduced or replayed with exact fidelity. In some embodiments, the method may include generating, by the processing device, a forecast visualization dataset that represents a consolidated view of group budget status, threshold variance, and modified budget values. The storage device may retain the visualization data for use in periodic or scheduled management reports. In some embodiments, the method may include normalizing, by the processing device, the budget and usage data received from multiple cloud service providers into a unified base currency or consistent financial model, thereby enabling cross-provider budget governance and comparative analysis within a common framework.

In some embodiments, a system for facilitating intelligent budget governance across multiple cloud service providers may include a communication device, a processing device, and a storage device. The communication device may be configured to obtain account, budget, and usage data related to a cloud resource, to transmit generated control intents to a cloud account system for enforcement, and to receive override information, such as approvals or additional allocations, relative to a budget threshold. The processing device may determine a grouped budget status, calculate threshold variance, evaluate scheduling data, and generate a control intent based on both variance and schedule conditions. The processing device may further modify the budget data to form a modified budget based on received override information. The storage device may persist account, budget, usage, and variance data along with the generated control intents for audit and governance purposes.

In some embodiments, the system may enable the processing device to determine effective start and end dates defining a resource's membership within a hierarchical entity, while the storage device maintains the effective dates as part of a verifiable audit history of membership changes. In some embodiments, the system may enable the processing device to evaluate threshold variances at multiple hierarchical levels, such as resource, account, and group, and the storage device may maintain a distinct threshold status for each level to facilitate cross-hierarchical budget comparison. In some embodiments, the system may enable the processing device to perform forecasting operations that project future utilization and spending for a resource, identify possible pre-breach indicators, and issue early warnings or policy triggers based on predicted threshold violations.

In some embodiments, the system may enable the processing device to determine a safe-execution window by correlating schedule information with dependency-health data to ensure that any applied resource action occurs without violating operational dependencies or blackout constraints. In some embodiments, the system may enable the processing device to automatically enforce policy conditions that correspond to threshold deviations by initiating preventive or freeze modes designed to reduce consumption and prevent unauthorized resource activation. In some embodiments, the system may enable the communication device to receive override requests associated with active control intents, enable the processing device to determine approval status for the requests, and enable the storage device to record the approval status along with a timestamp for traceability.

In some embodiments, the system may enable the storage device to record detailed audit entries, including account, budget, usage, variance, and control intent information. The processing device may generate and assign a unique identifier to each audit entry to support reproducible replay of prior governance evaluations. In some embodiments, the system may enable the processing device to produce a forecast visualization dataset containing representations of grouped budget status, threshold variance, and modified budget information, while the storage device retains the dataset for generating periodic management dashboards and reports. In some embodiments, the system may enable the processing device to normalize budget and usage data obtained from multiple cloud providers into a standardized base currency or normalized schema, thereby supporting unified cross-provider financial governance and consolidated reporting.

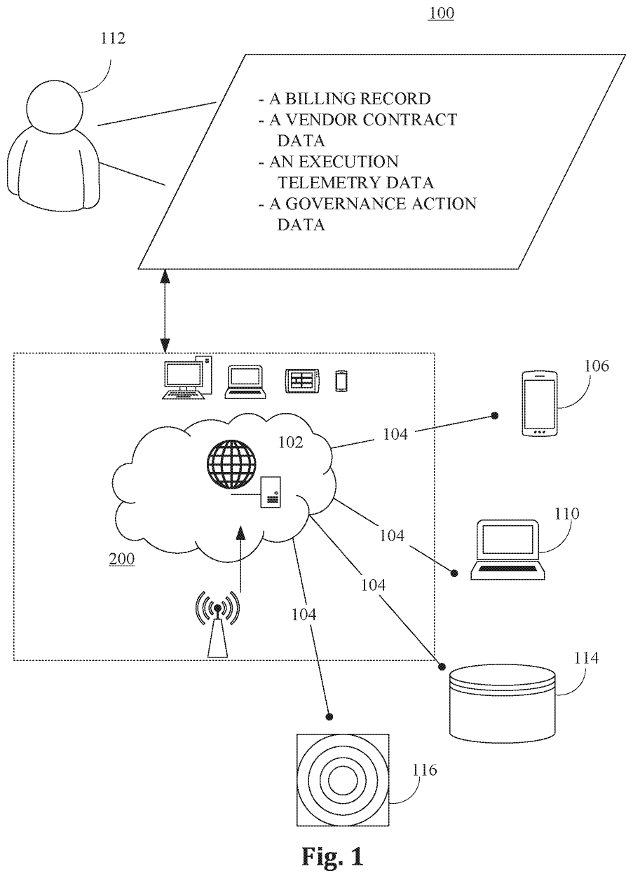

FIG. 1 is an illustration of an online platform 100 consistent with various embodiments of the present disclosure. By way of non-limiting example, the online platform 100 to facilitate managing budgets for cloud accounts may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web-based software application or browser. The web-based software application may be embodied as, for example, but not be limited to, a website, a web application, a desktop application, and a mobile application compatible with a computing device 200.

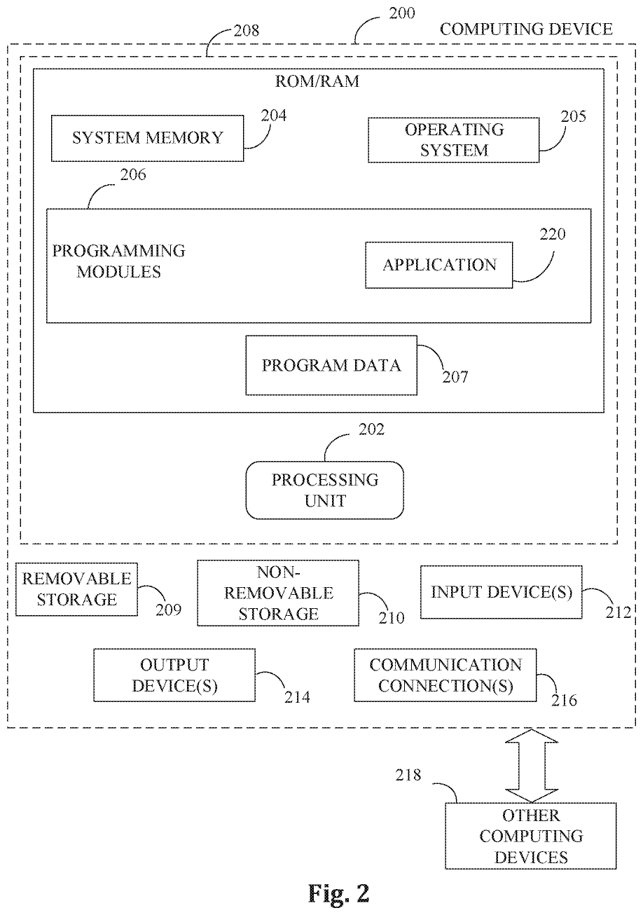

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g., random-access memory (RAM)), non-volatile (e.g., read-only memory (ROM)), flash memory, or any combination. System memory 204 may include an operating system 205, one or more programming modules 206, and may include a program data 207. Operating system 205, for example, may be suitable for controlling computing device 200's operation. In one embodiment, programming modules 206 may include machine learning modules. Furthermore, embodiments of the disclosure may be practiced in conjunction with a graphics library, other operating systems, or any other application program, and are not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable, and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD), or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, and databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

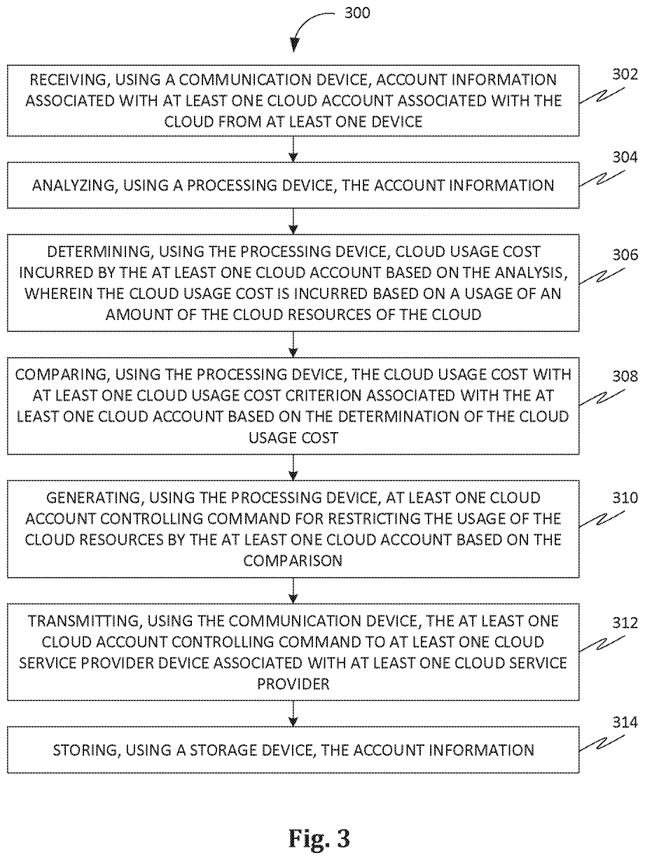

FIG. 3 is a flow chart of a method 300 for facilitating controlling and managing cloud usage costs incurred by cloud accounts for using cloud resources of a cloud, in accordance with some embodiments. The method 300 may include a step 302 of receiving, using a communication device (such as a communication device 1002), real-time account information associated with one or more cloud accounts associated with the cloud from one or more devices. Further, the account information may include cloud resources usage information associated with a usage of the cloud resources by the one or more cloud accounts. The method 300 may include a step 304 of analyzing, using a processing device (such as a processing device 1004), the account information. Further, the method 300 may include a step 306 of determining, using the processing device, cloud usage cost incurred by the one or more cloud accounts based on the calculation. Further, the cloud usage cost is incurred based on the usage of the cloud resources of the cloud. Further, the method 300 may include a step 308 of comparing, using the processing device, the cloud usage cost with cloud usage cost criterion associated with the one or more cloud accounts based on the calculation of the cloud usage cost. The method 300 may include a step 310 of generating, using the processing device, one or more cloud account controlling commands for restricting the usage of the cloud resources by the one or more cloud accounts based on the comparison. Further, the method 300 may include a step 312 of transmitting, using the communication device, the one or more cloud account controlling commands to one or more cloud service provider devices associated with the cloud service provider. Further, the one or more service provider devices restrict the usage of the cloud resources by the one or more cloud accounts based on the at least one cloud account controlling commands. Further, the method 300 may include a step 314 of storing, using a storage device (such as a storage device 1006), the account information.

In some embodiments, the restricting may include stopping or limiting the one or more cloud accounts from using additional amounts of the cloud resources during a second time period. The restricting may include initiating additional amounts of the cloud resources for the one or more cloud accounts during the second time period. The restricting may include terminating or limiting portions of the additional amounts of the cloud resource used by the one or more cloud accounts during the second time period. Further, the one or more cloud usage cost criterions may include one or more cloud usage cost endpoints. Further, the method 300 may include receiving, using the communication device, the one or more cloud usage cost endpoints associated with the one or more cloud accounts from one or more external devices. Further, the comparison of the cloud usage cost with the one or more cloud usage cost criterions may include comparing the cloud usage cost with the one or more cloud usage cost endpoints. Further, the generating of the one or more cloud account controlling commands for the restricting of the usage of the cloud resources by the one or more cloud accounts is based on the comparing the cloud usage cost with the one or more cloud usage cost endpoints.

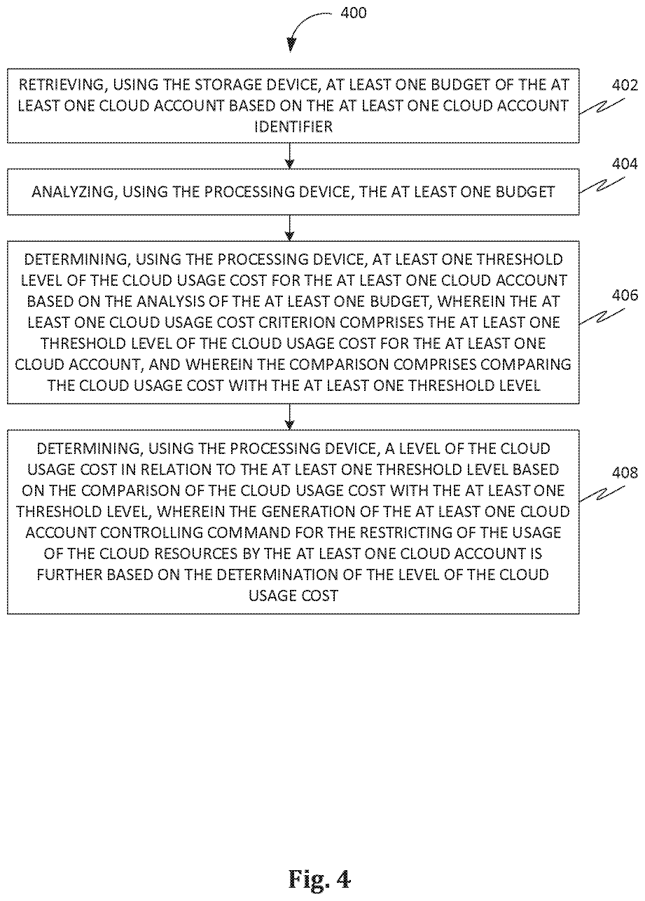

FIG. 4 is a flow chart of a method 400 for facilitating controlling and managing cloud usage costs incurred by cloud accounts for using cloud resources of a cloud. The method 400 may include determining a level of the cloud usage cost in relation to one or more threshold levels, in accordance with some embodiments. Further, the account information may include one or more cloud account identifiers of the one or more cloud accounts. Further, at 402, the method 400 may include retrieving, using the storage device, one or more budgets of the one or more cloud accounts based on the one or more cloud account identifiers. Further, at 404, the method 400 may include analyzing, using the processing device, the one or more budgets. Further, at 406, the method 400 may include determining, using the processing device, one or more threshold levels of the cloud usage cost for the one or more cloud accounts based on the analysis of the one or more budgets. The one or more cloud usage cost criterions may include the one or more threshold levels of the cloud usage cost for the one or more cloud accounts. Further, the comparison may include comparing the cloud usage cost with the one or more threshold levels. Further, at 408, the method 400 may include determining, using the processing device, a level of the cloud usage cost in relation to the one or more threshold levels based on the comparison of the cloud usage cost with the one or more threshold levels. Further, the generating of the one or more cloud account controlling commands for the restricting of the usage of the cloud resources by the one or more cloud accounts is based on the determining of the level of the cloud usage cost.

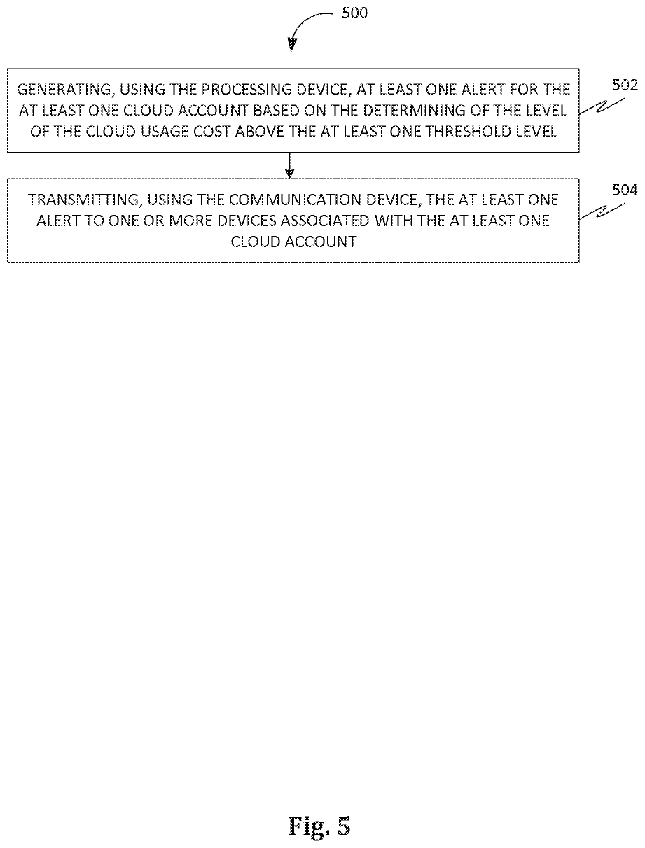

FIG. 5 is a flow chart of a method 500 for facilitating controlling and managing cloud usage costs incurred by cloud accounts for using cloud resources of a cloud. The method 500 may include transmitting the one or more alerts to one or more devices associated with the one or more cloud accounts, in accordance with some embodiments. Further, at 502, the method 500 may include generating, using the processing device, one or more alerts for the one or more cloud accounts based on the determination of the level of the cloud usage cost above the one or more threshold levels. Further, at 504, the method 500 may include transmitting, using the communication device, the one or more alerts to one or more devices associated with the one or more cloud accounts.

In some embodiments, the one or more threshold levels may include two or more threshold levels. Further, the determination of the level of the cloud usage cost above the one or more threshold levels may include determining the level of the cloud usage cost above a threshold level of the two or more threshold levels. Further, the generating of the one or more alerts may include generating an alert from two or more alerts for the one or more cloud accounts based on the determination of the level of the cloud usage cost above the threshold level of the two or more threshold levels.

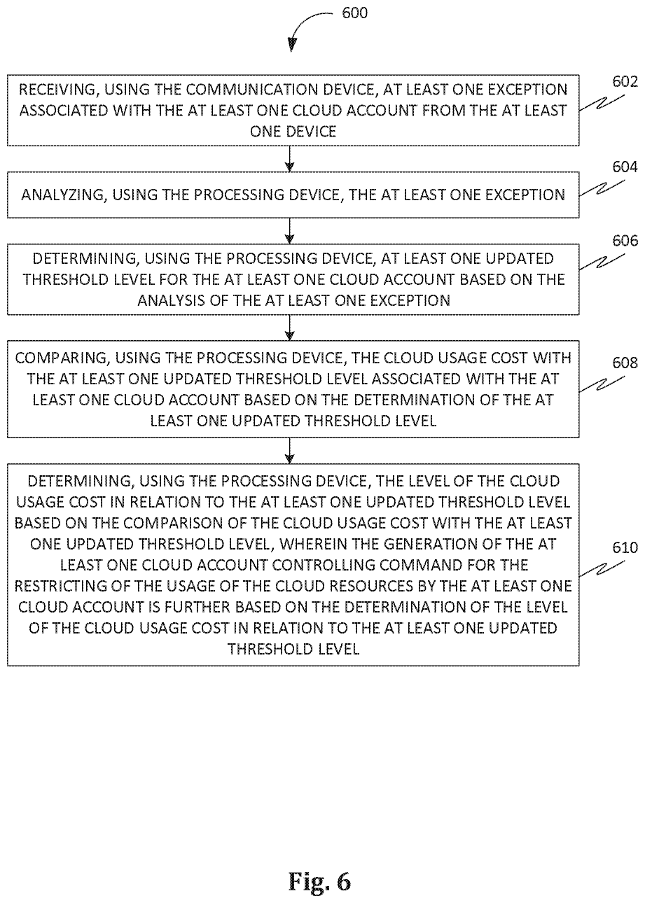

FIG. 6 is a flow chart of a method 600 for facilitating controlling and managing cloud usage costs incurred by cloud accounts for using cloud resources of a cloud. The method 600 may include determining the level of the cloud usage cost, in accordance with some embodiments. Further, the method 600 may include a step 602 of receiving, using the communication device, one or more exceptions associated with the one or more cloud accounts from the one or more devices. The method 600 may include a step 604 of analyzing, using the processing device, the one or more exceptions. Further, the method 600 may include a step 606 of determining, using the processing device, one or more updated threshold levels for the one or more cloud accounts based on the analysis of the one or more exceptions. Further, the method 600 may include a step 608 of comparing, using the processing device, the cloud usage cost with the one or more updated threshold levels associated with the one or more cloud accounts based on the determination of the one or more updated threshold levels. Further, the method 600 may include a step 610 of determining, using the processing device, the level of the cloud usage cost in relation to the one or more updated threshold levels based on the comparison of the cloud usage cost with the one or more updated threshold levels. Further, the generating of the one or more cloud account controlling commands for the restricting of the usage of the cloud resources by the one or more cloud accounts is further based on the determination of the level of the cloud usage cost in relation to the one or more updated threshold levels.

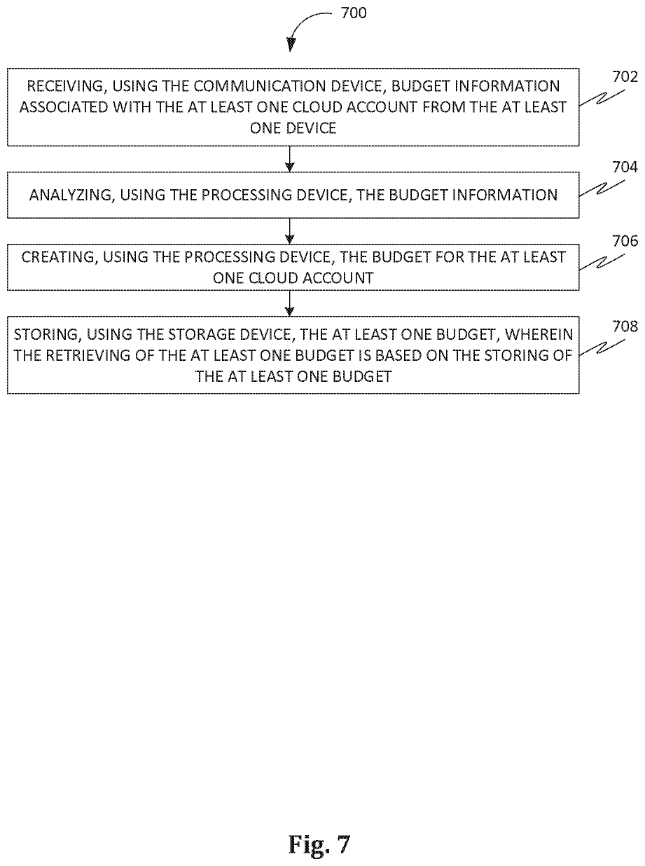

FIG. 7 is a flow chart of a method 700 for facilitating controlling and managing cloud usage costs incurred by cloud accounts for using cloud resources of a cloud. The method 700 may include creating the one or more budgets for the one or more cloud accounts, in accordance with some embodiments. Further, the method 700 may include a step 702 of receiving, using the communication device, budget information associated with the one or more cloud accounts from the one or more devices. The method 700 may include a step 704 of analyzing, using the processing device, the budget information. Further, the method 700 may include a step 706 of creating, using the processing device, the one or more budgets for the one or more cloud accounts. The method 700 may include a step 708 of storing, using the storage device, the one or more budgets. Further, the retrieving of the one or more budgets is based on the storing of the one or more budgets. Further, in some embodiments, the receiving of the budget information may include receiving the budget information from one or more budget planning interfaces of the one or more devices.

Further, in some embodiments, the one or more budget information may include one or more historical budgets of the one or more cloud accounts. Further, the analysis of the budget information may include analyzing the one or more historical budgets. Further, the creation of the one or more budgets is based on the analysis of the one or more historical budgets. Further, in some embodiments, the budget information may include historical cloud usage cost incurred by the one or more cloud accounts. Further, the analysis of the budget information may include analyzing the historical cloud usage cost using one or more ML algorithms. Further, the creation of the one or more budgets is based on the analyzing of the historical cloud usage cost.

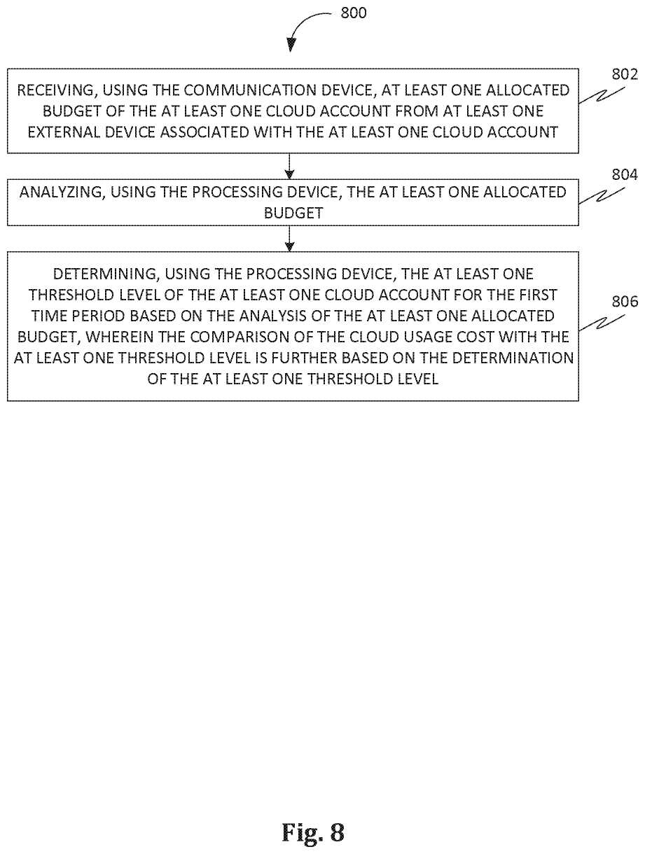

FIG. 8 is a flow chart of a method 800 for facilitating controlling and managing cloud usage costs incurred by cloud accounts for using cloud resources of a cloud. The method 800 may include determining the one or more threshold levels of the one or more cloud accounts, in accordance with some embodiments. Further, the method 800 may include a step 802 of receiving, using the communication device, one or more allocated budgets of the one or more cloud accounts from one or more external devices associated with the one or more cloud accounts. The method 800 may include a step 804 of analyzing, using the processing device, the one or more allocated budgets. Further, the method 800 may include a step 806 of determining, using the processing device, the one or more threshold levels of the one or more cloud accounts for the first time period based on the analyzing of the one or more allocated budgets. Further, the comparing of the cloud usage cost with the one or more threshold levels may be based on the determination of the one or more threshold levels.

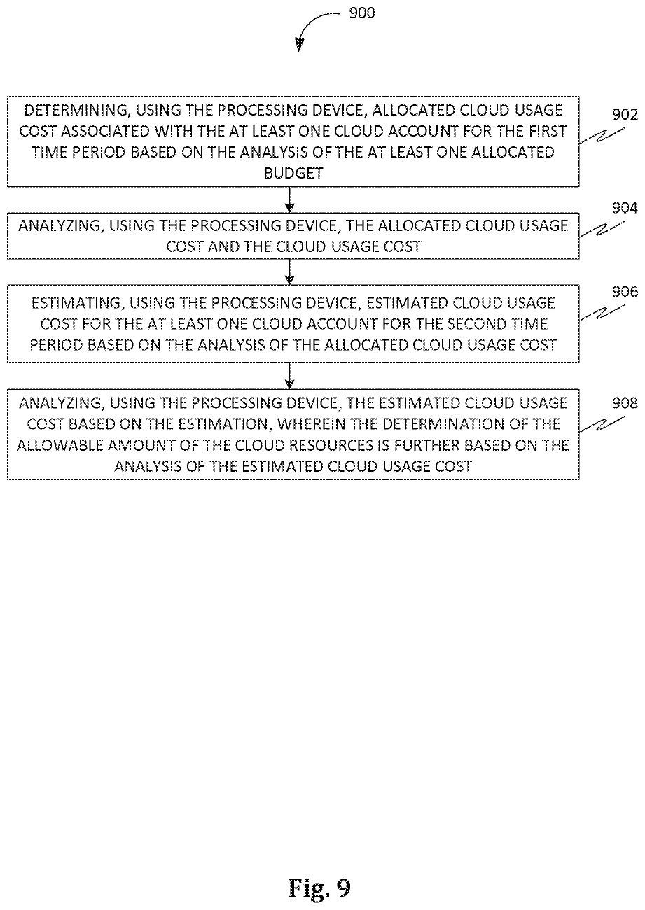

FIG. 9 is a flow chart of a method 900 for facilitating controlling and managing cloud usage costs incurred by cloud accounts for using cloud resources of a cloud in which the method 900 may include analyzing the one or more estimated cloud usage cost, in accordance with some embodiments. Further, the method 900 may include a step 902 of determining, using the processing device, one or more allocated cloud usage costs associated with the one or more cloud accounts for the one or more first time periods based on the analyzing of the one or more allocated budgets. Further, the method 900 may include a step 904 of analyzing, using the processing device, the allocated cloud usage cost and the cloud usage cost. The method 900 may include a step 906 of estimating, using the processing device, estimated cloud usage cost for the one or more cloud accounts for a second time period based on the analysis of the allocated cloud usage cost. Further, the method 900 may include a step 908 of analyzing, using the processing device, the estimated cloud usage cost based on the estimation. Further, the determination of the allowable amount of the cloud resources may be based on the analysis of the estimated cloud usage cost.

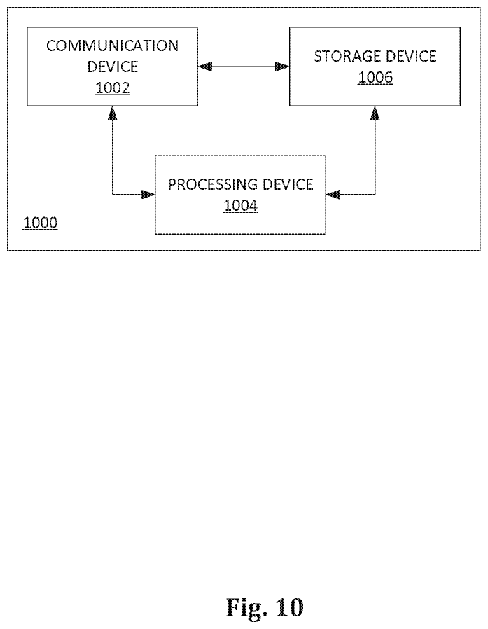

FIG. 10 is a block diagram of a system 1000 for facilitating controlling and managing cloud usage costs incurred by cloud accounts for using cloud resources of a cloud, in accordance with some embodiments. The system 1000 may include a communication device 1002, a processing device 1004, and a storage device 1006. The communication device 1002 may be configured for performing a step of receiving real-time account information associated with one or more cloud accounts associated with the cloud from one or more devices. Further, the account information may include cloud resources usage information associated with a usage of the cloud resources by the one or more cloud accounts. The communication device 1002 may be configured for performing a step of transmitting one or more cloud account controlling commands to one or more cloud service provider devices associated with one or more cloud service providers. Further, the one or more service provider devices restrict the usage of the cloud resources by the one or more cloud accounts based on the one or more cloud account controlling commands.

The processing device 1004 may be communicatively coupled with the communication device 1002. Further, the processing device 1004 may be configured for performing a step of analyzing the account information. The processing device 1004 may be configured for performing a step of determining cloud usage cost incurred by the one or more cloud accounts based on the analysis. Further, the cloud usage cost may be incurred based on the usage of one or more amounts of the cloud resources of the cloud. The processing device 1004 may be configured for performing a step of comparing the cloud usage cost with one or more cloud usage cost criteria associated with the one or more cloud accounts based on the determining of the cloud usage cost. Further, the processing device 1004 may be configured for performing a step of generating the one or more cloud account controlling commands for the restricting of the usage of the cloud resources by the one or more cloud accounts based on the comparison.

The storage device 1006 may be communicatively coupled with the processing device 1004. Further, the storage device 1006 may be configured for performing a step of storing the account information. The account information may include one or more cloud account identifiers of the one or more cloud accounts. Further, the storage device 1006 may be configured for retrieving one or more budgets of the one or more cloud accounts based on the one or more cloud account identifiers. Further, the processing device 1004 may be configured for analyzing the one or more budgets. The processing device 1004 may be configured for determining one or more threshold levels of the cloud usage cost for the one or more cloud accounts based on the analysis of the one or more budgets. Further, the one or more cloud usage cost criteria may include the one or more threshold levels of the cloud usage cost for the one or more cloud accounts. Further, the comparison may include comparing the cloud usage cost with the one or more threshold levels. Further, the processing device 1004 may be configured for determining a level of the cloud usage cost in relation to the one or more threshold levels based on the comparison of the cloud usage cost with the one or more threshold levels. Further, the generation of the one or more cloud account controlling commands for the restricting of the usage of the cloud resources by the one or more cloud accounts may be based on the determination of the level of the cloud usage cost.

Further, in some embodiments, the communication device 1002 may be configured for receiving budget information associated with the one or more cloud accounts from the one or more devices. The processing device 1004 may be configured for analyzing the budget information. Further, the processing device 1004 may be configured for creating the one or more budgets for the one or more cloud accounts. The storage device 1006 may be configured for storing the one or more budgets. Further, the retrieving of the one or more budgets may be based on the storing of the one or more budgets. Further, in an embodiment, the receiving of the budget information may include receiving the budget information from one or more budget planning interfaces of the one or more devices.

Further, in an embodiment, the budget information may include one or more historical budgets of the one or more cloud accounts. The analysis of the budget information may include analyzing the one or more historical budgets. Further, the creation of the one or more budgets may be based on the analysis of the one or more historical budgets. In an embodiment, the budget information may include historical cloud usage cost incurred by the one or more cloud accounts. Further, the analysis of the budget information may include analyzing the historical cloud usage cost using one or more ML algorithms. Further, the creation of the one or more budgets may be based on the analysis of the historical cloud usage cost.

Further, in some embodiments, the one or more cloud usage cost criteria may include one or more cloud usage cost endpoints. The communication device 1002 may be configured for receiving the one or more cloud usage cost endpoints associated with the one or more cloud accounts from one or more external devices. Further, the comparison of the cloud usage cost with the one or more cloud usage cost criteria may include comparing the cloud usage cost with the one or more cloud usage cost endpoints. Further, the generation of the one or more cloud account controlling commands for the restricting of the usage of the cloud resources by the one or more cloud accounts may be further based on the comparison of the cloud usage cost with the one or more cloud usage cost endpoints. In some embodiments, the restriction may include stopping the one or more cloud accounts from using additional amounts of the cloud resources during the second time period. In some embodiments, the restriction may include initiating additional amounts of the cloud resource for the one or more cloud accounts during the second time period. In some embodiments, the restriction may include terminating or limiting one or more portions of the amounts of the cloud resource used by the one or more cloud accounts during the second time period.

In some embodiments, the processing device 1004 may be configured for performing a step of generating one or more alerts for the one or more cloud accounts based on the determination of the level of the cloud usage cost above the one or more threshold levels. Further, the communication device 1002 may be configured for performing a step of transmitting the one or more alerts to one or more devices associated with the one or more cloud accounts. In some embodiments, the one or more threshold levels may include two or more threshold levels. Further, the determining of the level of the cloud usage cost above the one or more threshold levels may include determining the level of the cloud usage cost above a threshold level of the two or more threshold levels. Further, the generation of the one or more alerts may include generating an alert from two or more alerts for the one or more cloud accounts based on the determination of the level of the cloud usage cost above the threshold level of the two or more threshold levels.

In some embodiments, the communication device 1002 may be configured for performing a step of receiving one or more exceptions associated with the one or more cloud accounts from the one or more devices. The processing device 1004 may be configured for performing a step of analyzing the one or more exceptions. Further, the processing device 1004 may be configured for performing a step of determining one or more updated threshold levels for the one or more cloud accounts based on the analysis of the one or more exceptions. The processing device 1004 may be configured for performing a step of comparing the cloud usage cost with the one or more updated threshold levels associated with the one or more cloud accounts based on the determination of the one or more updated threshold levels. Further, the processing device 1004 may be configured for performing a step of determining the level of the cloud usage cost in relation to the one or more updated threshold levels based on the comparison of the cloud usage cost with the one or more updated threshold levels. Further, the generating of the one or more cloud account controlling commands for the restricting of the usage of the cloud resources by the one or more cloud accounts may be further based on the determining of the level of the cloud usage cost in relation to the one or more updated threshold levels.

In some embodiments, the communication device 1002 may be configured for performing a step of receiving historical cloud usage data associated with the one or more cloud accounts from one or more external devices associated with the one or more cloud accounts. Further, the processing device 1004 may be configured for performing a step of analyzing the historical cloud usage data using one or more ML algorithms. The processing device 1004 may be configured for performing a step of estimating one or more budgets of the one or more cloud accounts for the first time period based on the analysis of the historical cloud usage data. Further, the processing device 1004 may be configured for performing a step of determining the one or more threshold levels of the one or more cloud accounts for the first time period based on the one or more budgets. Further, the comparison of the cloud usage cost with the one or more threshold levels may be based on the determination of the one or more threshold levels.

In some embodiments, the communication device 1002 may be configured for performing a step of receiving one or more allocated budgets of the one or more cloud accounts from one or more external devices associated with the one or more cloud accounts. Further, the processing device 1004 may be configured for performing a step of analyzing the one or more allocated budgets. Further, the processing device 1004 may be configured for performing a step of determining the one or more threshold levels of the one or more cloud accounts for the first time period based on the analysis of the one or more allocated budgets. Further, the comparing of the cloud usage cost with the one or more threshold levels may be based on the determining of the one or more threshold levels.

In some embodiments, the processing device 1004 may be configured for performing a step of determining allocated cloud usage cost associated with the one or more cloud accounts for the first time period based on the analysis of the allocated budget. Further, the processing device 1004 may be configured for performing a step of analyzing the allocated cloud usage cost and the cloud usage cost. Further, the processing device 1004 may be configured for performing a step of estimating estimated cloud usage cost for the one or more cloud accounts for the second time period based on the analysis of the allocated cloud usage cost. Further, the processing device 1004 may be configured for performing a step of analyzing the estimated cloud usage cost based on the estimation. Further, the determination of the allowable amount of the cloud resources may be based on the analyzing of the estimated cloud usage cost.

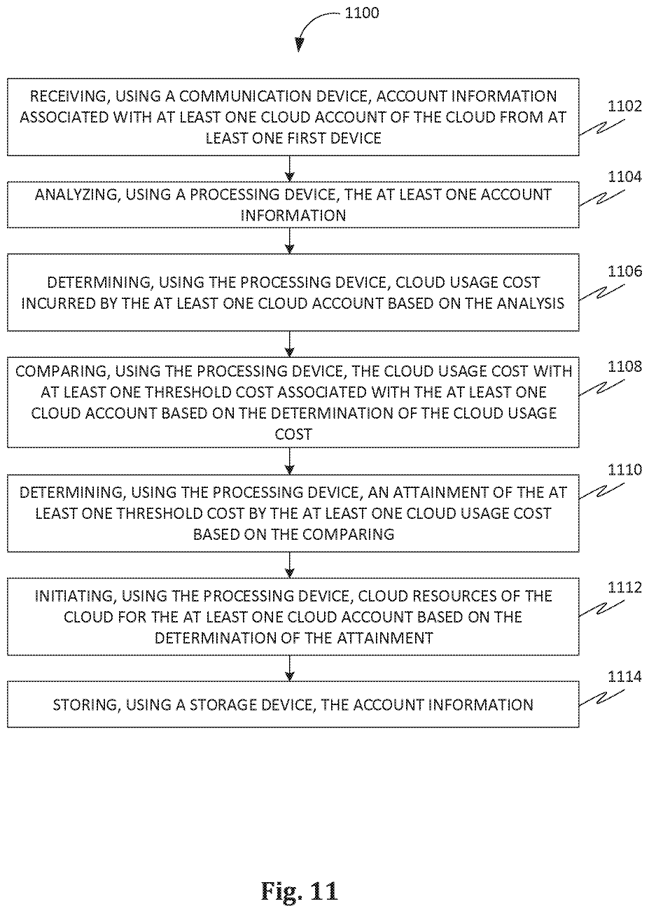

FIG. 11 is a flowchart of a method 1100 for facilitating controlling and managing cloud usage costs incurred by cloud accounts of a cloud, in accordance with some embodiments. Accordingly, the method 1100 may include a step 1102 of receiving, using a communication device, account information associated with at least one cloud account of the cloud from at least one first device. Further, the method 1100 may include a step 1104 of analyzing, using a processing device, the account information. The method 1100 may include a step 1106 of determining, using the processing device, the cloud usage cost incurred by the cloud account based on the analysis. Further, the method 1100 may include a step 1108 of comparing, using the processing device, the cloud usage cost with at least one threshold cost associated with the cloud account based on the determination of the cloud usage cost. The method 1100 may include a step 1110 of determining, using the processing device, an attainment of the at least one threshold cost by the cloud usage cost based on the comparison. Further, the method 1100 may include a step 1112 of initiating, using the processing device, cloud resources of the cloud for the cloud account based on the determination of the attainment. The cloud resources may not be initiated for the cloud account if the cloud usage cost attains the at least one threshold cost. Further, the cloud resources may be initiated for the cloud account if the cloud usage cost does not attain the at least one threshold cost. The method 1100 may include a step 1114 of storing, using a storage device, the account information.

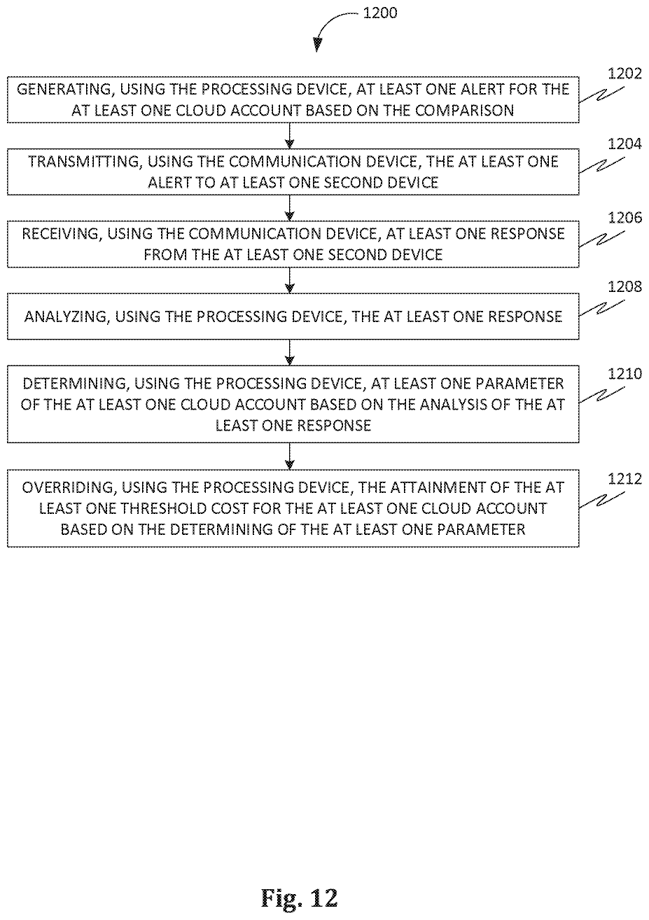

FIG. 12 is a flowchart of a method 1200 for facilitating overriding the attainment of the at least one threshold cost by the cloud usage cost, in accordance with some embodiments. Accordingly, the method 1200 may include a step 1202 of generating, using the processing device, at least one alert for the one cloud account based on the comparison. Further, the method 1200 may include a step 1204 of transmitting, using the communication device, the at least one alert to at least one second device. The method 1200 may include a step 1206 of receiving, using the communication device, at least one response from the at least one second device. Further, the method 1200 may include a step 1208 of analyzing, using the processing device, the at least one response. The method 1200 may include a step 1210 of determining, using the processing device, at least one parameter of the cloud account based on the analysis of the at least one response. Further, the method 1200 may include a step 1212 of overriding, using the processing device, the attainment of the at least one threshold cost for the cloud account based on the determination of the at least one parameter. Further, the initiating of the cloud resources for the cloud account may be based on the overriding.

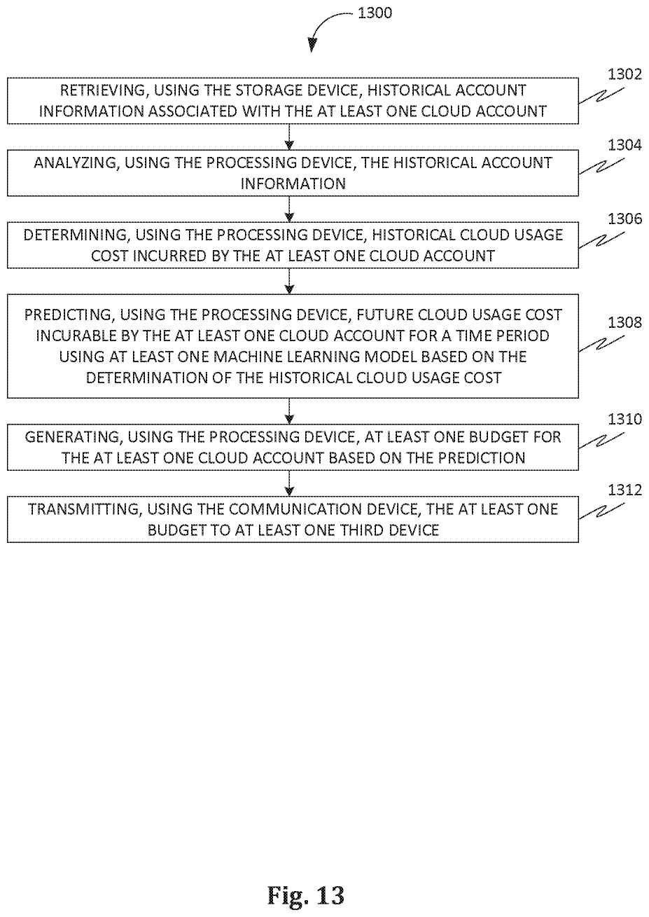

FIG. 13 is a flowchart of a method 1300 for facilitating generating of a budget for the cloud account, in accordance with some embodiments. Accordingly, the method 1300 may include a step 1302 of retrieving, using the storage device, historical account information associated with the at least one cloud account. Further, the method 1300 may include a step 1304 of analyzing, using the processing device, the historical account information. Further, the method 1300 may include a step 1306 of determining, using the processing device, historical cloud usage cost incurred by the at least one cloud account. Further, the method 1300 may include a step 1308 of predicting, using the processing device, future cloud usage cost incurred by the at least one cloud account for a time period using at least one machine learning model based on the determination of the historical cloud usage cost. Further, the method 1300 may include a step 1310 of generating, using the processing device, at least one budget for the at least one cloud account based on the prediction. Further, the method 1300 may include a step 1312 of transmitting, using the communication device, the at least one budget to at least one third device.

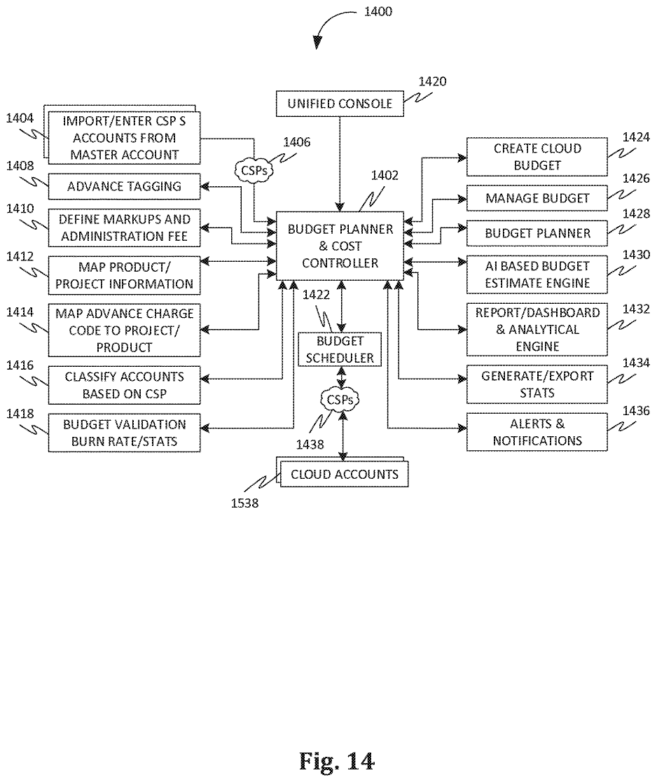

FIG. 14 is a block diagram of a system 1400 for creating, managing, and planning a budget for any given period or fiscal year across all the accounts in the cloud, in accordance with some embodiments. Further, the system 1400 may include a budget planner and cost controller 1402. At 1404, the budget planner and cost controller 1402 import/enter CSP's accounts from a master account using a CSP 1406. Further, at 1408, the budget planner and cost controller 1402 performs advanced tagging. At 1410, the budget planner and cost controller 1402 define markups and administration fees. Further, at 1412, the budget planner and cost controller 1402 map product/project information. At 1414, the budget planner and cost controller 1402 map the advance charge code to the project/product. Further, at 1416, the budget planner and cost controller 1402 classifies accounts based on CSP. Further, at 1418, the budget planner and cost controller 1402 determine budget validation/burn rate/stats. The system 1400 may include a unified console 1420, a budget scheduler 1422, a create cloud budget 1424, a manage budget 1426, a budget planner 1428, an AI-based budget estimate engine 1430, a report/dashboard and analytical engine 1432, a stats generation/export engine 1434, and alerts and notifications 1436. Further, the system 1400 generates a schedule via the budget scheduler 1422 to push the schedule to cloud accounts 1538 using a CSP 1438.

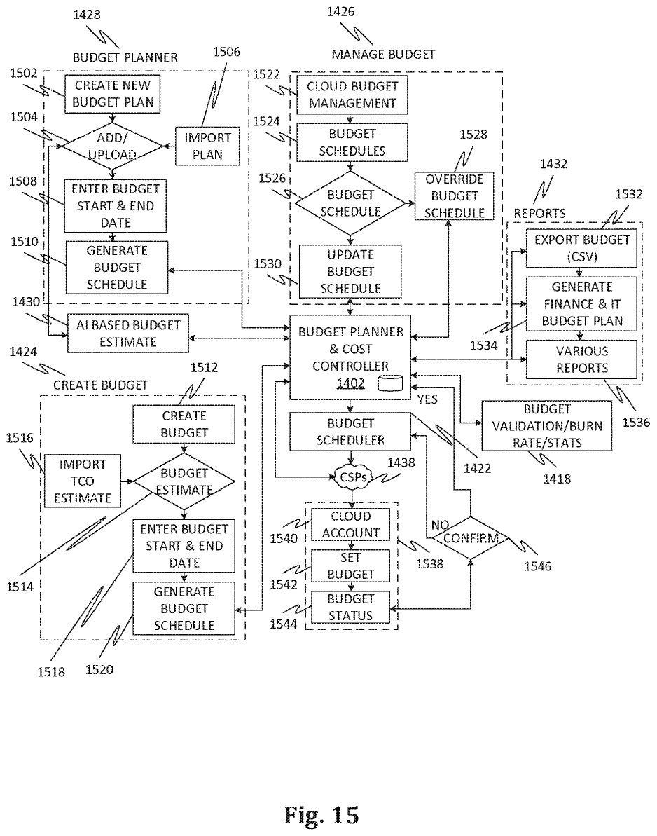

FIG. 15 is a flow diagram of methods for creating, managing, and controlling the budget, budget schedules, and budget planning for the cloud accounts 1538 across multiple cloud service providers (CSP), in accordance with some embodiments. At 1502, the budget planner 1428 may include creating a new budget plan. Further, at 1504, the budget planner 1428 may include adding/uploading based on importing a plan 1506 or from the system generated budget plan from the AI-based budget estimate engine 1430. Further, at 1508, the budget planner 1428 may include entering the budget's start and end dates. At 1510, the budget planner 1428 may include generating a budget schedule. Further, the budget planner and cost controller 1402 receive the budget schedule after the step 1510. At 1512, the create cloud budget 1424 may include creating a budget. Further, at 1514, the create cloud budget 1424 may include budget estimation based on importing TCO 1516. Further, at 1518, the create cloud budget 1424 may include entering the budget's start and end dates. Further, at 1520, the create cloud budget 1424 may include generating a budget schedule. Further, the budget planner and cost controller 1402 receive the budget schedule after the step 1520. Further, at 1522, the managed budget 1426 may include a cloud-based budget management. At 1524, the managed budget 1426 may include budget schedules. Further, at 1526, the managed budget 1426 may include a budget schedule. At 1528, the managed budget 1426 may include overriding the budget schedule based on the budget schedule 1526. Further, at 1530, the managed budget 1426 may include updating the budget schedule based on the budget schedule 1526. Further, the budget planner and cost controller 1402 receives the budget schedule after the step 1530. The budget planner and cost controller 1402 receives the budget schedule after the step 1528. Further, the report 1432 may include export budget (CSV) 1532, generate finance and IT budget plan 1534, and various reports 1536. Further, the cloud accounts 1538 may include cloud account 1540, set budget 1542, and budget status 1544. Further, the budget planner and cost controller 1402 and the budget scheduler 1422 receive the budget status 1544 via a step of 1546.

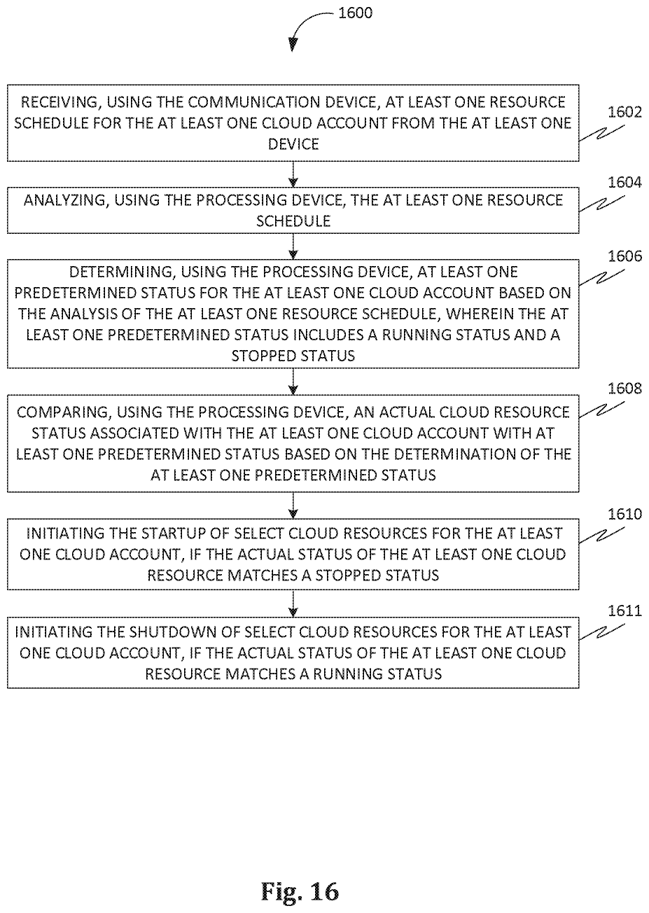

FIG. 16 is a flowchart of a method 1600 for dynamically stopping cloud resources when the cloud resources are not in use, in accordance with some embodiments. Accordingly, the method 1600 may include a step 1602 of receiving, using the communication device, at least one resource schedule for the at least one cloud account from the at least one device. The method 1600 may include a step 1604 of analyzing, using the processing device, the at least one resource schedule. Further, the method 1600 may include a step 1606 of determining, using the processing device, at least one predetermined status for the at least one cloud account based on the analysis of the at least one resource schedule, wherein the at least one predetermined status includes a running status and a stopped status. The method 1600 may include a step 1608 of comparing, using the processing device, an actual cloud resource status associated with the at least one cloud account with at least one predetermined status based on the determination of the at least one predetermined status. In addition, the method 1600 may include a step 1610 of initiating the startup of select cloud resources for the at least one cloud account, if the actual status of the at least one cloud resource matches a stopped status. Alternatively, the method 1600 may also include a step 1611 of initiating the shutdown of select cloud resources for the at least one cloud account, if the actual status of the at least one cloud resource matches a running status.

In the preferred embodiment, the at least one resource schedule may correspond to predetermined working hours associated with the at least one cloud account, wherein the running status corresponds to working hours within the range of the predetermined working hours, and wherein the stopped status corresponds to non-working hours outside the range of the predetermined working hours. In other words, if the cloud resources are not running during predetermined working hours, the cloud resources can be dynamically started if the cloud resources have not been manually started. If the cloud resources are running during predetermined non-working hours, the cloud resources can be dynamically stopped to save cloud usage cost if the cloud resources are not manually stopped.

In an alternate embodiment, the at least one resource schedule corresponds to predetermined service level requirements (SLAs) associated with the at least one cloud account, wherein the running status corresponds to service levels within the range of SLAs, and wherein the stopped status corresponds to service levels outside the range of SLAs. In other words, if the usage of cloud resources by the cloud account falls within the SLAs, the cloud resources can be dynamically brought up and running if the cloud resources have not been manually started. Further, the cloud resources can be dynamically stopped if the usage of cloud resources by the cloud account falls outside the predetermined SLAs.

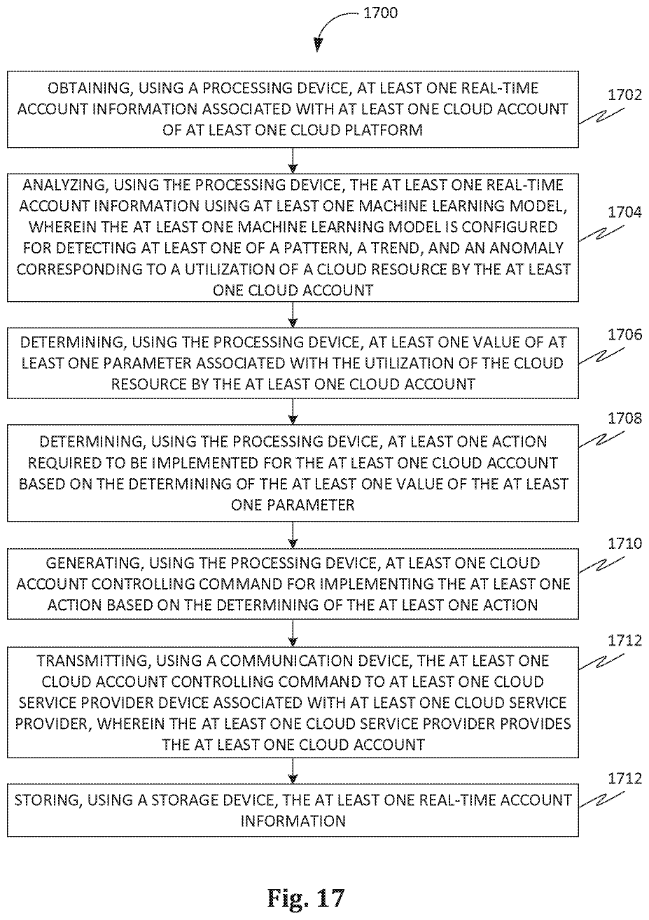

FIG. 17 is a flowchart of a method 1700 for facilitating managing budgets for cloud accounts, in accordance with some embodiments. Accordingly, at 1702, the method 1700 may include obtaining, using a processing device, at least one real-time account information associated with at least one cloud account of at least one cloud platform. Further, the at least one real-time account information may include information associated with a usage of one or more cloud resources by the at least one cloud account. Further, the one or more cloud resources may include a cloud storage resource. Further, the at least one real-time account information may include information associated with a usage of a budget allocated to the at least one cloud account. Further, the at least one real-time account information may include a cloud usage information. Further, the at least one cloud platform hosts the at least one cloud account. Further, the at least one real-time account information may include storage data, resource data, billing data, financial data, etc., associated with the at least one cloud account. Further, the obtaining of the at least one real-time account information may be based on an integration with at least one application programming interface (API) or any other mechanism of one or more cloud service providers associated with the at least one cloud platform. Further, the obtaining of the at least one real-time account information may include fetching the at least one account information in real time.

Further, at 1704, the method 1700 may include analyzing, using the processing device, the at least one real-time account information using one or more analytical techniques, which may include at least one machine learning model. Further, the one or more analytical techniques may include rule-based analysis, statistical modeling, threshold-based comparison, heuristic evaluation, deterministic algorithms, or predictive modeling techniques. In some embodiments, the at least one machine learning model may be trained using at least one machine learning algorithm, at least one artificial intelligence (AI) algorithm, etc. Further, the at least one machine learning model may be an artificial intelligence (AI) model. Further, at least one machine learning model or other analytical technique may be configured for detecting at least one of a pattern, a trend, and an anomaly corresponding to a utilization of a cloud resource by the at least one cloud account. Further, at least one of the pattern, the trend, and the anomaly may be detected in the at least one real-time account information. Further, the pattern may include a spending pattern associated with the budget allocated to the at least one cloud account, a usage pattern (such as cloud usage pattern, cloud resource usage pattern, etc.) associated with the cloud resource allocated to the at least one cloud account, a financial pattern associated with a financial of the at least one cloud account, a demand pattern associated with a demand for the cloud resource, an operational pattern associated with an operation of the at least one cloud account, a budget pattern, etc. Further, the pattern may be associated with a cloud usage pattern information. Further, the trend may include a spending trend associated with the budget allocated to the at least one cloud account, a financial trend associated with the financial, etc. Further, the anomaly may include an overutilization of the cloud resource, an underutilization of the cloud resource, an overspending of the budget, an underspending of the budget, a spike in a usage of the cloud resource and the budget allocated to the at least one cloud account, a budget anomaly, etc.

Further, at 1706, the method 1700 may include determining, using the processing device, at least one value of at least one parameter associated with the utilization of the cloud resource by the at least one cloud account. Further, the at least one parameter may include an operational parameter associated with the cloud resource, a resource utilization metric, a storage metric, a key metric (such as storage capacity usage, read/write operations, data transfer rates, etc.), an expenditure (daily expenditure), etc. Further, the at least one parameter may include a compliance with data privacy standards, including but not limited to General Data Protection Regulation (GDPR) and Health Insurance Portability and Accountability Act (HIPAA).

Further, at 1708, the method 1700 may include determining, using the processing device, at least one action required to be implemented for the at least one cloud account based on the determining of the at least one value of the at least one parameter. Further, the at least one action may include restricting a spinning of an additional cloud resource to the at least one cloud account, implementing one or more cost saving measures for the at least one cloud account, overriding a preset percentage consumption on the budget of the at least one cloud account, adding an additional fund to the budget of the at least one cloud account, restricting cloud resource provisioning for the at least one cloud account, etc.

Further, at 1710, the method 1700 may include generating, using the processing device, at least one cloud account controlling command for implementing the at least one action based on the determining of the at least one action.

Further, at 1712, the method 1700 may include transmitting, using a communication device, the at least one cloud account controlling command to at least one cloud service provider device associated with at least one cloud service provider. Further, the at least one cloud service provider provides the at least one cloud account. Further, the at least one cloud service provider device may include a server, a cloud server, a storage gateway appliance, a storage gateway device, a network attached storage (NAS) device, a load balancer, a networking device, etc.

Further, at 1714, the method 1700 may include storing, using a storage device, the at least one real-time account information. Further, the storing of the at least one real-time account information complies with global data privacy standards.

In further embodiments, the method 1700 may include aligning, using the processing device, one or more budget management processes with one or more regulatory requirements and one or more contractual practices applicable to federal and commercial contracting, thereby facilitating compliance with prevailing one or more acquisition regulations and enabling effective management of various contract types, including fixed-price contracts. Further, the method 1700 may include generating, using the processing device, a user interface for displaying real-time financial data, including expenditures, budget allocations, and resource utilization metrics, enabling users to make informed decisions regarding cloud cost management and resource allocation.

In further embodiments, the method 1700 may include predicting, using the processing device, at least one requirement associated with the at least one cloud account based on the at least one value of the at least one parameter. Further, the determining of the at least one action may be based on the at least one requirement. Further, the at least one requirement may include a resource requirement associated with the at least one cloud account, a project requirement of a project associated with the at least one cloud account, an operational requirement of an operation associated with the at least one cloud account, a budgetary requirement of the budget for the at least one cloud account, a regulatory requirement associated with an expenditure of the at least one cloud account, etc.

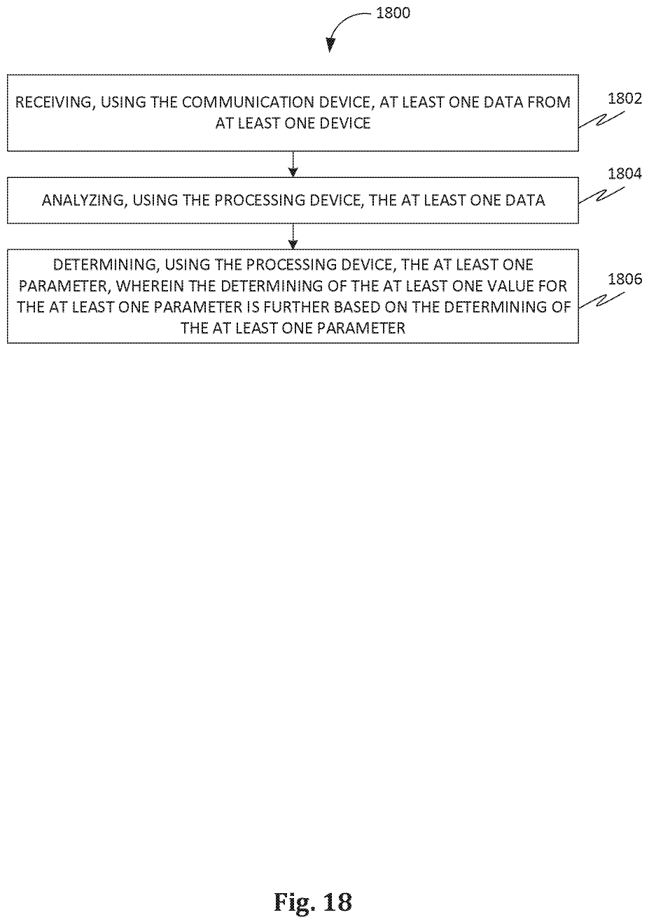

FIG. 18 is a flowchart of a method 1800 for facilitating managing budgets for cloud accounts, in accordance with some embodiments. Accordingly, at 1802, the method 1800 may include receiving, using the communication device, at least one data from at least one device. Further, the at least one data may include a feedback of at least one user associated with the at least one cloud account. Further, the at least one device may include a smartphone, a tablet, a laptop, a computer, and so on that may be associated with at least one user. Further, the at least one user may include an individual, an institution, and an organization. Further, the at least one device may include a client device, a user device, a computing device, a sensor, etc. Further, the at least one data may include data associated with cloud cost management, budget adjustments, cloud resource allocation, etc.

Further, at 1804, the method 1800 may include analyzing, using the processing device, the at least one data.

Further, at 1806, the method 1800 may include determining, using the processing device, the at least one parameter. Further, the at least one parameter may include one or more user-defined parameters. Further, the one or more user-defined parameters may include specific cloud services, budgetary thresholds, and financial goals. Further, the determining of the at least one value for the at least one parameter may be based on the determining of the at least one parameter.

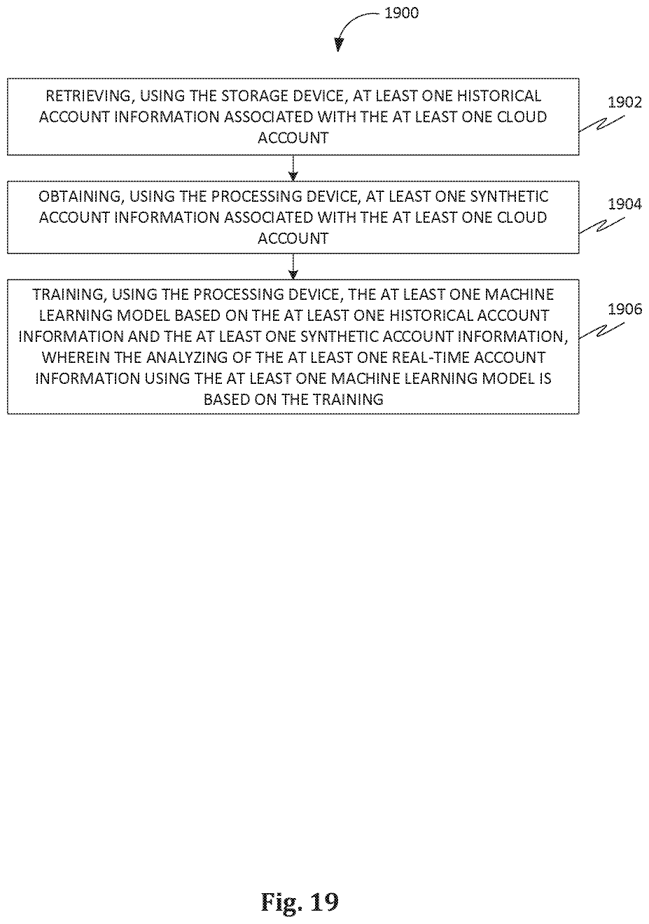

FIG. 19 is a flowchart of a method 1900 for facilitating managing budgets for cloud accounts, in accordance with some embodiments. Accordingly, at 1902, the method 1900 may include retrieving, using the storage device, at least one historical account information associated with the at least one cloud account. Further, the at least one historical account information may include historical data, historical financial data, historical budget data, historical usage data, historical cloud usage data, historical spending data, etc. Further, the at least one historical account information may be associated with a historical usage of the cloud resource.

Further, at 1904, the method 1900 may include obtaining, using the processing device, at least one synthetic account information associated with the at least one cloud account. Further, the at least one synthetic account information may include synthetic data. Further, the synthetic data may include a dataset that reflects various spending patterns, including typical daily expenses, sudden spikes in spending, and gradual increases in spending. Further, the dataset is designed to simulate a range of scenarios that might occur in real project management. Further, the obtaining of the at least one synthetic account information may include generating the at least one synthetic account information based on a statistical analysis of the at least one historical account information. Further, the statistical analysis may include distribution analysis, correlation analysis, and time series analysis, among other methods. Further, the at least one synthetic account information may be generated using at least one machine learning model using the at least one historical account information. Further, the at least one machine learning model detects at least one a pattern and a trend in the at least one historical account information. Further, the at least one machine learning model generates the at least one synthetic account information based on at least one the pattern and the trend. Further, the at least one machine learning model may include a Generative Adversarial Network (GAN), a Variational Autoencoder (VAE), or any other advanced data modeling technologies.

Further, at 1906, the method 1900 may include training, using the processing device, the at least one machine learning model based on the at least one historical account information and the at least one synthetic account information. Further, the analyzing of the at least one real-time account information using the at least one machine learning model may be based on the training. Further, the at least one machine learning model may include a trained machine learning model.

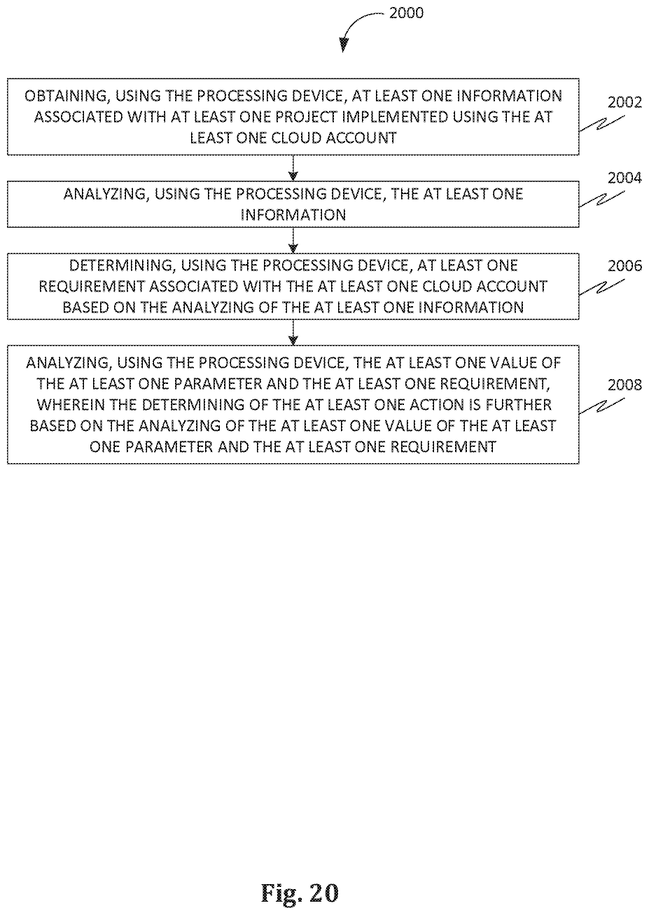

FIG. 20 is a flowchart of a method 2000 for facilitating managing budgets for cloud accounts, in accordance with some embodiments. Accordingly, at 2002, the method 2000 may include obtaining, using the processing device, at least one information associated with at least one project implemented using the at least one cloud account. Further, the at least one information may include an objective, a goal, a practice, a contract, a scope, a budget, a period, a duration, a project type, etc., associated with the at least one project. Further, the at least one information may include project data.

Further, at 2004, the method 2000 may include analyzing, using the processing device, the at least one information.

Further, at 2006, the method 2000 may include determining, using the processing device, at least one requirement associated with the at least one cloud account based on the analyzing of the at least one information. Further, the at least one requirement may include a project requirement.

Further, at 2008, the method 2000 may include analyzing, using the processing device, the at least one value of the at least one parameter and the at least one requirement. Further, the determining of the at least one action may be based on the analyzing of the at least one value of the at least one parameter and the at least one requirement.

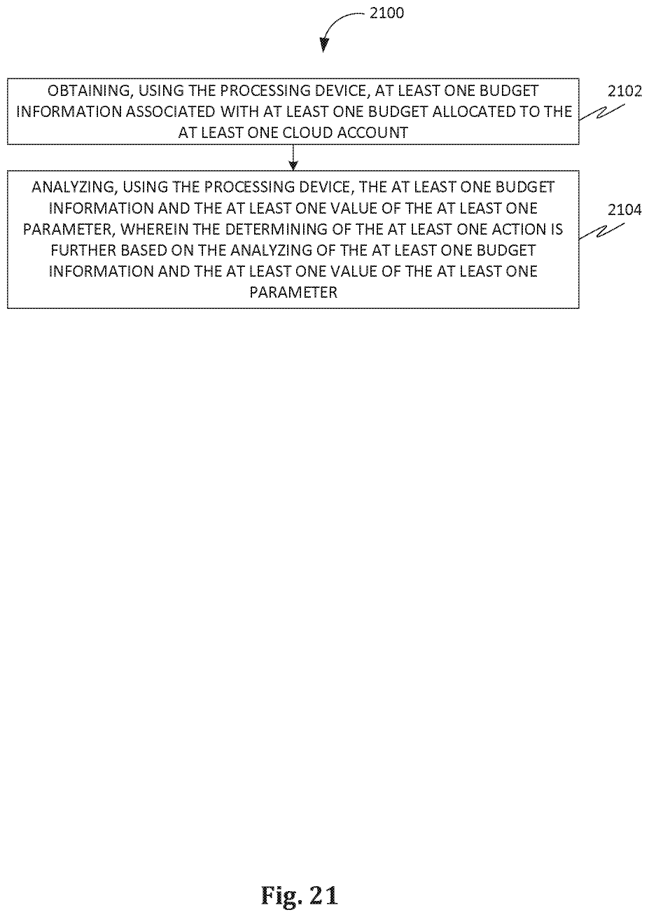

FIG. 21 is a flowchart of a method 2100 for facilitating managing budgets for cloud accounts, in accordance with some embodiments. Accordingly, at 2102, the method 2100 may include obtaining, using the processing device, at least one budget information associated with at least one budget allocated to the at least one cloud account.

Further, at 2104, the method 2100 may include analyzing, using the processing device, the at least one budget information and the at least one value of the at least one parameter. Further, the determining of the at least one action may be based on the analyzing of the at least one budget information and the at least one value of the at least one parameter.

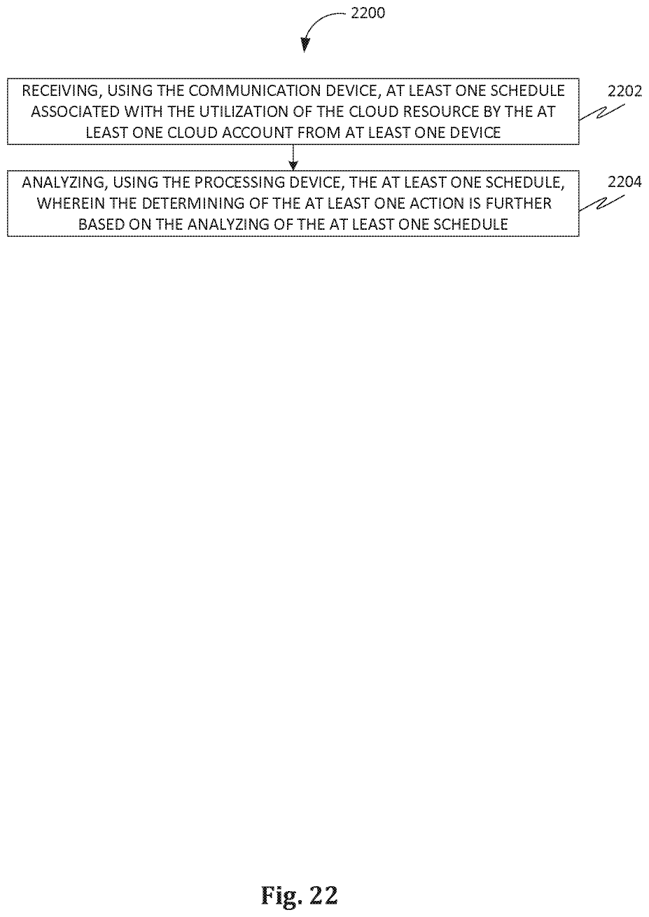

FIG. 22 is a flowchart of a method 2200 for facilitating managing budgets for cloud accounts, in accordance with some embodiments. Accordingly, at 2202, the method 2200 may include receiving, using the communication device, at least one schedule associated with the utilization of the cloud resource by the at least one cloud account from at least one device. Further, the at least one schedule may include an operational schedule, a holiday schedule, a cloud resource schedule, a preset schedule, a custom schedule, etc.

Further, at 2004, the method 2200 may include analyzing, using the processing device, the at least one schedule. Further, the determining of the at least one action may be further based on the analyzing of the at least one schedule.

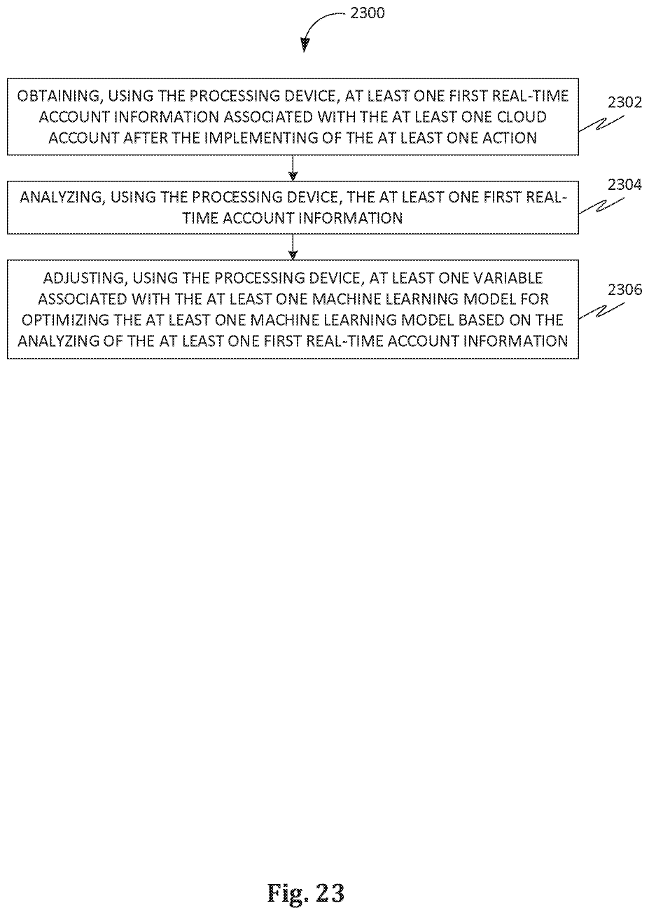

FIG. 23 is a flowchart of a method 2300 for facilitating managing budgets for cloud accounts, in accordance with some embodiments. Accordingly, at 2302, the method 2300 may include obtaining, using the processing device, at least one first real-time account information associated with the at least one cloud account after the implementing of the at least one action. Further, the at least one first real-time account information may include information associated with a usage of the cloud resource after the implementing of the at least one action.

Further, at 2304, the method 2300 may include analyzing, using the processing device, the at least one first real-time account information.

Further, at 2306, the method 2300 may include adjusting, using the processing device, at least one variable associated with the analytical model or technique, which may include the at least one machine learning model for optimizing the analytical model or technique based on the analyzing of the at least one first real-time account information. Further, the at least one variable may include model parameters (weights), hyperparameters, configurable thresholds, rule conditions, statistical factors, optimization algorithms, or other tunable control variables associated with the analytical model or machine learning model.

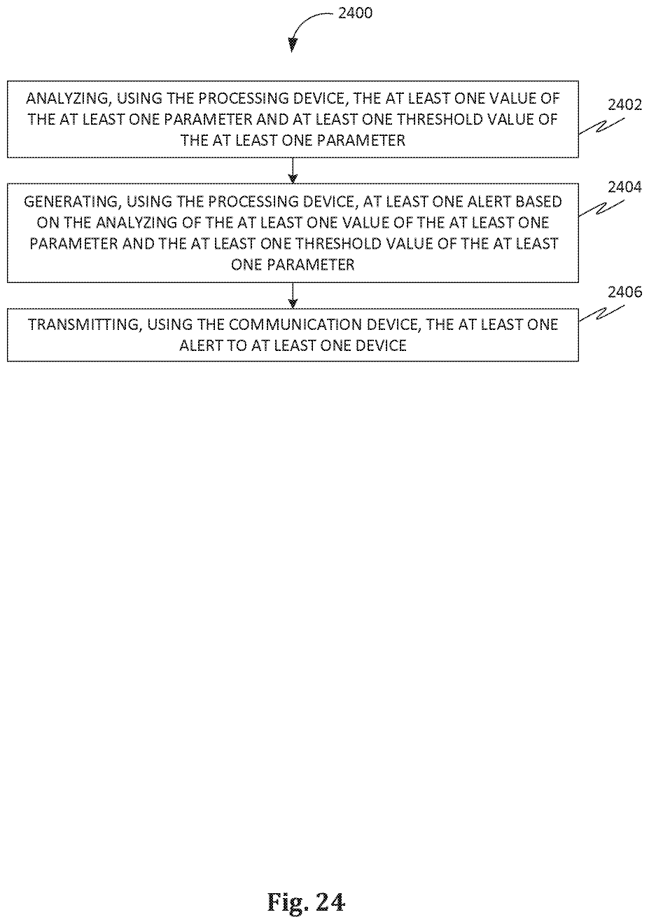

FIG. 24 is a flowchart of a method 2400 for facilitating managing budgets for cloud accounts, in accordance with some embodiments. Accordingly, at 2402, the method 2400 may include analyzing, using the processing device, the at least one value of the at least one parameter and at least one threshold value of the at least one parameter.

Further, at 2404, the method 2400 may include generating, using the processing device, at least one alert based on the analyzing of the at least one value of the at least one parameter and the at least one threshold value of the at least one parameter.

Further, at 2406, the method 2400 may include transmitting, using the communication device, the at least one alert to at least one device.

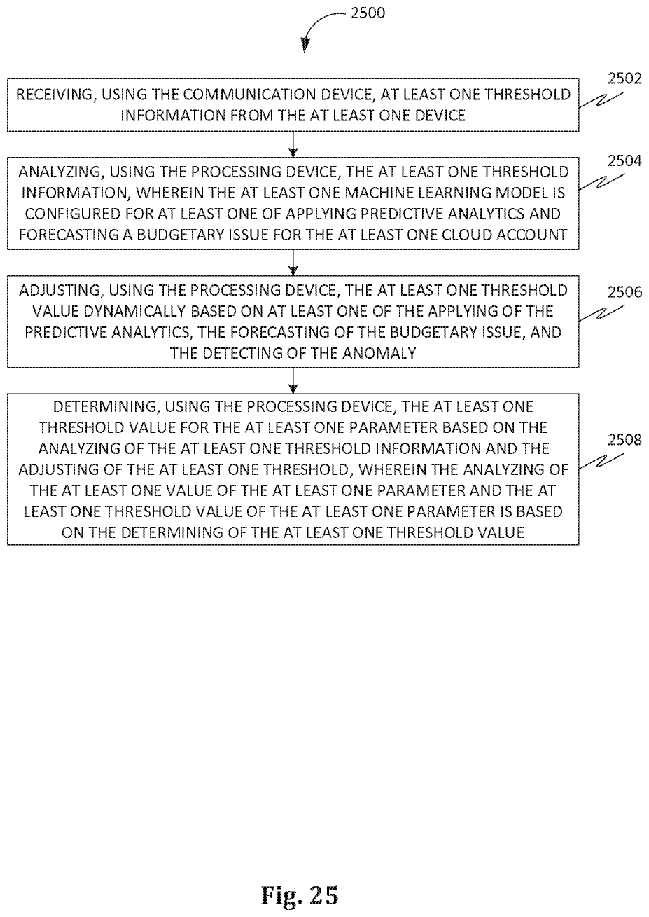

FIG. 25 is a flowchart of a method 2500 for facilitating managing budgets for cloud accounts, in accordance with some embodiments. Accordingly, at 2502, the method 2500 may include receiving, using the communication device, at least one threshold information from the at least one device. Further, the at least one threshold information may include one or more predefined criteria associated with the utilization of the budget and thresholds of the financial of the at least one cloud account.

Further, at 2504, the method 2500 may include analyzing, using the processing device, the at least one threshold information using one or more analytical techniques, which may include the at least one machine learning model. Further, the at least one machine learning model or other analytical technique may be configured for at least one of applying predictive analytics and forecasting a budgetary issue for the at least one cloud account.

Further, at 2506, the method 2500 may include adjusting, using the processing device, the at least one threshold value dynamically based on at least one of the applying of the predictive analytics, the forecasting of the budgetary issue, and the detecting of the anomaly.

Further, at 2508, the method 2500 may include determining, using the processing device, the at least one threshold value for the at least one parameter based on the analyzing of the at least one threshold information and the adjusting of the at least one threshold value. Further, the at least one threshold value may primarily include a soft cap, a hard cap, or other specified forms as required. Further, the analyzing of the at least one value of the at least one parameter and the at least one threshold value of the at least one parameter may be based on the determining of the at least one threshold value.

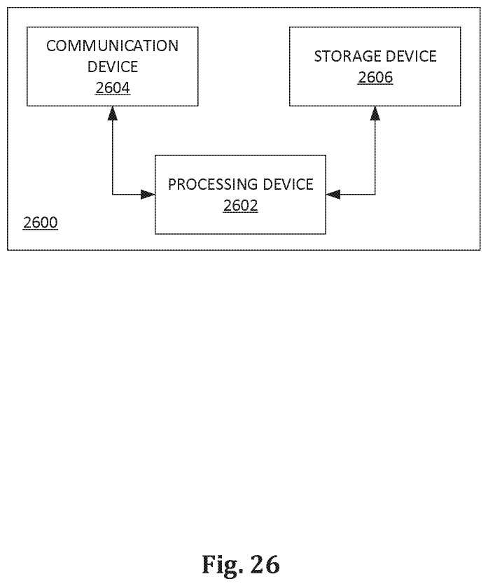

FIG. 26 is a block diagram of a system 2600 for facilitating managing budgets for cloud accounts, in accordance with some embodiments. Accordingly, the system 2600 may include a processing device 2602, a communication device 2604, and a storage device 2606.

Further, the processing device 2602 may be configured for obtaining at least one real-time account information associated with at least one cloud account of at least one cloud platform. Further, the processing device 2602 may be configured for analyzing the at least one real-time account information using one or more analytical techniques, which may include at least one machine learning model. Further, the at least one machine learning model or other analytical technique may be configured for detecting at least one of a pattern, a trend, and an anomaly corresponding to a utilization of a cloud resource by the at least one cloud account. Further, at least one of the pattern, the trend, and the anomaly may be detected in the at least one real-time account information. Further, the processing device 2602 may be configured for determining at least one value of at least one parameter associated with the utilization of the cloud resource by the at least one cloud account. Further, the processing device 2602 may be configured for determining at least one action required to be implemented for the at least one cloud account based on the determining of the at least one value of the at least one parameter. Further, the processing device 2602 may be configured for generating at least one cloud account controlling command for implementing the at least one action based on the determining of the at least one action.

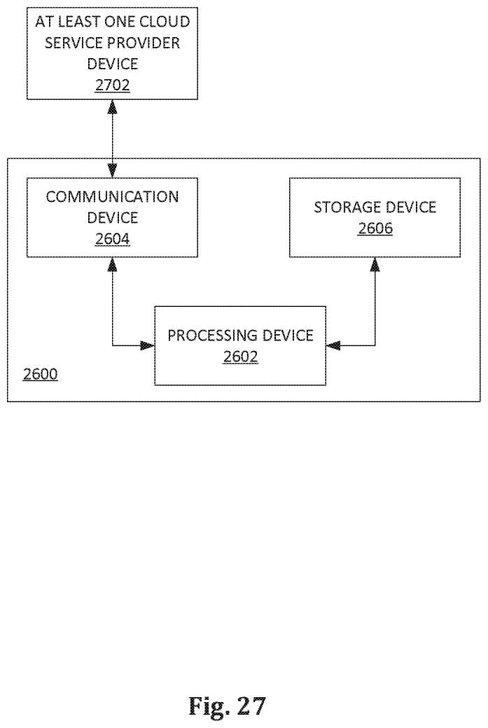

Further, the communication device 2604 may be communicatively coupled with the processing device 2602. Further, the communication device 2604 may be configured for transmitting the at least one cloud account controlling command to at least one cloud service provider device 2702, as shown in FIG. 27, associated with at least one cloud service provider. Further, the at least one cloud service provider provides the at least one cloud account.

Further, the storage device 2606 may be communicatively coupled with the processing device 2602. Further, the storage device 2606 may be configured for storing the at least one real-time account information.

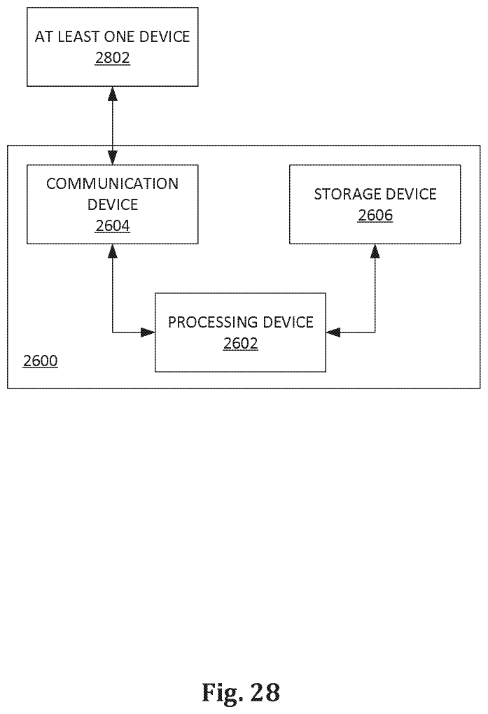

Further, in some embodiments, the communication device 2604 may be configured for receiving at least one data from at least one device 2802, as shown in FIG. 28. Further, the processing device 2602 may be configured for analyzing the at least one data. Further, the processing device 2602 may be configured for determining the at least one parameter. Further, the determining of the at least one value for the at least one parameter may be based on the determining of the at least one parameter.

Further, in some embodiments, the storage device 2606 may be configured for retrieving at least one historical account information associated with the at least one cloud account. Further, the processing device 2602 may be configured for obtaining at least one synthetic account information associated with the at least one cloud account. Further, the processing device 2602 may be configured for training or calibrating at least one analytical model or technique, which may include at least one machine learning model based on the at least one historical account information and the at least one synthetic account information. Further, the analyzing of the at least one real-time account information may be based on the trained or calibrated analytical model or technique.

Further, in some embodiments, the processing device 2602 may be configured for predicting at least one requirement associated with the at least one cloud account based on the at least one value of the at least one parameter. Further, the determining of the at least one action may be based on the at least one requirement.

Further, in some embodiments, the processing device 2602 may be configured for obtaining at least one information associated with at least one project implemented using the at least one cloud account. Further, the processing device 2602 may be configured for analyzing the at least one information. Further, the processing device 2602 may be configured for determining at least one requirement associated with the at least one cloud account based on the analyzing of the at least one information. Further, the processing device 2602 may be configured for analyzing the at least one value of the at least one parameter and the at least one requirement. Further, the determining of the at least one action may be based on the analyzing of the at least one value of the at least one parameter and the at least one requirement.

Further, in some embodiments, the processing device 2602 may be configured for obtaining at least one budget information associated with at least one budget allocated to the at least one cloud account. Further, the processing device 2602 may be configured for analyzing the at least one budget information and the at least one value of the at least one parameter. Further, the determining of the at least one action may be based on the analyzing of the at least one budget information and the at least one value of the at least one parameter.

Further, in some embodiments, the communication device 2604 may be configured for receiving at least one schedule associated with the utilization of the cloud resource by the at least one cloud account from the at least one device 2802. Further, the processing device 2602 may be configured for analyzing the at least one schedule. Further, the determining of the at least one action may be further based on the analyzing of the at least one schedule.

Further, in some embodiments, the processing device 2602 may be configured for obtaining at least one first real-time account information associated with the at least one cloud account after the implementing of the at least one action. Further, the processing device 2602 may be configured for analyzing the at least one first real-time account information. Further, the processing device 2602 may be configured for adjusting at least one variable associated with an analytical model or technique, which may include at least one machine learning model, for optimizing the analytical model or technique based on the analyzing of the at least one first real-time account information.

Further, in some embodiments, the processing device 2602 may be configured for analyzing the at least one value of the at least one parameter and at least one threshold value of the at least one parameter. Further, the processing device 2602 may be configured for generating at least one alert based on the analyzing of the at least one value of the at least one parameter and the at least one threshold value of the at least one parameter. Further, the communication device 2604 may be configured for transmitting the at least one alert to the at least one device 2802.

Further, in an embodiment, the communication device 2604 may be configured for receiving at least one threshold information from the at least one device 2802. Further, the processing device 2602 may be configured for analyzing the at least one threshold information using the at least one machine learning model. Further, the at least one machine learning model may be configured for at least one of applying predictive analytics and forecasting a budgetary issue for the at least one cloud account. Further, the processing device 2602 may be configured for adjusting the at least one threshold value dynamically based on at least one of the applying of the predictive analytics, the forecasting of the budgetary issue, and the detecting of the anomaly. Further, the processing device 2602 may be configured for determining the at least one threshold value for the at least one parameter based on the analyzing of the at least one threshold information and the adjusting of the at least one threshold value. Further, the analyzing of the at least one value of the at least one parameter and the at least one threshold value of the at least one parameter may be based on the determining of the at least one threshold value.

FIG. 27 is a block diagram of the system 2600, in accordance with some embodiments. FIG. 28 is a block diagram of the system 2600, in accordance with some embodiments.

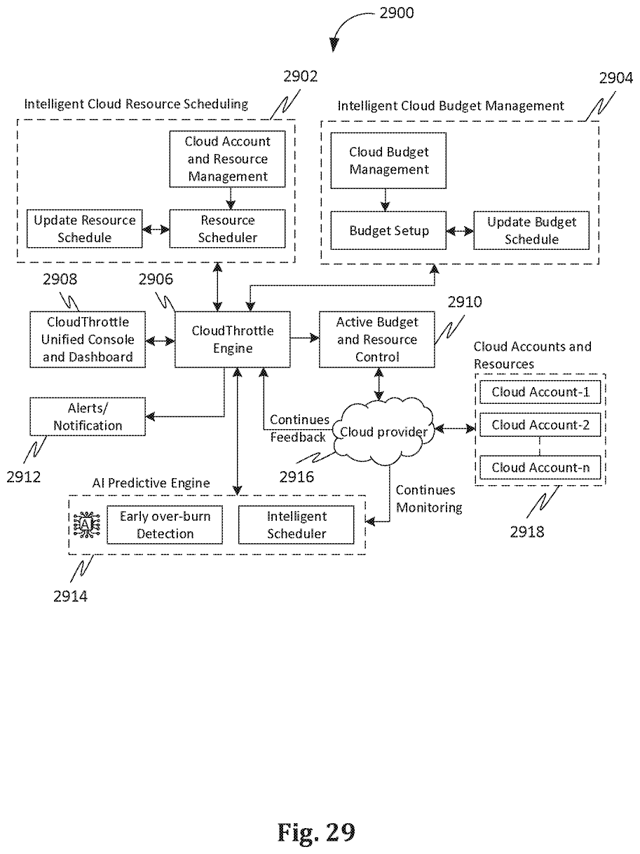

FIG. 29 is a block diagram of a system 2900 for facilitating managing budgets for cloud accounts, in accordance with some embodiments. Accordingly, the system 2900 may include an intelligent cloud resource scheduling unit 2902, an intelligent cloud budget management unit 2904, the disclosed system engine 2906, the disclosed system console and dashboard 2908, an active budget and resource control unit 2910, an alerts/notification display unit 2912, an AI predictive engine 2914, a cloud provider 2916, and cloud accounts and resources 2918.

Further, the system 2900 may be associated with the disclosed system. Further, the system 2900 may be associated with a process. Further, the process may include API or any other mechanism integration. Further, the API or any other similar mechanism integration encompasses:

Comprehensive Connectivity: The disclosed system integrates seamlessly with the APIs of various cloud service providers or any other similar mechanisms. This integration is vital for accessing current cloud account spending and budget data, ensuring accurate real-time financial monitoring. For example, when an organization uses AWS, Azure, and Google Cloud, the disclosed system connects to each service's API or an equivalent mechanism to fetch the latest financial data, providing a real-time overview of expenditures across these platforms.

Security and Compliance: The platform ensures secure connections with cloud providers' APIs or any other mechanism, emphasizing data security and adherence to privacy standards. This is crucial for the safe and reliable transfer of sensitive financial data. Example: The disclosed system employs encryption and compliance measures like GDPR and HIPAA when transferring financial data from cloud services, ensuring data integrity and security.

Multi-Cloud Compatibility-Diverse Cloud Service Support: The disclosed system's ability to integrate with multiple cloud providers offers businesses a unified view of their cloud spending, regardless of the cloud services they use. Example: A business using both AWS and Azure can view consolidated financial reports on the disclosed system, simplifying budget monitoring across different cloud environments.

Data Retrieval Configuration-Financial Data Collection: Persistent Data Collection: The disclosed system is configured to routinely collect essential data related to cloud account spending and budget allocations. This continuous data collection is critical for effective budget control and strategic financial planning. Example: The disclosed system automatically and consistently collects information on expenditures and budget utilization, enabling continuous monitoring and timely adjustments.

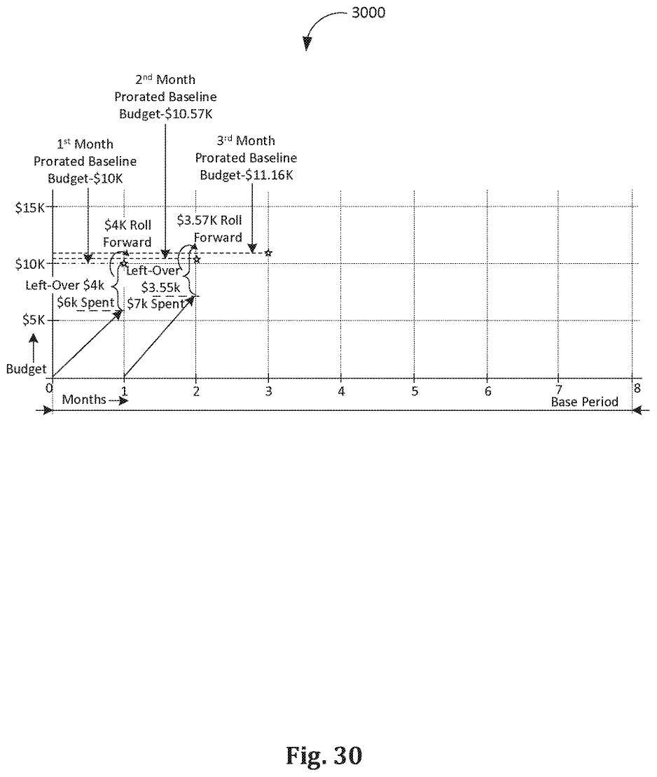

FIG. 30 is a graphical representation 3000 of a computation of a budget for a cloud account, in accordance with some embodiments. Further, base budget refers to the initial or foundational financial plan or allocation amount for a specific project on a Cloud account. It serves as the starting point for budgeting and as a benchmark against any changes or modifications. The base budget sets the framework for financial planning and decision-making, providing a reference point for evaluating performance and determining the need for adjustments or additional funding.

Budget Prorate: The disclosed system automatically prorates at the beginning of budget creation and at the end of every month, which allows for accurate tracking and reporting of budgetary performance of Cloud account/project spending.

Automated Budget Prorate: Budget proration involves proportionally allocating a budget based on a specific time period. It is used when a budget does not align precisely with a standard period, such as a fiscal year or calendar month. The total budget amount is divided or adjusted to match the duration of the given time period. Budget proration allows for accurate tracking and reporting of budgetary performance within specific timeframes. Example: If a budget is set for $120,000 for a 12-month period, the monthly budget proration would allocate $10,000 for each month.

This concept allows for more accurate tracking and reporting of budgetary performance within specific timeframes, providing a clearer picture of Cloud expenditures and enabling better decision-making.

Budget proration helps when there are changes or adjustments to the original budget during the course of a specific period. In such cases, the revised budget is prorated and allocated accordingly to reflect the updated financial plan. By utilizing the budget prorate concept, organizations can ensure that financial resources are allocated and managed appropriately, facilitating better control and visibility over their budgetary processes.

Budget Rollover: The disclosed system automatically rolls over any unused or unspent portion of a budget from the Cloud Account from one period to the next. Instead of resetting the budget to zero at the end of a specific time period, any remaining funds are carried forward and made available for use in subsequent periods. This ensures that the unutilized cloud budget is not lost but can be allocated and utilized effectively.

Budget rollover provides several benefits to organizations, including:
Continuity: Budget rollover allows for a seamless transition between budget periods, ensuring continuity in financial planning and resource allocation. It avoids disruptions caused by sudden budget resets and provides stability for ongoing projects and initiatives.
Efficient Resource Utilization: Carrying forward unused funds enables organizations to maximize the utilization of available resources. It allows for better planning and allocation of funds, especially for long-term projects that require consistent funding across multiple periods.
Improved Accuracy: Budget rollover enhances accuracy in financial forecasting and planning. By carrying forward the remaining budget, organizations can make more informed decisions based on actual spending patterns and adjust future budgets accordingly.
Strategic Flexibility: Budget carryover provides flexibility in adjusting budgets to align with changing business needs or priorities. Organizations can allocate carried-over funds to new initiatives, address unforeseen expenses, or capitalize on emerging opportunities.

Avoidance of “Use It or Lose It” Mentality: Budget rollover discourages a “use it or lose it” mentality, where departments or teams rush to spend their remaining budget at the end of a period to avoid losing funds. It promotes a more strategic and thoughtful approach to budget utilization throughout the year. Consider an example where a company has allocated an annual cloud budget of $120,000 for a cloud account, which breaks down to $10,000 per month. At the end of the first month, the actual cloud spending is only $8,000, leaving $2,000 unused. In a budget rollover scenario, this remaining $2,000 would be carried forward to the next budget period. Consequently, instead of starting with a fresh total budget of $110,000 for the remaining 11 months ($120,000-$10,000=$110,000), the total budget would be adjusted to $112,000 ($110,000+$2,000 from the unused funds), which equates to approximately $10,182 per month for the remaining 11 months ($112,000/11 months).

Moving on to the second month, if the actual spending amounts to $6,000, this leaves a surplus of $4,000 (not accounting for the previously rounded amount). This remaining $4,000 will be carried forward to the subsequent budget period, now spanning the remaining 10 months. Instead of starting with a fresh budget of $100,000 ($120,000-($10,000+$10,000)=$100,000), the adjusted total budget will be $106,000 ($112,000-$6,000 spent in the second month), which translates to $10,600 per month assuming equal redistribution across the for the remaining 10 months ($106,000/10 months). In this way, the disclosed system budget rollover ensures that the unutilized funds from previous periods are carried forward, allowing for more efficient allocation of resources and flexibility in budget management.

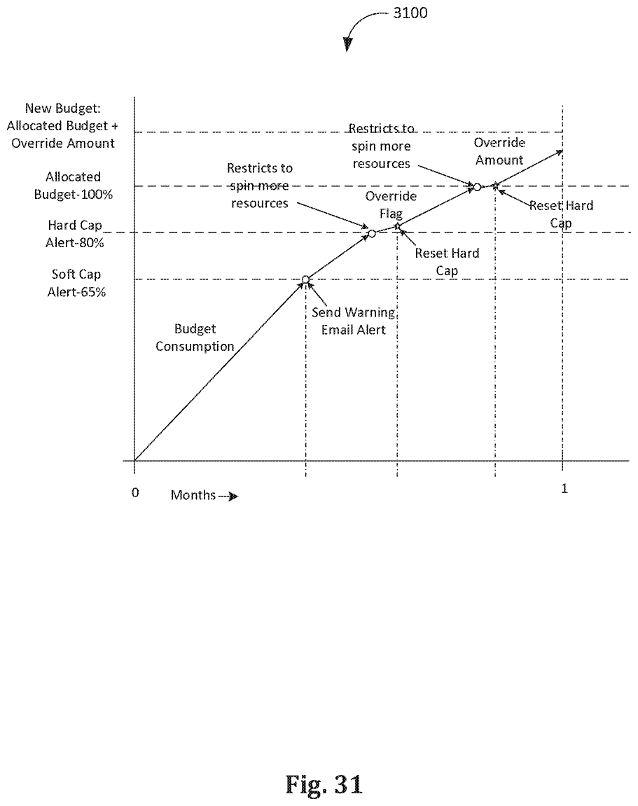

FIG. 31 is a graphical representation 3100 of a triggering of the budget for the cloud account and an overriding of the triggering of the budget, in accordance with some embodiments. Further, budget triggers and thresholds are an essential component of effective financial management strategies. They serve as tools to monitor, evaluate, and control Cloud account budgets.

Budget triggers, seamlessly incorporated into the built-in workflow management system, are predefined events or conditions that initiate targeted actions or interventions in the budgeting process. These triggers are usually connected to the actual percentage spent from the monthly budget allocation and activate at set thresholds. Upon activation, they not only prompt stakeholders to scrutinize the current financial situation and assess its impact on the budget but also serve as a cautionary signal to the Project or Product team. This warning encourages the team to closely monitor trending budget expenditures, ensuring proactive measures are taken to maintain financial stability and alignment with the overarching organizational objectives.

Advisory Threshold (Soft-Cap) and Control Limit (Hard-Cap): Advisory Threshold and Control Limit are concepts associated with budget thresholds, representing different levels of limits or boundaries within budget management:

Advisory Threshold (Soft-Cap): A soft cap is a threshold that indicates a warning level or guideline within the Cloud budget. When the budget reaches or exceeds the Advisory Threshold, it signals that closer attention and monitoring are required. It prompts stakeholders to review spending patterns, reassess resource allocation, and take proactive measures to prevent further deviations or potential budget overruns. The Advisory Threshold provides flexibility for adjustments and proactive management. Additionally, in addition to the Advisory Threshold, multiple alert levels can be implemented, such as a Preliminary Warning Level for early awareness and an Urgent Action Level for immediate response requirements, each defined by specific percentage or absolute value thresholds. In some embodiments, the disclosed system may support a multi-level threshold hierarchy comprising two or more configurable advisory and control levels, each associated with distinct notification, escalation, or enforcement actions.

Advisory Threshold (Soft-Cap) Example: Suppose a company establishes an Advisory Threshold of 65% for the monthly budget of an account to oversee and regulate cloud spending. When the monthly Cloud Spending approaches or exceeds this Advisory Threshold of 65%, it activates warning alerts to prompt scrutiny, evaluation, and alignment with the overall budget objectives. These alerts may escalate through various levels of urgency, triggering different responses tailored to the severity of the budget approach or exceedance.

Control Limit (Hard-Cap): On the other hand, a Control Limit represents a strict limit or boundary that must not be exceeded under any circumstances. It is an absolute maximum or ceiling on an allocated monthly budget. When the budget reaches or exceeds the Control Limit, it triggers immediate actions, such as restricting spinning more Cloud Resources, implementing cost-saving measures, or it may simply serve to alert senior management and other key stakeholders to evaluate the situation and decide on further steps. This flexibility ensures that executive decisions can be made based on current business priorities and conditions, potentially including approval to override preset percentage consumption on the monthly budget or to secure additional funding. Control Limits are put in place to enforce strict budgetary controls and prevent excessive cloud spending or financial risks.

Control Limit (Hard-Cap) Example: In this scenario, the company sets a Control Limit of 80% on the monthly budget for an account, which acts as the maximum limit for Cloud Spending. If the project expenses reach or exceed the 80% threshold, the disclosed system restricts further resource allocation or may simply notify senior management and other key stakeholders, for immediate review. This allows for a tailored response, depending on the severity and context of the budget exceedance, whether that involves halting non-essential activities, renegotiating contracts, overriding the 80% cap, or securing additional funds if necessary.

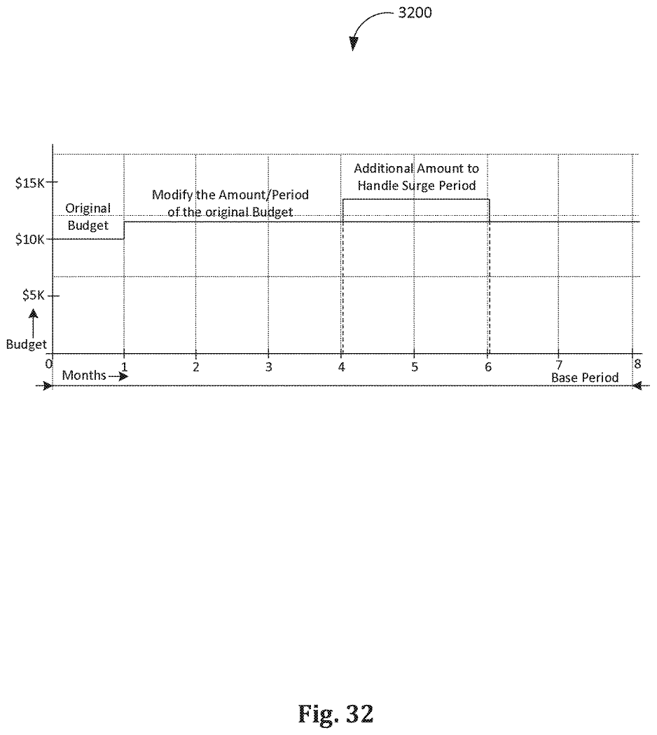

FIG. 32 is a graphical representation 3200 of a modification of the budget for the cloud account and an overriding of an amount of the budget, in accordance with some embodiments. Further, budget overrides and additional funds play pivotal roles in budget management, empowering organizations and agencies to adapt to flexibility, changing circumstances, address unexpected needs, and pursue strategic initiatives that surpass initial budget constraints. However, it is crucial to exercise proper justification and accountability when employing budget overrides and accessing additional funds. This preserves fiscal discipline, ensures efficient resource utilization, and mitigates the risk of cloud waste.

The disclosed system offers two Budget Override settings to cater to different scenarios.

Budget Override Flag: This setting enables the Override Flag to surpass a Cloud account's predefined Control Limit (Hard-Cap) or budgetary limits. By activating the budget “Override Flag,” the project gains access to the total 100% allocation of monthly funds, ensuring project continuity and fulfilling crucial operational requirements.

Consider a scenario where a company establishes a Control Limit (Hard-Cap) of 80% on the monthly budget for a Cloud account. Unexpected costs arise, causing the Cloud Spending to exceed 80% of the allocated budget. In this case, a Budget Override is granted, activating the “Override Flag” in the disclosed system to enable and allow the project to utilize the remaining 20% of the budget to for addressing the unforeseen costs.

Budget Override Amount: Represents the additional funds granted to a project or cloud account in a specific month, exceeding the predefined budgetary limits or caps. Utilizing this, the disclosed system setting makes it possible to allocate an additional amount to the project for a specific month in addition to the monthly allocated budget.

Example: A project has a monthly budget of $10,000, but unforeseen costs arise in a specific month. A Budget Override is approved, providing an additional, say, $2,000 to address the unexpected expenses.

Additional funds: Refer to extra financial resources obtained or allocated to augment the existing budget for a specific period. These funds provide the flexibility to address unforeseen costs, extend project scope, support testing, experiment with new methodologies, or capitalize on strategic opportunities that exceed the original budgetary limits.

Example: A project with a $120,000 annual budget encounters an unexpected opportunity for a new proof of concept. To accommodate this activity, an additional $20,000 is allocated for a two-month period, without modifying the original budget. Further, these additional funds may enable the disclosed project to expand its scope and successfully carry out the new proof of concept.

Budget Modification: Modifying the budget involves adjusting the allocated amount or budget period for a specific cloud account. This adjustment can include increasing or decreasing the budgeted amount or changing the duration of the budget period. The purpose of modifying the budget is to accommodate changes in project requirements, unexpected circumstances, or shifts in organizational priorities. By making these adjustments, the budget remains aligned with the project's needs and enables effective financial management throughout its lifecycle.

The disclosed system provides the flexibility to modify the base budget. Example: Imagine a project with an initial budget of $120,000. However, as the project advances, it becomes apparent that additional resources are necessary to fulfill the evolving requirements. To accommodate this, the project manager changes the budget to $160,000.

The disclosed system introduces a unified, centralized console that excels in managing the Budget Lifecycle and cloud budget spending across a multi-cloud environment. Tailored specifically to accommodate Federal contracts, fixed-price projects, and corporate settings, this platform continuously gathers data on cloud expenditures and budget utilization. It facilitates constant monitoring and swift adjustments while integrating workflow management features for handling scenarios like Budget Override Flag activation, Budget Override Amount setting, and Additional Funds Budget Modification. This ensures streamlined oversight and efficient management of cloud resources, enabling a cohesive budget control strategy in a diverse multi-cloud framework.

The Budget Overview Panel in the disclosed system is further enhanced by the integration of alert-triggered statuses and a comprehensive overview sequence of events that have occurred in the budget lifecycle, such as modifications, overrides, and more. This addition not only provides users with a snapshot of essential budgetary information but also offers an in-depth audit trail detailing who made changes, what changes were made, and when these changes occurred. By including this level of detail, the panel ensures complete transparency and accountability in budget management, allowing for precise tracking of all actions taken within the budget. This feature is crucial for maintaining financial integrity and facilitating informed decision-making by providing a clear, chronological overview of budget-related events and modifications.

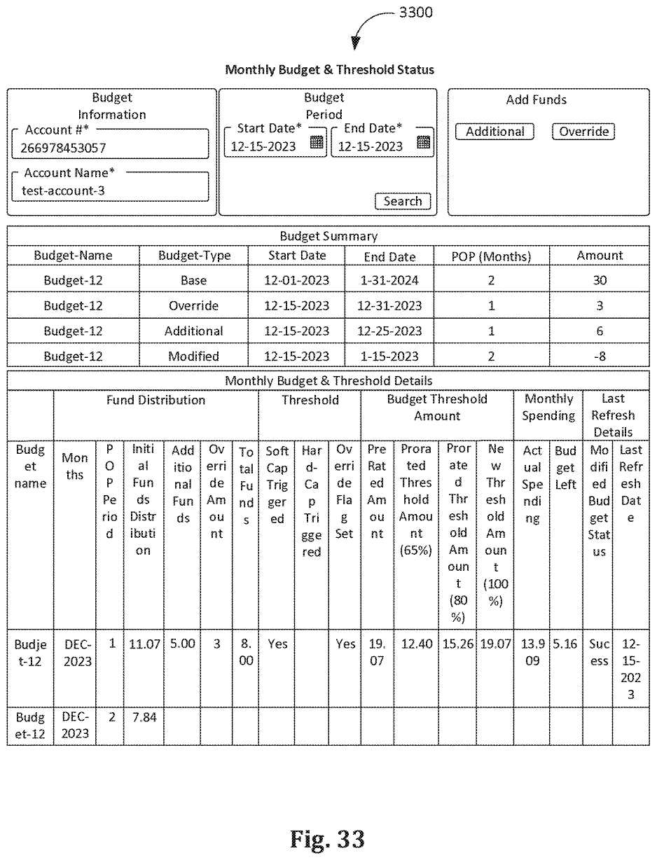

FIG. 33 is a screenshot of a Monthly Budget & Threshold Status interface 3300 of a software application for managing budgets for cloud accounts, in accordance with some embodiments.

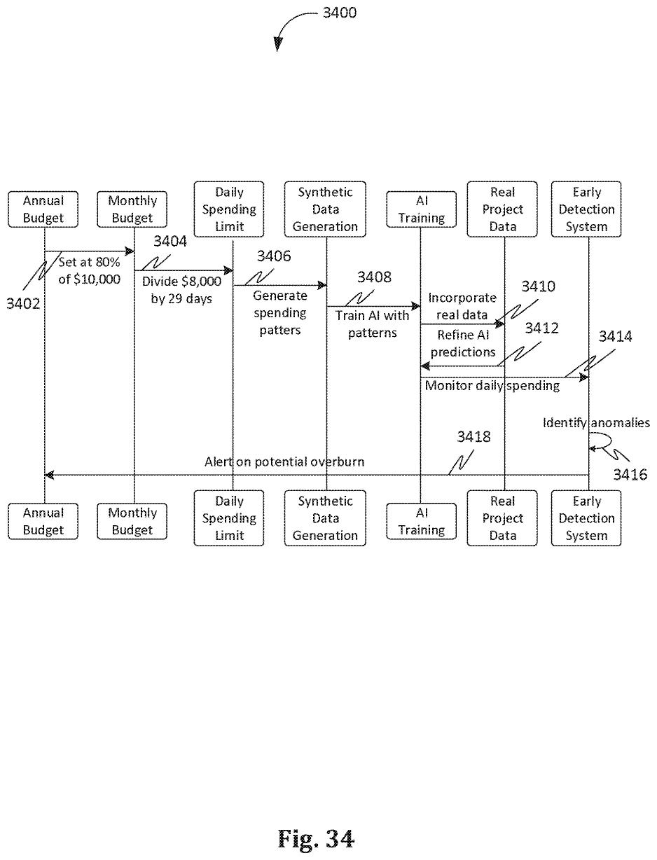

FIG. 34 is a flow diagram of a method 3400 for managing budgets for cloud accounts, in accordance with some embodiments. Further, the method 3400 may include a step 3402 of setting 80% of $10,000, which is an annual budget for a cloud account, as a monthly budget. Further, the method 3400 may include a step 3404 of dividing $8,000, which is the monthly budget, by 30 days, taking an average, for example, to calculate a daily spending limit. Further, the method 3400 may include a step 3406 of generating spending patterns for synthetic data generation. Further, the method 3400 may include a step 3408 of training an AI model with the patterns. Further, the method 3400 may include a step 3410 of incorporating real data associated with a project into the AI model training. Further, the method 3400 may include a step 3412 of refining predictions generated by the AI model. Further, the method 3400 may include a step 3414 of monitoring daily spending. Further, the method 3400 may include a step 3416 of identifying anomalies using an early detection system. Further, the method 3400 may include a step 3418 of generating an alert on potential overburn by the early detection system for updating the annual budget.

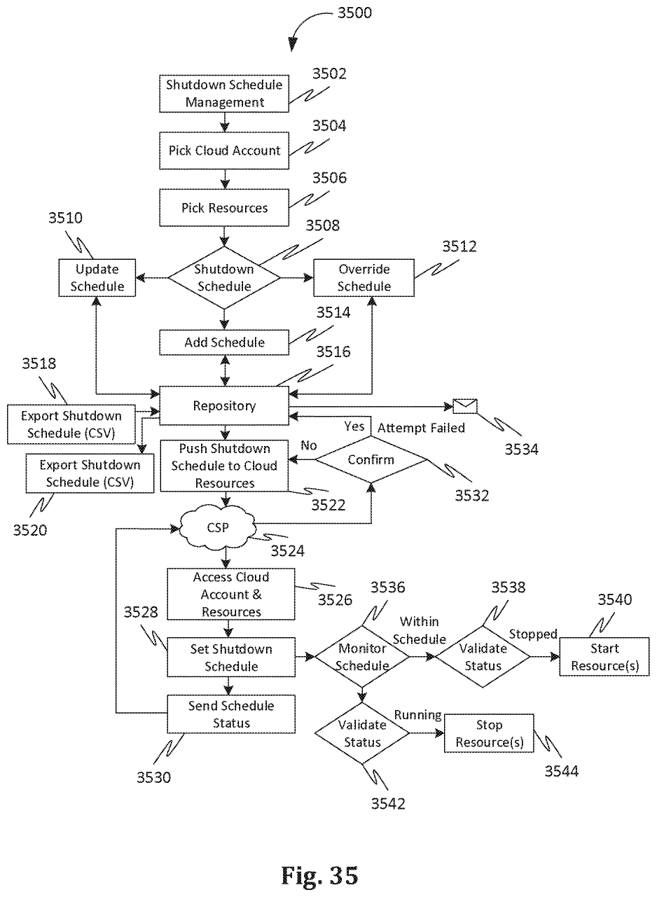

FIG. 35 is a flow diagram of a method 3500 for facilitating scheduling of resources, in accordance with some embodiments. Further, the method 3500 may include a step 3502 of initiating a shutdown schedule management. Further, the method 3500 may include a step 3504 of picking a cloud account. Further, the method 3500 may include a step 3506 of picking resources. Further, the method 3500 may include a step 3508 of determining a shutdown schedule. Further, the method 3500 may include a step 3510 of updating the schedule after the step 3508. Further, the method 3500 may include a step 3512 of overriding the schedule after the step 3508. Further, the method 3500 may include a step 3514 of adding the schedule after the step 3508. Further, the schedule may be added to a repository 3516. Further, the method 3500 may include a step 3518 of exporting shutdown schedule (CSV) to the repository 3516. Further, the method 3500 may include a step 3520 of exporting the shutdown schedule (CSV) from the repository 3516. Further, the method 3500 may include a step 3522 of pushing the shutdown schedule to cloud resources from the repository 3516 to a cloud service provider (CSP) 3524. Further, the method 3500 may include a step 3526 of accessing cloud accounts and resources from the CSP 3524. Further, the method 3500 may include a step 3528 of setting the shutdown schedule. Further, the method 3500 may include a step 3530 of sending the shutdown schedule to the CSP 3524. Further, the method 3500 may include a step 3532 of confirming the schedule. If the schedule is confirmed, the schedule is moved to the repository 3516, and if the schedule is not confirmed, the method 3500 moves to the step 3522. Further, the method 3500 may include a step 3534 of generating alerts/notifications. Further, the method 3500 may include a step 3536 of monitoring schedule after the step 3528. If resource utilization is within the schedule, the method 3500 may include a step 3538 of validating a status and if the status is stopped, the method 3500 may include a step 3540 of starting resources. Further, the method 3500 may include a step 3542 of validating status. If the resources are running, the method 3500 may include a step 3544 of stopping the resources

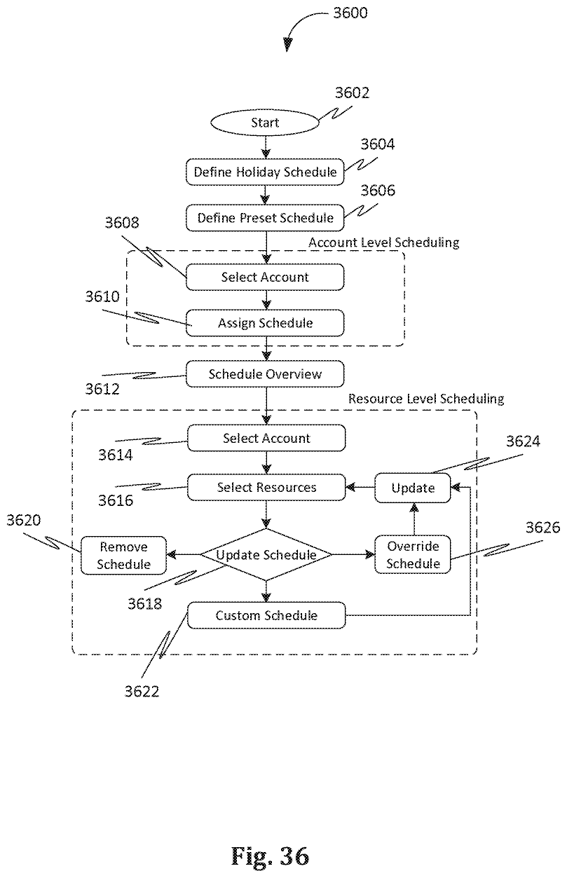

FIG. 36 is a flowchart of a method 3600 for facilitating scheduling of cloud resources, in accordance with some embodiments. Further, the method 3600 may include a step 3602 of starting. Further, the method 3600 may include a step 3604 of defining a holiday schedule. Further, the method 3600 may include a step 3606 of defining a preset schedule. Further, the method 3600 may include a step 3608 of selecting an account. Further, the method 3600 may include a step 3610 of assigning a schedule. Further, the steps 3608 and 3610 may be associated with account-level scheduling. Further, the method 3600 may include a step 3612 of providing a schedule overview. Further, the method 3600 may include a step 3614 of selecting an account. Further, the method 3600 may include a step 3616 of selecting resources. Further, the method 3600 may include a step 3618 of determining an update for the schedule. Further, the method 3600 may include a step 3620 of removing the schedule. Further, the method 3600 may include a step 3622 of customizing the schedule. Further, the method 3600 may include a step 3624 of updating. Further, the method 3600 moves to the step 3616 after the step 3624. Further, the method 3600 may include a step 3626 overriding the schedule. Further, the method moves to the step 3624 after the step 3626. Further, the steps 3614-3626 may be associated with resource level scheduling.

Further, the disclosed system may include an automated cloud resource scheduler. The cornerstone of the disclosed system is its cloud resource scheduler. This dynamic feature automates the process of enabling and disabling cloud resources and ensures that these resources are available precisely when needed, thereby minimizing waste and optimizing utilization.

Further, the disclosed system provides a centralized platform for comprehensive control and visibility over resource scheduling. This empowers organizations to meticulously manage their cloud resource uptime and make informed decisions to optimize costs effectively. Further, the disclosed system may be configured for multi-level scheduling, including but not limited to account-level and resource-level scheduling. Further, the disclosed system may be configured to recognize the diverse needs of organizations, the disclosed system offers multiple configurable scheduling tiers:

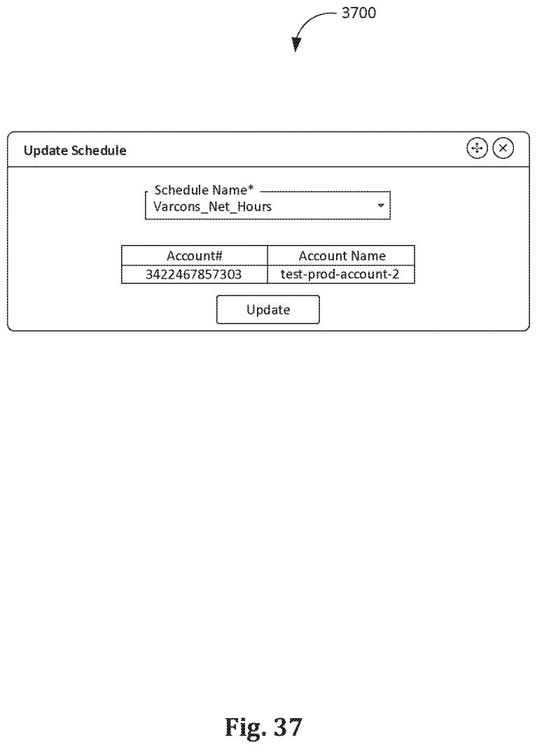

Account-Level Scheduling: Ideal for enterprises intending to schedule resources across an entire cloud account (as shown in FIG. 37).

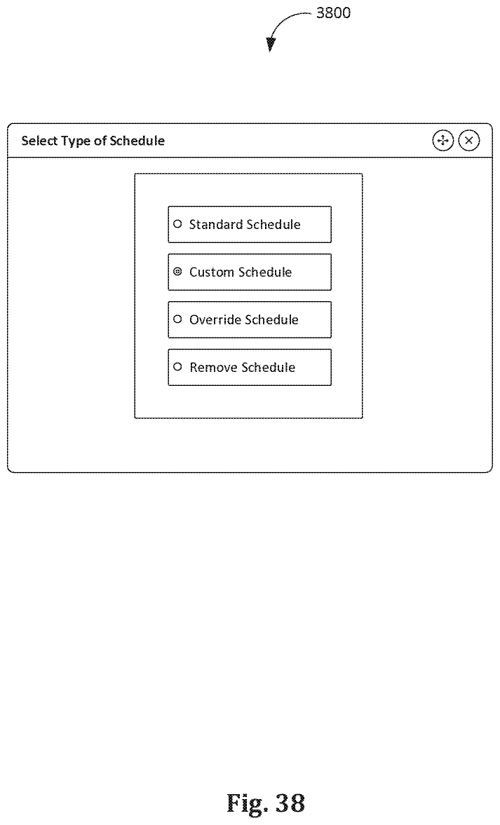

Resource-Level Scheduling: Tailored for situations where specific resources associated with an account require individual scheduling (as shown in FIG. 38).

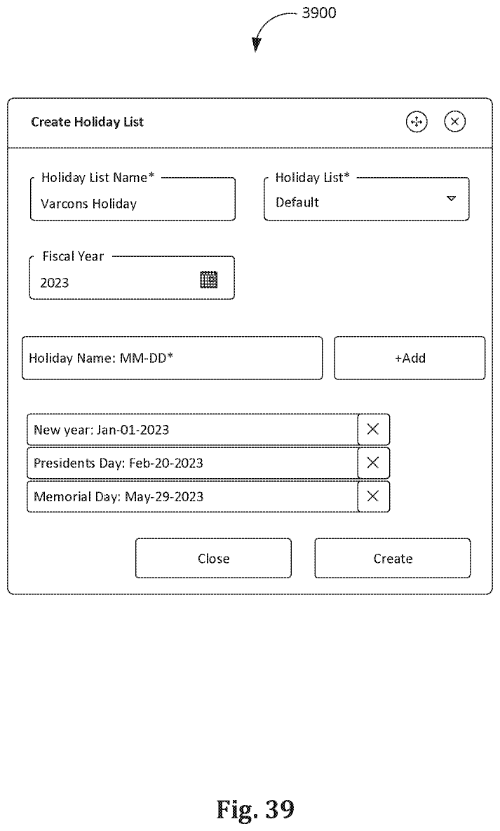

Further, the method may include holiday schedule integration (as shown in FIG. 39). An innovative aspect of the disclosed system is its integration of company-specific holiday schedules. This feature automatically shuts down cloud resources during non-operational days, streamlining the process and standardizing downtime for cloud resources.

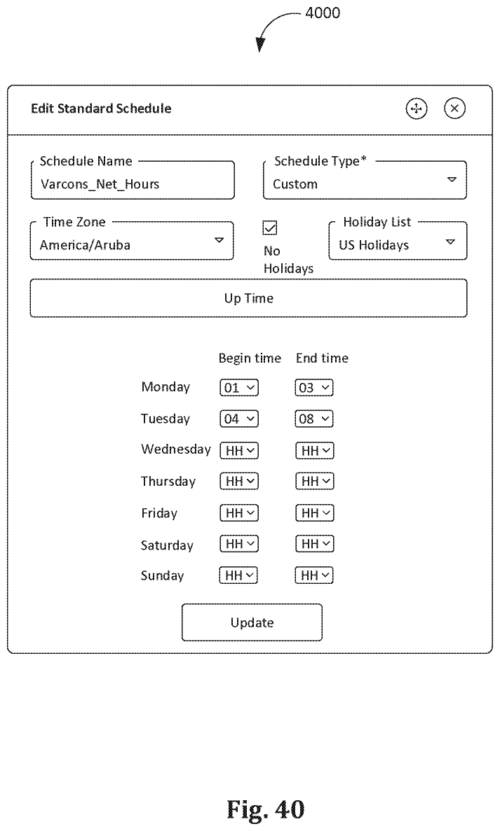

Further, the method may include defining preset schedules for operational efficiency (as shown in FIG. 40). Preset schedules are a pivotal component of the disclosed system. The Preset schedules are pre-determined timetables that outline the availability of cloud resources, ensuring they are active only during necessary operational hours. By standardizing operational hours, the preset schedules offer a consistent and efficient approach to resource management.

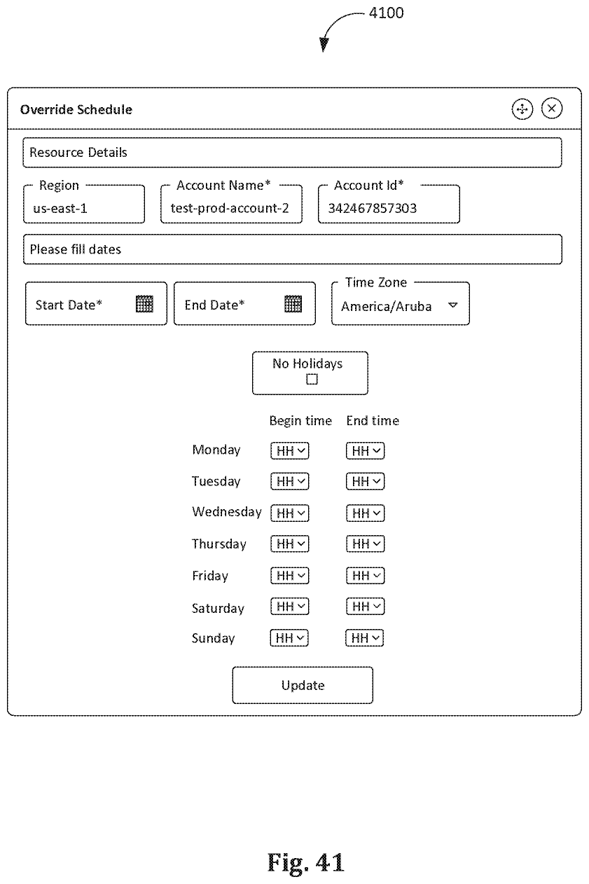

Further, the method may include scheduling override for flexibility (as shown in FIG. 41). In addition to these features, the disclosed system introduces a crucial strategy: Schedule Override. This function allows users to modify an already running schedule to accommodate urgent needs, such as reaching deadlines or conducting off-hours testing. By simply specifying the days of the week, the users may override the existing schedule with a new one, ensuring system availability during critical periods.

Customization and Easy Setup: The disclosed system is designed with flexibility in mind. Companies can establish a list of holiday schedules specific to their operations, integrating these into the setup process of both Preset and Custom Schedules. This level of customization ensures that resource utilization aligns seamlessly with the unique operational rhythms of each organization.

FIG. 37 is a screenshot of an Update Schedule interface 3700 of a software application for facilitating managing budgets for cloud accounts, in accordance with some embodiments.

FIG. 38 is a screenshot of a Select Type of Schedule interface 3800 of the software application, in accordance with some embodiments.

FIG. 39 is a screenshot of a Create Holiday List interface 3900 of the software application, in accordance with some embodiments.

FIG. 40 is a screenshot of an Edit Standard Schedule interface 4000 of the software application, in accordance with some embodiments.

FIG. 41 is a screenshot of an Override Schedule interface 4100 of the software application, in accordance with some embodiments.

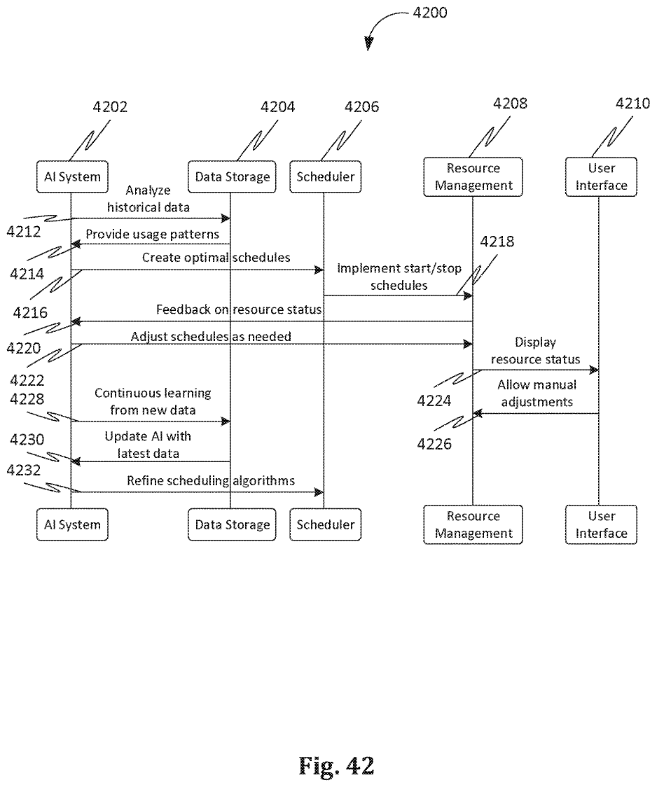

FIG. 42 is a flow diagram of a method 4200 for facilitating optimizing cloud resource utilization using a ProActive Resource Management System (ProRMS), in accordance with some embodiments. Accordingly, the method 4200 may represent a flow of operations and interactions between various components associated with the ProActive Resource Management System (ProRMS) over time. Further, the components may include an AI system 4202, a data storage 4204, a scheduler 4206, a resource management 4208, and a user interface 4210.

Further, at 4212 of the method 4200, the AI system 4202 interacts with the data storage 4204 for analyzing historical data. Further, at 4214 of the method 4200, the data storage 4204 interacts with the AI system 4202 to provide usage patterns. Further, at 4216 of the method 4200, the AI system 4202 interacts with the scheduler 4206 to create optimal schedules. Further, at 4218 of the method 4200, the scheduler 4206 may interact with the resource management 4208 to implement start/stop schedules. Further, at 4220 of the method 4200, the resource management 4208 may interact with the AI system 4202 to provide feedback on resource status. Further, at 4222 of the method 4200, the AI system 4202 interacts with the resource management 4208 to adjust schedules as needed. Further, at 4224 of the method 4200, the resource management 4208 may interact with the user interface 4210 to display resource status. Further, at 4226 of the method 4200, the user interface 4210 may interact with the resource management 4208 to allow manual adjustments. Further, at 4228 of the method 4200, the AI system 4202 may interact with the data storage 4204 to continuously learn from new data. Further, at 4230 of the method 4200, the data storage 4204 may interact with the AI system 4202 to update the AI model with the latest data. Further, at 4232 of the method 4200, the AI system 4202 may interact with the scheduler 4206 to refine scheduling algorithms.

Further, the ProActive Resource Management System (ProRMS) may be associated with the disclosed system. Further, the disclosed system may be configured for integrating AI to automate resource scheduling, focusing on identifying peak and non-peak hours to optimize cloud resource utilization and reduce costs. Further, the disclosed system may utilize AI to identify resources that are underutilized or not required during non-peak or off-hours. Further, the disclosed system may actively manage the status of these resources using the disclosed system's Scheduler to minimize cloud costs.

Further, the disclosed system may be configured for data analysis and pattern recognition.

Resource Utilization Analysis: The disclosed AI system analyzes historical data on cloud resource usage, identifying patterns of high and low demand.

Peak and Non-Peak Identification: AI algorithms are employed to distinguish between peak and non-peak hours, focusing on times when certain resources are underutilized or not needed.

Further, the disclosed system may be configured for intelligent scheduling logic development. Further, based on the AI's analysis, the disclosed system's Scheduler is programmed to create schedules for starting up and shutting down resources. Further, the Scheduler allows for customization based on specific organizational needs and patterns identified by the AI.

Further, the disclosed system may be configured for AI model training and integration. Further, the disclosed system may be configured for model training. The AI model is trained using the collected data, ensuring it accurately identifies low utilization periods and resource requirements. The trained AI model is integrated into the disclosed system, enabling it to control the Scheduler based on its predictions. Further, the disclosed system may be configured for automated resource management. The scheduler actively manages resources, automatically adjusting their status based on the AI-driven schedule. Further, the disclosed system may be configured for efficiency optimization. This automation ensures resources are only active when needed, significantly reducing unnecessary cloud costs. A feedback loop may be established for continuous learning, allowing the AI to adapt to changing usage patterns and organizational needs. Further, the AI model is regularly updated with new data to refine its scheduling predictions and maintain cost efficiency. Further, the disclosed system may provide a user interface. Further, the disclosed system provides a user interface where users can monitor the AI's scheduling decisions and manually adjust settings if necessary. Further, the users may track the impact of AI-driven scheduling on resource utilization and cost savings.

The system undergoes regular evaluations to ensure optimal performance and accuracy of the AI predictions. Further, the disclosed system continuously updates the AI algorithms and Scheduler based on user feedback and evolving cloud management practices.

By implementing AI-driven resource scheduling, the disclosed system effectively learns usage patterns to automate resource management, leading to significant cost savings and enhanced efficiency. This integration is a crucial advancement in commitment to providing intelligent, automated solutions for cloud cost optimization, particularly in managing Federal projects. Further, the disclosed system may significantly reduce resource wastage, a common challenge in Federal and large-scale organizational environments where cloud assets often remain idle outside of active development hours.

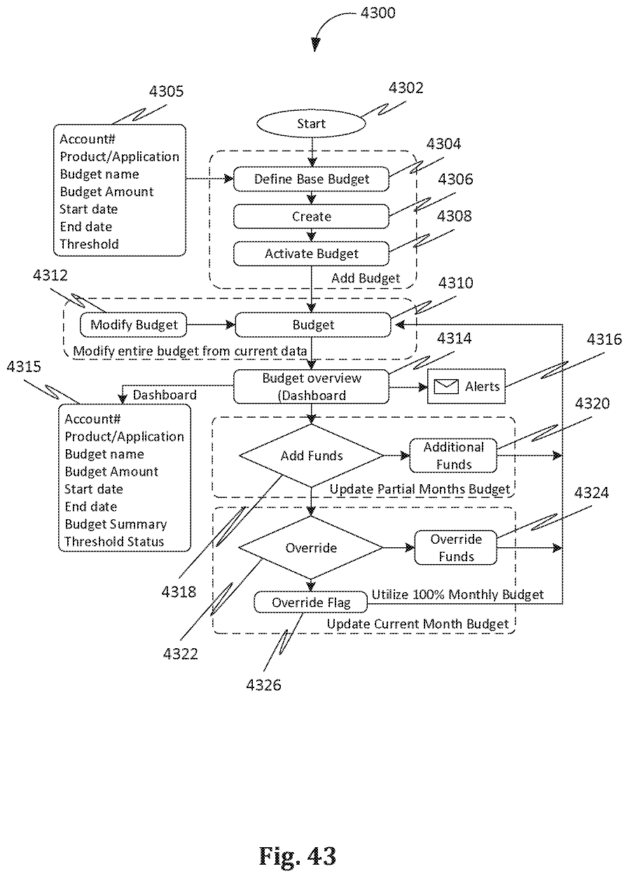

FIG. 43 is a flow diagram of a method 4300 for setting a budget using the disclosed system for facilitating managing budgets for cloud accounts, in accordance with some embodiments. Further, the method 4300 may include a step 4302 of starting. Further, the method 4300 may include a step 4304 of defining a base budget using information associated with an account (cloud account). Further, the method 4300 may include a step 4305 of receiving the information. Further, the information may include product/application, budget name, budget amount, start date, end date, threshold, etc. Further, the method 4300 may include a step 4306 of creating the budget. Further, the method 4300 may include a step 4308 of activating the budget. Further, the steps 4304, 4306, and 4308 may be associated with adding the budget. Further, the method 4300 may include a step 4310 of defining the budget. Further, the method 4300 may include a step 4312 of modifying the budget defined in the step 4310. Further, the steps 4310 and 4312 may be associated with modifying the entire budget from the current data. Further, the method 4300 may include a step 4314 of determining a budget overview. Further, the method 4300 may include a step 4315 of presenting the budget overview using a dashboard. Further, the budget overview may be associated with the account. Further, the budget overview may include the product/application, the budget name, the budget amount, the start date, the end date, a budget summary, a threshold status, etc. Further, the method 4300 may include a step 4316 of generating alerts. Further, the method 4300 may include a step 4318 of adding funds. Further, the method 4300 may include a step 4320 of adding additional funds. Further, the method 4300 moves to step 4310 after the step 4320. Further, steps 4318 and 4320 may be associated with updating partial months' budget. Further, the method 4300 may include a step 4322 of overriding the budget. Further, the method 4300 may include a step 4326 of determining an override flag. Further, the method 4300 may include a step 4324 of overriding funds. Further, the method 4300 moves to the step 4310 after the steps 4324 and 4326.

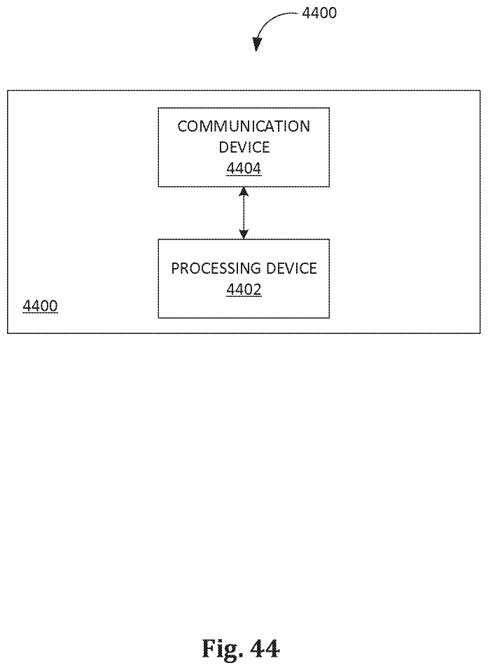

FIG. 44 is a block diagram of a system 4400 for facilitating cloud budget management based on artificial intelligence, in accordance with some embodiments. Accordingly, the system 4400 may include a processing device 4402 configured for obtaining at least one synthetic data. Further, the at least one synthetic data may include a dataset designed to simulate the range of scenarios that might occur in real project management.

Further, the processing device 4402 may be configured for training at least one artificial intelligence model based on the at least one synthetic data. Further, the at least one artificial intelligence model may be configured for recognizing standard spending patterns and identifying anomalies or unexpected spikes.

Further, the processing device 4402 may be configured for analyzing at least one project data using the at least one artificial intelligence model. Further, the processing device 4402 may be configured for determining a cloud usage information based on the analyzing. Further, in some embodiments, the determining of the cloud usage information may include determining the cloud usage information in real time.

Further, the processing device 4402 may be configured for processing the cloud usage information. Further, in some embodiments, the processing of the cloud usage information may be based on a daily expenditure threshold. Further, in an instance, the daily expenditure threshold may be $267. Further, the processing device 4402 may be configured for determining a cloud usage pattern information associated with a cloud usage pattern based on the processing of the cloud usage information. Further, the cloud usage pattern information may include at least one cloud usage attribute indicating a usage style associated with the cloud. Further, the cloud usage attributes may include a daily spending amount and spending patterns such as sudden spikes or consistently higher daily expenditures, etc.

Further, the processing device 4402 may be configured for determining a criticality level associated with the at least one cloud usage attribute.

Further, the processing device 4402 may be configured for generating at least one alert based on the criticality level.

Further, the system 4400 may include a communication device 4404 configured for receiving the at least one project data from at least one device. Further, the at least one device may include a smartphone, a tablet, a laptop, a computer, and so on that may be associated with at least one user. Further, the at least one user may include an individual, an institution, and an organization. Further, the communication device 4402 may be configured for transmitting the at least one alert to the at least one device.

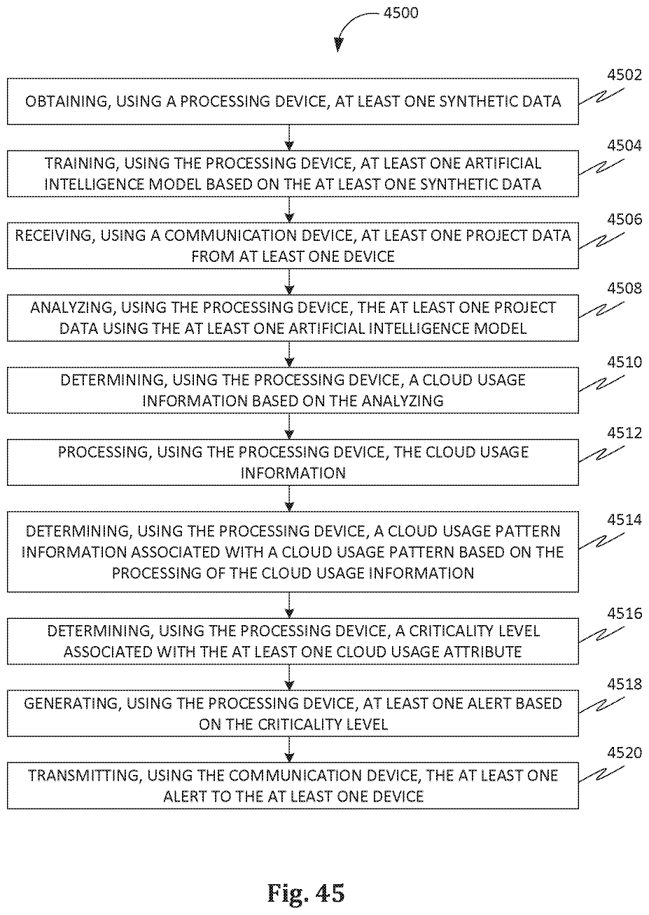

FIG. 45 is a flow chart of a method 4500 for facilitating cloud budget management based on artificial intelligence, in accordance with some embodiments. Accordingly, at 4502, the method 4500 may include obtaining, using a processing device, at least one synthetic data.

Further, at 4504, the method 4500 may include training, using the processing device, at least one artificial intelligence model based on the at least one synthetic data. Further, the at least one artificial intelligence model may be configured for recognizing standard spending patterns and identifying anomalies or unexpected spikes.

Further, at 4506, the method 4500 may include receiving, using a communication device, at least one project data from at least one device. Further, the at least one device may include a smartphone, a tablet, a laptop, a computer, and so on that may be associated with at least one user. Further, the at least one user may include an individual, an institution, and an organization.

Further, at 4508, the method 4500 may include analyzing, using the processing device, the at least one project data using the at least one artificial intelligence model.

Further, at 4510, the method 4500 may include determining, using the processing device, a cloud usage information based on the analyzing. Further, in some embodiments, the determining of the cloud usage information may include determining the cloud usage information in real time.

Further, at 4512, the method 4500 may include processing, using the processing device, the cloud usage information. Further, in some embodiments, the processing of the cloud usage information may be based on a daily expenditure threshold. Further, the daily expenditure threshold may be $267.

Further, at 4514, the method 4500 may include determining, using the processing device, a cloud usage pattern information associated with a cloud usage pattern based on the processing of the cloud usage information. Further, the cloud usage pattern information may include at least one cloud usage attribute indicating a usage style associated with the cloud. Further, the cloud usage attributes may include a daily spending amount and spending pattern such as sudden spikes or consistently higher daily expenditures, etc.

Further, at 4516, the method 4500 may include determining, using the processing device, a criticality level associated with the at least one cloud usage attribute.

Further, at 4518, the method 4500 may include generating, using the processing device, at least one alert based on the criticality level.

Further, at 4520, the method 4500 may include transmitting, using the communication device, the at least one alert to the at least one device.

According to some aspects, a method for real-time financial monitoring in cloud computing environments is disclosed. Further, the method may include establishing secure connections with multiple cloud service providers via their respective Application Programming Interfaces (APIs) or any other mechanism. Further, the method may include fetching real-time financial data from the connected cloud service providers, wherein said financial data includes expenditures, budget allocations, and resource utilization metrics, among others. Further, the method may include analyzing the fetched financial data to identify current spending trends, budget utilization, and potential cost-saving opportunities. Further, the method may include integrating the fetched and analyzed financial data across various storage types and cloud services to provide a comprehensive financial overview. Further, the method may include utilizing the integrated financial data for real-time budget monitoring and management, wherein such real-time monitoring facilitates the immediate identification of anomalies, overspending, or underutilization of resources. Further, the method may include implementing a secure data handling and processing framework that complies with data privacy standards, including but not limited to GDPR and HIPAA, to safeguard the integrity and confidentiality of the financial data. Further, the method may include providing a user interface that displays the analyzed financial data, enabling users to make informed decisions regarding cloud cost management, budget adjustments, and resource allocation in real-time.

Further, according to some aspects, the method may include customizing the analysis of financial data based on user-defined parameters, which may include specific cloud services, budgetary thresholds, and financial goals, thereby enhancing the method's adaptability to user needs.

Further, according to some aspects, the fetching and analysis of real-time financial data are automated through scheduled tasks, thus enabling continuous monitoring without the need for manual intervention and ensuring timely detection and response to financial dynamics.

Further, according to some aspects, the method may include the generation of alerts and notifications based on predefined criteria related to budget utilization and financial thresholds, thereby facilitating proactive financial management through timely interventions.

According to some aspects, advanced budget monitoring and management for Federal and commercial contracting is disclosed. Further, the advanced budget monitoring and management introduces an advanced system designed for the monitoring and managing cloud budgets, specifically tailored to meet the unique requirements of Federal and commercial contracting, including fixed-price budget projects. By leveraging foundational real-time financial data access through a comprehensive API or any other similar mechanism integration with cloud service providers, the system adeptly navigates the complexities and stringent regulatory requirements of Federal and commercial cloud expenditures. Importantly, it is suited for all sizes of businesses and startups, aiming to achieve control over cloud costs and ensuring that organizations, regardless of their scale, can benefit from optimized cloud financial management. Further, key features tailored for Federal and commercial contracting of the system are as follows:

Contract lifecycle alignment: The system is meticulously crafted to align with the general lifecycle of Federal and commercial contracts, from initiation through completion. It accommodates specific budgetary cycles, reporting requirements, and compliance mandates inherent to federal contracting, ensuring adherence to Federal Acquisition Regulations (FAR) and other relevant standards. This alignment is vital for managing contracts across various funding structures, including fixed-price projects, where budget management and reporting accuracy are paramount.

Fixed-price project budget management: This system introduces an advanced approach to managing and monitoring budgets established for fixed-price projects across all sectors. It provides a comprehensive solution for the detailed tracking of expenditures against a predetermined budget, ensuring that spending remains within the allocated limits for the budgeting period. This functionality is pivotal for any organization aiming to maintain financial discipline and efficiency, ensuring that projects stay within their allocated funding without overstepping budgetary constraints.

Proration for contract periods: Features an automated budget proration capability that aligns budget allocations with project milestones and periods, including the specific challenges posed by fixed-price projects or contracts. This ensures accurate budget allocations throughout the project's duration, facilitating precise financial planning and control.

Rollover for fiscal compliance: The system presents a flexible budget rollover system adaptable to diverse fiscal practices, enabling effective management of unspent funds. This innovative system allows for the seamless carrying forward of unused budgets to future periods or the strategic reallocation of funds according to organizational needs. By promoting financial discipline and budgetary efficiency, it serves a broad spectrum of business environments, ensuring that entities of any size can maintain fiscal health and operational agility.

Override for financial flexibility: The system introduces a budget override function designed to offer unparalleled flexibility and adaptability in budget management. This feature allows organizations to make timely adjustments to their budgets in response to unforeseen project requirements, scope changes, or other operational shifts. It provides the essential fiscal agility needed to navigate the dynamic business landscape, ensuring that organizations can maintain financial discipline while adapting to changing circumstances. This functionality is crafted to support a wide array of contractual arrangements and business models, ensuring its applicability beyond specific contract types or pricing agreements.

Modification for dynamic financial management: This feature introduces advanced budget modification capabilities designed to adapt to any changes in project scope, business objectives, or operational requirements. It enables organizations to meticulously manage their budgets, ensuring that adjustments can be made smoothly without compromising the overall financial strategy. This flexibility is crucial for maintaining financial discipline across various project types and funding arrangements, supporting the continuous optimization of cloud spending in alignment with evolving business needs and strategic goals.

Integration and value for federal and commercial contracting: Seamlessly integrated with cloud service platforms, the system utilizes APIs or any other similar mechanisms to access crucial real-time financial data for effective Federal and commercial contract management. Designed with the complexities of federal contracting in mind, it provides financial managers and contract administrators with a centralized, intuitive interface for efficient planning, monitoring, and adjusting of cloud budgets. Advanced analytics and customized reporting functionalities offer insights into budget performance against contract milestones, spending trends, and compliance with federal financial management standards.

Value Proposition: The disclosed system represents a strategic advancement in dynamically and efficiently managing cloud budgets, addressing critical challenges such as compliance with regulations, alignment with project milestones, efficient utilization of allocated funds, and adaptability to modifications. While it ensures that cloud spending is strategic, compliant, and adaptable to the intricacies of federal and commercial contracting, it is equally suited for businesses of all sizes, including startups, aiming to achieve stringent control over cloud costs. This broad applicability empowers organizations to enhance fiscal discipline and strategic resource allocation, mirroring the rigorous budget monitoring and control expected in federal contexts but tailored to meet the diverse needs of the modern business landscape.

According to some aspects, a ProActive Budget Alert System (ProBAS) is disclosed. Further, the ProBAS introduces an advanced system that revolutionizes budget monitoring and anomaly detection by leveraging artificial intelligence (AI) in a novel manner. Unlike traditional budget monitoring systems that solely rely on historical financial data, ProBAS integrates AI to analyze both real budget historical data and synthetic data. This dual-data approach enables the system to achieve unprecedented accuracy and foresight in identifying budgetary anomalies, setting a new standard in proactive financial management. Further, the features of the ProBAS are as follows:

Integration of synthetic data: ProBAS distinguishes itself by generating and incorporating synthetic data that simulates a wide range of possible financial scenarios and outcomes. This synthetic data is meticulously designed to mirror the complexity and variability of real-world financial activities, including irregular spending patterns, sudden budgetary shifts, and unexpected financial demands. By training the AI models with this comprehensive dataset, ProBAS significantly enhances the system's predictive capabilities, enabling it to recognize potential anomalies that could not be identified through historical data alone.

AI-driven anomaly detection: At the heart of ProBAS lies a sophisticated AI algorithm capable of discerning subtle patterns and discrepancies within financial data that may indicate emerging budgetary issues. This AI does not simply compare current spending against past trends; it employs advanced machine learning techniques to evaluate financial activities in the context of both historical and synthetic data. This allows for the early detection of anomalies, ranging from minor deviations to significant discrepancies, well before they escalate into critical financial concerns.

Proactive budgetary insights: By integrating AI in such a comprehensive manner, ProBAS goes beyond reactive financial reporting. It provides actionable insights that empower organizations to address potential budget overruns and inefficiencies preemptively. The system automatically generates alerts and recommendations when it identifies potential anomalies, offering guidance on corrective actions and adjustments. This proactive approach ensures that financial managers and decision-makers can maintain tighter control over budgets, optimize resource allocation, and avoid the financial pitfalls commonly encountered in dynamic business environments. Cloud Cost observability, or Cloud budget observability, is at the forefront of the disclosed system's design, enabling a proactive stance toward cloud budget management and operational efficiency.

Adaptive learning and continuous improvement: ProBAS's AI models are designed for continuous learning, allowing them to adapt to the evolving financial landscape of an organization. As the system processes more real and synthetic data over time, its predictive accuracy and anomaly detection capabilities improve. This adaptive learning ensures that ProBAS remains effective and relevant, even as an organization's financial patterns and priorities evolve.

Enhanced financial management and decision making: The integration of AI and synthetic data in ProBAS fundamentally transforms the approach to budget monitoring and management. By providing early warnings of potential issues and actionable insights for preemptive action, the system facilitates more informed and strategic financial decision-making. This leads to improved financial health, reduced risk of budget overruns, and enhanced operational efficiency for organizations.

According to some embodiments, a CloudPause-enhanced automated cloud resource scheduling system for optimal efficiency and cost reduction is disclosed.

This system capitalizes on the Pay-as-you-go (PAYG) philosophy of cloud computing, introducing a pioneering approach to cloud resource management. By integrating a sophisticated automated scheduling system capable of dynamically enabling and disabling cloud resources based on predefined operational schedules, CloudPause ensures that organizations only pay for the computing resources they consume, in alignment with the PAYG model. This contrasts sharply with traditional resource management solutions that do not optimize for variable usage, leading to unnecessary costs for idle resources. CloudPause is particularly effective in maximizing capacity utilization, thereby controlling the billion-dollar cloud waste issue. It optimizes the use of idle resources in development and testing environments, where cloud resources often remain unused during non-working hours, ensuring that organizations do not incur costs for unutilized services. CloudPause employs advanced algorithms to analyze usage patterns, predict resource requirements, and automatically adjust resource availability to align with actual operational needs. This proactive management minimizes idle resources, significantly reducing associated costs and maximizing the financial benefits of the PAYG pricing model. The system's innovative scheduling engine is adept at accommodating complex, multi-layered scheduling scenarios, including peak and off-peak hours, special event-driven resource needs, and ad-hoc adjustments for unforeseen demands. This ensures that resources are available when needed and conserved during downtime, leading to more sustainable cloud operations and environmental benefits through reduced energy consumption. Furthermore, CloudPause supports granular control over resource scheduling, allowing for the customization of schedules at both the macro (entire cloud environments or accounts) and micro (individual resources or groups of resources) levels. This multi-level scheduling capability ensures that the system can be tailored to the unique operational rhythms and requirements of various organizations, enhancing its applicability across a wide range of industries and cloud computing models. The system also features a user-friendly interface that provides real-time insights into resource utilization and scheduling effectiveness, offering actionable intelligence for continuous optimization. Through the integration of CloudPause, organizations can strike an ideal balance between operational efficiency and cost management, making it a transformative solution for the dynamic and resource-intensive nature of cloud computing environments. By leveraging the PAYG model through automated, intelligent scheduling, CloudPause represents a significant leap forward in the pursuit of operational efficiency, cost savings, and environmental sustainability within the cloud computing domain.

According to some aspects, a ProActive Resource Management System (ProRMS)-AI-driven optimization of cloud resources is disclosed. The ProActive Resource Management System (ProRMS) represents a groundbreaking advancement in the management and optimization of cloud resources, leveraging the power of artificial intelligence (AI) to transform cloud computing efficiency and cost-effectiveness. This system is distinctively designed to analyze extensive historical usage data of cloud resources across multiple platforms and services, employing sophisticated AI algorithms and machine learning techniques to discern patterns and trends in resource utilization. Further, key innovations and technical advancements are as follows:

Intelligent analysis of usage patterns: ProRMS goes beyond traditional static threshold-based approaches by dynamically analyzing historical and real-time data to understand usage patterns. This includes identifying peak usage times, recurring schedules of high demand, and periods of underutilization, facilitating a more nuanced understanding of cloud resource needs.

Identification of peak and non-peak hours: Utilizing AI, ProRMS accurately predicts peak and non-peak hours for resource utilization, enabling preemptive resource allocation or de-allocation. This predictive capability ensures that resources are optimally allocated, reducing waste and improving overall cloud efficiency.

AI-driven resource optimization: By harnessing the predictive insights gained from AI analysis, ProRMS automates the scheduling of resource scaling activities. This includes scaling up resources in anticipation of peak demand periods and scaling down or deallocating resources during predicted low-usage times, ensuring that cloud resource usage is both efficient and cost-effective.

Adaptive learning mechanism: ProRMS features an adaptive learning mechanism that continuously refines its predictive models based on new data, improving its accuracy and effectiveness over time. This self-improving system adapts to changes in usage patterns and evolving business needs, maintaining optimal resource allocation without manual intervention.

Cross-platform compatibility and integration: Designed to work seamlessly across multiple cloud platforms, ProRMS offers a unified solution for resource optimization. Its platform-agnostic approach enables businesses to manage and optimize resources across diverse cloud environments, enhancing operational flexibility and resource utilization.

Environmental impact and sustainability: By optimizing the utilization of cloud resources, ProRMS contributes to reduced energy consumption and lower carbon emissions associated with cloud computing facilities. This aligns with sustainability goals and environmental responsibility, making it an essential tool for eco-conscious organizations.

Further, the ProActive Resource Management System (ProRMS) has the following benefits over existing technologies:

Cost reduction: By ensuring that cloud resources are used efficiently, ProRMS significantly reduces unnecessary expenditure on idle or underutilized resources, offering substantial cost savings over traditional cloud management approaches.

Enhanced performance: Through AI-driven optimization, ProRMS ensures that adequate resources are always available to meet demand, enhancing application performance and user satisfaction.

Operational efficiency: Automating the complex task of resource management, ProRMS frees up valuable IT resources to focus on strategic initiatives rather than routine operational tasks.

Scalability and flexibility: ProRMS enables organizations to scale their cloud resource utilization up or down with unprecedented agility, responding swiftly to changing business requirements and market conditions.

Further, the ProActive Resource Management System (ProRMS) introduces a novel, AI-driven approach to cloud resource management, setting a new standard for efficiency, cost-effectiveness, and environmental sustainability in the cloud computing domain.

According to some aspects, an automated budget proration and rollover is disclosed. Further, the automated budget proration and rollover may be associated with a sophisticated system for dynamically managing cloud budgets across various timeframes, integrating seamlessly with the foundational real-time financial monitoring and sophisticated budget management systems. The system introduces a novel method for the automatic proration of budgets at the inception of budget creation and at the conclusion of each month, thereby ensuring budgets are accurately aligned with the temporal distribution of expenditures. This method addresses and resolves the common challenge of aligning budget allocations with irregular project timelines or fluctuating cloud resource usage patterns. Further enhancing its innovation, the system incorporates an automated budget rollover mechanism. This mechanism ensures that any unutilized funds from a given period are not forfeited but are instead automatically carried over to the next period. This feature mitigates the traditional “use it or lose it” predicament faced by many cloud budget managers, promoting a more efficient and responsible allocation of financial resources. The rollover process is meticulously designed to work in harmony with the real-time data analysis provided by a comprehensive API or any other similar mechanism integration with cloud service providers, leveraging the detailed financial insights garnered to optimize budget allocations over time. The automated proration and rollover functionalities are grounded in a robust analytical framework that utilizes advanced algorithms to assess spending patterns, forecast future expenditures, and adjust budget allocations dynamically. This framework is capable of handling complex budgeting scenarios, including varying project scales, multiple cloud environments, and diverse financial objectives, offering an unparalleled level of precision and flexibility in cloud budget management. By leveraging the capabilities introduced by the above-mentioned aspects, this expanded system not only simplifies the financial management of cloud resources but also introduces a level of automation and intelligence previously unseen in the field. It represents a significant leap forward in the ability of organizations to manage their cloud expenditures more effectively, reducing waste and enhancing the strategic use of financial resources in cloud computing environments.

According to some aspects, budget triggers and thresholds with advisory thresholds and control limits are disclosed. Further, the budget triggers and thresholds with advisory thresholds and control limits may be associated with an advanced “Budget Triggers and Thresholds with Advisory Thresholds and Control Limits” system, meticulously engineered to integrate within the sophisticated budget monitoring and management framework. This innovative system equips organizations with a dual-layered mechanism for nuanced cloud spending management, combining the flexibility of advisory alerts with the enforceability of spending ceilings, all while leveraging the comprehensive insights provided by the underlying budget management framework. Further, the “Budget Triggers and Thresholds with Advisory Thresholds and Control Limits” system is associated with:

Advisory thresholds (Soft Cap): Act as multi-level proactive alerts within the budget monitoring framework, designated at predetermined percentages of the budget to signal approaching financial boundaries. These thresholds can be set to trigger at various levels, enable early strategic responses, facilitating adjustments to spending patterns before reaching critical limits. By integrating these multi-level alerts, utilizing the advanced analytics of the framework, advisory thresholds help preempt budget overruns, allowing for timely interventions that align with financial objectives and project requirements.

Control limits (Hard Cap): Represent definitive financial boundaries, imposing strict restrictions on expenditure once these limits are reached. Integrated with the budget monitoring framework's real-time data analysis and forecasting capabilities, control limits automatically enforce budget compliance, halting additional spending to prevent budgetary overreach and maintain fiscal discipline. Embedding this system within the sophisticated budget monitoring and management framework significantly bolsters its utility, offering an automated, data-driven approach to financial oversight. The framework's capability to process real-time financial data and apply predictive analytics underpins the effective management of advisory thresholds and control limits, enabling. In some embodiments, reaching the control limit may trigger configurable enforcement actions, including automatic restriction of additional resource provisioning, limitation of scaling activities, issuance of escalation alerts, or notification-only responses requiring administrative approval. The specific response may be determined based on predefined governance policies.

Adaptive financial strategies: Dynamic management of advisory thresholds and control limits based on comprehensive financial insights and predictive models provided by the framework, ensuring that budget controls are responsive to evolving organizational dynamics and market conditions.

Informed financial decision-making: Leveraging the framework's detailed monitoring features to equip decision-makers with in-depth analyses of spending trends, facilitating precise and strategic financial planning.

Optimized resource utilization: Encouraging efficient allocation of cloud resources by aligning expenditure with strategic priorities and project demands, supported by the actionable intelligence delivered by the budget monitoring framework.

Automated financial governance: Automated enforcement of financial policies through the application of advisory thresholds and control limits, driven by the framework's seamless integration with cloud service APIs or any other mechanism and financial management platforms.

Incorporating the “Budget Triggers and Thresholds with Advisory Thresholds and Control Limits” system within the established budget monitoring and management framework significantly enhances cloud cost management practices. It provides organizations with a sophisticated tool for navigating the complexities of cloud expenditure, achieving an optimal balance of financial flexibility, control, and strategic oversight.

According to some aspects, budget triggers and thresholds with advisory thresholds and control limits are disclosed. Further, the budget triggers and thresholds with advisory thresholds and control limits may be associated with a “Budget Triggers and Thresholds with Advisory Thresholds and Control Limits” system which is intricately integrated within a sophisticated budget monitoring and management framework. This system offers organizations a comprehensive and nuanced approach to cloud expenditure management, leveraging both preemptive notifications and decisive spending controls, supported by the extensive data analytics capabilities of the underlying framework. Further, the “Budget Triggers and Thresholds with Advisory Thresholds and Control Limits” system may be associated with advisory thresholds and control limits.

Advisory thresholds: Set at designated budget percentages, these thresholds act as early warning systems, employing email and other integrated alerting mechanisms to promptly notify stakeholders of approaching budget limits. This feature ensures stakeholders are well-informed in real-time, facilitating strategic financial planning and preemptive adjustments to adhere to budgetary constraints, thus enhancing the organization's ability to manage finances proactively.

Control limits: Establish firm boundaries for allowable spending, with a configurable response mechanism that may restrict further cloud resource provisioning and/or send comprehensive alerts through email and integrated alerting systems when these limits are reached. This ensures that, based on predefined governance policies, the system may automatically halt the provisioning of new cloud resources to prevent overspending, or may issue notification-only alerts requiring administrative review, ensuring stakeholders are immediately made aware of the situation. This alert system allows for rapid administrative intervention to assess and address the cause of the breach, ensuring that financial governance is maintained and that measures are implemented to realign expenditures with budgetary frameworks.

By embedding these advanced controls within the budget monitoring and management framework, the system achieves:

Dynamic and responsive financial oversight: Through the use of Advisory Thresholds for early alerts and Control Limits for enforcing budgetary compliance, the system ensures that financial management is both proactive and reactive, capable of adapting to real-time fiscal developments.

Enhanced communication and stakeholder engagement: Guaranteeing immediate notification of critical budgetary events to all relevant parties through their preferred channels, thus facilitating collaborative decision-making and swift response to financial challenges.

Automated budgetary enforcement: With Control Limits that may restrict cloud resource provisioning and/or alert stakeholders based on predefined governance policies, the system ensures strict adherence to budgetary allocations, reinforcing the organization's financial discipline.

Strategic financial management and governance: Leveraging an automated, data-driven approach for both monitoring spending and controlling resource allocation, the system aligns cloud expenditures with strategic priorities, optimizing resource utilization and financial performance.

The integration of “Budget Triggers and Thresholds with Advisory Thresholds and Control Limits” into the budget monitoring and management framework represents a significant advancement in the domain of cloud cost management. This system provides organizations with a sophisticated toolset for navigating the complexities of cloud resource expenditure, striking the perfect balance between maintaining operational agility and enforcing strict budgetary limits through an informed, automated strategy for resource management and financial oversight.

According to some aspects, budget override and additional funds management is disclosed. Building upon the foundational system of Advanced Budget Monitoring and Management tailored for Federal and commercial contracting environments. Further, the budget override and additional funds management enhance the financial management framework by introducing two pivotal features: The Budget Override Mechanism and the Additional Funds Allocation. These features are specifically designed to extend the capabilities of the system, ensuring that it can adeptly handle scenarios that surpass the established budgetary control limits, thereby offering a nuanced level of financial adaptability and precision crucial for fixed-price and other contract types.

The budget override mechanism includes an override flag and an additional funds allocation.

Override flag: The system's Override Flag is a key feature designed to temporarily authorize the utilization of up to 100% of the allocated budget for a specific month. This is particularly crucial for situations where financial demands unexpectedly surpass the “Control Limits” set within the budget, offering a critical solution for projects facing immediate and unforeseen financial needs. The activation process for the Override Flag is carefully governed by a series of authorization checks, ensuring that any decision to exceed the control limit is taken with full accountability and strategic foresight. This mechanism is invaluable for navigating the strict confines of fixed-price contracts, providing a means to address sudden financial challenges while remaining compliant with established contractual and regulatory frameworks.

Additional funds allocation: In addition to the Override Flag, the system includes a feature for Additional Funds Allocation, enabling the infusion of financial resources beyond the monthly budget allocation. This functionality is essential for extraordinary circumstances where the project's financial needs extend beyond the allocated monthly budget and the capabilities provided by the Override Flag. It allows for the strategic augmentation of the project budget for a particular month, facilitating the management of unforeseen scenarios or the exploitation of emergent opportunities without destabilizing the project's financial structure or progress. The process for securing additional funds is structured around a stringent approval workflow, emphasizing the system's dedication to maintaining financial control and transparency.

Integrating these mechanisms within a unified Advanced Budget Monitoring and Management system, our approach is adept at managing the unique and often stringent requirements of Federal and commercial contracts. Leveraging foundational real-time financial data access through a comprehensive API or any other similar mechanism integration with cloud service providers, the system guarantees that budgetary adjustments are both timely and compliant with relevant financial regulations and contract stipulations.

According to some aspects, budget modification with contract lifecycle and fixed-price project alignment is disclosed. Further, the budget modification with contract lifecycle and fixed-price project alignment is a novel aspect of budget modification that leverages and expands upon the foundational budget management capabilities. Further, the budget modification with contract lifecycle and fixed-price project alignment introduces an integrated system designed for seamless alignment with the intricate requirements of contract lifecycles in both Federal and commercial sectors. This system enhances the basic budget adjustment functionalities to include dynamic modifications that are not only responsive to changing project needs and unexpected situations but also meticulously tailored to comply with the regulatory frameworks and fiscal cycles specific to federal and commercial contracting. Engineered to align with every phase of the contract lifecycle, from initiation through to completion, the system supports budget modifications that adhere to the unique budgetary cycles, detailed reporting obligations, and compliance mandates essential in Federal contracting. It ensures that all budget adjustments are in strict conformity with Federal Acquisition Regulations (FAR) and other relevant standards, thereby safeguarding against compliance risks and boosting operational effectiveness. By building on the foundational budget management capabilities, this expanded budget modification functionality not only underscores financial management efficiency but also ensures rigorous compliance with federal standards and enhances budget oversight throughout a project's lifecycle. This development marks a significant advancement in budget management, offering organizations enhanced financial discipline, adaptability, and compliance, crucial for successfully delivering federal and commercial projects.

According to some aspects, an automated cloud resource scheduler with centralized control is disclosed. Further, the automated cloud resource scheduler with centralized control heralds a significant innovation in cloud computing with the development of an Automated Cloud Resource Scheduler that features a dynamic, rule-based scheduling engine complemented by a centralized control mechanism and setting it apart from conventional scheduling solutions, which may operate in silos or necessitate manual oversight for resource allocation, this inventive scheduler utilizes sophisticated rule-based algorithms and real-time data to automate the management of cloud resource utilization efficiently across diverse cloud platforms and services. Further, the key innovations and benefits associated with the automated cloud resource scheduler with centralized control are as follows:

Dynamic scheduling engine: Employs advanced rule-based algorithms to automate the allocation and scheduling of cloud resources in accordance with real-time demand, workload fluctuations, and predefined operational policies. This capability ensures that resources are utilized optimally, minimizing idle times and reducing operational expenses.

Centralized control dashboard: Offers a comprehensive, intuitive dashboard providing centralized oversight and management capabilities for cloud resources across different environments. Through this dashboard, administrators can effortlessly monitor resource statuses, modify scheduling rules, and receive notifications about potential issues from a singular interface, thereby streamlining operations and enhancing strategic decision-making.

Rule-based optimization: Integrates a sophisticated rule-based logic system to analyze usage patterns and implement scheduling decisions based on a set of predefined rules and conditions. This approach ensures resources are allocated and scaled precisely according to organizational policies and workload requirements, optimizing performance and cost-efficiency.

Cross-platform compatibility: Designed for seamless integration with leading cloud service providers, this scheduler enables organizations to manage resources across AWS, Azure, Google Cloud, and others through a unified system. Such compatibility ensures a cohesive cloud management strategy that can adapt to the varied infrastructure needs of modern enterprises.

Environmental sustainability: By enhancing resource usage efficiency and curtailing unnecessary consumption, the scheduler aids in reducing the energy usage and carbon emissions associated with cloud operations, aligning with broader sustainability objectives and corporate responsibility initiatives.

According to some aspects, multi-level scheduling (including account and resource levels) is disclosed. Further, the multi-level scheduling system introduces an approach to cloud resource management by operating across account-level, individual resource-level, and other logical grouping levels within a cloud computing environment. This multi-level scheduling mechanism represents a significant leap in cloud management technology by offering an unprecedented level of flexibility and granularity in how cloud resources are scheduled for operation. Further, the key features and innovations associated with the multi-level scheduling are as follows:

Hierarchical scheduling framework: By implementing a hierarchical scheduling framework, the system enables comprehensive management across different organizational levels. At the top tier, account-level scheduling allows administrators to define overarching operational schedules that apply to all resources associated with a cloud account, facilitating broad-stroke efficiency improvements and policy compliance. At the lower tier, resource-level scheduling grants the ability to tailor operational parameters for individual resources or groups of resources, accommodating specific requirements, workload variations, and performance optimizations.

Enhanced operational flexibility: this multi-level approach empowers users to precisely align cloud resource utilization with actual demand patterns and operational needs. Account-level scheduling provides a macro-level tool for cost management and policy enforcement, while resource-level scheduling addresses micro-level efficiency and flexibility. These mechanisms ensure that resources are not just allocated but are dynamically adjusted to meet the organization's evolving needs, reducing waste and optimizing cost-efficiency.

Granular control and customization: The system allows for detailed customization of scheduling policies, enabling users to set specific operational windows, define exception rules, and adjust schedules based on real-time analytics. Such granularity ensures that critical resources remain available when needed, while non-essential resources can be scaled down or turned off to conserve costs. This level of control is pivotal for organizations managing diverse cloud environments with varying workload requirements.

Further, technical and operational advantages associated with the multi-level scheduling are as follows:

Cost reduction: By optimizing the operational schedule of cloud resources, organizations can significantly reduce their cloud expenditure. The system's ability to turn off or scale down resources during low-demand periods directly translates to lower usage costs.

Performance optimization: Tailoring resource availability to match demand ensures that applications and services have access to necessary resources when needed, enhancing performance and user experience.

Compliance and policy enforcement: The multi-level scheduling facilitates compliance with organizational policies and industry regulations by ensuring resources are used in accordance with predefined operational guidelines.

According to some aspects, holiday schedule integration and preset schedules for operational efficiency are disclosed. Further, the holiday schedule integration and preset schedules innovatively extend the foundational capabilities “CloudPause-Automated Cloud Resource Scheduling for Efficiency” by incorporating advanced scheduling features that leverage company-specific holiday schedules and preset operational schedules to optimize cloud resource utilization. Unlike conventional resource management approaches that operate on a static or manually adjusted schedule, our system dynamically aligns cloud resource activity with actual business operation needs, including recognizing non-standard workdays, holidays, and variable operational hours across different global regions. Further, features associated with the holiday schedule integration and preset schedules are as follows:

Customizable holiday scheduling: The system allows for the customization of holiday schedules, accommodating variations in public holidays, company-specific non-working days, and regional observances. This feature ensures that cloud resources are not unnecessarily active during periods when business operations are halted, thereby reducing operational costs and enhancing energy efficiency.

Preset operational schedules: Incorporating preset schedules for cloud resource activity based on typical business hours or specific operational needs further refines cost management and resource efficiency. These schedules can be predefined for regular operation periods, ensuring that resources are available during peak business hours while conserving resources during off-peak times.

Integration with cloud resource scheduler: This novel approach is seamlessly integrated with the automated cloud resource scheduler, enhancing its capability by incorporating intelligent, calendar-aware decisions into the scheduling logic. This integration ensures that the automated enabling and disabling of resources are not only based on operational patterns but also on specific calendar dates, providing a holistic approach to resource management.

Further, the holiday schedule integration and preset schedules underscore the inventive step of integrating holiday schedules and preset operational schedules into cloud resource management, highlighting its benefits in terms of cost savings, operational efficiency, and environmental sustainability.

According to some aspects, schedule override for flexibility is disclosed. Further, the schedule override introduces a groundbreaking “Schedule Override for Flexibility” feature designed to enhance operational flexibility within cloud resource management, a capability previously unattainable with conventional cloud management systems. This innovation is intricately dependent on the automated cloud resource scheduling for efficiency by leveraging its foundational infrastructure for a more dynamic, responsive operational model. The “Schedule Override for Flexibility” mechanism allows users to temporarily adjust or completely override the automated schedules for cloud resources without the need for manual reconfiguration or permanent alteration to the established scheduling policies. This feature is particularly innovative for several reasons:

Dynamic adaptation to changing requirements: It enables cloud resource management systems to adapt dynamically to sudden changes in operational requirements, workload demands, or specific project needs. For instance, if an unforeseen need arises for additional computing resources due to a spike in demand or to accommodate off-hours development activities, the schedule override feature allows for immediate resource availability adjustment, ensuring that the necessary resources are operational precisely when needed.

Enhanced user control and autonomy: By granting users the ability to override preset schedules, the system significantly enhances user autonomy over cloud resource management. This control extends beyond rigid scheduling frameworks, allowing for real-time adjustments that align with immediate operational objectives or unforeseen circumstances, thus maximizing resource utilization efficiency and minimizing wastage.

Seamless integration with automated scheduling systems: The feature seamlessly integrates with the automated cloud resource scheduling mechanisms, maintaining the integrity and efficiency of the overall resource management system while introducing an unprecedented level of flexibility. This integration ensures that overrides are handled efficiently, with minimal disruption to the overall scheduling logic and without compromising on the cost-saving benefits of automated scheduling.

Intelligent notification and feedback loops: The feature includes intelligent notification systems and feedback loops that inform users of the operational status of resources post-override and the impact on projected cloud spending. This real-time feedback empowers users to make data-driven decisions regarding the duration and extent of schedule overrides.

In essence, the “Schedule Override for Flexibility” encapsulates a novel approach to cloud resource management, addressing the limitations of existing automated scheduling systems by introducing a layer of operational flexibility that supports dynamic, cost-effective cloud resource utilization. This innovation represents a significant leap forward in enabling businesses to manage their cloud environments more effectively, adapting in real-time to the evolving demands of the digital landscape.

According to some aspects, AI-driven resource scheduling for cost optimization is disclosed. Further, the AI-driven resource scheduling for cost optimization represents a pioneering advancement in the field of cloud resource management, emphasizing the strategic deployment of artificial intelligence (AI) to automate and refine the scheduling of cloud resources with the primary objective of minimizing operational costs while maximizing efficiency. This inventive aspect is contingent upon the foundational technologies that establish the groundwork for utilizing AI in analyzing historical cloud usage data to discern patterns indicative of peak and non-peak resource utilization periods. Further, the key innovations associated with the AI-driven resource scheduling are as follows:

Predictive analysis: At the core of this claim is the application of sophisticated AI algorithms that perform predictive analysis on vast datasets, encompassing historical cloud usage patterns. This analysis is not merely reactive but anticipatory, allowing for the prediction of future resource needs with high accuracy.

Dynamic scheduling: Leveraging the insights gained from predictive analysis, the system dynamically adjusts the scheduling of cloud resources. This means that resources are allocated or de-allocated in real-time, based on the anticipated demand, thereby ensuring that resources are not lying idle and accruing unnecessary costs.

Cost-effective resource utilization: By optimizing the timing for resource availability, the system significantly reduces expenditure associated with over-provisioning or underutilization of cloud resources. This approach directly addresses one of the most critical challenges in cloud computing-managing operational costs without compromising on availability or performance.

Customization and flexibility: The AI-driven scheduling mechanism is highly customizable, allowing for adjustments based on specific operational requirements, seasonal variations in demand, or unexpected spikes in resource usage. This adaptability ensures that the scheduling system remains efficient and effective across diverse operational scenarios.

Efficiency and environmental impact: Beyond cost optimization, this claim also encompasses an enhancement in operational efficiency and a reduction in environmental impact. By optimizing resource usage, the system contributes to lower energy consumption and reduced carbon footprint, aligning with sustainability goals.

Continuous learning and improvement: The AI model is designed for continuous learning, incorporating new data into its analysis and refining its predictions over time. This aspect ensures that the system's scheduling decisions improve in accuracy and relevance, adapting to evolving usage patterns and operational needs.

According to some aspects, an advanced budget workflow system for enhanced fiscal discipline in cloud computing environments is disclosed. Further, the advanced budget workflow system introduces an innovative budget workflow system designed to revolutionize financial management within cloud computing environments. Leveraging real-time data analytics, this system provides unprecedented capabilities for tracking, forecasting, and adjusting cloud budgets, ensuring that organizations maintain enhanced fiscal discipline. By building upon the foundational budget management capabilities, the advanced budget workflow system integrates seamlessly with a comprehensive API or any other similar mechanism integration for real-time financial monitoring, enabling a dynamic and responsive approach to budget management that is both proactive and predictive. Further, the key features of the advanced budget workflow system include:

Real-time budget tracking: Utilizing real-time or near-real-time financial data obtained from various cloud service providers, the system offers a real-time, near-real-time, or periodically refreshed view of expenditures. This enables organizations to monitor their cloud spending continuously, identifying trends and anomalies as they occur.

Intelligent forecasting: By employing advanced algorithms and machine learning techniques, the system analyzes historical spending data alongside real-time inputs to predict future budgetary requirements. This predictive capability allows for more accurate financial planning, helping organizations to anticipate and prepare for future expenditures.

Dynamic budget adjustments: The system facilitates immediate budgetary adjustments in response to changing cloud resource needs or financial objectives. Through an intuitive interface, users can recalibrate their budgets based on the system's forecasting, ensuring that financial resources are allocated efficiently and effectively.

Enhanced fiscal discipline: By providing a comprehensive overview of cloud spending and facilitating informed decision-making, the system promotes a culture of fiscal responsibility. Organizations can set precise budgetary controls and thresholds, receive alerts for potential overspending, and implement strategies to optimize their cloud investments.

Seamless integration with existing financial systems: The Advanced Budget Workflow System is designed to integrate smoothly with an organization's existing financial management infrastructure, enhancing its capabilities without requiring significant changes to established processes.

Customizable alerts and reports: Users can configure the system to generate alerts for specific budgetary events or thresholds and create customized reports that align with organizational needs and compliance requirements. This customization ensures that stakeholders have access to relevant, actionable information tailored to their roles.

In-depth audit trail for transparency and accountability: The system offers an in-depth audit trail detailing who made changes, what changes were made, and when these changes occurred. By including this level of detail, the system ensures complete transparency and accountability, providing stakeholders with the ability to trace every action and decision back to its source, thereby enhancing the integrity and reliability of the budget management process.

By expanding the capabilities of traditional budget management systems with real-time data analytics, predictive forecasting, dynamic adjustments, and comprehensive auditing, the Advanced Budget Workflow System sets a new standard for financial management in the cloud. It addresses the unique challenges of cloud cost management, providing organizations with the tools they need to maintain control over their spending, optimize their cloud resource utilization, and achieve greater fiscal discipline.

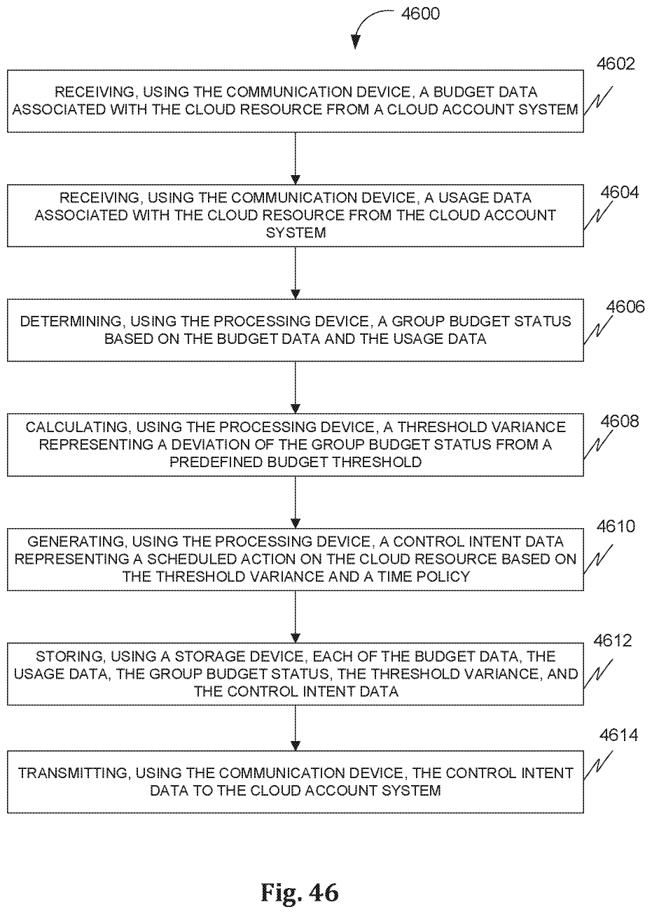

FIG. 46 illustrates a flowchart of a method 4600 of facilitating intelligent budget governance for a cloud resource, in accordance with some embodiments. Accordingly, the method 4600 may include a step 4602 of receiving, using the communication device 1002, a budget data associated with the cloud resource from a cloud account system. Further, the method 4600 may include a step 4604 of receiving, using the communication device 1002, a usage data associated with the cloud resource from the cloud account system. Further, the method 4600 may include a step 4606 of determining, using the processing device 1004, a group budget status based on the budget data and the usage data. Further, the method 4600 may include a step 4608 of calculating, using the processing device 1004, a threshold variance representing a deviation of the group budget status from a predefined budget threshold. Further, the method 4600 may include a step 4610 of generating, using the processing device 1004, a control intent data representing a scheduled action on the cloud resource based on the threshold variance and a time policy. Further, the method 4600 may include a step 4612 of storing, using a storage device 1006, each of the budget data, the usage data, the group budget status, the threshold variance, and the control intent data. Further, the method 4600 may include a step 4614 of transmitting, using the communication device 1002, the control intent data to the cloud account system.

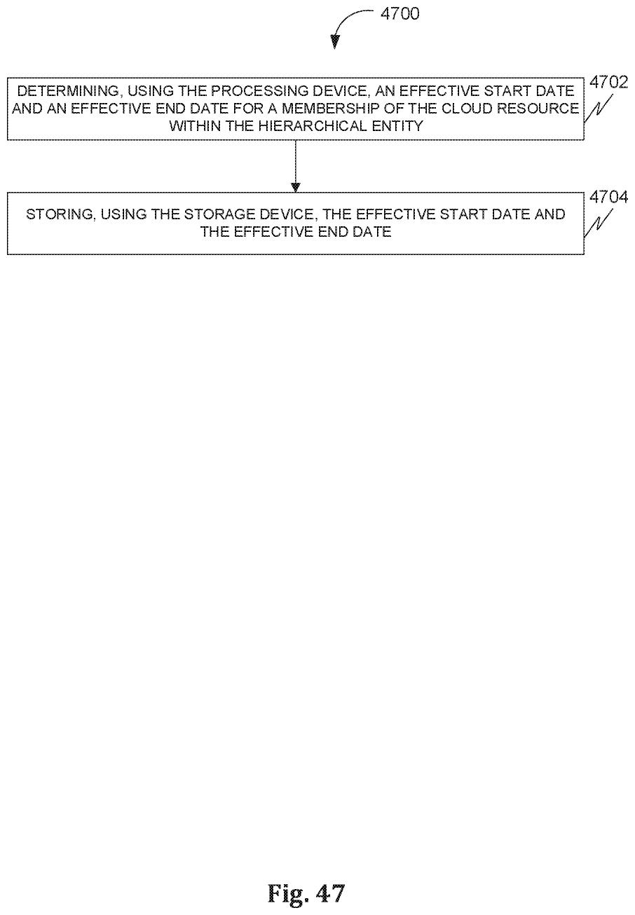

FIG. 47 illustrates a flowchart of a method 4700 of facilitating intelligent budget governance for a cloud resource, including determining, using the processing device 1004, an effective start date and an effective end date for a membership of the cloud resource within the hierarchical entity, in accordance with some embodiments. Further, in some embodiments, the method 4700 further may include a step 4702 of determining, using the processing device 1004, an effective start date and an effective end date for a membership of the cloud resource within the hierarchical entity. Further, in some embodiments, the method 4700 further may include a step 4704 of storing, using the storage device 1006, the effective start date and the effective end date.

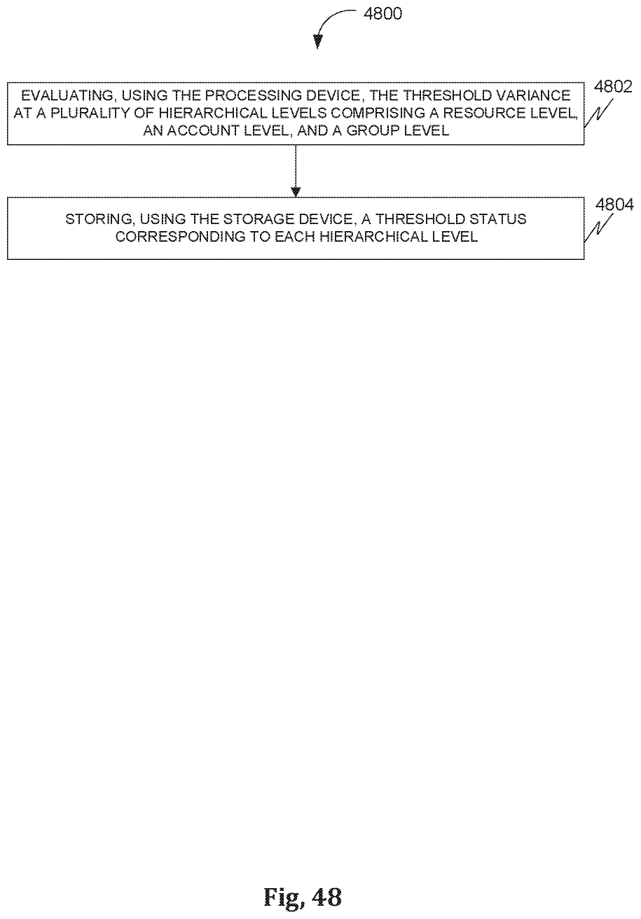

FIG. 48 illustrates a flowchart of a method 4800 of facilitating intelligent budget governance for a cloud resource including evaluating, using the processing device 1004, the threshold variance at a plurality of hierarchical levels comprising a resource level, an account level, and a group level, in accordance with some embodiments. Further, in some embodiments, the method 4800 further may include a step 4802 of evaluating, using the processing device 1004, the threshold variance at two or more hierarchical levels comprising a resource level, an account level, and a group level. Further, in some embodiments, the method 4800 further may include a step 4804 of storing, using the storage device 1006, a threshold status corresponding to each hierarchical level.

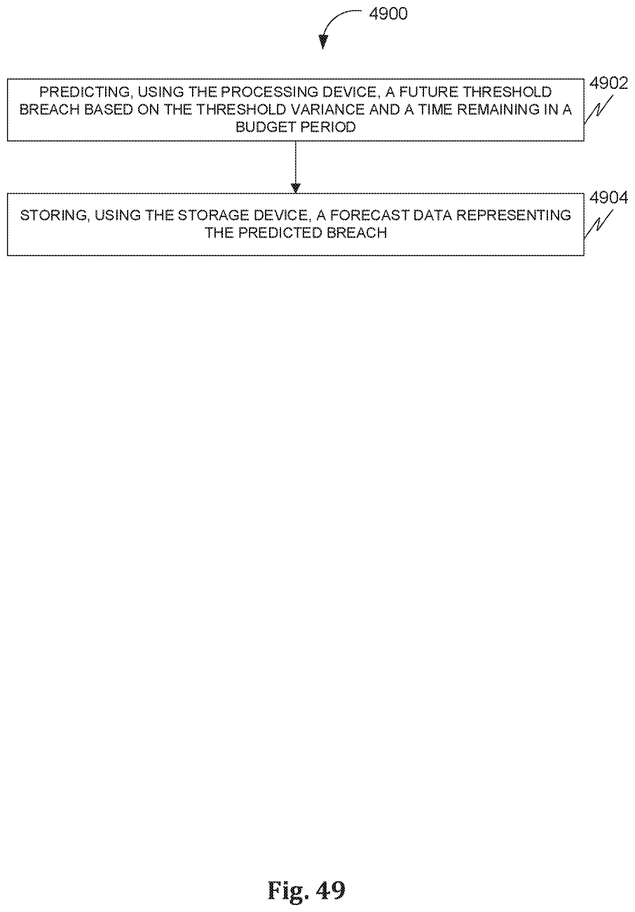

FIG. 49 illustrates a flowchart of a method 4900 of facilitating intelligent budget governance for a cloud resource including predicting, using the processing device 1004, a future threshold breach, in accordance with some embodiments. Further, in some embodiments, the method 4900 further may include a step 4902 of predicting, using the processing device 1004, a future threshold breach based on the threshold variance and a time remaining in a budget period. Further, in some embodiments, the method 4900 further may include a step 4904 of storing, using the storage device 1006, a forecast data representing the predicted breach.

In some embodiments, the generating of the control intent data further includes computing, using the processing device 1004, a safe-execution window for performing a resource action based on a calendar data and a holiday data stored in the storage device 1006.

In some embodiments, the method 4600 may further include triggering, using the processing device 1004, an automatic enforcement of the control intent data according to a policy condition associated with the budget threshold.

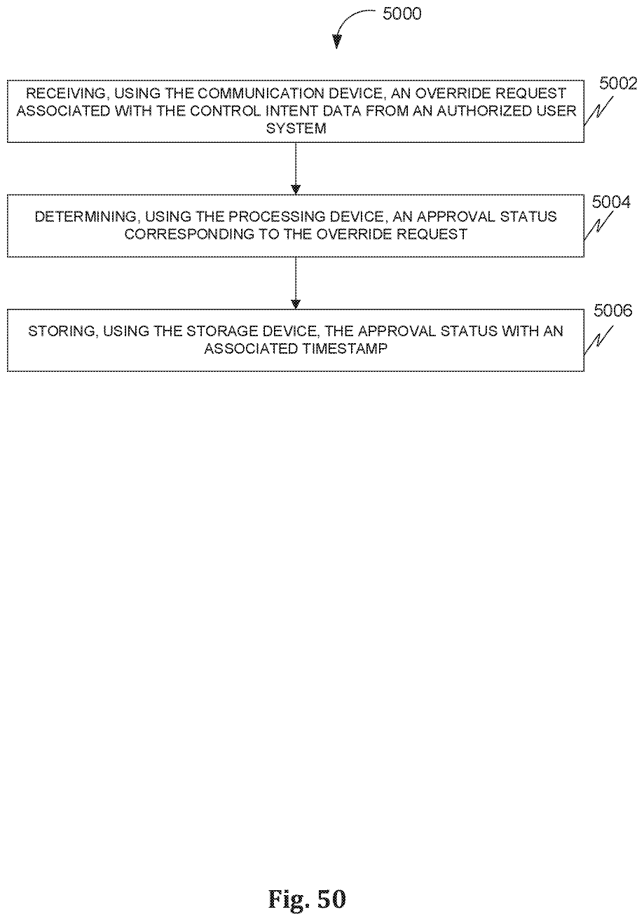

FIG. 50 illustrates a flowchart of a method 5000 of facilitating intelligent budget governance for a cloud resource including determining, using the processing device 1004, an approval status corresponding to the override request, in accordance with some embodiments. Further, in some embodiments, the method 5000 further may include a step S002 of receiving, using the communication device 1002, an override request associated with the control intent data from an authorized user system. Further, in some embodiments, the method 5000 further may include a step S004 of determining, using the processing device 1004, an approval status corresponding to the override request. Further, in some embodiments, the method 5000 further may include a step S006 of storing, using the storage device 1006, the approval status with an associated timestamp.

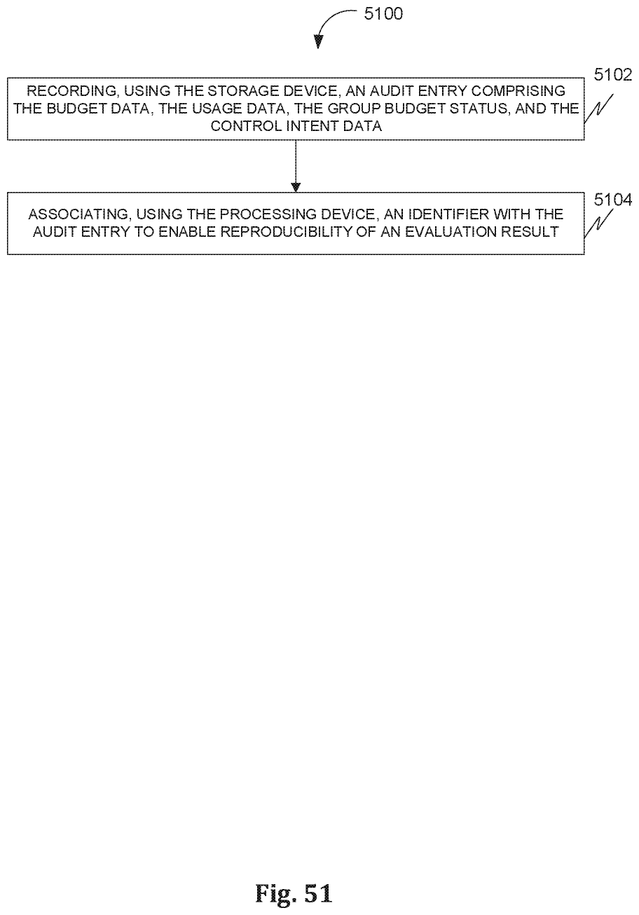

FIG. 51 illustrates a flowchart of a method 5100 of facilitating intelligent budget governance for a cloud resource including associating, using the processing device 1004, an identifier with the audit entry to enable reproducibility of an evaluation result, in accordance with some embodiments. Further, in some embodiments, the method 5100 further may include a step S102 of recording, using the storage device 1006, an audit entry comprising the budget data, the usage data, the group budget status, and the control intent data. Further, in some embodiments, the method 5100 further may include a step S104 of associating, using the processing device 1004, an identifier with the audit entry to enable reproducibility of an evaluation result.

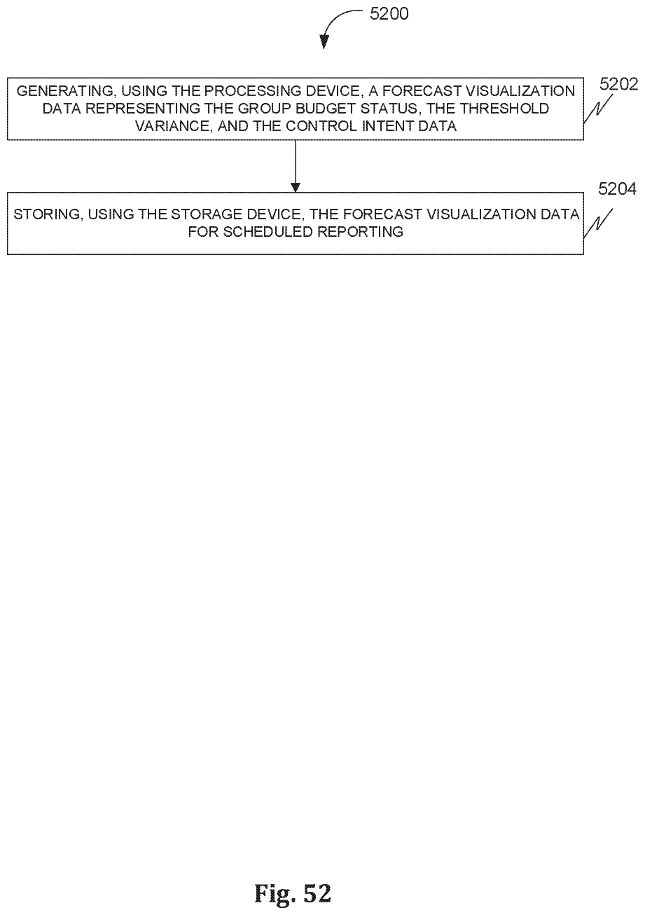

FIG. 52 illustrates a flowchart of a method 5200 of facilitating intelligent budget governance for a cloud resource including generating, using the processing device 1004, a forecast visualization data representing the group budget status, the threshold variance, and the control intent data, in accordance with some embodiments. Further, in some embodiments, the method 5200 further may include a step S202 of generating, using the processing device 1004, a forecast visualization data representing the group budget status, the threshold variance, and the control intent data. Further, in some embodiments, the method 5200 further may include a step S204 of storing, using the storage device 1006, the forecast visualization data for scheduled reporting.

In some embodiments, the method 4600 may further include normalizing, using the processing device 1004, each of the budget data and the usage data received from two or more cloud provider systems into a unified base currency to enable cross-provider governance.

Accordingly, the system 1000 may include the communication device 1002. Further, the communication device 1002 may be configured for receiving a budget data associated with the cloud resource from a cloud account system. Further, the communication device 1002 may be configured for receiving a usage data associated with the cloud resource from the cloud account system. Further, the communication device 1002 may be configured for transmitting a control intent data to the cloud account system. Further, the system 1000 may include the processing device 1004 communicatively coupled with the communication device 1002. Further, the processing device 1004 may be configured for determining a group budget status based on the budget data and the usage data. Further, the processing device 1004 may be configured for calculating a threshold variance representing a deviation of the group budget status from a predefined budget threshold. Further, the processing device 1004 may be configured for generating the control intent data representing a scheduled action on the cloud resource based on the threshold variance and a time policy. Further, the system 1000 may include the storage device 1006 communicatively coupled with the processing device 1004. Further, the storage device 1006 may be configured for storing each of the budget data, the usage data, the group budget status, the threshold variance, and the control intent data.

In some embodiments, the processing device 1004 may be further configured for determining an effective start date and an effective end date for a membership of the cloud resource within a hierarchical entity. Further, the storage device 1006 may be further configured for storing the effective start date and the effective end date.

In some embodiments, the processing device 1004 may be further configured for evaluating the threshold variance at two or more hierarchical levels comprising a resource level, an account level, and a group level. Further, the storage device 1006 may be further configured for storing a threshold status corresponding to each hierarchical level.

In some embodiments, the processing device 1004 may be further configured for predicting a future threshold breach based on the threshold variance and a time remaining in a budget period. Further, the storage device 1006 may be further configured for storing a forecast data representing the predicted breach.

In some embodiments, the processing device 1004 may be further configured for computing a safe-execution window for performing a resource action based on a calendar data and a holiday data stored in the storage device 1006.

In some embodiments, the processing device 1004 may be further configured for triggering an automatic enforcement of the control intent data according to a policy condition associated with the budget threshold.

In some embodiments, the communication device 1002 may be further configured for receiving an override request associated with the control intent data from an authorized user system. Further, the processing device 1004 may be further configured for determining an approval status corresponding to the override request. Further, the storage device 1006 may be further configured for storing the approval status with an associated timestamp.

In some embodiments, the storage device 1006 may be further configured for recording an audit entry comprising the budget data, the usage data, the group budget status, and the control intent data. Further, the processing device 1004 may be further configured for associating an identifier with the audit entry to enable reproducibility of an evaluation result.

In some embodiments, the processing device 1004 may be further configured for generating a forecast visualization data representing the group budget status, the threshold variance, and the control intent data. Further, the storage device 1006 may be further configured for storing the forecast visualization data for scheduled reporting.

In some embodiments, the processing device 1004 may be further configured for normalizing each of the budget data and the usage data received from two or more cloud provider systems into a unified base currency to enable cross-provider governance.

FIG. 53 illustrates a block diagram of a smart budget grouping and schedule enforcement architecture 5300, in accordance with some embodiments. Further, the smart budget grouping and schedule enforcement architecture 5300 may include multiple integrated components and communication buses for ingesting data, evaluating schedules, enforcing policies, and recording audit information. A set of cloud accounts and cloud service providers 5304 may represent various cloud infrastructure environments hosting one or more computing resources. The cloud accounts and cloud service providers 5304 may transmit operational, billing, and utilization data to the architecture through an ingestion bus 5328. Cost and usage signals 5306 may provide real-time and historical consumption metrics, while tags and metadata 5308 may include one or more contextual identifiers such as organizational hierarchy, cost center, project, or environment information. The ingestion bus 5328 may normalize and deliver the incoming data streams to one or more subsequent engines for evaluation. A smart budget grouping engine 5310 may receive the ingested account, usage, and metadata information to dynamically organize or group cloud resources under corresponding budget entities based on configurable or policy-defined criteria. The grouping engine 5310 may further interact with a policy store 5302 that maintains thresholds and one or more schedule policies applicable across organizational levels. A schedule evaluation engine (Time-aware) 5316 may process one or more schedule definitions from the policy store 5302 to determine valid operational windows, lock periods, and holiday overlays for each resource or group. The output of the schedule evaluation engine 5316 may be directed to a threshold evaluation and escalation module 5318, which may compare real-time or forecasted usage against defined budget thresholds to determine if an escalation or enforcement action is required. A decision engine 5312 may include rule-based, logic-based, or optionally one or more AI-based models for evaluating one or more patterns, predicting one or more budget overruns, or recommending one or more actions such as start, stop, pause, resume, and block command. The decision engine 5312 may interact with a planning-period budget planner 5318 that correlates one or more active budgets with one or more planning-period constraints, one or more forecast bands, and a schedule data to compute one or more updated budget states. A conflict resolver 5320 may manage one or more overlapping policies, one or more contradictory schedules, and one or more concurrent control intents to ensure one or more coherent enforcement outcomes. The smart budget grouping and schedule enforcement architecture 5300 may further interface with external components via an enforcement and audit bus 5330. The enforcement and audit bus 5330 may transmit one or more control signals to provider APIs 5326 through a gateway or management account to execute one or more provider-agnostic operational commands, such as start, stop, pause, resume, and block actions on one or more cloud resources. Simultaneously, the enforcement and audit bus 5330 may route event and audit data to an audit log and reporting scheduler 5322, which may record each action with one or more associated policy identifiers, one or more timestamps, and actor information. A dashboards and insights module 5324 may receive a summarized audit and analytics data to generate visual and one or more textual reports that convey budget status, threshold adherence, one or more forecast variances, and one or more enforcement outcomes to one or more administrative users. Throughout the smart budget grouping and schedule enforcement architecture 5300, one or more solid lines may represent runtime data, one or more command flows, one or more dashed lines may represent configuration, one or more recommendation exchanges, one or more dotted lines may represent audit, and one or more event taps for one or more monitoring purposes. Collectively, the smart budget grouping and schedule enforcement architecture 5300 provides an integrated framework in which policy-driven budget grouping, schedule evaluation, and automated enforcement operate cohesively, thereby enabling proactive governance, traceable decision-making, and consistent policy application across multiple cloud service providers.

FIG. 54 illustrates a block diagram of a hierarchical grouping engine and portfolio rollup architecture 5400, in accordance with some embodiments. The hierarchical grouping engine and portfolio rollup architecture 5400 provides a hierarchical model for aggregating cost, usage, and budget data across multiple organizational entities, enabling precise tracking, financial accountability, and policy-driven reporting within one or more complex cloud environments. The set of tags and metadata 5306 may be used to define logical associations among cloud resources. The tags and metadata 5306 may represent one or more attributes such as organization, cost center, project, or environment, and may provide the foundational context for automated grouping and one or more rollup operations. The system may further receive account and provider-level data from cloud accounts and providers 5304, which may supply account structure, billing details, and resource information. Additionally, cost and usage signals 5408 may provide one or more detailed consumption metrics, both real-time and historical, reflecting the operational utilization of one or more resources across one or more providers. The smart budget grouping engine 5310 may receive and process the tags, metadata 5306, account data, and one or more usage signals to dynamically organize one or more resources into one or more meaningful financial and operational groups. The smart budget grouping engine 5310 may apply rule-based and/or policy-driven logic to associate one or more cloud resources with one or more corresponding business entities. The smart budget grouping engine 5310 may also support re-parenting with retro proration 5414, which allows the reassignment of a resource, account, or project from one group to another. The operation may be performed in an audited manner, ensuring historical cost integrity through retroactive proration that adjusts one or more prior financial records proportionally. The one or more hierarchical relationships generated by the smart budget grouping engine 5310 may be structured within a hierarchy stack 5404. The hierarchy stack 5404 may organize one or more entities such that a portfolio layer 5402 represents the topmost aggregation level encompassing the entire organization. The portfolio layer 5402 may contain one or more business units 5406, each corresponding to a major organizational division. Each business unit 5406 may include one or more products or projects 5408 that represent one or more logical or operational groupings for budgeting and one or more accountability purposes. Below the project level, one or more cloud accounts 5410 may be maintained, each linking to one or more resources 5412 that may exist within or across the one or more accounts. The hierarchical grouping engine and portfolio rollup architecture 5400 may support cross-account resource aggregation, allowing one or more resources that span multiple accounts to be included in a single group when appropriately tagged. Within the hierarchy stack 5404, budget and cost rollups may be performed at each level to aggregate cost and usage information upward through the hierarchy stack 5404. The rollup process may compute planned versus actual expenditures, one or more cumulative variances, and one or more financial indicators. The results may be analyzed by a rollup and period variance module 5420, which may evaluate one or more differences between one or more planned budgets and actual usage over a defined time period, thereby highlighting under- or over-utilization trends. The aggregated and analyzed result may be presented through one or more organizational dashboards and reports 5418, which may include one or more show back and chargeback summaries, one or more alert notifications, and one or more escalation triggers. The one or more organizational dashboards and reports 5418 may visualize performance and compliance across one or more hierarchical levels, providing transparency and accountability throughout the organization. The hierarchical grouping engine and portfolio rollup architecture 5400 may further compute one or more threshold status and alerts 5416 for each group or level based on the variance and one or more utilization metrics. The one or more threshold status and alerts 5416 may indicate one or more potential policy breaches, one or more forecasted overspend conditions, and one or more efficiency opportunities. Each group or resource within the hierarchy stack 5404 may maintain one or more effective start and end membership dates 5414 that define the period of validity for inclusion within a given organizational group, ensuring temporal accuracy and preventing misattribution of cost during one or more transitions. All hierarchical aggregations, variances, and alerts may be aggregated across levels 5422 to provide an enterprise-wide view of financial health and policy compliance. The hierarchical grouping engine and portfolio rollup architecture 5400 thus supports both bottom-up data rollups and top-down policy enforcement. Throughout the block diagram, one or more solid lines may represent one or more rollup or runtime output paths, while one or more dashed lines may represent inheritance, one or more configuration flows between one or more hierarchical levels. Collectively, the hierarchical grouping engine and portfolio rollup architecture 5400 enable automated, auditable, and time-aware financial consolidation across multi-cloud environments, ensuring that one or more budgets, usage, and governance policies remain synchronized with organizational structure and one or more operational objectives.

FIG. 55 illustrates a flowchart of a schedule creation and holiday definition workflow 5500, in accordance with some embodiments. The schedule creation and holiday definition workflow 5500 provides a structured, auditable sequence of operations for defining, validating, and publishing one or more time-based schedules that govern when one or more specific cloud resources, one or more accounts, or groups are permitted or restricted to operate. The schedule creation and holiday definition workflow 5500 ensures alignment with one or more organizational calendars, one or more maintenance windows, and one or more fiscal lock periods while maintaining traceability and compliance with one or more approval and escalation policies. The process begins with a scope selection 5508 in which a user or automated process may identify the applicable scope for a schedule, such as a specific resource, account, and one or more groups of resources. The scope selection 5508 defines the operational boundary for which the schedule will apply. Next, a schedule type selection 5510 may be performed to determine whether a preset or custom time window should be used. The schedule type may incorporate one or more standard working periods, one or more off-hours, and one or more maintenance windows, and may also include time zone and daylight saving time (DST) handling 5530 to ensure correct alignment with one or more global time differences and one or more periodic clock adjustments. Once the schedule type is chosen, the system may attach calendar 5512 that associates one or more calendars with the defined scope. The calendars may originate from one or more holiday list sources 5502, which may include one or more company-specific or regional holiday datasets, or from internal release and one or more maintenance window definitions. The association ensures that one or more schedules accurately reflect one or more periods of downtime, holidays, or one or more restricted operations. Following the calendar attachment, a lock window definition 5514 may be executed to specify one or more control windows corresponding to a period, month, or one or more quarter ends. The one or more lock window templates may define one or more start, prevent rules, ensuring that one or more operations, such as one or more budget modifications, resource creation, or one or more deletions, are restricted during one or more sensitive periods, like one or more financial closures or reporting cycles. The next operation may include a stage mapping 5516, in which one or more schedules are linked to one or more operational stages such as development, testing, user acceptance testing (UAT), or production. The stage mapping 5516 may utilize a stage catalog 5506 that defines each stage along with one or more per-stage rules or constraints. Mapping one or more stages to one or more schedules ensures that one or more environment-specific governance policies are enforced consistently across operational tiers. Once the one or more inputs are defined, the system may perform a conflict and precedence validation 5518 to analyze one or more overlaps, one or more contradictions, or capped conditions among one or more schedules, one or more lock windows, and one or more calendar entries. The validation ensures that multiple concurrent rules do not produce one or more conflicting enforcement results. An optional impact preview and approval routing 5520 may then be initiated. During the impact preview and approval routing 5520, the system may present a simulation of one or more proposed schedules' effects on one or more current operations and may route the schedule for review according to an approval policy or escalation chain 5524. The approval process may involve one or more tiered authorization workflows in which one or more requests escalate through one or more management levels if one or more predefined thresholds or conditions are exceeded. Upon approval, the finalized schedule may undergo a publish schedule 5522, during which it is written to a policy store 5526 that maintains threshold and schedule data for active enforcement. Concurrently, the system may generate and record a corresponding entry in an audit log 5528. Each audit log 5528 may capture actor identity, scope, schedule identifier, one or more timestamps, and related metadata, ensuring full traceability of one or more configuration changes. Throughout the schedule creation and holiday definition workflow 5500, one or more solid arrows represent the main authoring flow, while one or more dashed arrows denote one or more configuration references, one or more policy lookups, and one or more publishing interactions with one or more external modules. Collectively, the schedule creation and holiday definition workflow 5500 defines a repeatable, governed process for schedule creation, conflict validation, approval routing, and publication. By integrating time-zone handling, one or more lock windows, and one or more policy-driven approvals, the system ensures that the one or more cloud resource schedules are consistently aligned with one or more organizational priorities, one or more compliance requirements, and one or more temporal governance constraints.

FIG. 56 illustrates a planning-period rollup graph 5600, in accordance with some embodiments. The planning-period rollup graph 5600 shows an allocated budget, an updated budget, an actual spend, and a forecast with confidence band, with variance and threshold status across the planning calendar. The one or more solid lines represent the actual spend, while the one or more dashed lines represent the allocated budget, the forecast overview, and the updated budget. The planning-period rollup graph 5600 represents a first budget breach, with the actual spend greater in value than the updated budget. Further, the planning-period rollup graph 5600 represents a projected breach with the forecast overview, greater in value than the updated budget.

FIG. 57 illustrates a flowchart of a policy-handling engine 5700, in accordance with some embodiments. The policy-handling engine 5700 is configured to evaluate one or more thresholds, apply one or more guardrails, manage one or more overrides and one or more approvals, and determine one or more automated or escalated control actions based on one or more policy-defined conditions. The workflow ensures consistent enforcement of one or more governance rules while minimizing one or more false positives through noise suppression, temporal validation, and hierarchical inheritance logic. The policy-handling engine 5700 may serve as the central decision-making module responsible for applying one or more guardrails, checking one or more overrides and one or more approvals, resolving one or more conflicts, and deduplicating one or more alerts 5702. The policy-handling engine 5700 may interact with various policy and data inputs, including one or more threshold policies 5704, one or more planning and forecasting inputs 5708, and one or more schedule evaluation inputs 5710, each providing one or more distinct governance parameters that influence one or more policy decisions. The one or more threshold policies 5706 may define multiple levels of budget or usage limits commonly structured as one or more soft caps and one or more hard caps that correspond to one or more progressive stages of escalation. Further, the one or more soft caps and one or more hard caps may be arranged within a threshold ladder 5712 that transitions through one or more states, such as Green (normal), Yellow (warning), and Red (critical). One or more soft caps may trigger one or more notifications, while one or more hard caps may initiate escalation or enforcement control. In some embodiments, one or more thresholds may be defined across one or more hierarchical entities through a define thresholds step S724, which may apply to the one or more scopes such as portfolio, business unit, account, group, or resource. The define thresholds step S724 step may support one or more inheritance and overrides 5726, allowing one or more policies to cascade from parent to child levels, while also permitting one or more stricter or temporary overrides for one or more specific lower-level entities, such as one or more development or testing environments. The one or more inheritances and overrides 5726 may be subject to one or more expiration dates to ensure temporary applicability. Once the one or more thresholds are established, the system may execute a signal collection step S728 that gathers both actual and forecasted data corresponding to allocated, updated, and spent budget. The one or more signals may be derived from one or more planning and forecasting inputs, which may include allocated budget, forecast variance, one or more confidence bands, and one or more safe-execution or blackout calendars. The one or more collected signals may then be analyzed for one or more anomalies or limit violations during a breach detection step S730. After one or more potential breaches are identified, a classification and noise control step S732 may be performed to filter one or more redundant or low-confidence alerts. The classification and noise control step S732 may apply hysteresis, deduplication, one or more suppression windows, and data-freshness gates to avoid one or more oscillating or outdated triggers. The cleaned and validated input may then progress to a policy decision step S734, where the policy-handling engine determines whether a control action, notification, or escalation is warranted. When a breach is confirmed, the system may optionally permit a policy-permitted auto override 5736. In such cases, one or more predefined guardrails may allow limited temporary bypasses of one or more standard enforcement conditions under one or more controlled circumstances. During auto override, the system may capture one or more snapshots or save-states of operational and policy data to maintain full auditability. If manual intervention is required, the policy-handling engine 5702 may generate an override or approval request 5718 that triggers an escalation chain or approval routing process. The approval routing process may involve one or more designated stakeholders or managers who review and approve one or more temporary exceptions. Upon approval, the system may activate one or more control modes 5720, which may include a preventive mode (blocking new starts), a freeze mode (holding active states or permitting only safe stops), or an exception window (a temporary override mode active for a limited period). If approval is denied or times out, the system may proceed with default notification or escalation procedures without one or more enforcement changes. Following any enforcement or override action, the system may perform a post-action audit and verification step S722. During the post-action audit and verification step S722, one or more detailed audit records may be created, capturing actor identity, the one or more timestamps, one or more policy and threshold identifiers, one or more approval references, one or more inputs and one or more snapshots, one or more decisions and outcomes, and membership or foreign exchange (FX) snapshot identifiers. The one or more detailed audit records ensure complete traceability and verifiable compliance for one or more automated and manual policy-handling activities. Throughout the flowchart of a policy-handling engine 5700, one or more solid lines represent data and one or more decision flows within the engine, while the one or more dashed lines denote one or more reference or contextual relationships, such as inheritance, configuration, and one or more escalation interactions.

FIG. 58 illustrates a flowchart of an override and approval routing 5800, in accordance with some embodiments. The override and approval routing 5800 generates a temporary exception window with one or more guardrails. The override and approval routing 5800 comprises one or more override triggers 5802. The one or more override triggers 5802 comprise one or more of a forecast risk, an operational limit, a capacity threshold, a disaster recovery event, or a policy exception. The system performs a context capture 5804 to record one or more of a scope, a rationale duration, and actor information. The system submits an override request 5808, initiating automated impact analysis 5822 to analyze one or more potential budget variations and one or more schedule conflicts. A guardrails check 5828 ensures a safe execution, stability of one or more dependencies, one or more snapshots, and one or more recovery states. The override request 5808 passes through approval routing 5810, where a delegation of authority may occur by following one or more policy rules 5812 and an approval decision 5824. The one or more policy rules 5812 comprises one or more of a timeout, one or more duration caps, and one or more auto-override rules. The approval decision 5824 determines whether an override is granted. If approved, an exception window 5814 is created. If denied or a time-out 5826 occurs, one or more escalations and one or more notifications are triggered. The exception window 5814 comprises one or more exception window fields 5816 comprising one or more allowed actions, a start and an end time, one or more caps, and one or more stage rules. In the exception window 5814, enforcement under exception 5818 ensures that one or more preventive rules are bypassed only within one or more approved limits. The system continuously monitors and expires 5820 the exception window 5814, triggering an auto-rollback when the duration lapses. The system preserves one or more actors, one or more window details, one or more time stamps, one or more decisions, and one or more snapshot IDs through audit and recordkeeping 5806.

FIG. 59 illustrates an audit and reporting table 5900, in accordance with some embodiments. The audit and reporting table 5900 comprises one or more actors enforcing access across one or more scopes. The audit and reporting table 5900 further comprises one or more timestamps, one or more policy identifiers, one or more approval references, and supporting metadata comprising one or more data freshness indicators, a delivery schedule, one or more correlation IDs, and one or more snapshot IDs.

FIG. 60 illustrates a flowchart of a resource scheduling engine 6000, in accordance with some embodiments. The resource scheduling engine 6000 is configured to coordinate one or more cloud resource operations, such as start, stop, pause, resume, and block, in a policy-compliant and time-aware manner. The resource scheduling engine 6000 ensures that each resource action occurs within one or more authorized time windows, under validated health and one or more dependency conditions, and in alignment with defined budget and one or more forecast constraints. The resource scheduling engine 6000 may receive three categories of input data: one or more schedule inputs 6002, one or more budget and forecast inputs 6004, and one or more policy or control state inputs 6006. The one or more schedule inputs 6002 may include one or more time-only schedules, one or more holiday and lock windows, and one or more safe-execution windows, defining when one or more resource operations are permissible. The one or more budget and forecast inputs 6004 may represent allocated or updated budgets, actual spending, forecast bands, and variance data used for budget-aware decision-making. The one or more policy or control state inputs may define one or more system-level conditions, such as one or more preventive or freeze modes, as well as one or more active exception windows in which temporary deviation from one or more standard control policies is allowed. The scheduling process may begin with a mode selection step 6008, during which the engine determines whether the scheduling operation should be executed in a “time-only” mode or a “budget-aware” mode. The time-only mode may rely exclusively on one or more temporal scheduling parameters, whereas the budget-aware mode may integrate both time and financial constraints into the decision logic. Following mode selection, an admission gate 6010 may be applied to evaluate the current policy and control State. The admission gate 6010 may determine whether the system is in a preventive, freeze, or exception mode, thereby governing whether a requested operation can proceed. If conditions permit, the workflow advances to a safe-execution evaluation step 6012, where the engine performs dependency and one or more health checks to ensure operational readiness. The safe-execution evaluation step 6012 may also evaluate blackout and one or more grace periods to avoid executing one or more actions during one or more periods of one or more restricted or unstable system states. The safe-execution evaluator 6012 may interact with one or more safeguard modules 6024, which may include one or more snapshot or save-state functions, one or more draining or quiescence procedures, and rate or quota limit enforcement. The one or more safeguard modules 6024 ensure that one or more activities are preserved, operational states remain consistent, and the risk of data or state corruption is minimized during one or more transitions. Upon successful validation of the safe-execution phase, the system may invoke a utilization and idle detection step 6014 to monitor the operational state of the resource. The utilization and idle detection step 6014 may measure CPU utilization, one or more I/O operations, one or more request rates, and compare with one or more idle thresholds to determine whether a resource is underutilized or inactive. The results of the detection phase feed into the next stage of the workflow. An action decision step 6016 follows, during which one or more scheduling engines determine whether a control operation, such as start, stop, pause, resume, or block, should be executed. The action decision step 6016 may depend on the evaluated schedule, current utilization state, and one or more active budget or forecast constraints. Once a decision is made, the engine may perform the corresponding action execution step 6018, applying the selected control operation in a provider-agnostic manner. Ensuring consistent enforcement across multiple cloud service providers without reliance on one or more provider-specific interfaces or formats. Following execution, a post-action verification step 6020 may confirm that the resource has reached the intended state. If the desired state is not achieved or a failure is detected, the resource scheduling engine 6000 may initiate a rollback to restore the resource to a stable condition. After verification, the system may proceed to an event emission and audit reporting step 6022, records comprehensive operational data including actor identity, one or more timestamps, one or more policy and version identifiers, one or more snapshot identifiers (e.g., membership or exchange data), decision and outcome information, and one or more correlation identifiers. One or more audit trails ensure that all scheduling operations are fully traceable and compliant with organizational and one or more regulatory governance requirements. Throughout the block diagram, one or more solid lines represent the primary processing flow of data and one or more decisions, while one or more dashed lines indicate one or more context exchanges and one or more safeguard feedback paths, such as one or more updates to policy state or dependency status. Collectively, the resource scheduling engine 6000 provides an integrated, policy-driven framework for dynamic control of one or more cloud resources. By combining time-based scheduling, budget-aware governance, dependency validation, and safeguard enforcement, the resource scheduling engine 6000 ensures operational efficiency, policy compliance, and system stability across multi-cloud environments.

FIG. 61 illustrates a flowchart of an operational workflow 6100, in accordance with some embodiments. The operational workflow 6100 represents the end-to-end process of scheduling, validating, approving, and enforcing time- and policy-based control of one or more cloud resources associated with the intelligent governance system. The operational workflow 6100 integrates scheduling, conflict resolution, approval routing, policy enforcement, and audit reporting to ensure consistent, traceable, and policy-compliant operations across multiple environments and multiple organizational hierarchies. The process may begin with a schedule creation step 6102 in which the system defines a schedule by selecting scope, type, one or more time windows, and one or more applicable stage mappings (for example, development, testing, or production). The schedule creation step 6102 establishes the foundational temporal and one or more operational parameters for one or more subsequent control actions. Once created, the system may proceed to a conflict and precedence validation step 6104. The system analyzes one or more configured schedules for one or more potential overlaps, one or more contradictions, or one or more violations of one or more established capacity caps, ensuring that no conflicting time windows exist between one or more dependent operations. After successful validation, the system may execute a holiday overlay and preset application step 6106, where one or more preconfigured calendars and one or more organization-wide holiday definitions are superimposed onto the schedule. The integration ensures that no one or more control operations are executed during one or more blackout periods, one or more holidays, or one or more maintenance freeze windows. Subsequently, a customization step 6108 may be performed to apply one or more exception rules. The customizations may include one or more deviations for one or more specific environments, such as permitting additional flexibility in testing while enforcing one or more stricter controls in production. Once customized, the workflow proceeds to a routing for approval or override step 6110. The approval or override step 6110 step may invoke a delegation of authority chain that routes the schedule or control request through one or more designated reviewers and one or more approvers. Each approval may be time-bound and may also permit the submission of one or more override requests when justified by operational necessity. The workflow then reaches an approval decision point 6112. If the request is approved, the process continues; however, if the approval is denied or times out 6124, the system may initiate a notification and escalation process 6124, and no enforcement action may be taken, and the system may simply record the outcome for audit purposes. When approval is granted, the workflow advances to a deduplication and suppression step 6114, where the system eliminates one or more redundant triggers and manages one or more quiet windows using hysteresis-based suppression. Ensures that one or more alerts and one or more actions are not re-triggered unnecessarily due to one or more temporary fluctuations or duplicate policy events. Following suppression, the system performs a policy-state check step 6116 to confirm the current operational mode. The policy-state check step 6116 determines whether the system is in a preventive, freeze, or exception state and whether an active window allows enforcement. If a pre-breach advisory condition is detected, such as when a forecasted cost or usage level is projected to exceed a defined target, the system may automatically perform one or more advisory actions 6126, such as tightening one or more schedule parameters, blocking one or more resource starts, or scaling down one or more idle resources to prevent the breach. If policy checks confirm enforcement readiness, the workflow proceeds to an enforcement step 6118, where one or more provider-agnostic actions such as start, stop, pause, resume, or block are executed. One or more provider-agnostic actions are applied according to the approved schedule and active policy state. After execution, a verification step 6120 validates whether the target operational state has been successfully achieved. If verification fails, the system may initiate a rollback procedure to restore the resource or system to a previous stable condition. Upon successful verification, the system proceeds to an event emission and audit reporting step 6122. The event emission and audit reporting step 6122 records all relevant operational and decision-making data, including actor identity, one or more timestamps, associated policy and approval identifiers, one or more snapshot references, and one or more correlation identifiers that enable traceability across related workflows. The audit and reporting process ensures full compliance and accountability for each automated or manual action taken within the system. Throughout FIG. 61, one or more solid lines represent the primary enforced operational flow, while one or more dashed lines represent advisory, conditional, or reference paths that provide feedback and policy context, such as pre-breach advisories or rollback triggers. Collectively, the operational workflow 6100 establishes a structured and auditable control framework that integrates schedule governance, approval routing, conflict validation, and policy-based enforcement. By combining predictive advisory logic with deterministic control execution, the workflow ensures operational stability, financial predictability, and compliance across dynamic cloud environments.

FIG. 62 illustrates a flowchart of a decision framework 6200, in accordance with some embodiments. The decision framework 6200 governs automated and semi-automated decision-making within the intelligent budget governance and policy management architecture. The decision framework 6200 functions as a recommendation and inference engine that synthesizes one or more policy rules, one or more contextual signals, and one or more predictive models to generate one or more actionable insights, resolve one or more conflicts, and provide explainable guidance for resource, budget, and schedule management in multi-cloud environments. The decision framework 6200 may begin with multiple input streams, including one or more rules and logic inputs 6202. The one or more rules and logic inputs 6202 may comprise one or more policy rules, one or more financial and operational thresholds, one or more deterministic heuristics, one or more historical constraints, and one or more business-specific objectives such as one or more service-level objectives (SLOs) or one or more service-level agreements (SLAs). The one or more rules and logic inputs 6202 define the one or more operational boundaries and one or more logical constraints under which the decision framework must operate. The policy guardrails 6204 may establish one or more safety limits and one or more procedural controls. The policy guardrails 6204 may include scope and cap definitions, one or more safe-execution conditions, delegation of one or more authority (DoA) hierarchies, and one or more approval structures. Guardrails may also incorporate data-freshness gates to ensure that only recent and reliable data are used in decision-making. The policy guardrails 6204 act as one or more non-negotiable policy constraints that all recommendations must comply with. The decision framework 6200 may also receive one or more context signals 6208 that represent real-time operational and financial data. The one or more context signals 6208 may include budget allocation, actual expenditure, and one or more forecast values associated with one or more confidence bands. One or more additional signals may capture one or more schedule states, one or more calendar windows, and one or more idle patterns of one or more cloud resources. Snapshot data, such as one or more membership identifiers, one or more financial exchange references, may also be incorporated to ensure accurate temporal and contextual interpretation. In some embodiments, the decision framework 6200 may optionally integrate one or more AI-assist components 6206 to enhance inference accuracy and interpretability. The one or more AI-assist components 6206 may employ pattern mining, one or more clustering algorithms, one or more large language model (LLM)-based explanations, one or more ensemble-based forecast models, and one or more counterfactual search techniques. The AI-assist module may identify one or more hidden correlations, one or more contextual anomalies, or one or more optimization opportunities while producing one or more explainable outputs with confidence metrics for human review. All incoming data streams may converge at a decision framework module (Recommendation Engine) 6210. The recommendation engine 6210 may perform grouping inference, variance forecasting, schedule planning, and conflict detection and resolution. may compare the incoming operational state against one or more policy rules and guardrails to detect deviations and determine if corrective action, reallocation, or schedule adjustment is necessary. If one or more potential contradictions or policy violations are detected, a conflict analysis step 6218 may be triggered. The system may evaluate whether a given condition constitutes a genuine policy conflict or a transient inconsistency. When a conflict is detected, the framework may resolve via rules or suggest an override 6220, applying deterministic logic or, when appropriate, proposing temporary exceptions under defined governance controls. If no conflicts 6222 are found, the workflow proceeds with normal recommendation generation. The system then produces one or more recommendations 6212, which may include proposed one or more group membership changes or re-parenting actions, one or more budget adjustments or re-forecasts, one or more schedule modifications, one or more idle-pause proposals, and one or more operational recommendations. Each recommendation may be accompanied by an explanatory note and a confidence score derived from data reliability and model precision. All recommendations remain subject to the enforcement of policy guardrails, ensuring compliance and risk containment. Following recommendation generation, the system may engage in a feedback and learning phase 6214. During the feedback and learning phase 6214 the framework may accept, modify, or ignore one or more specific outcomes based on real-world validation or human-in-the-loop review. The decision framework 6200 may also track performance drift, model accuracy, and long-term compliance trends to continuously refine future decision-making. Over time, the feedback mechanism enhances the system's adaptive intelligence and governance accuracy. All executed or proposed decisions may then be recorded in a log and audit reporting module 6216. Each record may include the actor identity, timestamp, policy, and one or more version identifiers, one or more correlation identifiers, and one or more inputs and one or more snapshots that led to the decision. The audit record may also capture the rationale for the decision, ensuring transparency, explainability, and full traceability for compliance audits and operational review. Throughout FIG. 62, one or more solid lines represent the primary data and decision flow between one or more modules, while one or more dashed lines represent advisory, learning, and one or more policy filtering feedback paths. Collectively, the decision framework 6200 enables dynamic, explainable, and policy-aligned decision-making in cloud budget and resource governance. By integrating one or more deterministic policy rules with one or more AI-driven insights and guardrail-enforced validation, the decision framework 6200 ensures that each decision remains operationally sound, auditable, and adaptable to evolving enterprise and cloud ecosystem conditions.

FIG. 63 illustrates a centralized control plane architecture 6300, in accordance with some embodiments. The centralized control plane architecture 6300 enables unified governance, monitoring, and enforcement across multiple cloud service providers. The control plane 6300 provides a cohesive management and decision-making layer that aggregates telemetry data, enforces one or more policies, and executes one or more provider-agnostic control actions through one or more standardized interfaces. The centralized control plane architecture 6300 ensures consistent budgetary, operational, and compliance oversight across one or more heterogeneous cloud environments while maintaining auditable traceability and enforcement transparency. As shown, the architecture may integrate with multiple cloud providers (6302, 6304, 6306)—for example, Provider A, Provider B, and Provider C, each comprising one or more associated cloud accounts (e.g., A1, A2, B1, B2, C1, etc.). The cloud providers may supply both telemetry data and one or more operational control endpoints to the centralized system through two primary interface categories: one or more telemetry adapters 6308 and one or more control adapters 6310. The one or more telemetry adapters 6308 may be responsible for collecting usage, spend, and event data from each provider's respective APIs, as well as log and performance metrics. The data may be transmitted via read-only telemetry, analytics path (depicted as dashed lines) to one or more internal governance modules, such as the policy store and decision engine 6312 and analytics and reporting user interface 6320. The policy store and decision engine 6312 may contain one or more thresholds, one or more schedules, and one or more guardrails necessary for compliance and operational decision-making. The components collectively analyze incoming telemetry data to detect one or more policy breaches, one or more budget overruns, one or more schedule conflicts, and may initiate corresponding one or more control actions, one or more recommendations. The one or more control adapters 6310 may provide an active control interface to execute one or more provider-agnostic actions such as start, stop, pause, resume, tagging, quota enforcement, or policy application across all integrated cloud accounts. The adapters may interact bidirectionally (depicted by solid control paths) with a central management or gateway account 6314. The central management account 6314 serves as the orchestration hub of the control plane, translating provider-agnostic control intents from the policy engine into provider-specific API calls while ensuring secure and consistent execution. An identity, delegation of authority (DoA), and approval service 6316 may be integrated with the gateway account to authenticate one or more actors, manage one or more workflows, and ensure compliance with one or more delegated authorization hierarchies. The delegation of authority (DoA) and approval service 6316 enables structured access control, approval routing, and conditional override validation for administrative actions initiated within the system. The central management account 6314 may communicate with an event bus and audit bus 6318, which serve as the backbone for both real-time event propagation and continuous audit logging. The event bus and audit bus 6318 may capture data from both telemetry and control paths, ensuring that every event, command, or decision is recorded with full fidelity for traceability and post-action analysis. An enforcement layer 6322 may operate downstream of the decision engine to execute preventive, freeze, or exception-window controls based on the active policy state. The enforcement layer 6322 enforces operational compliance in real time, ensuring that no unauthorized or non-compliant actions are performed. The enforcement layer 6322 may interact with both the gateway account 6314 and the audit log and evidence store 6324 to record one or more enforcement outcomes and preserve immutable evidence of all control decisions, including one or more timestamps, one or more policy references, and one or more action identifiers. Simultaneously, all processed data, including performance summaries and compliance analytics, may be transmitted to an analytics and reporting user interface 6320. The analytics and reporting user interface 6320 may provide one or more administrators and one or more auditors with one or more real-time dashboards, one or more budget utilization charts, one or more forecast variance reports, and one or more policy compliance visualizations. Throughout the control plane architecture 6300, one or more solid lines represent one or more control and action paths associated with active management and enforcement, while one or more dashed lines represent read-only telemetry and one or more analytics flows used for monitoring, evaluation, and reporting. Collectively, the centralized control plane 6300 establishes a unified governance model that integrates multi-provider telemetry, policy decision-making, and enforcement under a single management umbrella. By combining policy-driven automation with identity-based authorization and continuous audit logging, the architecture provides a secure, transparent, and provider-agnostic framework for cloud governance and operational accountability.

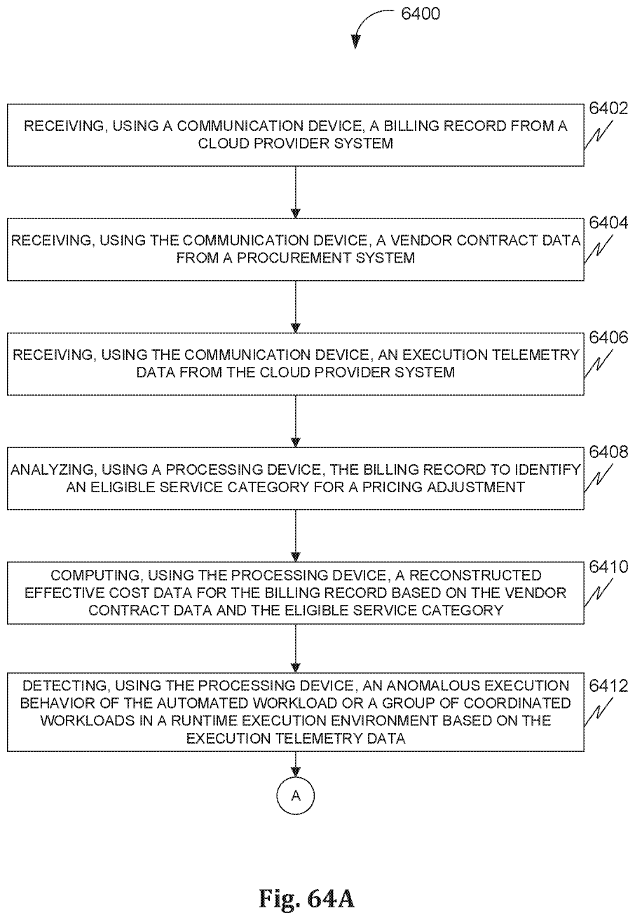

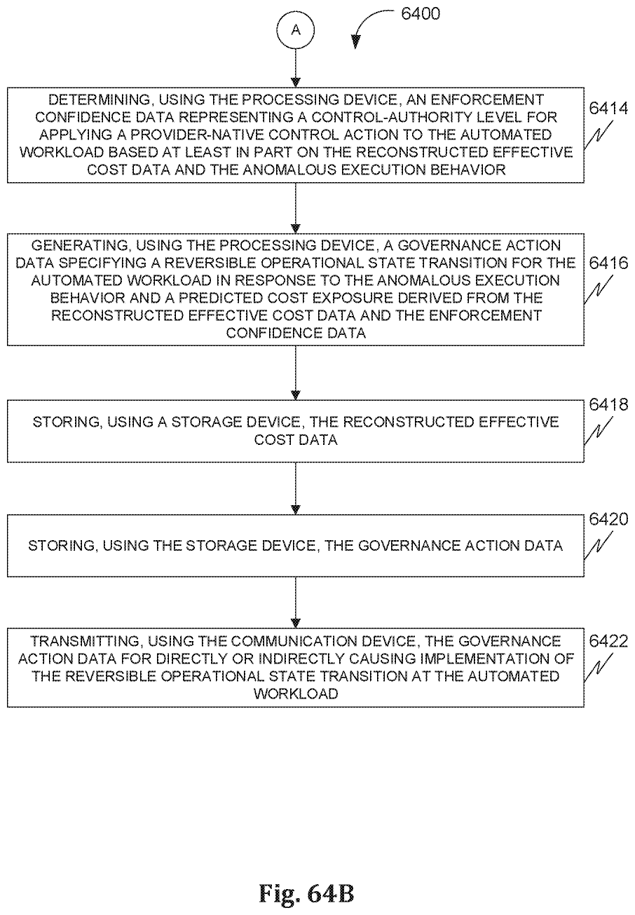

FIG. 64A and FIG. 64B illustrate a flowchart of a method 6400 of facilitating multi-cloud financial and execution governance of an automated workload, in accordance with some embodiments. Accordingly, the method 6400 may include a step 6402 of receiving, using a communication device 7402, a billing record from a cloud provider system. Further, the method 6400 may include a step 6404 of receiving, using the communication device 7402, a vendor contract data from a procurement system. Further, the method 6400 may include a step 6406 of receiving, using the communication device 7402, an execution telemetry data from the cloud provider system. Further, the method 6400 may include a step 6408 of analyzing, using a processing device 7404, the billing record to identify an eligible service category for a pricing adjustment. Further, the method 6400 may include a step 6410 of computing, using the processing device 7404, a reconstructed effective cost data for the billing record based on the vendor contract data and the eligible service category. Further, the method 6400 may include a step 6412 of detecting, using the processing device 7404, an anomalous execution behavior of the automated workload based on the execution telemetry data. Further, the method 6400 may include a step 6414 of determining, using the processing device 7404, an enforcement confidence data representing a control-authority level for applying a provider-native control action to the automated workload. Further, the method 6400 may include a step 6416 of generating, using the processing device 7404, a governance action data specifying a reversible operational state transition for the automated workload based on the anomalous execution behavior and the enforcement confidence data. Further, the method 6400 may include a step 6418 of storing, using a storage device 7406, the reconstructed effective cost data. Further, the method 6400 may include a step 6420 of storing, using the storage device 7406, the governance action data. Further, the method 6400 may include a step 6422 of transmitting, using the communication device 7402, the governance action data to a client device.

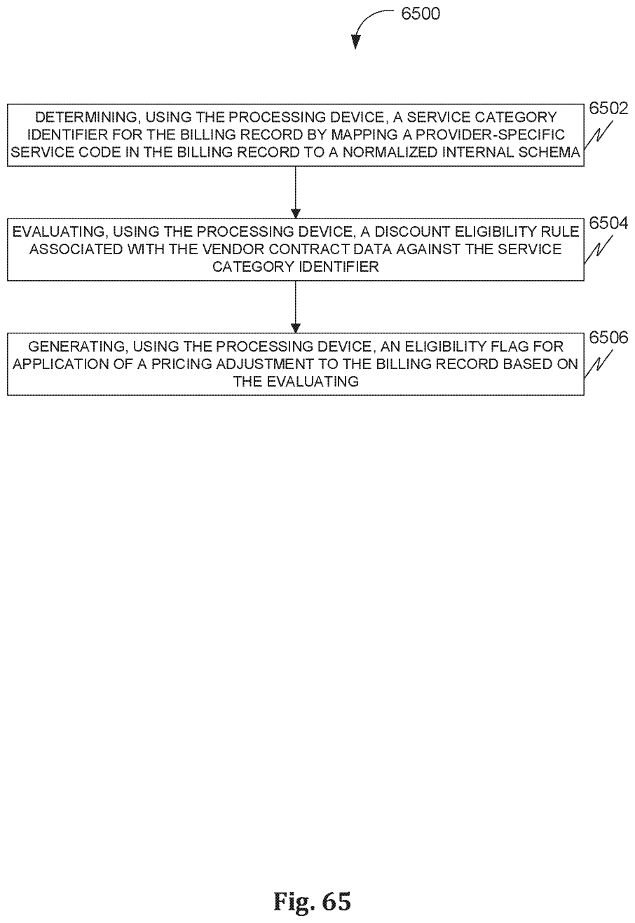

FIG. 65 illustrates a flowchart of a method 6500 of facilitating multi-cloud financial and execution governance of an automated workload including generating, using the processing device 7404, an eligibility flag for application of a pricing adjustment to the billing record, in accordance with some embodiments. Further, in some embodiments, the method 6500, further may include a step 6502 of determining, using the processing device 7404, a service category identifier for the billing record by mapping a provider-specific service code in the billing record to a normalized internal schema. Further, in some embodiments, the method 6500, further may include a step 6504 of evaluating, using the processing device 7404, a discount eligibility rule associated with the vendor contract data against the service category identifier. Further, in some embodiments, the method 6500, further may include a step 6506 of generating, using the processing device 7404, an eligibility flag for application of a pricing adjustment to the billing record based on the evaluating.

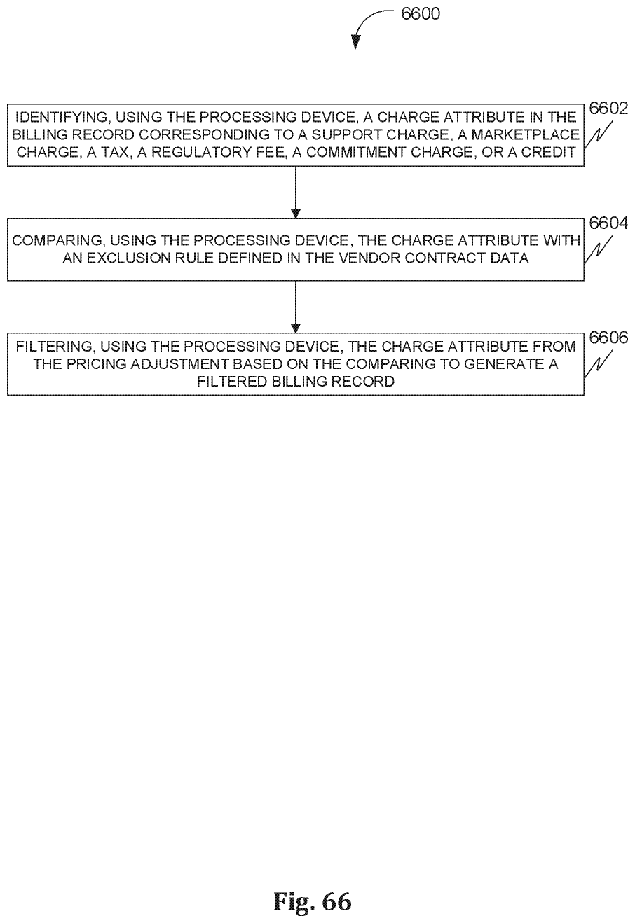

FIG. 66 illustrates a flowchart of a method 6600 of facilitating multi-cloud financial and execution governance of an automated workload including filtering, using the processing device 7404, the charge attribute from the pricing adjustment, in accordance with some embodiments. Further, in some embodiments, the method 6600, further may include a step 6602 of identifying, using the processing device 7404, a charge attribute in the billing record corresponding to a support charge, a marketplace charge, a tax, a regulatory fee, a commitment charge, or a credit. Further, in some embodiments, the method 6600, further may include a step 6604 of comparing, using the processing device 7404, the charge attribute with an exclusion rule defined in the vendor contract data. Further, in some embodiments, the method 6600, further may include a step 6606 of filtering, using the processing device 7404, the charge attribute from the pricing adjustment based on the comparing to generate a filtered billing record.

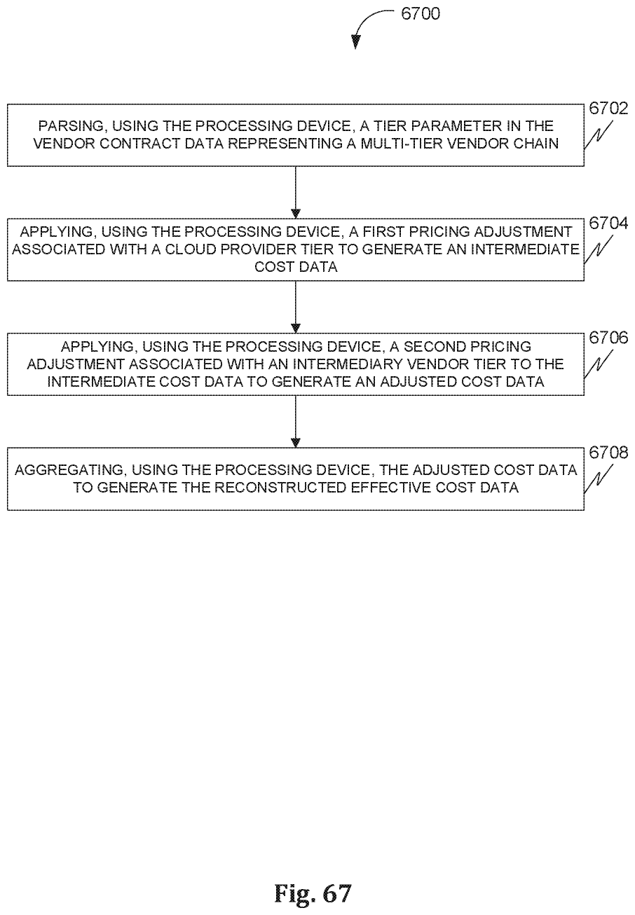

FIG. 67 illustrates a flowchart of a method 6700 of facilitating multi-cloud financial and execution governance of an automated workload including aggregating, using the processing device 7404, the adjusted cost data to generate the reconstructed effective cost data, in accordance with some embodiments. Further, in some embodiments, the computing of the reconstructed effective cost data further may include a step 6702 of parsing, using the processing device 7404, a tier parameter in the vendor contract data representing a multi-tier vendor chain. Further, the computing of the reconstructed effective cost data further may include a step 6704 of applying, using the processing device 7404, a first pricing adjustment associated with a cloud provider tier to generate an intermediate cost data. Further, the computing of the reconstructed effective cost data further may include a step 6706 of applying, using the processing device 7404, a second pricing adjustment associated with an intermediary vendor tier to the intermediate cost data to generate an adjusted cost data. Further, the computing of the reconstructed effective cost data further may include a step 6708 of aggregating, using the processing device 7404, the adjusted cost data to generate the reconstructed effective cost data.

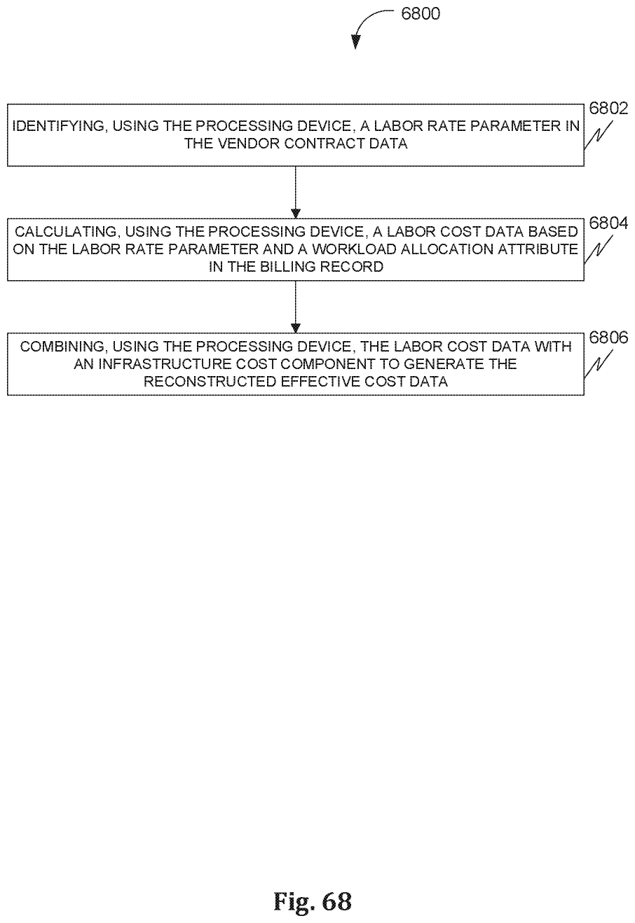

FIG. 68 illustrates a flowchart of a method 6800 of facilitating multi-cloud financial and execution governance of an automated workload including combining, using the processing device 7404, the labor cost data with an infrastructure cost component to generate the reconstructed effective cost data, in accordance with some embodiments. Further, in some embodiments, the computing of the reconstructed effective cost data further may include a step 6802 of identifying, using the processing device 7404, a labor rate parameter in the vendor contract data. Further, the computing of the reconstructed effective cost data further may include a step 6804 of calculating, using the processing device 7404, a labor cost data based on the labor rate parameter and a workload allocation attribute in the billing record. Further, the computing of the reconstructed effective cost data further may include a step 6806 of combining, using the processing device 7404, the labor cost data with an infrastructure cost component to generate the reconstructed effective cost data.

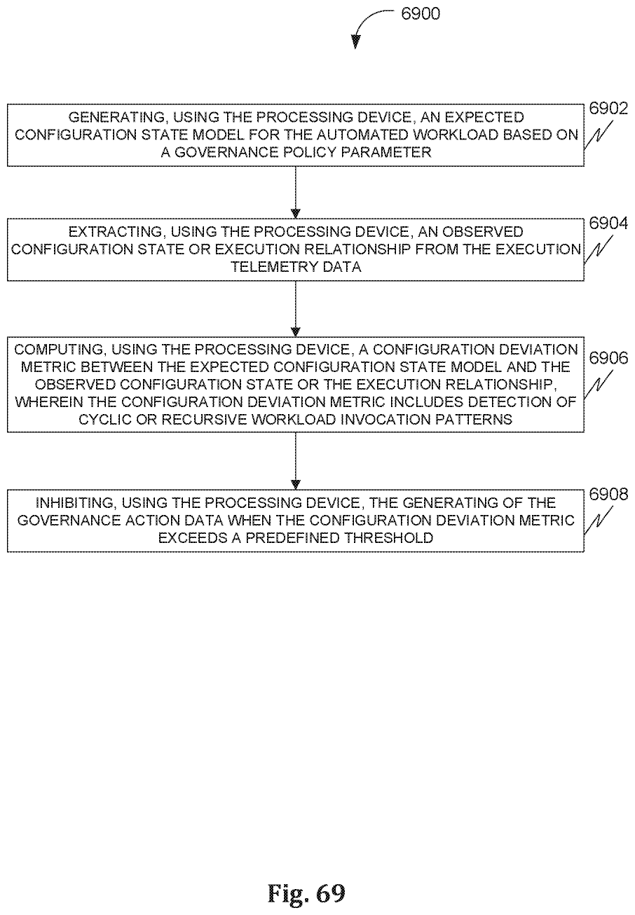

FIG. 69 illustrates a flowchart of a method 6900 of facilitating multi-cloud financial and execution governance of an automated workload including inhibiting, using the processing device 7404, the generating of the governance action data when the configuration deviation metric exceeds a predefined threshold, in accordance with some embodiments. Further, in some embodiments, the method 6900, further may include a step 6902 of generating, using the processing device 7404, an expected configuration state model for the automated workload based on a governance policy parameter. Further, in some embodiments, the method 6900, further may include a step 6904 of extracting, using the processing device 7404, an observed configuration state from the execution telemetry data. Further, in some embodiments, the method 6900, further may include a step 6906 of computing, using the processing device 7404, a configuration deviation metric between the expected configuration state model and the observed configuration state. Further, in some embodiments, the method 6900, further may include a step 6908 of inhibiting, using the processing device 7404, the generating of the governance action data when the configuration deviation metric exceeds a predefined threshold.

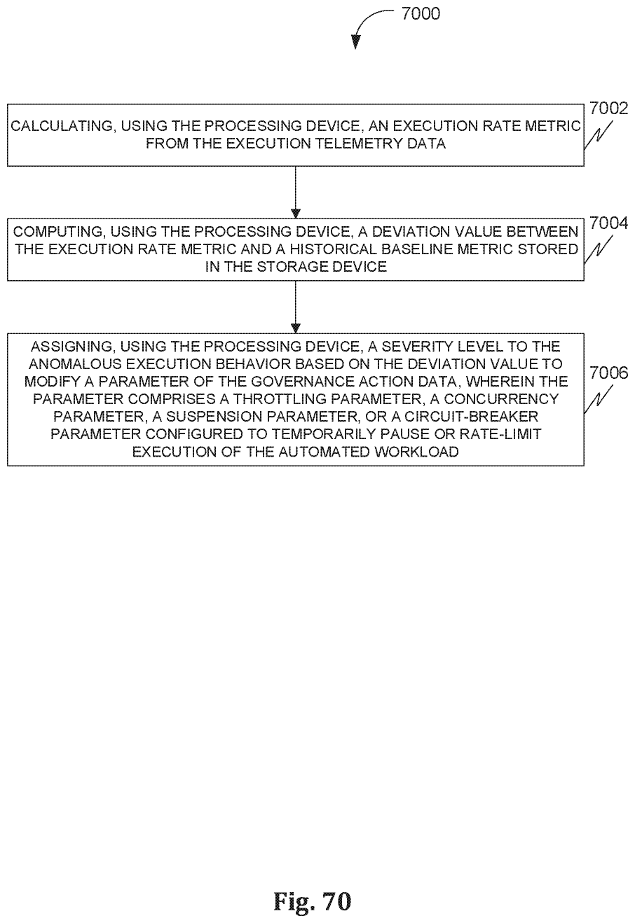

FIG. 70 illustrates a flowchart of a method 7000 of facilitating multi-cloud financial and execution governance of an automated workload including assigning, using the processing device 7404, a severity level to the anomalous execution behavior, in accordance with some embodiments. Further, in some embodiments, the method 7000, further may include a step 7002 of calculating, using the processing device 7404, an execution rate metric from the execution telemetry data. Further, in some embodiments, the method 7000, further may include a step 7004 of computing, using the processing device 7404, a deviation value between the execution rate metric and a historical baseline metric stored in the storage device 7406. Further, in some embodiments, the method 7000, further may include a step 7006 of assigning, using the processing device 7404, a severity level to the anomalous execution behavior based on the deviation value to modify a parameter of the governance action data.

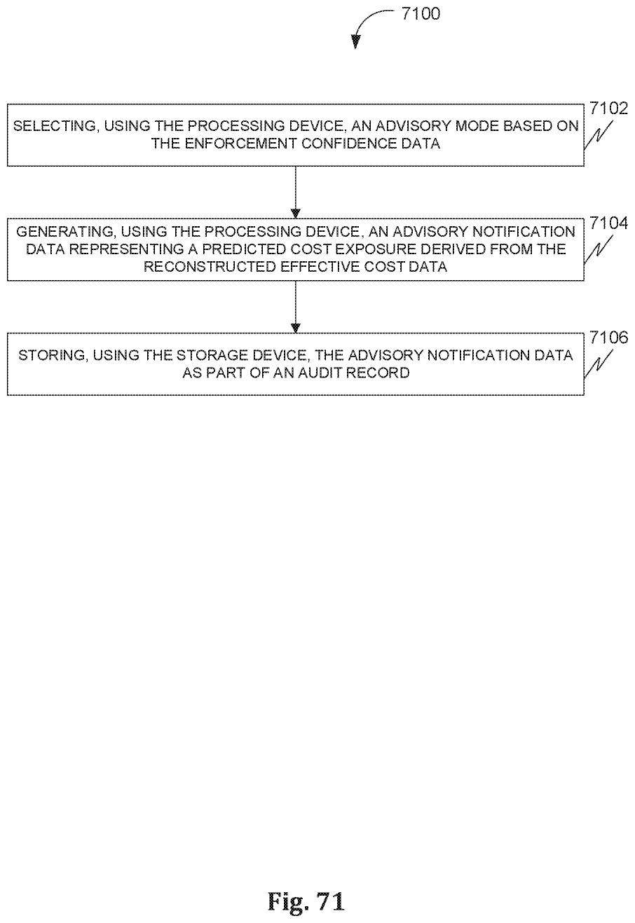

FIG. 71 illustrates a flowchart of a method 7100 of facilitating multi-cloud financial and execution governance of an automated workload including generating, using the processing device 7404, an advisory notification data representing a predicted cost exposure derived from the reconstructed effective cost data, in accordance with some embodiments. Further, in some embodiments, the generating of the governance action data further may include a step 7102 of selecting, using the processing device 7404, an advisory mode based on the enforcement confidence data. Further, the generating of the governance action data further may include a step 7104 of generating, using the processing device 7404, an advisory notification data representing a predicted cost exposure derived from the reconstructed effective cost data. Further, the generating of the governance action data further may include a step 7106 of storing, using the storage device 7406, the advisory notification data as part of an audit record.

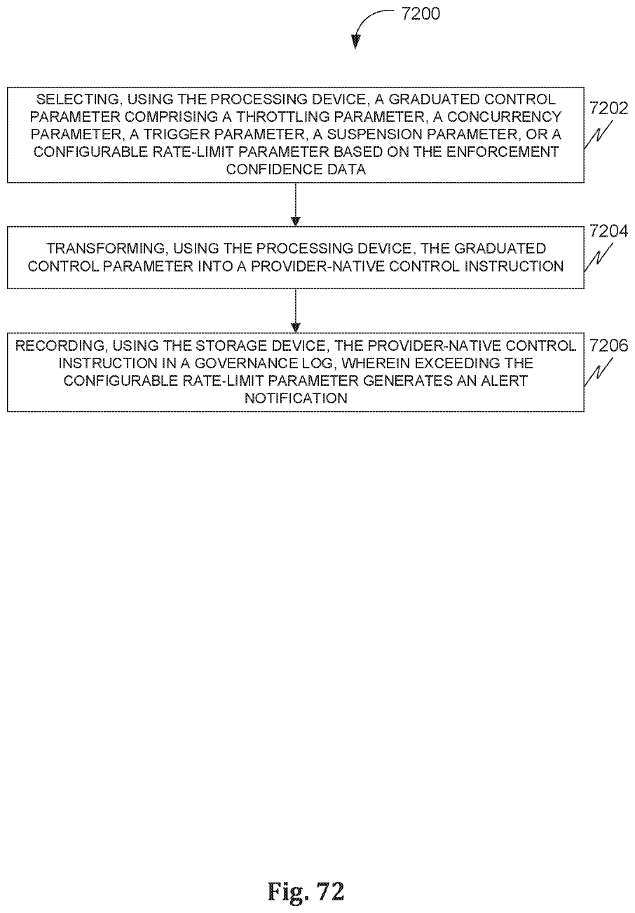

FIG. 72 illustrates a flowchart of a method 7200 of facilitating multi-cloud financial and execution governance of an automated workload including recording, using the storage device 7406, the provider-native control instruction in a governance log, in accordance with some embodiments. Further, in some embodiments, the generating of the governance action data further may include a step 7202 of selecting, using the processing device 7404, a graduated control parameter comprising a throttling parameter, a concurrency parameter, a trigger parameter, or a suspension parameter based on the enforcement confidence data. Further, the generating of the governance action data further may include a step 7204 of transforming, using the processing device 7404, the graduated control parameter into a provider-native control instruction. Further, the generating of the governance action data further may include a step 7206 of recording, using the storage device 7406, the provider-native control instruction in a governance log.

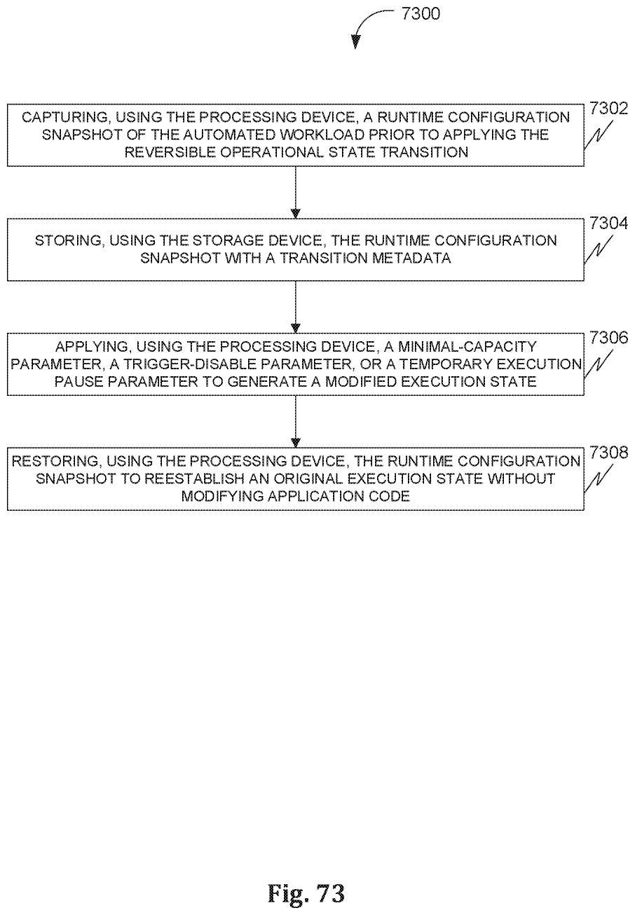

FIG. 73 illustrates a flowchart of a method 7300 of facilitating multi-cloud financial and execution governance of an automated workload including restoring, using the processing device 7404, the runtime configuration snapshot to reestablish an original execution state without modifying application code, in accordance with some embodiments. Further, in some embodiments, the reversible operational state transition further may include a step 7302 of capturing, using the processing device 7404, a runtime configuration snapshot of the automated workload prior to applying the reversible operational state transition. Further, the reversible operational state transition further may include a step 7304 of storing, using the storage device 7406, the runtime configuration snapshot with a transition metadata. Further, the reversible operational state transition further may include a step 7306 of applying, using the processing device 7404, a minimal-capacity parameter or a trigger-disable parameter to generate a modified execution state. Further, the reversible operational state transition further may include a step 7308 of restoring, using the processing device 7404, the runtime configuration snapshot to reestablish an original execution state without modifying application code.

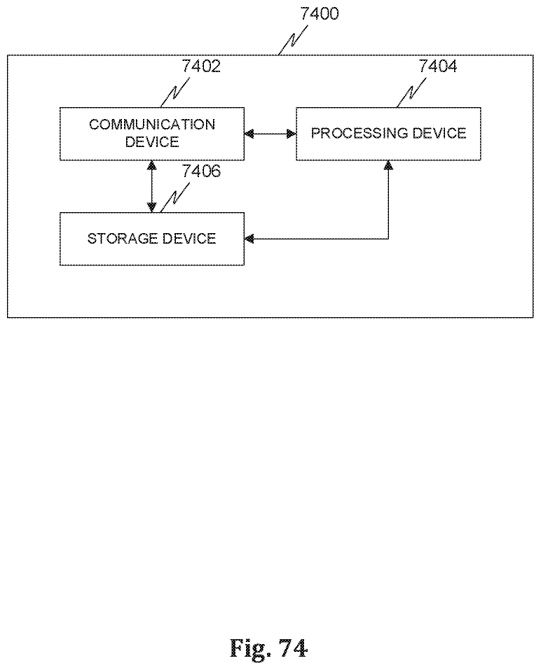

FIG. 74 illustrates a block diagram of a system 7400 of facilitating multi-cloud financial and execution governance of an automated workload, in accordance with some embodiments. Accordingly, the system 7400 may include a communication device 7402. Further, the communication device 7402 may be configured for receiving a billing record from a cloud provider system. Further, the communication device 7402 may be configured for receiving a vendor contract data from a procurement system. Further, the communication device 7402 may be configured for receiving an execution telemetry data from the cloud provider system. Further, the communication device 7402 may be configured for transmitting a governance action data to a client device. Further, the system 7400 may include a processing device 7404. Further, the processing device 7404 may be configured for analyzing the billing record to identify an eligible service category for a pricing adjustment. Further, the processing device 7404 may be configured for computing a reconstructed effective cost data for the billing record based on the vendor contract data and the eligible service category. Further, the processing device 7404 may be configured for detecting an anomalous execution behavior of the automated workload based on the execution telemetry data. Further, the processing device 7404 may be configured for determining an enforcement confidence data representing a control-authority level for applying a provider-native control action to the automated workload. Further, the processing device 7404 may be configured for generating the governance action data specifying a reversible operational state transition for the automated workload based on the anomalous execution behavior and the enforcement confidence data. Further, the system 7400 may include a storage device 7406 which may be configured for storing the reconstructed effective cost data and the governance action data.

Further, in some embodiments, the processing device 7404 may be further configured for determining a service category identifier for the billing record by mapping a provider-specific service code in the billing record to a normalized internal schema. Further, the processing device 7404 may be further configured for evaluating a discount eligibility rule associated with the vendor contract data against the service category identifier. Further, the processing device 7404 may be further configured for generating an eligibility flag for application of a pricing adjustment to the billing record based on the evaluating.

Further, in some embodiments, the processing device 7404 may be further configured for identifying a charge attribute in the billing record corresponding to a support charge, a marketplace charge, a tax, a regulatory fee, a commitment charge, or a credit. Further, the processing device 7404 may be further configured for comparing the charge attribute with an exclusion rule defined in the vendor contract data. Further, the processing device 7404 may be further configured for filtering the charge attribute from the pricing adjustment based on the comparing to generate a filtered billing record.

Further, in some embodiments, the processing device 7404 may be further configured for parsing a tier parameter in the vendor contract data representing a multi-tier vendor chain. Further, the processing device 7404 may be further configured for applying a first pricing adjustment associated with a cloud provider tier to generate an intermediate cost data. Further, the processing device 7404 may be further configured for applying a second pricing adjustment associated with an intermediary vendor tier to the intermediate cost data to generate an adjusted cost data. Further, the processing device 7404 may be further configured for aggregating the adjusted cost data to generate the reconstructed effective cost data.

Further, in some embodiments, the processing device 7404 may be further configured for identifying a labor rate parameter in the vendor contract data. Further, the processing device 7404 may be further configured for calculating a labor cost data based on the labor rate parameter and a workload allocation attribute in the billing record. Further, the processing device 7404 may be further configured for combining the labor cost data with an infrastructure cost component to generate the reconstructed effective cost data.

Further, in some embodiments, the processing device 7404 may be further configured for generating an expected configuration state model for the automated workload based on a governance policy parameter. Further, the processing device 7404 may be further configured for extracting an observed configuration state from the execution telemetry data. Further, the processing device 7404 may be further configured for computing a configuration deviation metric between the expected configuration state model and the observed configuration state. Further, the processing device 7404 may be further configured for inhibiting the generating of the governance action data when the configuration deviation metric exceeds a predefined threshold.

Further, in some embodiments, the processing device 7404 may be further configured for calculating an execution rate metric from the execution telemetry data. Further, the processing device 7404 may be further configured for computing a deviation value between the execution rate metric and a historical baseline metric stored in the storage device 7406. Further, the processing device 7404 may be further configured for assigning a severity level to the anomalous execution behavior based on the deviation value to modify a parameter of the governance action data.

Further, in some embodiments, the processing device 7404 may be further configured for selecting an advisory mode based on the enforcement confidence data. Further, the processing device 7404 may be further configured for generating an advisory notification data representing a predicted cost exposure derived from the reconstructed effective cost data. Further, the processing device 7404 may be further configured for the storage device 7406 may be further configured for storing the advisory notification data as part of an audit record.

Further, in some embodiments, the processing device 7404 may be further configured for selecting a graduated control parameter comprising a throttling parameter, a concurrency parameter, a trigger parameter, or a suspension parameter based on the enforcement confidence data. Further, the processing device 7404 may be further configured for transforming the graduated control parameter into a provider-native control instruction. Further, the processing device 7404 may be further configured for the storage device 7406 which may be further configured for recording the provider-native control instruction in a governance log.

Further, in some embodiments, the processing device 7404 may be further configured for identifying a workload identifier associated with the automated workload. Further, the processing device 7404 may be further configured for mapping the workload identifier to a cross-cloud group identifier independent of a deployment account or runtime substrate. Further, the processing device 7404 may be further configured for applying a shared governance policy parameter to the cross-cloud group identifier to coordinate the generating of the governance action data.

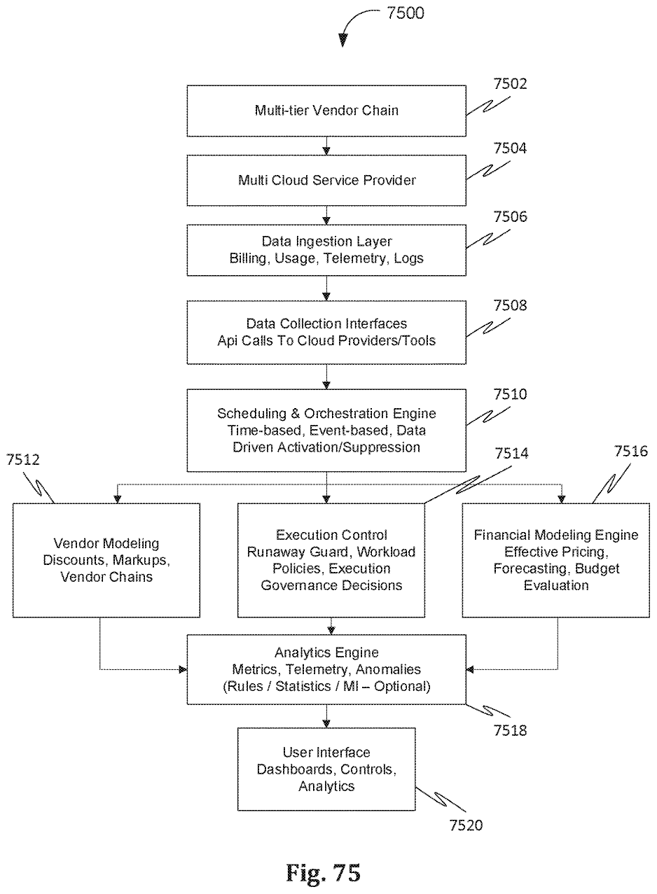

FIG. 75 illustrates an example integrated architecture 7500 of a multi-cloud financial and execution governance system in which procurement-layer vendor modeling, execution-layer governance, financial modeling, analytics, and user interaction components operate in a coordinated framework, in accordance with some embodiments. Further, at the top of the figure, a multi-tier vendor chain 7502 is shown. In some embodiments, the multi-tier vendor chain 7502 may represent a procurement structure comprising a cloud service provider and one or more intermediary entities such as a distributor, a reseller, an integrator, or a managed service provider. The multi-tier vendor chain 7502 may define discount structures, markup policies, contractual terms, labor-related components, and pricing eligibility constraints that influence downstream financial modeling and governance decisions.

Below the multi-tier vendor chain 7502, a multi-cloud service provider environment 7504 is illustrated. In some embodiments, the multi-cloud service provider environment 7504 may include one or more heterogeneous cloud platforms providing compute, storage, database, networking, analytics, or managed execution services. The multi-cloud service provider environment 7504 may generate billing data, usage data, execution telemetry, configuration metadata, and event signals associated with automated workloads.

A data ingestion layer 7506 is shown beneath the multi-cloud service provider environment 7504. In some embodiments, the data ingestion layer 7506 may be configured to receive billing records, usage metrics, telemetry streams, configuration state information, and log data from the multi-cloud service provider environment 7504 and from procurement-related systems associated with the multi-tier vendor chain 7502. The data ingestion layer 7506 may normalize heterogeneous provider-specific formats into a unified internal representation suitable for downstream analysis.

A data collection interface 7508 is illustrated below the data ingestion layer 7506. In some embodiments, the data collection interface 7508 may include application programming interface (API) connectors, secure communication endpoints, credential management components, and integration adapters configured to retrieve data from cloud provider control planes, monitoring systems, and vendor management tools. The data collection interface 7508 may support periodic polling, event-driven subscription, or scheduled synchronization.

A scheduling and orchestration engine 7510 is shown beneath the data collection interface 7508. In some embodiments, the scheduling and orchestration engine 7510 may coordinate time-based, event-based, or data-driven activation and suppression of workload governance processes. The scheduling and orchestration engine 7510 may initiate evaluation cycles for financial modeling, anomaly detection, and governance action generation based on configurable triggers, including threshold events, billing cycle boundaries, telemetry anomalies, or manual policy invocation.

From the scheduling and orchestration engine 7510, the architecture branches into three coordinated subsystems.

A vendor modeling module 7512 is illustrated on a first branch. In some embodiments, the vendor modeling module 7512 may process vendor-chain metadata, discount eligibility rules, markup structures, contract parameters, and labor overlays defined in the multi-tier vendor chain 7502. The vendor modeling module 7512 may compute effective pricing across multiple tiers, apply category-based exclusion rules, and generate reconstructed effective cost data for use by other system components.

An execution control module 7514 is illustrated on a second branch. In some embodiments, the execution control module 7514 may implement workload governance logic including runaway detection, workload policy evaluation, enforcement-confidence assessment, and selection of graduated governance responses. The execution control module 7514 may evaluate execution telemetry derived from automated workload activity and may generate advisory signals or provider-native control instructions to regulate execution behavior.

A financial modeling engine 7516 is illustrated on a third branch. In some embodiments, the financial modeling engine 7516 may use reconstructed effective cost data produced by the vendor modeling module 7512 to perform effective pricing analysis, forecasting, budget evaluation, and scenario modeling. The financial modeling engine 7516 may generate projections based on historical consumption patterns, vendor contract parameters, and workload growth assumptions.

An analytics engine 7518 is shown receiving input from the vendor modeling module 7512, the execution control module 7514, and the financial modeling engine 7516. In some embodiments, the analytics engine 7518 may compute metrics, derive anomaly indicators, evaluate statistical patterns, and optionally apply machine learning models to assist in classification, prioritization, and decision support. The analytics engine 7518 may process telemetry signals, reconstructed effective cost data, and governance state information to produce composite evaluation outputs.

A user interface 7520 is illustrated beneath the analytics engine 7518. In some embodiments, the user interface 7520 may present dashboards, configuration controls, governance state indicators, audit logs, cost analytics, and enforcement summaries to an operator. The user interface 7520 may enable review of workload state, vendor-chain economics, effective pricing projections, and governance action history while interacting with underlying modules through defined system interfaces.

In some embodiments, the architecture depicted in FIG. 75 may support independent operation of the vendor modeling module 7512, the execution control module 7514, and the financial modeling engine 7516. In some embodiments, the architecture may also support coordinated operation in which reconstructed effective cost data influences execution governance decisions and in which execution-layer signals influence financial forecasting and budget evaluation. The scheduling and orchestration engine 7510 may manage evaluation timing across all subsystems to enable continuous, periodic, or event-driven governance in a unified multi-cloud control framework.

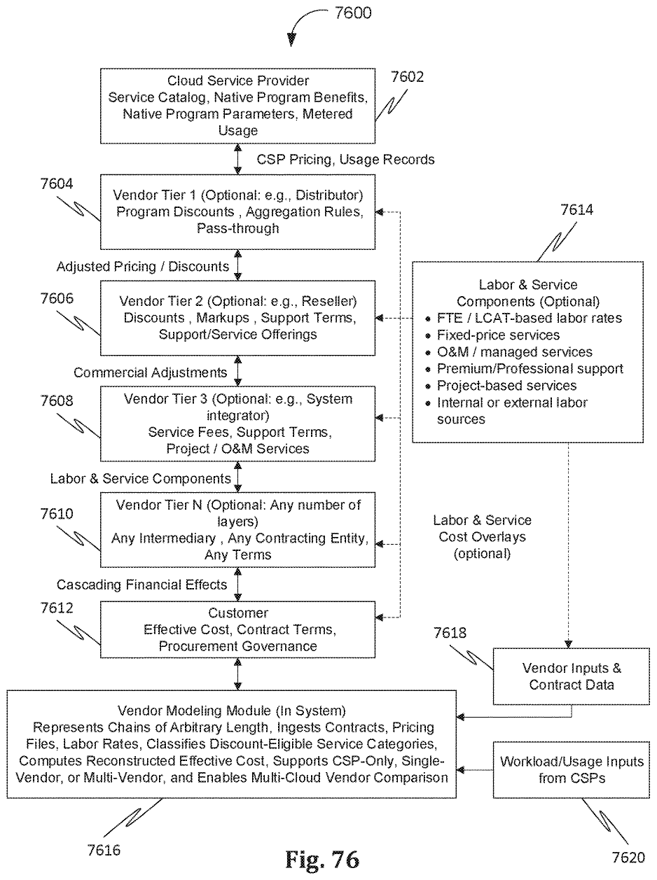

FIG. 76 illustrates an example vendor-chain representation and associated cost reconstruction workflow 7600 in which a cloud service provider and one or more optional intermediary vendor tiers contribute pricing adjustments, commercial terms, and optional labor or service overlays that collectively influence effective cost and procurement governance, in accordance with some embodiments. Further, at the top of the figure, a cloud service provider 7602 is shown. In some embodiments, the cloud service provider 7602 may provide a service catalog, native program benefits, native program parameters, and metered usage associated with cloud resource consumption. The cloud service provider 7602 may generate provider-native pricing data and usage records, which may include service identifiers, usage metrics, region attributes, discount program indicators, and billing line items.

Beneath the cloud service provider 7602, a first intermediary vendor tier 7604 is illustrated. In some embodiments, the first intermediary vendor tier 7604 may represent an optional distributor entity that applies program discounts, aggregation rules, pass-through pricing conditions, or other commercial constructs to provider-native pricing and usage records. The first intermediary vendor tier 7604 may generate adjusted pricing data reflecting tier-specific discount structures and aggregation logic applied to eligible service categories.

Below the first intermediary vendor tier 7604, a second intermediary vendor tier 7606 is shown. In some embodiments, the second intermediary vendor tier 7606 may represent an optional reseller entity that applies additional discounts, markups, support terms, or bundled service offerings. The second intermediary vendor tier 7606 may introduce commercial adjustments that modify upstream pricing outputs and may incorporate reseller-specific pricing constructs such as percentage-based markups, fixed-fee components, or conditional discounts tied to contractual commitments.

Beneath the second intermediary vendor tier 7606, a third intermediary vendor tier 7608 is illustrated. In some embodiments, the third intermediary vendor tier 7608 may represent an optional system integrator or managed service provider that applies service fees, project-based pricing, operational support terms, or operations and maintenance services. The third intermediary vendor tier 7608 may introduce additional labor or service-related components that affect the total effective cost of cloud consumption.

Further below, a generalized vendor tier N 7610 is shown. In some embodiments, the vendor tier N 7610 may represent any number of additional intermediary layers, contracting entities, aggregators, subcontractors, or commercial participants that may be included in a procurement chain of arbitrary length. Each such tier may introduce cascading financial effects, including incremental discount adjustments, markup overlays, fee schedules, or contract-specific pricing conditions.

Beneath the vendor tier N 7610, a customer layer 7612 is illustrated. In some embodiments, the customer layer 7612 may represent an end consumer of cloud resources and may receive effective cost outputs that reflect aggregated adjustments from all upstream tiers. The customer layer 7612 may evaluate contract terms, pricing conditions, and procurement governance parameters based on reconstructed effective cost data derived from the entire vendor chain.

To the right of the intermediary tiers, a labor and service components module 7614 is shown. In some embodiments, the labor and service components module 7614 may include optional fully burdened full-time equivalent (FTE) or labor category (LCAT)-based labor rates, fixed-price services, operations and maintenance services, premium or professional support offerings, project-based services, or labor sourced from internal or external entities. The labor and service components module 7614 may provide labor and service cost overlays that may be associated with one or more intermediary vendor tiers 7604, 7606, 7608, or 7610. In some embodiments, such labor and service cost overlays may be applied selectively based on contract scope, service category, time period, or workload allocation.

At the bottom of the figure, a vendor modeling module 7616 is illustrated within the system. In some embodiments, the vendor modeling module 7616 may represent chains of arbitrary length corresponding to the cloud service provider 7602 and intermediary vendor tiers 7604, 7606, 7608, and 7610. The vendor modeling module 7616 may ingest contract documents, pricing files, labor rate schedules, and vendor-specific pricing parameters. The vendor modeling module 7616 may classify discount-eligible service categories by analyzing provider-native billing records and may exclude non-eligible categories such as support plans, marketplace transactions, credits, taxes, or regulatory fees according to contractual eligibility rules. The vendor modeling module 7616 may compute reconstructed effective cost by applying cascading discount structures, markup policies, pass-through rules, and labor overlays across each tier in the vendor chain.

To the right of the vendor modeling module 7616, vendor inputs and contract data 7618 are shown. In some embodiments, the vendor inputs and contract data 7618 may include negotiated discount parameters, program eligibility definitions, rate cards, markup structures, service-level agreements, contract terms, renewal schedules, and labor rate tables. The vendor inputs and contract data 7618 may be ingested by the vendor modeling module 7616 to define tier-specific pricing behavior.

Also to the right, workload or usage inputs from cloud service providers 7620 are illustrated. In some embodiments, the workload or usage inputs from cloud service providers 7620 may include detailed billing line items, usage metrics, resource identifiers, and metered consumption records corresponding to the cloud service provider 7602. These workload or usage inputs may be used by the vendor modeling module 7616 to determine eligible service categories and to apply vendor-tier adjustments in computing reconstructed effective cost.

In some embodiments, the cascading financial effects introduced by intermediary vendor tiers 7604, 7606, 7608, and 7610 may be modeled sequentially by the vendor modeling module 7616, such that adjusted pricing output from one tier becomes input to the next tier. In some embodiments, labor and service cost overlays from the labor and service components module 7614 may be applied at any tier and may be represented as additive, percentage-based, time-based, or allocation-based components. In some embodiments, the vendor modeling module 7616 may support scenarios including cloud-service-provider-only procurement, single-vendor arrangements, or multi-vendor chains, and may enable multi-cloud vendor comparison by generating normalized reconstructed effective cost outputs across heterogeneous provider environments.

In some embodiments, FIG. 76 illustrates that the vendor modeling module 7616 may operate as a procurement-governance engine that reconstructs effective cost independent of provider-native billing presentation and independent of vendor-chain complexity. The representation in FIG. 76 demonstrates how multi-tier pricing adjustments, contractual conditions, and optional labor overlays may be integrated into a unified cost computation framework that supports procurement governance across single-vendor or multi-vendor cloud environments.

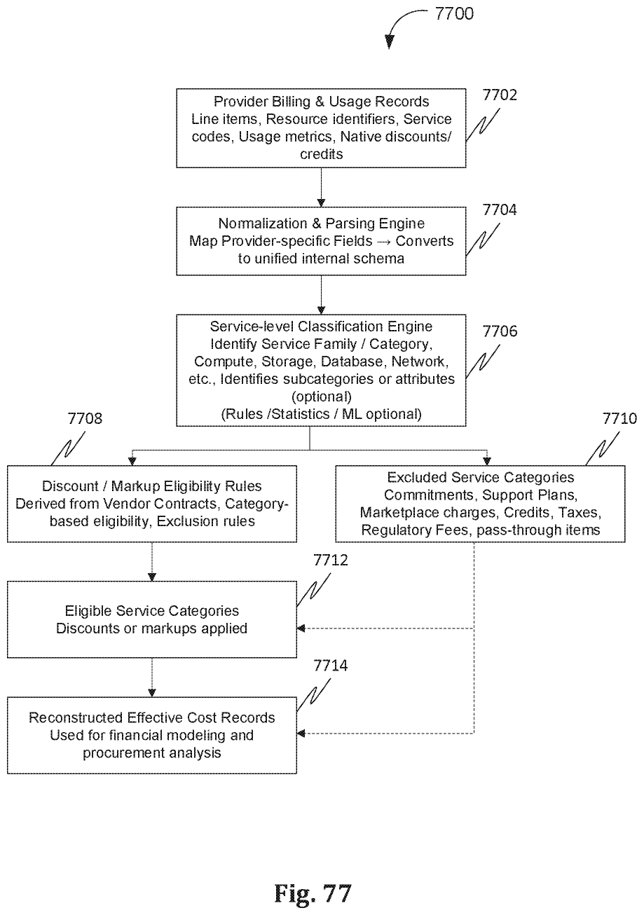

FIG. 77 illustrates an example service-level classification and discount eligibility workflow 7700 for reconstructing effective cost records from provider billing and usage data, in accordance with some embodiments. Further, the workflow of FIG. 77 demonstrates how provider billing records may be normalized into a unified internal representation, classified into service categories, evaluated against discount or markup eligibility rules derived from vendor contracts, and processed to exclude non-eligible categories, thereby generating reconstructed effective cost records suitable for downstream financial modeling and procurement analysis.

At the top of FIG. 77, provider billing and usage records 7702 are illustrated. In some embodiments, the provider billing and usage records 7702 may include billing line items, resource identifiers, service codes, usage metrics, region identifiers, account identifiers, usage time windows, and provider-native discounts or credits. In some embodiments, the provider billing and usage records 7702 may be retrieved from a cloud provider billing API, a usage export feed, a cost and usage report dataset, or an internal financial reporting interface.

Below, provider billing and usage records 7702, a normalization and parsing engine 7704, are shown. In some embodiments, the normalization and parsing engine 7704 may map provider-specific fields into a unified internal schema. The normalization and parsing engine 7704 may convert heterogeneous billing formats into standardized attributes such as service category identifier, charge type identifier, usage quantity, unit price, billing period, resource tag, and provider discount indicator. In some embodiments, the normalization and parsing engine 7704 may resolve differences between provider-specific naming conventions and may standardize resource identity representation across different cloud platforms.

Beneath the normalization and parsing engine 7704, a service-level classification engine 7706 is illustrated. In some embodiments, the service-level classification engine 7706 may identify a service family or category associated with each billing line item. Such categories may include compute, storage, database, network, analytics, logging, identity services, monitoring services, or other cloud service families. In some embodiments, the service-level classification engine 7706 may identify subcategories or service attributes, such as compute family, storage class, network transfer type, or managed service tier. In some embodiments, classification may be performed using deterministic rules derived from service code mappings. In some embodiments, classification may be performed using statistical inference or a machine learning model to resolve ambiguous service codes, normalize unstructured provider descriptors, or infer missing metadata.

From the service-level classification engine 7706, the workflow branches into two parallel evaluation paths.

A discount or markup eligibility rules module 7708 is illustrated on a first branch. In some embodiments, the discount or markup eligibility rules module 7708 may be derived from vendor contracts and may specify category-based eligibility conditions and exclusion rules. Such rules may define which service categories qualify for a vendor-applied discount, which categories are subject to a markup, and which billing attributes are subject to pass-through handling. In some embodiments, the discount or markup eligibility rules module 7708 may include contract-effective dates, tier-specific discount parameters, reseller adjustment policies, and conditional eligibility based on service region, account scope, consumption threshold, or contract term.

An excluded service categories module 7710 is illustrated on a second branch. In some embodiments, the excluded service categories module 7710 may define billing components that are excluded from discount or markup application. Such excluded categories may include commitment charges, support plan charges, marketplace charges, credits, taxes, regulatory fees, and pass-through items. In some embodiments, the excluded service categories module 7710 may specify exclusion conditions that override discount eligibility rules even when a billing record is otherwise associated with a discount-eligible service family.

Below the discount or markup eligibility rules module 7708, an eligible service categories output 7712 is illustrated. In some embodiments, the eligible service categories output 7712 may represent billing line items for which discounts or markups may be applied. In some embodiments, the processing device may generate an eligibility flag for each billing line item based on evaluation of the discount or markup eligibility rules module 7708 and the excluded service categories module 7710. In some embodiments, the eligible service categories output 7712 may represent a filtered dataset of normalized billing line items that remain eligible after exclusion filtering is applied.

In some embodiments, the excluded service categories module 7710 may influence the eligible service categories output 7712 by removing, overriding, or preventing application of discount or markup adjustments to line items that match an exclusion condition. This relationship is illustrated by a dashed linkage from the excluded service categories module 7710 toward the eligible service categories output 7712.

Beneath the eligible service categories output 7712, reconstructed effective cost records 7714 are illustrated. In some embodiments, the reconstructed effective cost records 7714 may be generated by applying vendor-specific discount parameters, markup parameters, pass-through pricing conditions, or tier-specific commercial adjustments to the eligible service categories output 7712. The reconstructed effective cost records 7714 may provide a normalized financial representation of cloud consumption that incorporates vendor contract effects beyond provider-native pricing representation. In some embodiments, the reconstructed effective cost records 7714 may be used for financial modeling, procurement analysis, budget evaluation, forecasting, vendor comparison, or contract performance tracking.

In some embodiments, the excluded service categories module 7710 may also influence the reconstructed effective cost records 7714 by ensuring that excluded charges are represented in the reconstructed effective cost records 7714 without vendor-applied adjustments, or by designating such excluded charges as pass-through cost components. This relationship is illustrated by a dashed linkage from the excluded service categories module 7710 toward the reconstructed effective cost records 7714.

In some embodiments, FIG. 77 illustrates that the system may compute reconstructed effective cost records 7714 by first converting heterogeneous provider billing and usage records 7702 into a normalized schema via the normalization and parsing engine 7704, then classifying service family attributes via the service-level classification engine 7706, then applying vendor contract-derived eligibility evaluation using the discount or markup eligibility rules module 7708 while enforcing exclusion constraints using the excluded service categories module 7710, thereby producing eligible service categories output 7712 that may be adjusted to generate reconstructed effective cost records 7714 suitable for downstream procurement governance and financial analysis.

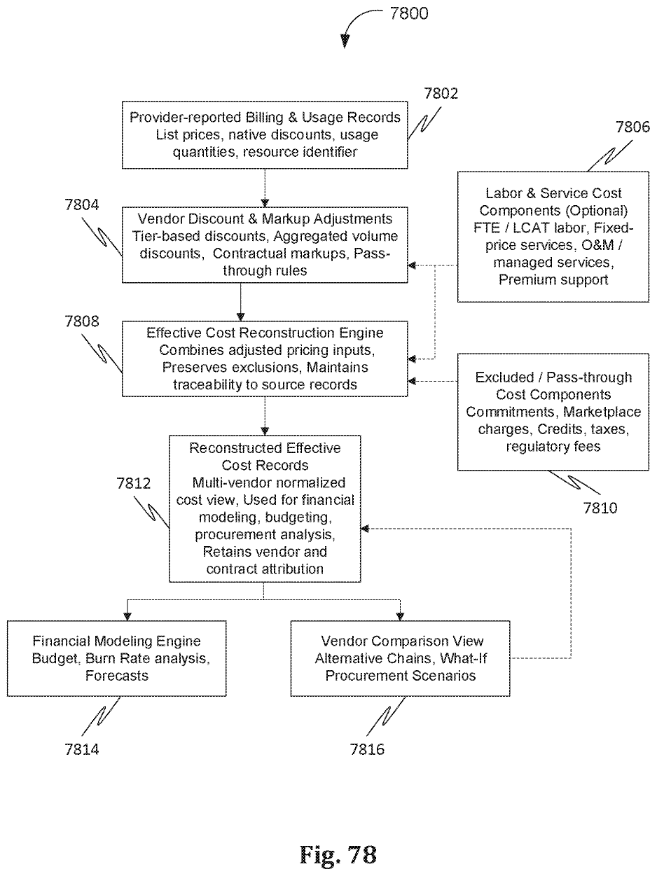

FIG. 78 illustrates an example reconstructed effective cost workflow 7800 in which provider-reported billing and usage records are processed through vendor discount and markup adjustment logic, combined with optional labor and service cost overlays, filtered using excluded or pass-through cost components, and transformed into reconstructed effective cost records that support downstream financial modeling and vendor comparison, in accordance with some embodiments. Further, at the top of FIG. 78, provider-reported billing and usage records 7802 are illustrated. In some embodiments, the provider-reported billing and usage records 7802 may include list price line items, provider-native discounts, usage quantities, and resource identifiers associated with cloud resource consumption. In some embodiments, the provider-reported billing and usage records 7802 may be generated by a cloud provider billing system and may be obtained through billing export datasets, cost and usage reports, usage record feeds, or billing APIs.

Below, provider-reported billing and usage records 7802, vendor discount and markup adjustments 7804 are illustrated. In some embodiments, the vendor discount and markup adjustments 7804 may include tier-based discounts, aggregated volume discounts, contractual markups, pass-through pricing rules, or other vendor-specific commercial adjustments derived from vendor contract data. In some embodiments, the vendor discount and markup adjustments 7804 may be applied to provider-reported billing and usage records 7802 to generate adjusted pricing inputs reflecting negotiated vendor-chain economics. In some embodiments, the vendor discount and markup adjustments 7804 may include multiple sequential pricing adjustment stages corresponding to multiple vendor tiers.

To the right of the vendor discount and markup adjustments 7804, labor and service cost components 7806 are illustrated. In some embodiments, the labor and service cost components 7806 may be optional cost overlays that include fully burdened full-time equivalent (FTE) labor, labor category (LCAT)-based labor, fixed-price services, operations and maintenance services, managed services, or premium support offerings. In some embodiments, the labor and service cost components 7806 may be associated with a vendor tier and may be applied as additive cost, allocation-based cost, time-based cost, or percentage-based cost overlays. In some embodiments, the labor and service cost components 7806 may be applied to adjusted pricing inputs generated by vendor discount and markup adjustments 7804.

Beneath vendor discount and markup adjustments 7804, an effective cost reconstruction engine 7808 is illustrated. In some embodiments, the effective cost reconstruction engine 7808 may combine adjusted pricing inputs, preserve excluded cost elements, and maintain traceability to source billing records. In some embodiments, the effective cost reconstruction engine 7808 may apply pricing adjustments from vendor discount and markup adjustments 7804 while ensuring that excluded or pass-through categories remain unmodified. In some embodiments, the effective cost reconstruction engine 7808 may generate a reconstructed cost representation in which each cost record retains a linkage to an originating provider billing line item and to the vendor contract rule responsible for the applied adjustment.

To the right of the effective cost reconstruction engine 7808, excluded or pass-through cost components 7810 are illustrated. In some embodiments, the excluded or pass-through cost components 7810 may include commitment charges, marketplace charges, credits, taxes, regulatory fees, and other cost elements that are excluded from discount application or are required to be passed through without adjustment. In some embodiments, the excluded or pass-through cost components 7810 may be identified based on exclusion rules defined in vendor contract data. In some embodiments, the excluded or pass-through cost components 7810 may be preserved by the effective cost reconstruction engine 7808 without modification while remaining associated with a reconstructed cost record for audit and reporting.

In some embodiments, dashed linkages in FIG. 78 indicate that labor and service cost components 7806 and excluded or pass-through cost components 7810 may provide optional overlay inputs or exclusion constraints that influence the operation of the effective cost reconstruction engine 7808. In some embodiments, the effective cost reconstruction engine 7808 may incorporate labor and service cost components 7806 into a reconstructed cost record while maintaining a separate attribution field identifying the labor source or service contract tier. In some embodiments, the effective cost reconstruction engine 7808 may preserve excluded or pass-through cost components 7810 by tagging such cost records as excluded and preventing application of discount or markup adjustments.

Beneath the effective cost reconstruction engine 7808, reconstructed effective cost records 7812 are illustrated. In some embodiments, the reconstructed effective cost records 7812 may represent a multi-vendor normalized cost view that incorporates tier-based discounts, markups, pass-through rules, and optional labor overlays. In some embodiments, the reconstructed effective cost records 7812 may be used for financial modeling, budgeting, procurement analysis, burn rate evaluation, forecasting, and contract performance evaluation. In some embodiments, reconstructed effective cost records 7812 may retain vendor and contract attribution metadata identifying which vendor tier and which contractual rule contributed to each pricing adjustment.

In some embodiments, the reconstructed effective cost records 7812 may be stored as structured cost records including fields such as service category identifier, adjusted unit price, adjusted total cost, contract identifier, vendor tier identifier, exclusion indicator, and labor overlay indicator. In some embodiments, the reconstructed effective cost records 7812 may provide a normalized cost representation independent of cloud provider billing formats, thereby enabling cross-provider cost comparison.

Below, the reconstructed effective cost records 7812, a financial modeling engine 7814, are illustrated. In some embodiments, the financial modeling engine 7814 may process reconstructed effective cost records 7812 to generate budget evaluations, burn rate analysis, forecasting outputs, and scenario-based financial projections. In some embodiments, the financial modeling engine 7814 may generate cost trend analytics, contract period rollups, and projected spending estimates based on historical reconstructed effective cost records.

Also, below, the reconstructed effective cost records 7812, a vendor comparison view 7816 is illustrated. In some embodiments, the vendor comparison view 7816 may provide analysis of alternative vendor chains and what-if procurement scenarios. In some embodiments, the vendor comparison view 7816 may compute alternative reconstructed effective cost records under different vendor tier structures or discount assumptions and may provide a comparative evaluation across vendor pathways. In some embodiments, the vendor comparison view 7816 may enable evaluation of procurement outcomes when discount terms expire, when markup structures change, or when labor overlays are modified.

In some embodiments, the dashed linkage shown in FIG. 78 indicates that the vendor comparison view 7816 may utilize reconstructed effective cost records 7812 as input and may optionally incorporate contract metadata, tier structures, and scenario parameters to generate comparative cost outputs.

In some embodiments, FIG. 78 illustrates that provider-reported billing and usage records 7802 may be transformed through vendor discount and markup adjustments 7804, combined with optional labor and service cost components 7806, processed by the effective cost reconstruction engine 7808 while preserving excluded or pass-through cost components 7810, and output as reconstructed effective cost records 7812. These reconstructed effective cost records 7812 may then support downstream financial modeling performed by financial modeling engine 7814 and procurement scenario evaluation performed by vendor comparison view 7816.

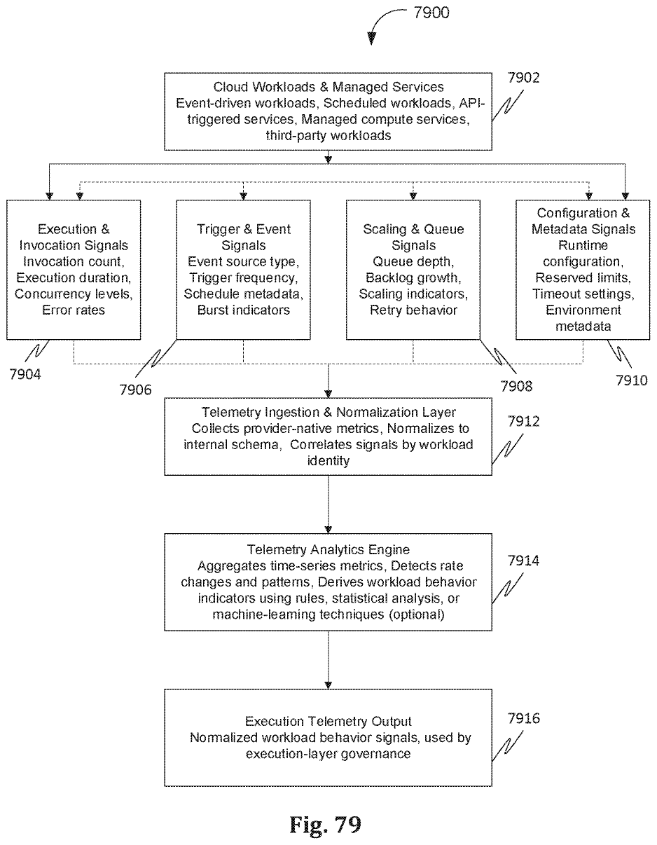

FIG. 79 illustrates an example workload telemetry flow 7900 in which execution-related signals generated by cloud workloads and managed services are collected, normalized, analyzed, and transformed into execution telemetry output signals used by an execution-layer governance system, in accordance with some embodiments. Further, at the top of FIG. 79, cloud workloads and managed services 7902 are illustrated. In some embodiments, cloud workloads and managed services 7902 may include event-driven workloads, scheduled workloads, API-triggered services, managed compute services, and third-party workloads executing within one or more cloud environments. In some embodiments, such workloads may be serverless functions, containerized applications, batch jobs, streaming pipelines, message-driven consumers, scheduled tasks, or managed service components that execute automatically based on configured triggers or schedules.

Below cloud workloads and managed services 7902, multiple categories of execution-related signals are illustrated.

An execution and invocation signals module 7904 is shown. In some embodiments, execution and invocation signals 7904 may include invocation count, execution duration, concurrency levels, and error rates associated with workload execution. In some embodiments, the invocation count may represent a number of discrete workload executions within a time window. In some embodiments, execution duration may represent a time interval associated with each invocation. In some embodiments, concurrency levels may represent a number of simultaneous execution instances. In some embodiments, error rates may represent a ratio of failed executions to total invocations.

A trigger and event signals module 7906 is shown. In some embodiments, trigger and event signals 7906 may include event source type, trigger frequency, schedule metadata, and burst indicators. In some embodiments, the event source type may identify a source such as a message queue, storage event, HTTP request, scheduler, or external integration. In some embodiments, trigger frequency may represent a rate of event arrival or scheduled execution. In some embodiments, burst indicators may identify abrupt increases in trigger volume or clustered invocation patterns.

A scaling and queue signals module 7908 is shown. In some embodiments, scaling and queue signals 7908 may include queue depth, backlog growth, scaling indicators, and retry behavior. In some embodiments, queue depth may represent a number of pending tasks in a message queue. In some embodiments, backlog growth may represent an increasing queue length over time. In some embodiments, scaling indicators may include auto-scaling activity, instance or compute count changes, or concurrency scaling events. In some embodiments, retry behavior may represent a number of retry attempts or repeated processing of failed events.

A configuration and metadata signals module 7910 is shown. In some embodiments, configuration and metadata signals 7910 may include runtime configuration, reserved limits, timeout settings, environment metadata, and workload parameter definitions. In some embodiments, runtime configuration may include memory allocation, CPU allocation, or execution environment settings. In some embodiments, reserved limits may include concurrency caps or throughput limits. In some embodiments, timeout settings may define maximum execution duration. In some embodiments, environment metadata may include a region identifier, an account identifier, or a deployment stage.

In some embodiments, dashed linkages between modules 7904, 7906, 7908, and 7910 indicate that signals from these modules may be correlated or jointly analyzed prior to ingestion into downstream telemetry processing.

Below the signal modules, a telemetry ingestion and normalization layer 7912 is illustrated. In some embodiments, the telemetry ingestion and normalization layer 7912 may collect provider-native metrics and signals from execution and invocation signals 7904, trigger and event signals 7906, scaling and queue signals 7908, and configuration and metadata signals 7910. In some embodiments, the telemetry ingestion and normalization layer 7912 may convert heterogeneous provider-specific telemetry formats into a unified internal schema. In some embodiments, the telemetry ingestion and normalization layer 7912 may correlate signals by workload identity, such that invocation metrics, scaling metrics, trigger metadata, and configuration attributes associated with a given workload are linked using a normalized workload identifier.

Beneath the telemetry ingestion and normalization layer 7912, a telemetry analytics engine 7914 is illustrated. In some embodiments, the telemetry analytics engine 7914 may aggregate time-series metrics across defined time windows. In some embodiments, the telemetry analytics engine 7914 may detect rate changes, growth patterns, burst behavior, sustained backlog conditions, or anomalous execution patterns. In some embodiments, the telemetry analytics engine 7914 may derive workload behavior indicators using rule-based evaluation, statistical analysis, or optional machine learning techniques. For example, the telemetry analytics engine 7914 may compute deviation metrics relative to historical baseline values, identify rapid increases in invocation rate combined with backlog growth, or detect configuration drift correlated with error rate increase.

Below the telemetry analytics engine 7914, execution telemetry output 7916 is illustrated. In some embodiments, execution telemetry output 7916 may represent normalized workload behavior signals derived from aggregated and analyzed telemetry data. In some embodiments, execution telemetry output 7916 may include indicators such as invocation rate change, concurrency saturation, queue growth acceleration, retry amplification, configuration anomaly flags, or derived anomaly scores. In some embodiments, execution telemetry output 7916 may be used by an execution-layer governance system to evaluate workload behavior, detect runaway execution patterns, assess severity, and determine whether to generate advisory notification or enforce governance action.

In some embodiments, FIG. 79 illustrates a structured telemetry pipeline in which cloud workloads and managed services 7902 generate execution and invocation signals 7904, trigger and event signals 7906, scaling and queue signals 7908, and configuration and metadata signals 7910. These signals may be collected and normalized by telemetry ingestion and normalization layer 7912, analyzed by telemetry analytics engine 7914, and transformed into execution telemetry output 7916 for use by an execution-layer governance framework.

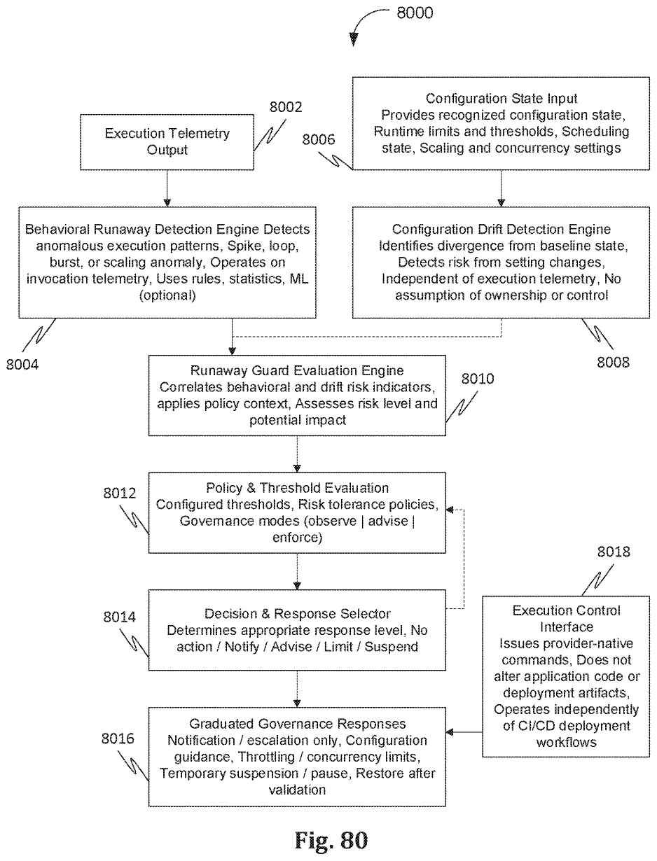

FIG. 80 illustrates an example Runaway Guard detection and response architecture 8000 for monitoring execution-layer risk of an automated workload and generating graduated governance responses based on behavioral telemetry analysis, configuration drift detection, policy evaluation, and response selection, in accordance with some embodiments. Further, FIG. 80 depicts a structured decision pipeline in which execution telemetry output and configuration state input are processed to identify anomalous execution behavior, assess risk, determine governance mode, and issue provider-native control actions without altering application code or deployment artifacts.

At the upper left of FIG. 80, execution telemetry output 8002 is illustrated. In some embodiments, the execution telemetry output 8002 may be received from a telemetry analytics engine, such as the telemetry analytics engine described in FIG. 79. The execution telemetry output 8002 may include normalized workload behavior indicators such as invocation rate changes, execution duration patterns, concurrency utilization, queue growth metrics, retry amplification indicators, or derived anomaly scores. In some embodiments, the execution telemetry output 8002 may represent aggregated time-series telemetry signals correlated to a workload identity.

Below, the execution telemetry output 8002, a behavioral runaway detection engine 8004, is illustrated. In some embodiments, the behavioral runaway detection engine 8004 may detect anomalous execution patterns, including spike behavior, loop behavior, burst execution, scaling anomalies, or other runaway patterns. The behavioral runaway detection engine 8004 may operate on invocation telemetry derived from execution telemetry output 8002. In some embodiments, the behavioral runaway detection engine 8004 may apply deterministic rule evaluation to detect patterns such as repeated invocation within a short time window, sustained concurrency saturation, monotonic queue growth, or repeated retry cycles. In some embodiments, the behavioral runaway detection engine 8004 may apply statistical analysis to compute deviation values relative to a historical baseline. In some embodiments, the behavioral runaway detection engine 8004 may optionally use machine learning techniques to classify anomaly patterns into behavioral categories.

At the upper right of FIG. 80, configuration state input 8006 is illustrated. In some embodiments, the configuration state input 8006 may provide recognized configuration state information, including runtime limits, execution thresholds, scheduling state, scaling settings, and concurrency settings. In some embodiments, the configuration state input 8006 may include configuration parameters retrieved from a cloud provider control plane, such as timeout configuration, reserved concurrency values, event trigger routing configuration, queue retention settings, scaling bounds, or deployment environment metadata.

Below the configuration state input 8006, a configuration drift detection engine 8008 is illustrated. In some embodiments, the configuration drift detection engine 8008 may identify divergence of a workload configuration from a baseline configuration state. In some embodiments, the configuration drift detection engine 8008 may detect risk arising from changes in runtime configuration, scheduling state, scaling thresholds, concurrency caps, trigger definitions, or timeout parameters. In some embodiments, the configuration drift detection engine 8008 may operate independently of execution telemetry and may identify drift risk even when telemetry does not yet indicate abnormal execution behavior. In some embodiments, the configuration drift detection engine 8008 may perform drift detection without assuming ownership or control of the workload, such that the drift detection engine may provide risk classification even when the enforcement authority is uncertain.

In some embodiments, a dashed linkage between the behavioral runaway detection engine 8004 and the configuration drift detection engine 8008 indicates that behavioral anomaly indicators and configuration drift indicators may be correlated or jointly evaluated in a downstream evaluation stage. In some embodiments, drift detection output may be treated as contextual input to behavioral risk evaluation.

Below the behavioral runaway detection engine 8004 and the configuration drift detection engine 8008, a runaway guard evaluation engine 8010 is illustrated. In some embodiments, the runaway guard evaluation engine 8010 may correlate behavioral risk indicators derived from the behavioral runaway detection engine 8004 with drift risk indicators derived from the configuration drift detection engine 8008. The runaway guard evaluation engine 8010 may apply policy context to assess a risk level and the potential impact of the detected anomaly. In some embodiments, the runaway guard evaluation engine 8010 may compute a composite risk score representing a likelihood of runaway execution and a projected severity of financial or operational impact.

Beneath the runaway guard evaluation engine 8010, a policy and threshold evaluation module 8012 is illustrated. In some embodiments, the policy and threshold evaluation module 8012 may evaluate configured thresholds, risk tolerance policies, and governance mode selection logic. In some embodiments, the governance mode may include an observe mode, an advice mode, or an enforce mode. In some embodiments, observe mode may represent a monitoring-only state in which no response is initiated. In some embodiments, advise mode may represent a state in which advisory notification or guidance is generated. In some embodiments, enforce mode may represent a state in which provider-native control actions may be issued to modify execution behavior. In some embodiments, the policy and threshold evaluation module 8012 may determine governance mode based on risk score, anomaly classification, enforcement confidence, and policy-defined thresholds.

Below the policy and threshold evaluation module 8012, a decision and response selector 8014 is illustrated. In some embodiments, the decision and response selector 8014 may determine an appropriate response level based on evaluated policy outputs. In some embodiments, the decision and response selector 8014 may select a response option including no action, notify, advise, limit, or suspend. In some embodiments, notify may include generation of an alert signal. In some embodiments, advice may include generation of recommended configuration changes or mitigation steps. In some embodiments, limit may include selection of throttling actions or concurrency reduction actions. In some embodiments, suspend may include selection of trigger suppression, workload pausing, or temporary disabling of execution pathways.

In some embodiments, a dashed linkage between the policy and threshold evaluation module 8012 and the decision and response selector 8014 indicates that governance mode selection may influence response selection and may provide contextual constraints for the response selector. For example, when governance mode is observe, the decision and response selector 8014 may be constrained to select no action or notification. When governance mode is enforced, the decision and response selector 8014 may be permitted to select limiting or suspension actions.

Beneath the decision and response selector 8014, graduated governance responses 8016 are illustrated. In some embodiments, the graduated governance responses 8016 may include notification-only escalation, configuration guidance, throttling actions, concurrency limit enforcement, temporary suspension or pause actions, and restoration actions after validation. In some embodiments, graduated governance responses 8016 may be ordered by severity, such that a lower severity response may be selected before a higher severity response. In some embodiments, restoration actions may be reversible state transitions that return the workload to an original execution state after anomaly conditions subside or after operator approval.

To the right of the graduated governance responses 8016, an execution control interface 8018 is illustrated. In some embodiments, the execution control interface 8018 may issue provider-native commands to implement selected governance responses. In some embodiments, the execution control interface 8018 may interact with cloud provider control plane APIs to apply concurrency limits, modify scaling thresholds, disable triggers, suspend scheduled execution, or reduce execution capacity. In some embodiments, the execution control interface 8018 may operate without altering application code or deployment artifacts. In some embodiments, the execution control interface 8018 may operate independently of CI/CD deployment workflows or other deployment orchestration mechanisms, thereby enabling runtime enforcement without requiring a redeployment pipeline.

In some embodiments, the linkage between graduated governance responses 8016 and the execution control interface 8018 indicates that selected response actions may be translated into provider-native control instructions. In some embodiments, the execution control interface 8018 may receive a response specification from the graduated governance responses 8016 and may generate a corresponding provider-specific API instruction.

In some embodiments, the dashed arrows illustrated in FIG. 80 indicate non-blocking or contextual inputs. For example, in some embodiments, drift detection results may be treated as contextual signals that influence evaluation without being required to trigger enforcement. Similarly, policy evaluation results may provide contextual gating conditions for response selection.

In some embodiments, FIG. 80 illustrates that the system may generate graduated governance responses 8016 by ingesting execution telemetry output 8002 and configuration state input 8006, performing behavioral anomaly detection using behavioral runaway detection engine 8004, performing drift detection using configuration drift detection engine 8008, correlating risk indicators using runaway guard evaluation engine 8010, evaluating thresholds and governance mode using policy and threshold evaluation module 8012, selecting a response level using decision and response selector 8014, and implementing enforcement through execution control interface 8018 without modifying application code or deployment artifacts.

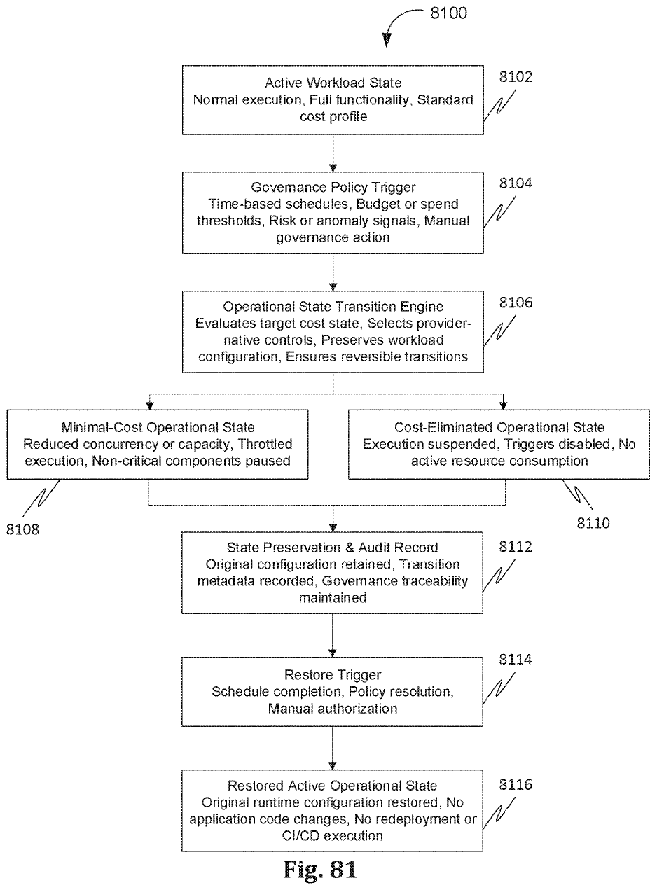

FIG. 81 illustrates an example workflow 8100 for performing runtime operational state transitions for cost governance in which an automated workload may be transitioned between an active workload state, a minimal-cost operational state, and a cost-eliminated operational state, while preserving original configuration state for later restoration, in accordance with some embodiments. FIG. 81 further illustrates that restoration to an active operational state may be performed without modifying application code and without requiring execution of a deployment pipeline.

At the top of FIG. 81, an active workload state 8102 is illustrated. In some embodiments, the active workload state 8102 may represent a normal operational execution mode in which an automated workload executes with full functionality and a standard cost profile. In some embodiments, the active workload state 8102 may correspond to a state in which triggers are enabled, schedules are active, scaling parameters operate normally, and concurrency limits are configured to support expected workload demand.

Below the active workload state 8102, a governance policy trigger 8104 is illustrated. In some embodiments, the governance policy trigger 8104 may represent one or more conditions that initiate a cost-governance state transition. The governance policy trigger 8104 may include time-based schedules, budget thresholds, spending thresholds, risk indicators, anomaly signals, or manual governance action. For example, in some embodiments, the governance policy trigger 8104 may occur when a predefined budget allocation is exceeded, when an anomalous execution pattern is detected, when a scheduled governance window begins, or when an operator manually authorizes a cost reduction action.

Beneath the governance policy trigger 8104, an operational state transition engine 8106 is illustrated. In some embodiments, the operational state transition engine 8106 may evaluate a target cost state based on the governance policy trigger 8104 and associated governance policy parameters. In some embodiments, the operational state transition engine 8106 may select one or more provider-native control mechanisms to implement a cost-reduction transition. Such provider-native controls may include concurrency reduction, throttling configuration, trigger disabling, schedule suspension, scaling constraint modification, or queue processing limitation. In some embodiments, the operational state transition engine 8106 may preserve workload configuration by capturing a configuration snapshot prior to applying any provider-native control action. In some embodiments, the operational state transition engine 8106 may ensure that applied transitions are reversible by storing transition metadata describing each modification applied during the transition.

From the operational state transition engine 8106, the workflow branches into two alternative operational states.

A minimal-cost operational state 8108 is illustrated on a first branch. In some embodiments, the minimal-cost operational state 8108 may represent a reduced-capacity state in which concurrency or execution capacity is reduced, execution is throttled, and non-critical components are paused. In some embodiments, the minimal-cost operational state 8108 may allow the workload to remain partially operational while reducing cost exposure by limiting invocation throughput, scaling boundaries, or resource allocation.

A cost-eliminated operational state 8110 is illustrated on a second branch. In some embodiments, the cost-eliminated operational state 8110 may represent a suspended execution state in which triggers are disabled and execution is halted such that no active resource consumption occurs. In some embodiments, the cost-eliminated operational state 8110 may include disabling an event trigger, pausing scheduled invocation, suspending queue consumption, or setting concurrency limits to prevent invocation.

In some embodiments, the minimal-cost operational state 8108 and the cost-eliminated operational state 8110 may represent alternative governance actions selected based on severity of a detected anomaly, budget urgency, enforcement confidence, or policy-defined escalation rules.

Below the minimal-cost operational state 8108 and the cost-eliminated operational state 8110, a state preservation and audit record 8112 is illustrated. In some embodiments, the state preservation and audit record 8112 may retain an original configuration snapshot of the workload prior to transition and may store transition metadata describing actions applied during the transition. In some embodiments, the state preservation and audit record 8112 may include identifiers of modified control settings, timestamps, governance policy identifiers, selected operational state type, and provider-native control instruction data. In some embodiments, the state preservation and audit record 8112 may maintain governance traceability by linking each transition event to a triggering condition and to an applied response.

Beneath the state preservation and audit record 8112, a restore trigger 8114 is illustrated. In some embodiments, the restore trigger 8114 may represent a condition for initiating restoration of the workload from a reduced-cost state to an active state. The restore trigger 8114 may include schedule completion, policy resolution, anomaly resolution, or manual authorization. For example, in some embodiments, restoration may be triggered after a defined governance time window ends, after an operator confirms that the anomaly condition is resolved, or after budget policy resets at the start of a billing cycle.

Below the restore trigger 8114, a restored active operational state 8116 is illustrated. In some embodiments, the restored active operational state 8116 may represent a state in which the original runtime configuration is restored. The restored active operational state 8116 may reinstate original trigger configuration, concurrency limits, scaling settings, scheduling state, and other runtime parameters that existed prior to the cost governance transition. In some embodiments, restoration may be performed without modifying application code. In some embodiments, restoration may be performed without initiating a redeployment process or executing a CI/CD pipeline or other deployment orchestration mechanisms, because restoration may rely on provider-native configuration control rather than code changes.

In some embodiments, FIG. 81 illustrates a reversible runtime governance workflow in which an automated workload begins in an active workload state 8102, transitions in response to a governance policy trigger 8104 through an operational state transition engine 8106 into either a minimal-cost operational state 8108 or a cost-eliminated operational state 8110, and records original configuration and transition metadata in a state preservation and audit record 8112. Subsequently, upon a restore trigger 8114, the workload may be returned to a restored active operational state 8116 by reinstating original configuration settings without application code changes or redeployment execution.

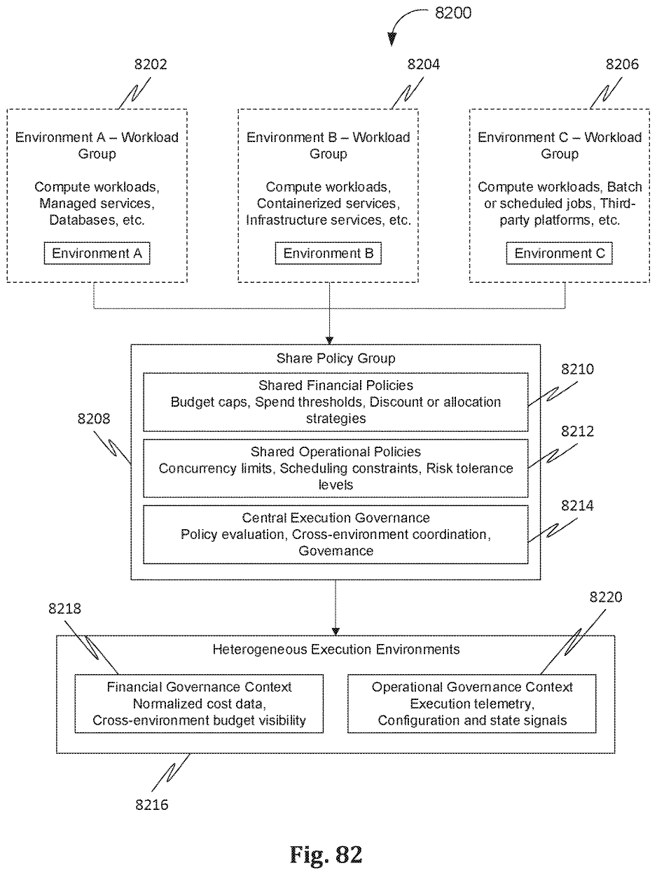

FIG. 82 illustrates an example configuration 8200 for cross-environment workload grouping for unified governance, in which workloads executing across heterogeneous environments are logically grouped under a shared policy group that applies coordinated financial and operational governance policies independent of deployment platform or execution location, in accordance with some embodiments. Further, at the upper portion of FIG. 82, multiple environment-specific workload groups are illustrated. A first environment, environment A-workload group 8202, is shown as including compute workloads, managed services, databases, and related execution resources. In some embodiments, environment A may represent a first cloud provider account, a first region, a first business unit environment, or a managed service environment. The environment A-workload group 8202 may include workloads of differing types that are logically associated within a common operational boundary.

A second environment, environment B-workload group 8204, is illustrated adjacent to environment A. In some embodiments, environment B-workload group 8204 may include compute workloads, containerized services, infrastructure services, or platform-native services operating in a second cloud provider, a second account, or a separate deployment boundary. The workloads within environment B may differ in runtime model, orchestration mechanism, or control plane configuration relative to environment A.

A third environment, environment C-workload group 8206, is illustrated as including compute workloads, batch jobs, scheduled tasks, third-party platforms, or other execution resources. In some embodiments, environment C may represent a hybrid or on-premise environment, a third-party managed platform, or a separate tenant environment. The workloads in environment C may operate under distinct configuration models, scheduling semantics, or scaling characteristics.

In some embodiments, environments A, B, and C may be heterogeneous execution environments that differ in provider, runtime model, service abstraction, billing structure, or operational control interface. Despite such differences, workloads within these environments may be logically associated for governance purposes.

Below the environment-specific workload groups 8202, 8204, and 8206, a shared policy group 8208 is illustrated. In some embodiments, the shared policy group 8208 may represent a logical governance construct that spans multiple heterogeneous environments. The shared policy group 8208 may associate workloads from environment A, environment B, and environment C under a unified governance scope without requiring those workloads to share a common execution platform.

Within the shared policy group 8208, shared financial policies 8210 are illustrated. In some embodiments, shared financial policies 8210 may include budget caps, spend thresholds, discount strategies, allocation strategies, or cost distribution rules. In some embodiments, the shared financial policies 8210 may apply normalized cost data derived from multi-cloud vendor modeling and reconstructed effective cost computation. The shared financial policies 8210 may define aggregate spend limits across environments A, B, and C, rather than per-environment limits alone.

Also within the shared policy group 8208, shared operational policies 8212 are illustrated. In some embodiments, shared operational policies 8212 may include concurrency limits, scheduling constraints, scaling boundaries, or risk tolerance levels that apply across multiple environments. For example, in some embodiments, a concurrency cap defined in shared operational policies 8212 may constrain combined workload execution across environments A, B, and C, even if each environment exposes distinct provider-native concurrency controls.

A central execution governance component 8214 is further illustrated within the shared policy group 8208. In some embodiments, central execution governance 8214 may perform policy evaluation across cross-environment telemetry and financial signals. The central execution governance 8214 may coordinate governance actions affecting multiple environments. In some embodiments, central execution governance 8214 may evaluate risk indicators from execution telemetry across environments A, B, and C and determine whether governance actions should be applied to one or more workload groups within the shared policy group 8208.

Below the shared policy group 8208, heterogeneous execution environments 8216 are illustrated. In some embodiments, heterogeneous execution environments 8216 may represent the collective set of underlying execution platforms corresponding to environments A, B, and C. These heterogeneous execution environments 8216 may differ in service abstraction, API interface, telemetry format, billing schema, and operational semantics.

Within heterogeneous execution environments 8216, a financial governance context 8218 is illustrated. In some embodiments, the financial governance context 8218 may include normalized cost data derived from multi-tier vendor modeling and reconstructed effective cost computation. In some embodiments, the financial governance context 8218 may provide cross-environment budget visibility that aggregates cost signals across environments A, B, and C into a unified cost representation.

Also within heterogeneous execution environments 8216, an operational governance context 8220 is illustrated. In some embodiments, the operational governance context 8220 may include execution telemetry signals, configuration state signals, and runtime indicators collected from workloads across environments A, B, and C. The operational governance context 8220 may provide normalized workload behavior signals used by central execution governance 8214 to evaluate cross-environment risk conditions.

In some embodiments, FIG. 82 illustrates that workloads executing across heterogeneous environments 8202, 8204, and 8206 may be logically grouped under a shared policy group 8208 that applies shared financial policies 8210, shared operational policies 8212, and central execution governance 8214. The governance evaluation may operate on financial governance context 8218 and operational governance context 8220 derived from heterogeneous execution environments 8216, thereby enabling unified governance independent of the specific deployment platform or execution location of each workload.

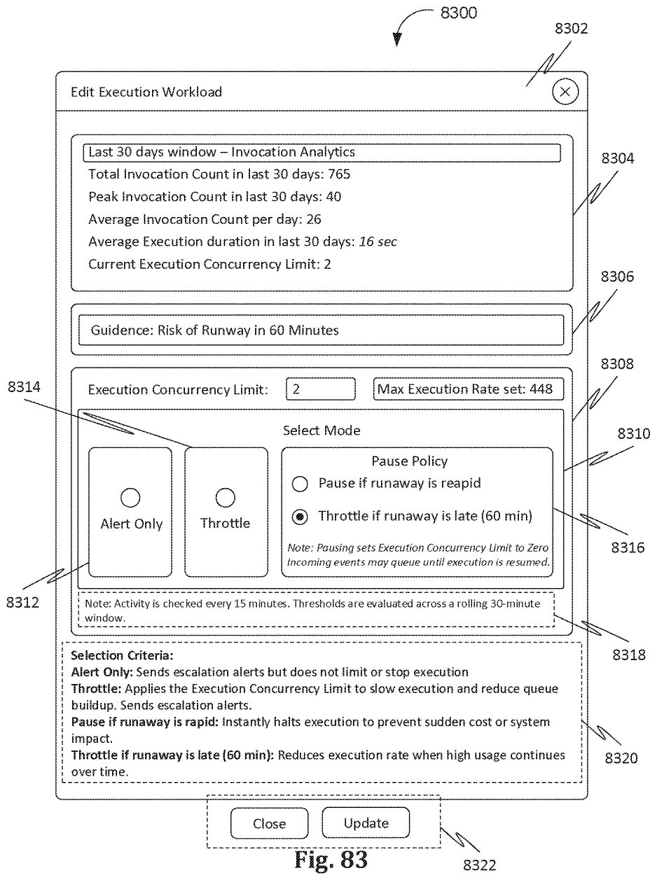

FIG. 83 illustrates an example combined financial and execution-layer governance workflow presented through a user interface, in which a governance system provides execution telemetry analytics, generates runaway risk guidance, enables selection of an execution governance mode, and applies a selected execution control configuration to manage cost and runaway behavior of an automated workload, in accordance with some embodiments.

At the top of FIG. 83, a combined financial and execution-layer governance workflow interface 8300 is illustrated. In some embodiments, the combined financial and execution-layer governance workflow interface 8300 may be presented as a configuration window associated with an execution workload. The interface may enable a user to view workload execution behavior indicators and to configure governance actions that may be applied to the workload. In some embodiments, the interface may be generated by a governance platform that aggregates telemetry and cost-related information and provides centralized execution control capabilities across one or more cloud environments.

Within the interface 8300, an edit execution workload panel 8302 is illustrated. In some embodiments, the edit execution workload panel 8302 may enable modification of governance parameters associated with a selected workload identity. The edit execution workload panel 8302 may include analytics data, risk guidance, configurable execution limits, and selectable governance modes.

Within the edit execution workload panel 8302, an invocation analytics section 8304 is illustrated. In some embodiments, the invocation analytics section 8304 may provide a rolling time window view of workload telemetry, such as a last 30-day window. The invocation analytics section 8304 may display metrics including total invocation count, peak invocation count, average invocation count per day, average execution duration, and current execution concurrency limit. In some embodiments, the invocation analytics section 8304 may be derived from normalized telemetry output generated by a telemetry ingestion and analytics subsystem, and may be computed based on time-series aggregation of invocation and execution metrics.

In some embodiments, the total invocation count displayed in the invocation analytics section 8304 may represent a total number of workload invocations over a selected evaluation window. In some embodiments, the peak invocation count may represent a maximum invocation frequency or maximum invocation burst observed during the evaluation window. In some embodiments, the average invocation count per day may represent a computed average derived from time-bucketed invocation events. In some embodiments, the average execution duration may represent an aggregated duration metric computed from execution traces, logs, or provider runtime metadata. In some embodiments, the current execution concurrency limit may represent a provider-native control parameter currently applied to the workload.

Below the invocation analytics section 8304, a guidance indicator 8306 is illustrated. In some embodiments, the guidance indicator 8306 may provide a computed risk message, such as a predicted risk of runaway execution within a future time horizon. For example, the guidance indicator 8306 may indicate that there is a risk of runaway within a defined time period. In some embodiments, the guidance indicator 8306 may be generated based on evaluation of behavioral anomaly signals, scaling indicators, retry patterns, queue backlog growth, or trigger frequency analysis. In some embodiments, the guidance indicator 8306 may be presented as a selectable guidance panel, such that multiple guidance messages may be available depending on the detected condition or policy context.

In some embodiments, the guidance indicator 8306 may represent advisory-only output generated by a governance engine operating in an observe mode or advise mode. In some embodiments, the guidance indicator 8306 may be generated without automatically applying enforcement actions, thereby enabling a user to determine whether to apply a throttling action or a suspension action.

Below the guidance indicator 8306, an execution concurrency configuration section 8308 is illustrated. In some embodiments, the execution concurrency configuration section 8308 may enable a user to specify a target execution concurrency limit for the workload. The execution concurrency configuration section 8308 may include a numeric field representing a concurrency limit value. In some embodiments, the execution concurrency configuration section 8308 may also include a derived maximum execution rate indicator representing a computed throughput limit corresponding to the selected concurrency value. For example, in some embodiments, the maximum execution rate may be computed based on average execution duration and concurrency limit. In some embodiments, the maximum execution rate may be computed using a formula that maps concurrency to estimated invocation throughput per unit time.

In some embodiments, the execution concurrency configuration section 8308 may provide a mechanism for implementing throttling-based cost governance by reducing the rate at which the workload may consume compute resources. In some embodiments, a concurrency reduction may limit burst behavior, prevent uncontrolled scaling, and reduce cost exposure caused by runaway trigger events.

Below the execution concurrency configuration section 8308, a mode selection section 8310 is illustrated. In some embodiments, the mode selection section 8310 may enable a user to select an execution governance mode associated with a policy group or workload-specific governance policy. The mode selection section 8310 may include selectable options such as alert only, throttle, or pause policy.

In some embodiments, an alert-only mode 8314 may be selectable. The alert-only mode 8312 may represent a governance mode in which escalation alerts are generated without limiting or stopping execution. In some embodiments, selecting alert-only mode 8312 may cause the governance system to continue monitoring workload behavior and to generate notifications upon detecting anomaly conditions without applying enforcement actions.

In some embodiments, a throttle mode 8314 may be selectable. The throttle mode 8314 may represent a governance mode in which the system applies a concurrency limit or throughput constraint to slow execution and reduce queue buildup. In some embodiments, throttle mode 8314 may be configured to send escalation alerts while also applying rate limiting.

In some embodiments, a mode selection section 8310 may be selectable within a user interface of the system. The mode selection section 8310 may include a pause policy section 8316 that provides selectable governance options for managing runaway workload behavior. In some embodiments, a conditional circuit-breaker mode may be selectable. The conditional circuit-breaker mode may apply an initial configurable protection interval following activation, reactivation, deployment, modification, or enabling of a workload, process, automation, or event-driven execution path. During the protection interval, if a runaway condition is detected, execution may be paused automatically, and alerts may be issued to designated users for investigation and remediation. If no runaway condition is detected during the configurable protection interval, the system may automatically transition to a throttled enforcement mode in which subsequent abnormal execution behavior is managed by applying configurable rate limits or reducing execution rate, concurrency, or processing capacity instead of fully pausing execution. This approach provides heightened protection against recursive or cascading execution behavior during initial execution monitoring periods while allowing controlled operational continuity after the workload is determined to be operating within expected limits.

In some embodiments, when workload activity exceeds the configured rate limits, the system may generate alerts to notify designated users that execution demand has surpassed the configured rate threshold. Such notifications may enable operators to analyze historical workload behavior and adjust configuration parameters, scaling policies, or execution limits to mitigate sustained queue buildup or excessive resource consumption.

In some embodiments, additional runaway protection mechanisms may be implemented including configurable invocation rate guardrails, duplicate execution safeguards, and recursive dependency detection. Invocation rate guardrails may limit the frequency of workload execution within defined time intervals. Duplicate execution safeguards may prevent repeated processing of identical events or tasks. Recursive dependency detection may identify cyclic execution patterns among workloads, triggers, or automated processes and may initiate governance responses when such patterns are detected. These mechanisms further reduce the likelihood of uncontrolled execution cascades or cost escalation.

In some embodiments, the pause policy section 8316 may represent a reversible operational state transition in which execution is temporarily halted and later restored. In some embodiments, the pause policy section 8316 may correspond to a cost-eliminated operational state transition in which triggers may be disabled, or concurrency is reduced to prevent invocation.

In some embodiments, the mode selection section 8310 may further include a policy evaluation note 8318. The policy evaluation note 8318 may indicate that activity is checked periodically and that thresholds are evaluated across a rolling time window. In some embodiments, the periodic evaluation may occur at a configurable interval, and threshold evaluation may occur across a configurable rolling time window. In some embodiments, the periodic evaluation frequency and the rolling window duration may be configurable based on governance policy.

Below the mode selection section 8310, a selection criteria description section 8320 is illustrated. In some embodiments, the selection criteria description section 8320 may provide a textual explanation of each selectable governance mode. For example, in some embodiments, the selection criteria description section 8320 may describe that alert-only mode generates escalation alerts without limiting execution, that throttle mode applies concurrency limits to reduce queue buildup, and that pause policy options halt execution or reduce execution rate depending on runaway timing characteristics.

At the bottom of the interface 8300, a control action section 8322 is illustrated. In some embodiments, the control action section 8322 may include an update control that applies selected governance parameters to the workload. In some embodiments, the update control may cause the governance system to transmit provider-native configuration commands to a cloud provider control plane to implement the selected concurrency limit and governance mode. In some embodiments, the control action section 8322 may also include a close control for dismissing the interface without applying modifications.

In some embodiments, FIG. 83 illustrates that the governance system may provide combined financial and execution-layer governance by presenting invocation analytics section 8304, generating guidance indicator 8306 indicating a risk of runaway, enabling configuration of execution concurrency configuration section 8308, enabling selection of a governance mode through mode selection section 8310 including alert-only mode 8312, throttle mode 8314, and pause policy section 8316, and applying the selected configuration using control action section 8322. In some embodiments, this workflow may enable runtime governance actions that mitigate runaway execution and cost escalation while maintaining reversible state control and policy-driven operational oversight.

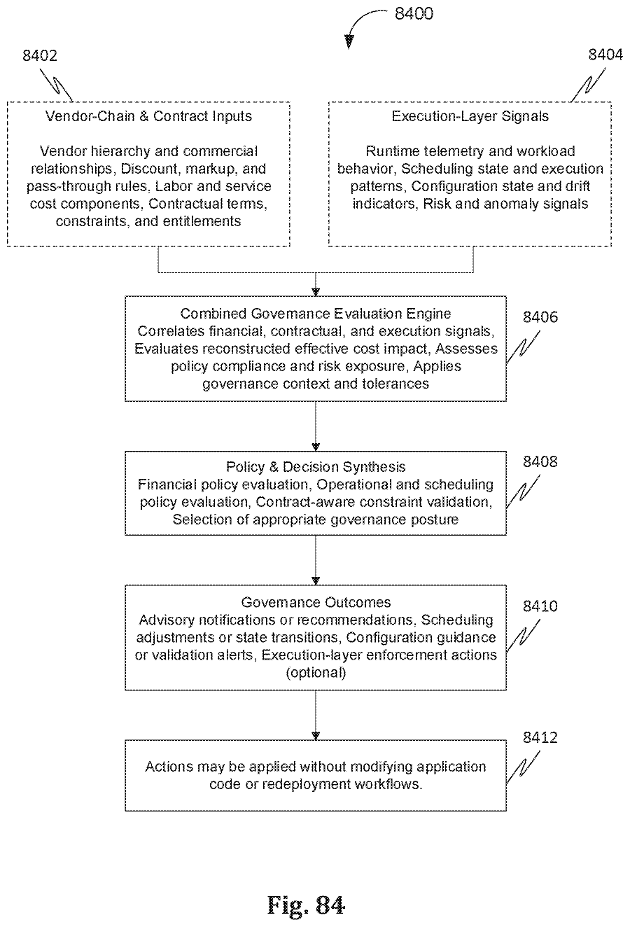

FIG. 84 illustrates an example combined financial and execution-layer governance workflow 8400 in which vendor-chain economics, reconstructed effective cost data, contract conditions, and execution-layer signals are collectively evaluated to generate workload governance decisions including advisory notifications, scheduling adjustments, configuration guidance, validation alerts, and optional execution-layer enforcement actions, in accordance with some embodiments. FIG. 84 further illustrates that governance outcomes may be applied without modifying application code or performing redeployment workflows.

At the upper portion of FIG. 84, vendor-chain and contract inputs 8402 are illustrated. In some embodiments, the vendor-chain and contract inputs 8402 may include vendor hierarchy data representing a multi-tier vendor chain, commercial relationship data between vendor entities, discount data, markup data, and pass-through rule data. In some embodiments, the vendor-chain and contract inputs 8402 may further include labor and service cost component data, contractual term data, constraint data, entitlement data, and other procurement-layer parameters that affect effective pricing. For example, in some embodiments, vendor-chain and contract inputs 8402 may include a distributor pricing schedule, reseller markup rules, system integrator service fee schedules, or contract-specific discount eligibility conditions.

Also at the upper portion of FIG. 84, execution-layer signals 8404 are illustrated. In some embodiments, the execution-layer signals 8404 may include runtime telemetry data representing workload behavior, scheduling state data, and execution pattern data. In some embodiments, execution-layer signals 8404 may further include configuration state data, configuration drift indicator data, scaling behavior data, queue depth data, retry pattern data, anomaly indicator data, and risk signal data. For example, in some embodiments, execution-layer signals 8404 may include invocation frequency spikes, concurrency saturation indicators, abnormal execution duration, or scheduling irregularities.

In some embodiments, the vendor-chain and contract inputs 8402 and the execution-layer signals 8404 may represent independent data streams collected from different sources, such as procurement systems and cloud provider telemetry systems. In some embodiments, the vendor-chain and contract inputs 8402 may be derived from vendor contract ingestion and procurement modeling modules, whereas execution-layer signals 8404 may be derived from telemetry ingestion and execution governance modules.

Below the vendor-chain and contract inputs 8402 and the execution-layer signals 8404, a combined governance evaluation engine 8406 is illustrated. In some embodiments, the combined governance evaluation engine 8406 may correlate procurement-layer economic signals with execution-layer runtime signals. In some embodiments, the combined governance evaluation engine 8406 may evaluate reconstructed effective cost impact associated with an execution behavior change, such as a scaling spike or sustained invocation surge. In some embodiments, the combined governance evaluation engine 8406 may assess policy compliance and risk exposure by combining financial contract context with operational execution context. In some embodiments, the combined governance evaluation engine 8406 may apply governance context and tolerance levels derived from financial policy definitions and operational policy definitions.

For example, in some embodiments, the combined governance evaluation engine 8406 may determine that a detected execution anomaly corresponds to a high-cost service category under the vendor-chain and contract inputs 8402, thereby elevating a risk score. In some embodiments, the combined governance evaluation engine 8406 may determine that a detected cost escalation occurs within a contractual commitment structure that includes penalty conditions, thereby influencing a governance response decision. In some embodiments, the combined governance evaluation engine 8406 may evaluate whether a workload execution event violates a spend threshold or risk tolerance policy.

Below the combined governance evaluation engine 8406, a policy and decision synthesis module 8408 is illustrated. In some embodiments, the policy and decision synthesis module 8408 may perform financial policy evaluation and may determine whether reconstructed effective cost data satisfies budget constraints, spending limits, allocation rules, or discount eligibility constraints. In some embodiments, the policy and decision synthesis module 8408 may also perform operational policy evaluation and scheduling policy evaluation, such as evaluating concurrency policies, trigger constraints, execution duration thresholds, and schedule governance policies.

In some embodiments, the policy and decision synthesis module 8408 may perform contract-aware constraint validation. For example, in some embodiments, the policy and decision synthesis module 8408 may validate whether a proposed governance action violates a contractual restriction or an entitlement condition. In some embodiments, the policy and decision synthesis module 8408 may select an appropriate governance posture, such as an observe posture, an advice posture, or an enforce posture, based on combined evaluation outputs.

In some embodiments, the policy and decision synthesis module 8408 may synthesize a unified decision output representing both financial and operational governance implications. For example, in some embodiments, the policy and decision synthesis module 8408 may determine that a workload should be throttled based on both risk of runaway execution and financial exposure under effective pricing rules.

Below the policy and decision synthesis module 8408, governance outcomes 8410 are illustrated. In some embodiments, the governance outcomes 8410 may include advisory notifications, recommendation output, scheduling adjustment output, operational state transition output, configuration guidance output, validation alert output, and execution-layer enforcement action output. In some embodiments, advisory notifications may include escalation alerts or warnings transmitted to an operator system. In some embodiments, recommendations may include suggested configuration changes, recommended concurrency adjustments, or proposed schedule modifications. In some embodiments, scheduling adjustments may include suppression of a scheduled invocation window or modification of trigger frequency. In some embodiments, operational state transitions may include transitioning a workload to a minimal-cost state or a cost-eliminated state. In some embodiments, configuration guidance may include recommended changes to concurrency settings, scaling thresholds, timeout parameters, or retry policies. In some embodiments, validation alerts may include alerts indicating contract compliance risk, budget violation risk, or abnormal cost impact risk.

In some embodiments, execution-layer enforcement actions may be optional and may be performed when enforcement confidence is sufficient. For example, in some embodiments, an enforcement action may include applying a provider-native concurrency limit, disabling a trigger, throttling a queue consumer, or suspending a scheduled job.

Below governance outcomes 8410, an application constraint statement 8412 is illustrated, indicating that actions may be applied without modifying application code or redeployment workflows. In some embodiments, this statement may represent a governance architecture in which operational actions are performed through provider-native configuration controls rather than by altering application logic. In some embodiments, enforcement actions may be implemented through control plane API calls and may not require code modification, compilation, or redeployment.

In some embodiments, FIG. 84 illustrates that vendor-chain and contract inputs 8402 and execution-layer signals 8404 may be provided to the combined governance evaluation engine 8406 for correlated evaluation. The combined governance evaluation engine 8406 may produce combined assessment outputs that are processed by the policy and decision synthesis module 8408 to generate governance outcomes 8410. The governance outcomes 8410 may include advisory actions, scheduling actions, configuration guidance, validation alerting, and optional execution-layer enforcement actions, which may be applied without modifying application code or executing redeployment workflows as indicated by application constraint statement 8412.

In some embodiments, a technical problem addressed by the present disclosure may include an inability of conventional multi-cloud cost tooling to reconstruct an effective cost when a procurement pathway includes a multi-tier vendor chain with tier-specific discount, markup, pass-through rule, and labor overlay, because provider billing formats and vendor contract semantics may be heterogeneous and because adjustments may be eligible for only a subset of service category. In some embodiments, the disclosed system may improve cloud financial governance technology by ingesting a billing record and a vendor contract data, normalizing provider-specific service code into a normalized internal schema, and computing a reconstructed effective cost data by applying a pricing adjustment only to an eligible service category while excluding a non-eligible charge component. In some embodiments, the normalized internal schema may be implemented as a canonical service taxonomy that maps provider-specific identifiers (for example, service code, SKU, meter identifier, usage type, region tag) into a service category identifier (for example, compute, storage, network, database, analytics, logging) and may additionally map charge attributes into a standardized charge class (for example, usage, commitment, support, marketplace, tax, regulatory fee, credit) to enable deterministic eligibility evaluation across provider format variation. In some embodiments, the eligibility evaluation may be implemented using an exclusion rule table derived from vendor contract data, where the exclusion rule table may encode service-category scope, charge-class scope, effective date window, and precedence order across tiers, and where the processing device may evaluate precedence by selecting a most-specific rule match based on a tuple (tier, service category identifier, charge class, region, contract period). In some embodiments, an example implementation may include computing a first intermediate cost data by applying a cloud-provider tier discount to eligible compute usage line item while excluding commitment and support charges, and then computing an adjusted cost data by applying an intermediary vendor tier markup to the intermediate cost data while applying a pass-through rule to excluded charges, thereby yielding reconstructed effective cost data that may be auditable and comparable across procurement pathways. In some embodiments, the specific technology improved may include cloud billing normalization and vendor-aware cost reconstruction, because the system may generate a normalized effective cost representation that may be independent of provider-native discount presentation and may reflect contract-governed adjustments at each vendor tier.

In some embodiments, a technical problem addressed by the present disclosure may include that conventional execution governance for automated workload may be unsafe or unreliable when control authority is uncertain, because provider-native control surfaces may differ, access scope may be incomplete, and runtime configuration drift may cause an enforcement action to target an unintended control point. In some embodiments, the disclosed system may improve multi-cloud operational control technology by determining an enforcement confidence data representing a control-authority level prior to generating a governance action data that specifies a reversible operational state transition. In some embodiments, the enforcement confidence data may be computed by extracting an observed configuration state from execution telemetry data and comparing the observed configuration state to an expected configuration state model derived from a governance policy parameter, where the processing device may compute a configuration deviation metric and may inhibit governance action generation when the deviation metric exceeds a predefined threshold. In some embodiments, the expected configuration state model may be implemented as a compact state vector that may include an expected trigger state, an expected concurrency limit, an expected schedule window, an expected autoscaling parameter, and an expected identity/permission scope, and the observed configuration state may be implemented as a provider-reported configuration snapshot, a telemetry-derived indicator, or a merged view derived from multiple sources. In some embodiments, an example may include determining low enforcement confidence when a trigger-disable control appears unavailable for a managed service due to a missing permission scope, and the system may then generate advisory notification data rather than a provider-native control instruction. In some embodiments, the specific technology improved may include the safety of cloud control-plane enforcement, because gating by enforcement confidence may reduce erroneous or disruptive enforcement under drift or partial authority.

In some embodiments, a technical problem addressed by the present disclosure may include that runaway compute protection may be too coarse when it treats all anomalies as equal, thereby causing either a delayed response to high-severity runaway execution or an unnecessary disruption to a benign bursty workload. In some embodiments, the disclosed system may improve runtime anomaly handling technology by detecting an anomalous execution behavior from execution telemetry data and classifying the anomalous execution behavior according to a severity level prior to generating governance action data. In some embodiments, the processing device may calculate an execution rate metric from execution telemetry data, may compute a deviation value relative to a historical baseline metric stored in the storage device, and may assign severity based on deviation magnitude, deviation persistence, and reversibility indicator, where reversibility indicator may be inferred from whether the workload has a reversible control surface such as throttling, concurrency reduction, or trigger suppression. In some embodiments, an example may include assigning high severity when execution rate increases by an order of magnitude above baseline within a short evaluation interval while queue depth grows monotonically, and assigning lower severity when execution rate increases but cost exposure remains bounded by a policy parameter. In some embodiments, the specific technology improved may include automated workload governance accuracy, because severity-aware classification may support graduated, policy-consistent control selection rather than a single blunt action.

In some embodiments, a technical problem addressed by the present disclosure may include that conventional cost-management approaches may require application redeployment or CI/CD intervention, or other deployment or execution orchestration intervention to change workload behavior, thereby increasing mean time to mitigate runaway consumption and increasing operational risk during incident response. In some embodiments, the disclosed system may improve cloud operational state management technology by generating governance action data that specifies a reversible operational state transition, where the reversible operational state transition may include transitioning an automated workload between an active operational state, a minimal-cost operational state, and a cost-eliminated operational state while preserving a configuration state for restoration. In some embodiments, the processing device may capture a runtime configuration snapshot prior to applying a minimal-capacity parameter or trigger-disable parameter, and the storage device may store the runtime configuration snapshot with transition metadata to support deterministic restoration. In some embodiments, an example may include transitioning to minimal-cost by reducing concurrency while preserving schedule and identity configuration, and transitioning to cost-eliminated by disabling trigger while preserving the prior trigger routing configuration for later restoration, thereby avoiding code modification and redeployment. In some embodiments, the specific technology improved may include cloud incident response and control-plane governance, because reversible provider-native transitions may shorten mitigation latency while maintaining recoverability and auditability.

In some embodiments, a technical problem addressed by the present disclosure may include that multi-cloud governance may be fragmented when related workloads execute across different provider environments, account boundaries, or runtime substrates, thereby preventing consistent enforcement of policy and preventing unified cost exposure control. In some embodiments, the disclosed system may improve cross-cloud governance technology by mapping a workload identifier to a cross-cloud group identifier independent of deployment account or runtime substrate and by applying a shared governance policy parameter to the cross-cloud group identifier to coordinate governance action generation. In some embodiments, the workload identifier may be normalized from provider-native identifier (for example, function identifier, job identifier, service identifier, cluster identifier) into a canonical workload identity record that may include workload name, environment tag, cost center tag, and dependency tag, and the cross-cloud group identifier may be computed as a deterministic hash or registry key over a subset of these tags. In some embodiments, an example may include grouping a scheduled job in one provider with an event-driven service in another provider under a single budget threshold policy parameter, and the system may coordinate advisory notification data and enforcement confidence gating across the group. In some embodiments, the specific technology improved may include multi-cloud policy consistency and unified control-loop evaluation, because grouping may enable policy to be expressed and evaluated at a logical workload layer rather than at provider-specific silos.

In some embodiments, a technical problem addressed by the present disclosure may include that conventional governance may be non-responsive or overly chatty due to fixed polling, thereby missing fast runaway events or wasting resources by over-evaluating a stable workload. In some embodiments, the disclosed system may improve governance loop scheduling technology by performing detecting and determining operations in a continuous evaluation mode, a periodic evaluation mode, or an event-driven evaluation mode, where a control-loop scheduler may initiate evaluation upon a time tick, upon a threshold event, or upon a telemetry trigger. In some embodiments, an event-driven evaluation mode may be implemented by subscribing to a telemetry stream and initiating a policy evaluation routine only when a trigger condition is met, such as sudden change in execution rate metric, queue depth metric, or cost accumulation rate derived from reconstructed effective cost data. In some embodiments, the specific technology improved may include scalability and responsiveness of runtime governance, because control-loop evaluation may adapt to workload volatility and may reduce wasted compute while preserving fast reaction to runaway patterns.

In some embodiments, a technical problem addressed by the present disclosure may include that operators may require decision support without immediate enforcement when control authority is uncertain or when governance policy intends a non-disruptive response. In some embodiments, the disclosed system may improve governance explainability and audit technology by selecting an advisory mode based on enforcement confidence data, generating advisory notification data representing predicted cost exposure derived from reconstructed effective cost data, and storing the advisory notification data as part of an audit record. In some embodiments, predicted cost exposure may be computed by projecting current execution rate metric across a policy horizon and multiplying by reconstructed effective cost rate derived from eligible service category mapping, thereby producing an exposure estimate that may be contract-aware rather than provider-list-price-aware. In some embodiments, the specific technology improved may include governance auditability and operator decision support, because advisory outputs may be traceable to normalized cost reconstruction and to enforcement-confidence gating signals.

In some embodiments, a technical problem addressed by the present disclosure may include that enforcement confidence may be difficult to assess when telemetry provenance is uncertain or when configuration state is subject to spoofing or stale reporting, thereby risking unsafe governance action. In some embodiments, an additional feature may include computing an attested telemetry integrity signal and incorporating the attested telemetry integrity signal into the enforcement confidence data, where the processing device may verify an attestation token associated with the execution telemetry data and may reduce enforcement confidence when attestation verification fails. In some embodiments, an implementation may include using a hardware-backed attestation mechanism available to a provider-managed runtime or a trusted execution environment, and the processing device may verify signature validity, freshness window, and binding to a workload identifier prior to accepting telemetry for enforcement gating. In some embodiments, an example may include requiring valid attestation for trigger-disable instruction issuance while permitting advisory notification when attestation is absent. In some embodiments, the specific technology improved may include trustworthiness of telemetry-driven control-plane governance.

In some embodiments, a technical problem addressed by the present disclosure may include that policy evaluation may produce inconsistent or non-deterministic outcomes across deployments when policy is authored manually in different formats, thereby harming repeatability and increasing configuration drift. In some embodiments, an additional feature may include compiling a governance policy parameter from a declarative policy representation into a deterministic evaluation graph and executing the evaluation graph using the processing device, where the evaluation graph may be versioned and stored as a governance state record. In some embodiments, an implementation may include representing policy as a constraint set over normalized schema fields (for example, service category identifier, charge class, execution rate metric, deviation value, and enforcement confidence) and compiling the constraint set into an ordered decision structure with explicit precedence and short-circuit semantics. In some embodiments, an example may include storing a policy evaluation trace alongside the governance action data to support repeatable outcomes and post-incident audit. In some embodiments, the specific technology improved may include determinism and portability of multi-cloud governance policy execution.

In some embodiments, a technical problem addressed by the present disclosure may include that workload grouping may be brittle when grouping relies on static tags that drift or are missing, thereby preventing robust cross-cloud grouping for shared governance. In some embodiments, an additional feature may include computing a workload similarity embedding from execution telemetry data and using the embedding to propose or validate a cross-cloud group identifier, where the processing device may generate an embedding vector from normalized telemetry features and may compare the embedding vector to a stored embedding centroid for a group. In some embodiments, an implementation may include generating embeddings from features such as invocation periodicity, burstiness, queue depth dynamics, and cost accumulation rate derived from reconstructed effective cost data, and using cosine similarity or distance thresholding to associate a workload with a group when tag data is incomplete. In some embodiments, the specific technology improved may include resilience and accuracy of cross-cloud workload grouping.

In some embodiments, a technical problem addressed by the present disclosure may include that anomaly detection based purely on thresholding may generate false positives under seasonal patterns or under planned scale events, thereby causing unnecessary throttling or suspension. In some embodiments, an additional feature may include implementing a baseline model that is seasonality-aware and updating the historical baseline metric using a robust estimator, where the processing device may compute a baseline envelope over time-of-day or day-of-week buckets and may compute a deviation value relative to a bucket-specific baseline rather than a global baseline. In some embodiments, an implementation may include using a median-of-means estimator or a percentile-based envelope for baseline update to reduce the impact of outlier bursts and runaway episodes on future baselines. In some embodiments, the specific technology improved may include accuracy and stability of telemetry-based runaway detection and severity assignment.

In some embodiments, a technical problem addressed by the present disclosure may include that storing reconstructed effective cost data and governance action data may expose sensitive contract pricing and operational control trace, thereby increasing risk in multi-tenant SaaS deployments. In some embodiments, an additional feature may include applying field-level encryption and access-scoped tokenization to reconstructed effective cost data and to governance log data prior to storing, where the processing device may encrypt contract-derived adjustment parameters and may tokenize workload identifier fields while maintaining join capability via a keyed pseudonym. In some embodiments, an implementation may include encrypting vendor-specific discount rate, markup factor, and labor rate parameter at rest and maintaining a separate key scope per tenant or per contract period, thereby enabling audit and computation while limiting exposure. In some embodiments, the specific technology improved may include security of SaaS-based multi-cloud financial and execution governance data handling.

In some embodiments, a technical problem addressed by the present disclosure may include that translating a graduated control parameter into a provider-native control instruction may be error-prone across provider versions and API changes, thereby degrading reliability of reversible state transition. In some embodiments, an additional feature may include maintaining a provider-control capability profile for a workload and validating a control instruction against the capability profile prior to recording and transmission, where the processing device may match the graduated control parameter to a supported control surface and may select a safe fallback action when a target control surface is unsupported. In some embodiments, an example may include selecting concurrency reduction when trigger suppression is unsupported, or selecting advisory mode when neither control surface is supported with sufficient enforcement confidence. In some embodiments, the specific technology improved may include compatibility and reliability of multi-provider control-plane instruction synthesis.

In some embodiments, a technical problem addressed by the present disclosure may include that cost exposure estimates may be inaccurate when they rely on list pricing and ignore vendor-chain reconstructed effective cost, thereby reducing usefulness of advisory notification and policy thresholding. In some embodiments, an additional feature may include computing a cost accumulation rate using reconstructed effective cost data and integrating the cost accumulation rate into the detection of anomalous execution behavior, where the processing device may compute a combined anomaly score from execution rate metric and reconstructed effective cost rate to prioritize governance action when cost acceleration is high, even if invocation growth is moderate. In some embodiments, the specific technology improved may include cost-aware anomaly detection and prioritization for runaway compute protection.

In some embodiments, a technical problem addressed by the present disclosure may include that a reversible operational state transition may fail to restore correctly when state snapshot is incomplete or when restoration must be ordered across multiple control surfaces, thereby risking partial restoration. In some embodiments, an additional feature may include storing a state transition plan as an ordered sequence of provider-native control instruction with dependency metadata and executing restoration according to the dependency metadata, where the processing device may generate a plan that orders trigger restoration after concurrency restoration or that verifies a guard condition before re-enabling schedule. In some embodiments, the specific technology improved may include correctness and repeatability of reversible state transition and restoration in a provider-native control framework.

Although the present disclosure has been explained in relation to its preferred embodiment, it is to be understood that many other possible modifications and variations can be made without departing from the spirit and scope of the disclosure.

What is claimed is:

1. A method of facilitating multi-cloud financial and execution governance of an automated workload, the method comprising:
receiving, using a communication device, a billing record from a cloud provider system;
receiving, using the communication device, a vendor contract data from a procurement system;
receiving, using the communication device, an execution telemetry data from the cloud provider system;
analyzing, using a processing device, the billing record to identify an eligible service category for a pricing adjustment;
computing, using the processing device, a reconstructed effective cost data for the billing record based on the vendor contract data and the eligible service category;
detecting, using the processing device, an anomalous execution behavior of the automated workload or a group of coordinated workloads in a runtime execution environment based on the execution telemetry data;
determining, using the processing device, an enforcement confidence data representing a control-authority level for applying a provider-native control action to the automated workload based at least in part on the reconstructed effective cost data and the anomalous execution behavior;
generating, using the processing device, a governance action data specifying a reversible operational state transition for the automated workload in response to the anomalous execution behavior and a predicted cost exposure derived from the reconstructed effective cost data and the enforcement confidence data;
storing, using a storage device, the reconstructed effective cost data;
storing, using the storage device, the governance action data; and
transmitting, using the communication device, the governance action data for directly or indirectly causing an implementation of the reversible operational state transition at the automated workload.

2. The method of claim 1, further comprising:
determining, using the processing device, a service category identifier for the billing record by mapping a provider-specific service code in the billing record to a normalized internal schema;
evaluating, using the processing device, a discount eligibility rule associated with the vendor contract data against the service category identifier; and
generating, using the processing device, an eligibility flag for application of a pricing adjustment to the billing record based on the evaluating.

3. The method of claim 2, further comprising:
identifying, using the processing device, a charge attribute in the billing record corresponding to a support charge, a marketplace charge, a tax, a regulatory fee, a commitment charge, or a credit;
comparing, using the processing device, the charge attribute with an exclusion rule defined in the vendor contract data; and
filtering, using the processing device, the charge attribute from the pricing adjustment based on the comparing to generate a filtered billing record.

4. The method of claim 1, wherein the computing of the reconstructed effective cost data further comprises:
parsing, using the processing device, a tier parameter in the vendor contract data representing a multi-tier vendor chain;
applying, using the processing device, a first pricing adjustment associated with a cloud provider tier to generate an intermediate cost data;
applying, using the processing device, a second pricing adjustment associated with an intermediary vendor tier to the intermediate cost data to generate an adjusted cost data; and
aggregating, using the processing device, the adjusted cost data to generate the reconstructed effective cost data.

5. The method of claim 1, wherein the computing of the reconstructed effective cost data further comprises:
identifying, using the processing device, a labor rate parameter in the vendor contract data;
calculating, using the processing device, a labor cost data based on the labor rate parameter and a workload allocation attribute in the billing record; and
combining, using the processing device, the labor cost data with an infrastructure cost component to generate the reconstructed effective cost data.

6. The method of claim 1, further comprising:
generating, using the processing device, an expected configuration state model for the automated workload based on a governance policy parameter;
extracting, using the processing device, an observed configuration state or execution relationship from the execution telemetry data;
computing, using the processing device, a configuration deviation metric between the expected configuration state model and the observed configuration state or the execution relationship, wherein the configuration deviation metric includes detection of cyclic or recursive workload invocation patterns; and
inhibiting, using the processing device, the generating of the governance action data when the configuration deviation metric exceeds a predefined threshold.

7. The method of claim 1, further comprising:
calculating, using the processing device, an execution rate metric from the execution telemetry data;
computing, using the processing device, a deviation value between the execution rate metric and a historical baseline metric stored in the storage device; and
assigning, using the processing device, a severity level to the anomalous execution behavior based on the deviation value to modify a parameter of the governance action data, wherein the parameter comprises a throttling parameter, a concurrency parameter, a suspension parameter, or a circuit-breaker parameter configured to temporarily pause or rate-limit execution of the automated workload.

8. The method of claim 1, wherein the generating of the governance action data further comprises:
selecting, using the processing device, an advisory mode based on the enforcement confidence data;
generating, using the processing device, an advisory notification data representing a predicted cost exposure derived from the reconstructed effective cost data; and
storing, using the storage device, the advisory notification data as part of an audit record.

9. The method of claim 1, wherein the generating of the governance action data further comprises:
selecting, using the processing device, a graduated control parameter comprising a throttling parameter, a concurrency parameter, a trigger parameter, a suspension parameter, or a configurable rate-limit parameter based on the enforcement confidence data;
transforming, using the processing device, the graduated control parameter into a provider-native control instruction; and
recording, using the storage device, the provider-native control instruction in a governance log, wherein exceeding the configurable rate-limit parameter generates an alert notification.

10. The method of claim 1, wherein the reversible operational state transition further comprises:
capturing, using the processing device, a runtime configuration snapshot of the automated workload prior to applying the reversible operational state transition;
storing, using the storage device, the runtime configuration snapshot with a transition metadata;
applying, using the processing device, a minimal-capacity parameter, a trigger-disable parameter, or a temporary execution pause parameter to generate a modified execution state; and
restoring, using the processing device, the runtime configuration snapshot to reestablish an original execution state without modifying application code.

11. A system for facilitating multi-cloud financial and execution governance of an automated workload, the system comprising:
a communication device configured for:
receiving a billing record from a cloud provider system;
receiving a vendor contract data from a procurement system;
receiving an execution telemetry data from the cloud provider system; and
transmitting a governance action data to a client device;
a processing device configured for:
analyzing the billing record to identify an eligible service category for a pricing adjustment;
computing a reconstructed effective cost data for the billing record based on the vendor contract data and the eligible service category;
detecting an anomalous execution behavior of the automated workload based on the execution telemetry data;
determining an enforcement confidence data representing a control-authority level for applying a provider-native control action to the automated workload; and
generating the governance action data specifying a reversible operational state transition for the automated workload based on the anomalous execution behavior and the enforcement confidence data; and
a storage device configured for storing the reconstructed effective cost data and the governance action data.

12. The system of claim 11, wherein the processing device is further configured for:
determining a service category identifier for the billing record by mapping a provider-specific service code in the billing record to a normalized internal schema;
evaluating a discount eligibility rule associated with the vendor contract data against the service category identifier; and
generating an eligibility flag for application of a pricing adjustment to the billing record based on the evaluating.

13. The system of claim 12, wherein the processing device is further configured for:
identifying a charge attribute in the billing record corresponding to a support charge, a marketplace charge, a tax, a regulatory fee, a commitment charge, or a credit;
comparing the charge attribute with an exclusion rule defined in the vendor contract data; and
filtering the charge attribute from the pricing adjustment based on the comparing to generate a filtered billing record.

14. The system of claim 11, wherein the processing device is further configured for:
parsing a tier parameter in the vendor contract data representing a multi-tier vendor chain;
applying a first pricing adjustment associated with a cloud provider tier to generate an intermediate cost data;
applying a second pricing adjustment associated with an intermediary vendor tier to the intermediate cost data to generate an adjusted cost data; and
aggregating the adjusted cost data to generate the reconstructed effective cost data.

15. The system of claim 11, wherein the processing device is further configured for:
identifying a labor rate parameter in the vendor contract data;
calculating a labor cost data based on the labor rate parameter and a workload allocation attribute in the billing record; and
combining the labor cost data with an infrastructure cost component to generate the reconstructed effective cost data.

16. The system of claim 11, wherein the processing device is further configured for:
generating an expected configuration state model for the automated workload based on a governance policy parameter;
extracting an observed configuration state from the execution telemetry data;
computing a configuration deviation metric between the expected configuration state model and the observed configuration state; and
inhibiting the generating of the governance action data when the configuration deviation metric exceeds a predefined threshold.

17. The system of claim 11, wherein the processing device is further configured for:
calculating an execution rate metric from the execution telemetry data;
computing a deviation value between the execution rate metric and a historical baseline metric stored in the storage device; and
assigning a severity level to the anomalous execution behavior based on the deviation value to modify a parameter of the governance action data.

18. The system of claim 11, wherein the processing device is further configured for:
selecting an advisory mode based on the enforcement confidence data;
generating an advisory notification data representing a predicted cost exposure derived from the reconstructed effective cost data, wherein the storage device is further configured for storing the advisory notification data as part of an audit record.

19. The system of claim 11, wherein the processing device is further configured for:
selecting a graduated control parameter comprising a throttling parameter, a concurrency parameter, a trigger parameter, or a suspension parameter based on the enforcement confidence data;
transforming the graduated control parameter into a provider-native control instruction, wherein the storage device is further configured for recording the provider-native control instruction in a governance log.

20. The system of claim 11, wherein the processing device is further configured for:
identifying a workload identifier associated with the automated workload;
mapping the workload identifier to a cross-cloud group identifier independent of a deployment account or runtime substrate; and
applying a shared governance policy parameter to the cross-cloud group identifier to coordinate the generating of the governance action data.
